(19) United States
(12) Patent Application Publication
(10) Pub. No.: US 2026/0340586 A1
(43) Pub. Date: Oct. 29, 2026

(54) METHOD AND APPARATUS FOR AUTOMATED ASSESSMENT, MONITORING AND RISK MITIGATION

(71) Applicant: Live Circle, Inc., Ridgewood, NJ (US)

(72) Inventors: Charles Chadwick, Ridgewood, NJ (US); Darin Ragozzine, Heber City, UT (US); Blake Wilkey, Soddy Daisy, TN (US); Samuel Brotherton, Park City, UT (US)

(21) Appl. No.: 19/736,004

(22) Filed: Jul. 9, 2026

Related U.S. Application Data
(63) Continuation of application No. 18/082,544, filed on Dec. 15, 2022.
(63) Continuation of application No. 18/951,616, filed on Nov. 18, 2024.
(60) Provisional application No. 63/600,269, filed on Nov. 17, 2023.
(60) Provisional application No. 63/674,386, filed on Jul. 23, 2024.
(60) Provisional application No. 63/694,886, filed on Sep. 15, 2024.

(51) Int. Cl. G06Q 10/101; G06F 16/2455

(52) U.S. Cl. CPC G06Q 10/101; G06F 16/24568

(57) ABSTRACT

An agentic-based artificial intelligence system is provided for use in connection with deep learning systems and large language models. In one aspect, the AI system's ontology-based class hierarchies are used to define the relational operations of the system. In other aspects, the agents generate and respond to prompts to govern the agent operation. A prompt generation system is included that facilities agent operation in connection with the deep learning and large language models used by the AI to generate feedback. The agents may be organized as a network of agents and the individual AI system components themselves may each be configured as an agent within the overall AI system.

### CROSS-REFERENCE TO PRIORITY APPLICATIONS

This application is a continuation of U.S. patent application Ser. No. 18/951,616, filed on Nov. 18, 2024, and titled “METHOD AND APPARATUS FOR COLLABORATIVE NETWORK POWERED BY ARTIFICIAL INTELLIGENCE”, which claims priority to and the benefit of U.S. Provisional Application No. 63/600,269, filed on Nov. 17, 2023 and titled “COLLABORATIVE NETWORK POWERED BY ARTIFICIAL INTELLIGENCE”; U.S. Provisional Application No. 63/694,886, filed on Jul. 23, 2024, and titled “AUTOMATED ASSESSMENT AND ENGAGEMENT EVALUATION SYSTEM”; and U.S. Provisional Application No. 63/694,886, filed on Sep. 15, 2024; and titled “AUTOMATED HEALTH RISK MONITORING AND MITIGATION SYSTEM”, which is incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2020-2022, Live Circle Inc., All Rights Reserved.

### TECHNICAL FIELD

The invention relates to artificial intelligence (AI) computational tools involving probabilistic programming that are used to create automated prompts based on the system operation. Agents and networks of agents are a fundamental building block of the subsystems of the present invention.

### BACKGROUND

In other aspects, the inventions herein relate to computer-implemented AI software systems, data processing, and machine learning systems according to example embodiments, and more specifically to an automated assessment system for monitoring health, wellness and lifestyle changes from conversational and other data inputs correlating to higher risk of hospitalization or other urgent health resource utilizations.

In yet other aspects, the inventions herein relate to computer-implemented software systems, data processing, and machine learning systems according to example embodiments, and more specifically to an automated assessment system for evaluating the quality of interactions between people and scoring their respective health or wellness situations based on their conversations.

### 2. DESCRIPTION OF RELATED ART

Thus, the need exists in the art to provide for the AI systems and methods described and provided within this application.

### BRIEF SUMMARY OF THE INVENTION

According to one embodiment, the invention of the present invention provides for an automated method for encoding user communications with an ontology, the ontology being embedded within an artificial intelligence system, the method including: receiving a communications input from a user of the AI system; featurizing the communications input; extracting from the featurized communications input an ontology information structure including a first class attribute in the ontology; determining if a second class attribute is present in the ontology information structure; and soliciting input from the user based on the second class attribute in the ontology information structure.

In other aspects, the method of the invention further including determining a missing class attribute within the ontology; and the method further includes determining a value and an uncertainty for the missing class attribute; and the method further including using the agent to determine the value and the uncertainty.

According to one embodiment, the invention of the present invention provides an intelligent agent system within an artificial intelligence (AI) system, the intelligent agent system receiving communications from the plurality of users regarding an ontology specific to the group of users, the ontology containing missing attributes; a deep learning model, the agent system querying the deep learning model for information based on the ontology, the intelligent agent system retrieving the missing ontology information in response to the query; and a scoring agent, the scoring agent included as part of the intelligent agent system, the scoring agent providing a score based on the retrieved missing ontology information.

In other aspects, the invention further including a set of training transcripts, the deep learning model using the training transcripts to train the scoring agent; and further including a prompt generation system, the prompt generation system governing the scoring agent.

In another embodiment, an automated method for generating health assessments from a transcript of a conversation includes the steps of: Receiving an original transcript with speaker identification; Matching, using a large language model-powered agent system and a chain of reasoning prompts, each semantic unit (word, phrase, intent) in the received transcript to a set of relevant training transcripts for which there is an associated assessment instrument score; Ranking each training transcript by relevance to received original transcript; Determining, based on score of highest ranking training transcripts, a score for each speaker identified in the original transcript; Communicating to each speaker said score.

In another embodiment, an automated method for training a large language model to generate clinical health evaluations includes the steps of: Receiving audio data from conversations associated temporally with a human-completed health assessment instrument; Generating a training transcript from said audio data; Mapping a health assessment score, based on the scoring method of the health assessment instrument, to a temporally associated training transcript; Selecting randomly a plurality of training transcripts tagged with a health assessment score to match each possible score for said health assessment instrument; Creating a prompt instructing a large language model how to score an original transcript using a randomly selected training transcript as an example for each possible score; Generating, using the prompts and large language model, health assessment scores for original transcripts until weights for large language model output are above desired thresholds.

In another embodiment, an automated method for generating a health alert based on interactions involving a caregiver, the method including the steps of: receiving a set of data related to an interaction; generating a set of featurized data from the received set of data; using said set of featurized data, extracting an at least one predicate related to the caregiver; based on said at least one extracted predicate, generating a health trajectory of the caregiver; based on said health trajectory, predicting for a patient an at least one of a risk of hospitalization, a risk of an emergency (911) call, and a risk of an urgent health-care encounter; and communicating said at least one risk to an appropriate party; wherein said interaction is a conversation including a live conversation, a recorded conversation, a text, a live multi-party communication, a recorded multi-party communication, or a combination thereof; wherein said featurization system is trained on clinical data (e.g., clinical trial data collected during a clinical trial study, including conversational data, involving voice recordings); wherein the extracting step includes using an agentic network that includes an agent for each prompt, a predicate extraction tool, and a deep learning model pre-trained on vast amounts of data (e.g., a generative model or a large language model or a multi-modal large language model); wherein said agent directs the predicate extraction tool to perform an extraction based on an ontology; wherein said agentic network is trained using a selection of a health-assessment-instrument score, a biometric measure, an electronic medical record information, a hospitalization cost, a medical provider cost, a clinical conversation, a conversation recorded during a studied intervention, a statistical data, a computed data, or a combination thereof; wherein the step of generating a health trajectory is based on an automated health-assessment-instrument score using the at least one extracted predicate; wherein said at least one extracted predicate relates to one of a set of possible answers in a validated health-assessment instrument; wherein said health-assessment instrument is one of a Generalized Anxiety Disorder assessment (e.g., GAD-7), a personal health care questionnaire assessment (e.g., PHQ-9 or other depression assessment instrument), a Caregiver Burden assessment, a quality of life assessment, and other health care assessment (e.g., therapeutic engagement index); wherein the health-assessment-instrument score is determined for said at least one extracted predicate based on a scoring rubric of a validated health-assessment instrument; wherein predicting said at least one risk is based on a classification model using a set of predicates related to the patient and the caregiver; wherein the health trajectory is generated for each party in the interaction; wherein said at least one risk is communicated to said caregiver; wherein said at least one risk is communicated to said patient; wherein said at least one risk is communicated to a case manager; wherein said at least one risk is communicated to an electronic medical records system; wherein communicating step includes an alert regarding said at least one risk; wherein said at least one risk includes an information that includes an at least one of a probability value, an audio data, a text data, an image data, and a reading data from a device (e.g., sensor data).

In another embodiment, an automated method for generating a health alert based on interactions involving a caregiver, includes the steps of: receiving a set of data related to an interaction; generating a set of featurized data from the received set of data; using said set of featurized data, extracting an at least one predicate related to the caregiver; based on said at least one extracted predicate, generating a health trajectory of the caregiver; based on said health trajectory, predicting for said caregiver an at least one of a risk of hospitalization, a risk of an emergency (911) call, and a risk of an urgent health-care encounter; and communicating said at least one risk to an appropriate party.

The objects and features of the present invention may be applied jointly or severally in any combination or sub-combination by those skilled in the art.

### BRIEF DESCRIPTION OF THE SEVERAL VIEWS OF THE DRAWING(S)

Detailed embodiments of the present invention(s) are disclosed herein; however, it is to be understood that the disclosed embodiments are merely exemplary of the invention(s), which may be embodied in various forms. Therefore, specific structural and functional details disclosed herein are not to be interpreted as limiting, but merely as a basis for the claims and as a representative basis for teaching one skilled in the art to variously employ the present invention(s) in virtually any appropriately detailed structure. Further, the terms and phrases used herein are not intended to be limiting, but rather to provide an understandable description of the invention(s).

The accompanying drawings, which are incorporated in and constitute part of this specification, illustrate embodiments and/or aspects of the invention and/or disclosure, and together with the written description, these drawing serve to explain the principles of the invention. Wherever possible, the same reference numbers are used throughout the drawings to refer to the same or like elements of an embodiment. The embodiments illustrated herein are presently preferred, it being understood, however, that the invention is not limited to the precise arrangements and instrumentalities shown, in which:

FIG. 1 is a block diagram illustrating a multi-agent collaborative network system in accordance with various embodiments of the invention;

FIG. 2 illustrates the sharing of information between intelligent agent system and the intelligent agent, especially during initialization, in accordance with various embodiments of the invention;

FIG. 3 shows the class hierarchy of a story-based ontology class hierarchy in accordance with various embodiments of the invention;

FIG. 4A and FIG. 4B show the class structure and class instances, respectively, in a class hierarchy of a story-based ontology in accordance with various embodiments of the invention;

FIG. 5 illustrates a partial instance of the class hierarchy of a story-based ontology, particularly an Identity class and a Role class, each with associated property and relations attributes in accordance with various embodiments of the invention;

FIG. 6 shows an example of how user input scored by classifier models trained or fine-tuned on validated instruments may be represented in the story-based ontology class hierarchy in accordance with various embodiments of the invention;

FIG. 7 shows how the Contract class may act as a collaborative conjunction between different instances of different Identities using the same story-based ontology class Hierarchy, in accordance with various embodiments of the invention;

FIG. 8 is a diagram showing a Contract as a ledger in accordance with various embodiments of the invention;

FIG. 9 shows an example of how a best next action step may impact the value and uncertainty components of a property attribute instance in accordance with various embodiments of the invention;

FIG. 10 shows an overview of how user current states and user future states may be represented in terms of story-based ontology instances in accordance with various embodiments of the invention;

FIG. 11 is a diagram showing a comparison between likely trajectories of user states in accordance with various embodiments of the invention;

FIG. 12 is a flow diagram showing a continuous learning loop where a prompt generation system may learn iteratively from user inputs and prompted downstream model and program outputs (based on user inputs) how best to advance users to user goals with each newly generated prompt, in accordance with various embodiments of the invention;

FIG. 13 is a diagram showing a decentralized network of intelligent agents and users in accordance with various embodiments of the invention;

FIG. 14A is a block diagram showing an intelligent agent schema in accordance with various embodiments of the invention;

FIG. 14B is a diagram showing how users may interact with their Agents, and how their Agents may interact with the Agents of other users in a collaborative network in accordance with various embodiments of the invention;

FIG. 15 is a flow diagram showing how intelligent agents may support the advance of users towards goals based on their inputs or on inputs about them in accordance with various embodiments of the invention;

FIG. 16 is a flow diagram showing collaborative use of a story-based ontology featurizer as part of a communications featurization system, in accordance with various embodiments of the invention;

FIG. 17 is a flow diagram showing collaborative use of a validated instrument featurizer, in accordance with various embodiments of the invention;

FIG. 18 is a flow diagram showing collaborative use of a use case featurizer, in accordance with various embodiments of the invention;

FIG. 19 is a flow diagram showing collaborative use of a specific user featurizer, in accordance with various embodiments of the invention;

FIG. 20 is a diagram showing a communications featurization system in accordance with various embodiments of the invention;

FIG. 21 is a diagram showing a communications featurization system with embedded models and analysis in accordance with various embodiments of the invention;

FIG. 22A is a diagram showing a method of encoding of predicates with an ontology in accordance with various embodiments of the invention;

FIG. 22B is a flow diagram showing encoding of featurized inputs with a story-based ontology in accordance with various embodiments of the invention;

FIG. 22C is a flow diagram showing collaborative development of a prompt in accordance with various embodiments of the invention;

FIG. 23 illustrates example elements of a prompt for instructing a LLM how to score a live conversation in accordance with various embodiments of the invention;

FIG. 24 is a flow diagram showing how LLMs may be prompted to score input in accordance with various embodiments of the invention;

FIG. 25 is a diagram showing how a LLM may classify and score inputs and associate these scored inputs with a story-based ontology in accordance with various embodiments of the invention;

FIG. 26 is a flow diagram showing a collaborative process for scoring and evaluating anxiety using a fine-tuned LLM in accordance with various embodiments of the invention;

FIG. 27 is a flow diagram showing the transformation of a use case into a story based on a story-based ontology in accordance with various embodiments of the invention;

FIG. 28 shows how a large language model may be prompted to encode user's multi-modal input with a story-based ontology in accordance with various embodiments of the invention;

FIG. 29A is a diagram showing highlighting and annotating functions of dataslices, or partitions, of a datastream by type of datastream in accordance with various embodiments of the invention;

FIG. 29B is a diagram showing an abstractive summarizer (e.g., seeing a summary of transcript in whole or in part during or after a video call with scores associated with selection) in accordance with various embodiments of the invention;

FIG. 29C is a diagram showing annotations of displays in accordance with various embodiments of the invention;

FIG. 29D is a diagram showing commenting threads in accordance with various embodiments of the invention;

FIG. 30A is a flow diagram illustrating steps of an automated method for training a classifier on reference speech data in accordance with various embodiments of the invention;

FIG. 30B is a flow diagram illustrating steps of an automated method for training an extractor on reference speech data in accordance with various embodiments of the invention;

FIG. 30C is a flow diagram illustrating steps of an automated method for training a classifier on reference Treatment data in accordance with various embodiments of the invention;

FIG. 30D is a flow diagram illustrating steps of an automated method for training an extractor on reference treatment data in accordance with various embodiments of the invention;

FIG. 30E shows how training data may be curated collaboratively in accordance with various embodiments of the invention;

FIG. 31 is a flow diagram showing a collaborative process for fine-tuning a large language model in accordance with various embodiments of the invention;

FIG. 32 shows intelligent agents during training dataset curation in accordance with various embodiments of the invention;

FIG. 33 shows a sequence of collaboratively developed software artifacts in accordance with various embodiments of the invention;

FIG. 34 is a block diagram showing activity information provided to users in accordance with various embodiments of the invention;

FIG. 35 illustrates a flow from natural language input to a LLM in accordance with various embodiments of the invention;

FIG. 36 is a process flow diagram for standardizing data types for use by system models from input datastreams in accordance with various embodiments of the invention;

FIG. 37 is a flow diagram for standardizing system data relating specifically to creating a universal format for each type of received datastreams in accordance with various embodiments of the invention;

FIG. 38 shows the transformation flow from universally formatted data by data type to vectorization in accordance with various embodiments of the invention;

FIG. 39 shows custom ASR featurization and vectorization, particularly, audio featurized into two streams of different datatypes and merged into one tensor in accordance with various embodiments of the invention;

FIG. 40 shows a flow of steps involving production of one or more tensors from a multi-modal input (e.g., audio/video with text) in accordance with various embodiments of the invention;

FIG. 41 shows vectorization, particularly during simple data conversion flow, to transform simple data into a tensor in accordance with various embodiments of the invention;

FIG. 42 shows deep learning extractors, particularly during Insight Extraction Flow and Simple Data Conversion Flow, may work on multiple featurized datastreams in accordance with various embodiments of the invention;

FIG. 43 shows how extractors, during Insight Extraction Flow, particularly video extractors, may detect objects (a real cat) in accordance with various embodiments of the invention;

FIG. 44 shows insight extraction flow-extractors, particularly video-OCR in accordance with various embodiments of the invention;

FIG. 45 shows insight extraction flow-extractors, particularly audio-object detection (sounds of a real cat) in accordance with various embodiments of the invention;

FIG. 46 shows a flow involving the transformation of a tensor representation of text into raw text in accordance with various embodiments of the invention;

FIG. 47 shows insight extraction flow-SVOs and predicates, particularly producing SVOs and predicates from deep learning text extraction models in accordance with various embodiments of the invention;

FIG. 48 shows a flow for a LLM-prompted extraction of SVOs from inputs in accordance with various embodiments of the invention;

FIG. 49 shows a large language model input and output process in accordance with various embodiments of the invention;

FIG. 50 shows insight extraction flow involving SVOs and predicates in accordance with various embodiments of the invention;

FIG. 51 shows insight extraction flow scores from classifiers, in accordance with various embodiments of the invention;

FIG. 52 shows insight extraction flow involving SVOs, in accordance with various embodiments of the invention;

FIG. 53 is a flow diagram showing steps to determine reciprocity in accordance with various embodiments of the invention;

FIG. 54 is a box diagram shows core transformations of data into standardized representations of structured knowledge in accordance with various embodiments of the invention;

FIG. 55 is a process flow diagram showing the training of a ML-based agent network to predict assessments using transcripts in accordance with various embodiments of the present invention;

FIG. 56 is a flow diagram showing transformation of audio input to scoring outputs using a ML-based agent network, a LLM, and predicates, in accordance with various embodiments of the present invention;

FIG. 57 is a flow diagram showing an annotated transcript generated from audio recording or live conversation and displayed in accordance with various embodiments of the present invention;

FIG. 58 is a structure diagram showing total assessment score for each speaker based on completed conversation between speakers in accordance with various embodiments of the present invention;

FIG. 59 is a flow diagram showing an overview of processing an active interaction using an agentic network in accordance with various embodiments of the present invention;

FIG. 60 is a flow diagram showing an overview of a single agent in an agentic network in accordance with various embodiments of the present invention; and

FIG. 61 is a flow diagram showing how an alert may be generated using an agentic network in accordance with various embodiments of the present invention.

To facilitate understanding, identical reference numerals have been used, where possible, to designate identical elements that are common to the figures.

### DETAILED DESCRIPTION OF THE INVENTION

To facilitate a clear understanding of the present invention, illustrative examples are provided herein which describe certain aspects of the invention. However, it is to be appreciated that these illustrations are not meant to limit the scope of the invention, and are provided herein to illustrate certain concepts associated with the invention.

It is also to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed. Specifically, any of the computers or devices may be interconnected using any existing or later-discovered networking technology and may also all be connected through a lager network system, such as a corporate network, metropolitan network or a global network, such as the internet.

Many examples within the description below are provided in the particular context of a healthcare system. However, any practical application may be made of the system of the present invention.

### Ontology-Driven Agents and Agent Network

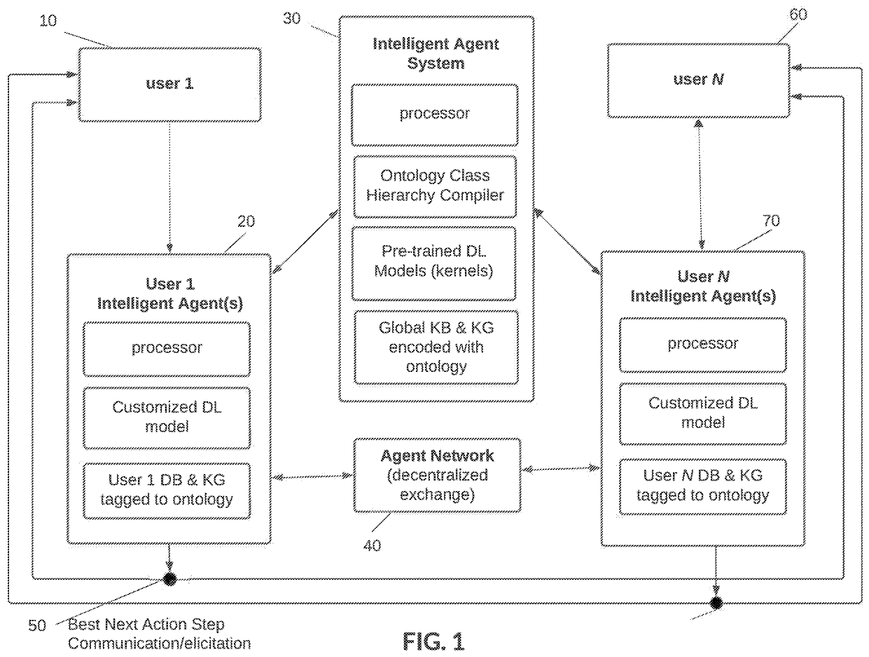

FIG. 1 is a block diagram illustrating a multi-agent collaborative network system in accordance with various embodiments of the invention. As shown, the components of the collaborative network system include at least users, user intelligent agents, an intelligent agent system, and an agent network.

In particular, FIG. 1 illustrates collaborations between users and their intelligent agents and between users, including through collaborations between their respective agents as facilitated by the agent network (Note, in the figure, the term “User N” is meant to convey any number of users, or N users, with their respective agent or agents).

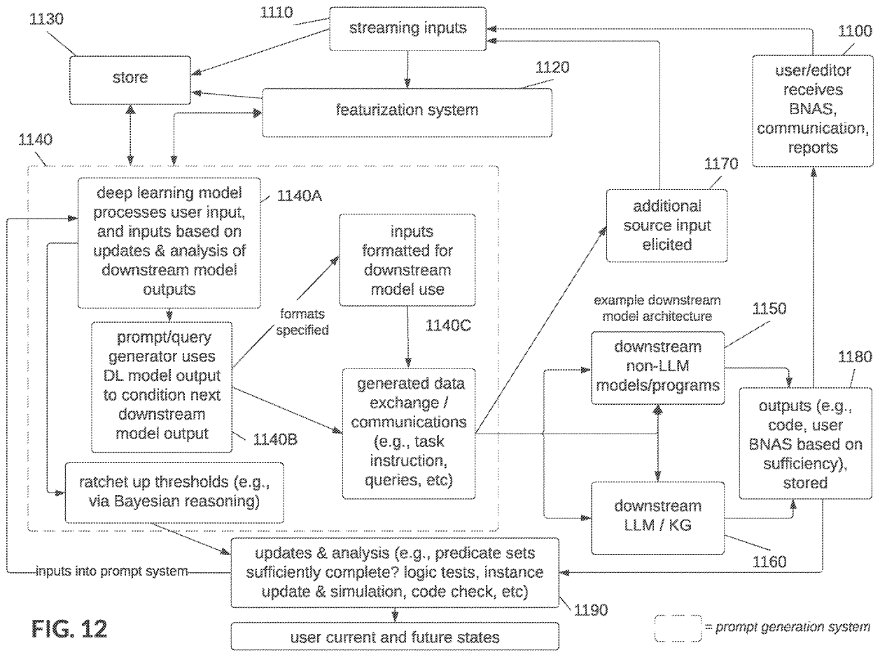

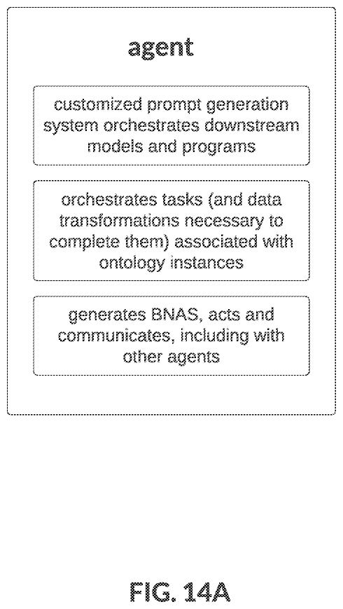

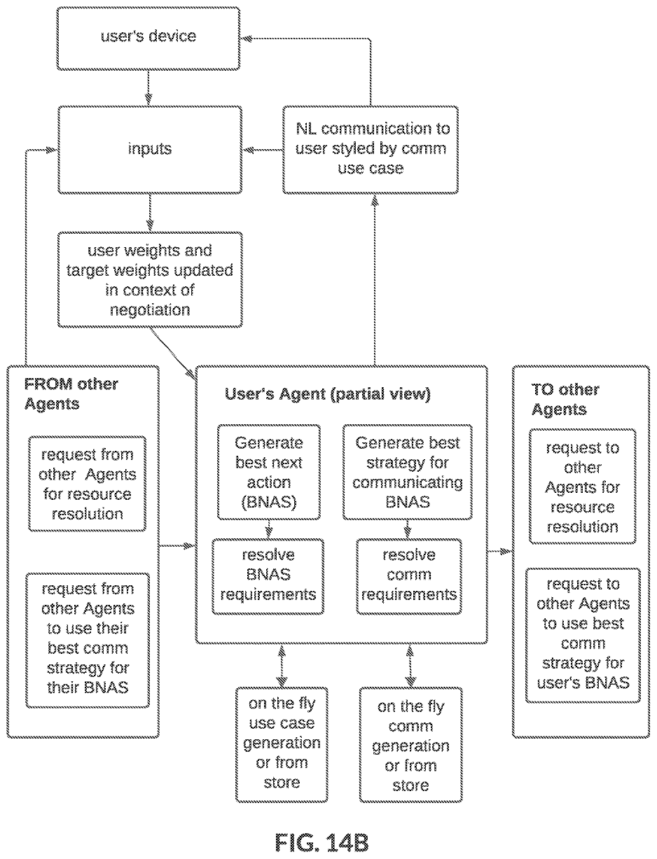

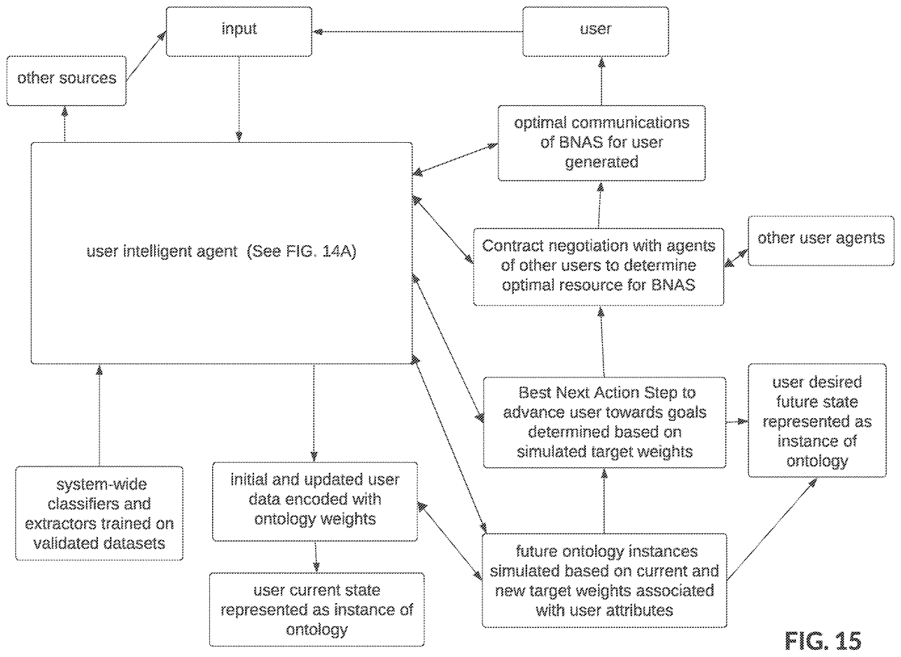

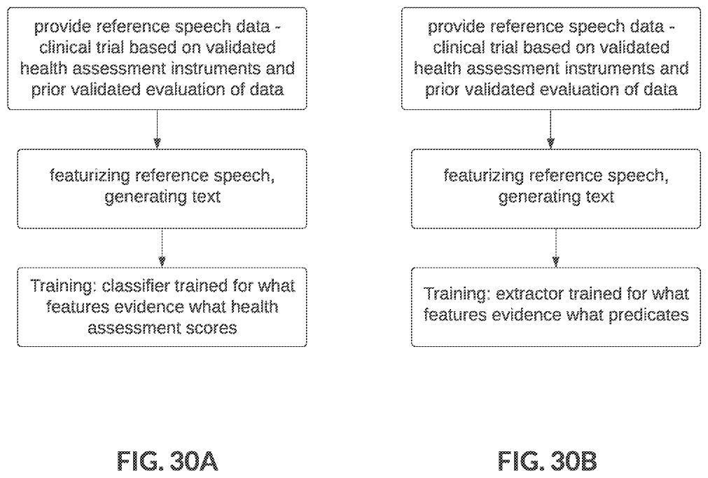

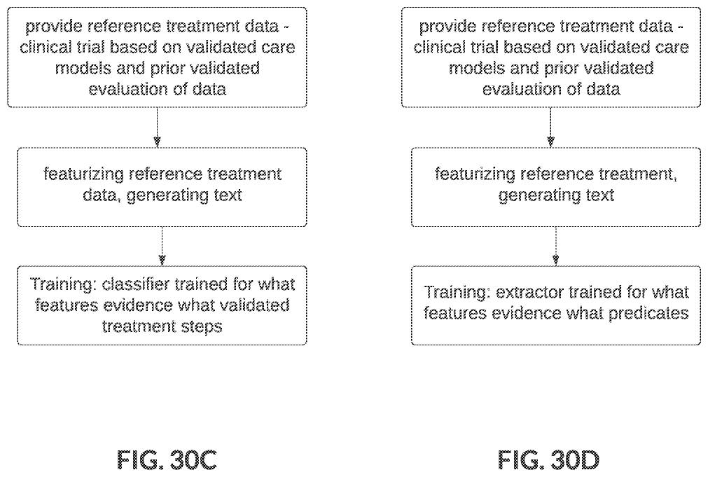

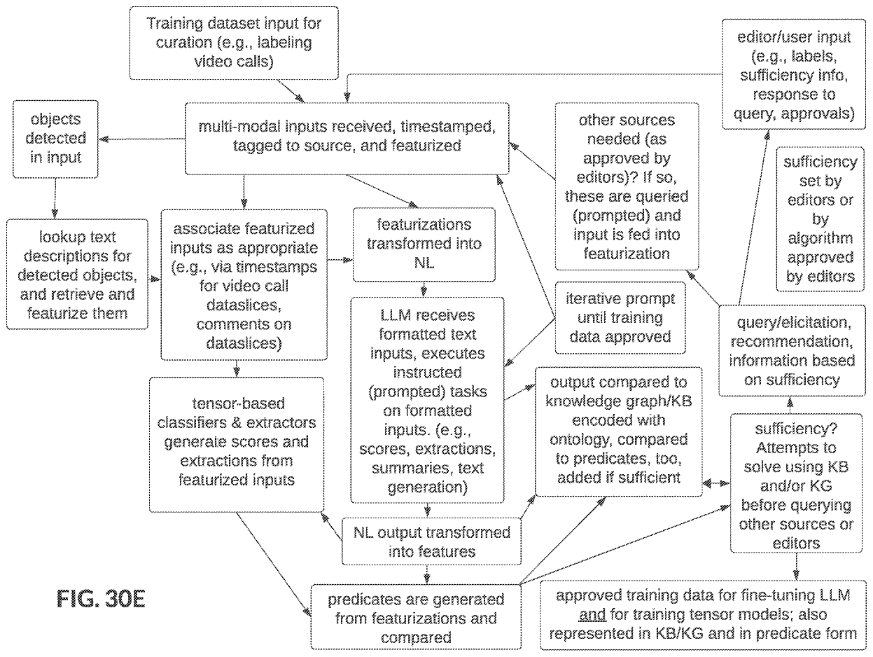

In the example embodiment, a prompt generation system, together with the downstream models and programs it prompts (See FIG. 12), may act as intelligent agents 20 and 70 (See FIG. 14A). Additionally, in the example embodiment, the models and programs comprising the prompt generation system and the downstream models it prompts may be trained, as core models of the intelligent agent system 30 (See FIGS. 30A-30E on training). From said core models, or “kernels”, user models may be customized based on user and user agent inputs.

Referring now to User 10 in the block diagram, a user may refer to a person and/or device that operates software which may be connected in various ways (e.g., cloud, APIs, other) and in virtually any context to the artificial intelligence (AI) system running over a network in the example embodiment. While many example uses provided herein involve people, it is understood that avatars, agents, software systems, and other products of software and in combinations thereof may be users. In various embodiments, the Intelligent Agent System may be a user and as a user also have one or more agents.

As shown in FIG. 1, User intelligent agent 20, which is User 10's agent, may receive outputs of User 10. These outputs may be streaming (real-time) data of various types and in various combinations (e.g., text and images, such as emoji's). In the example embodiment, User intelligent agent 20 may process the outputs of User 10 using its own processor. In another example embodiment, User intelligent agent 20 may receive outputs of User 10, and then feed them into a processor of Intelligent Agent System 30.

In the example embodiment, the original outputs of User 10 may be stored as original outputs of user 10 in a database for User 10. User 10 database may be hosted in Intelligent Agent System 30 or locally. Access to User 10 database may be through APIs and may have protected access requiring authentication and other privacy and authorization processes, particularly related to human users.

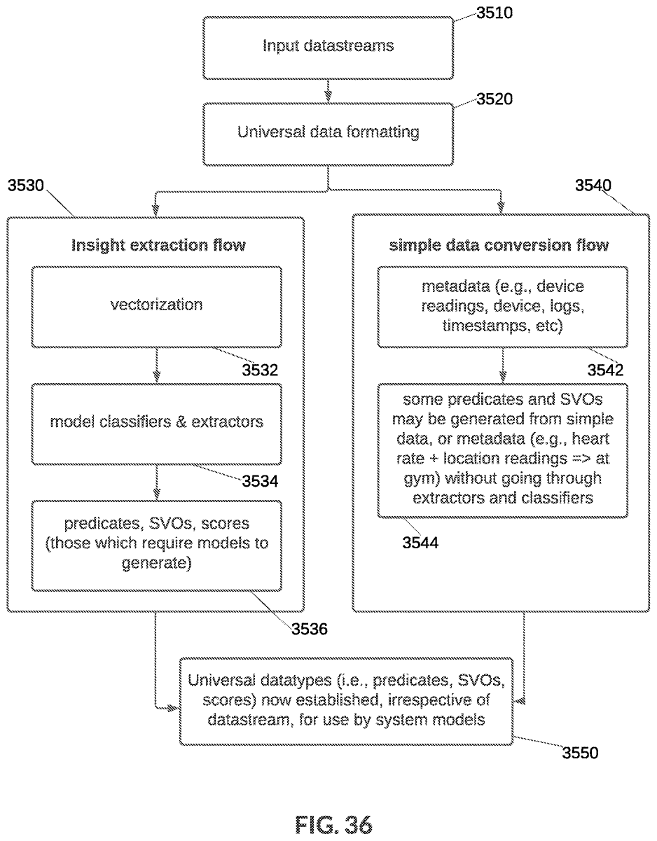

In the example embodiment, original outputs of User 10 may be processed by a receiving processor first into a universal format used for the type of data that User 10 output is determined to be, which may include a video stream and/or audio stream and/or device output data and/or text data (See FIG. 36). Once formatted into a universal format by datatype, the data may undergo various transformations resulting in vectors or tensors for use in deep learning models that use vectors and/or tensors, and may complete the featurization of User 10 outputs.

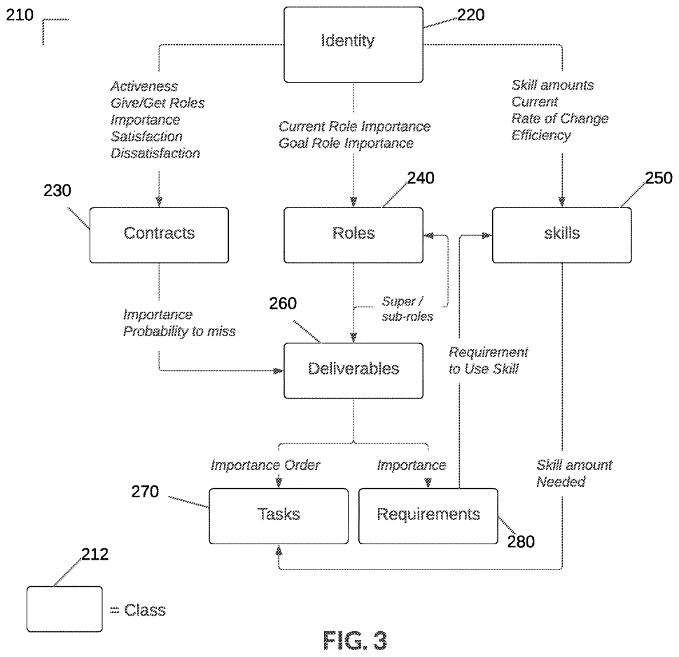

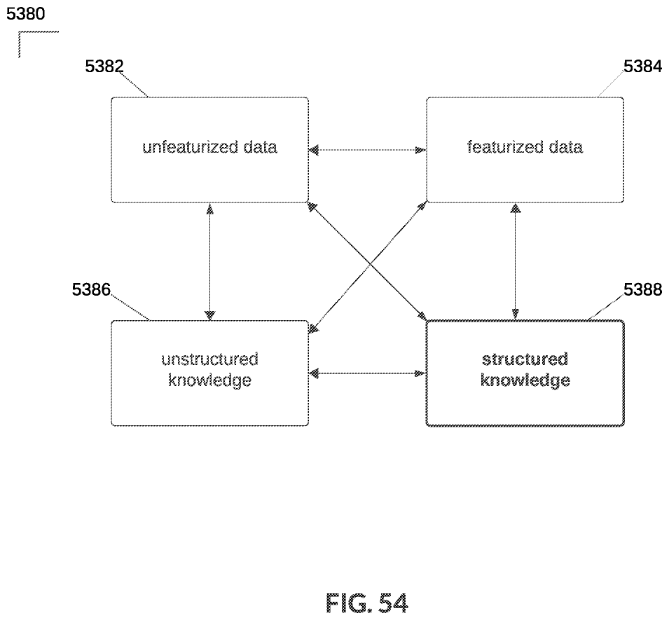

Next, the featurized data from User 10 may be used (e.g., via transfer learning techniques and transformer-based models) to customize the pre-trained classifiers and extractors made available to User intelligent agent 20 through Intelligent Agent System 30. The customization may involve further data transformations (See FIG. 54), which may be orchestrated by a prompt generation system (See FIG. 12). In the example embodiment, a prompt generation system (and the tasks it orchestrates) may be conditioned to act as an intelligent agent. In the example embodiment, pre-trained deep learning (DL) models being made available to User intelligent agent 20 may be already trained (See FIG. 30A-D) to perform certain tasks (e.g., classification/extraction) based on datasets comprising examples of a story-based ontology class hierarchy (See FIGS. 3-9), and various validated instrument assessments and/or use cases preferably related to the assessments.

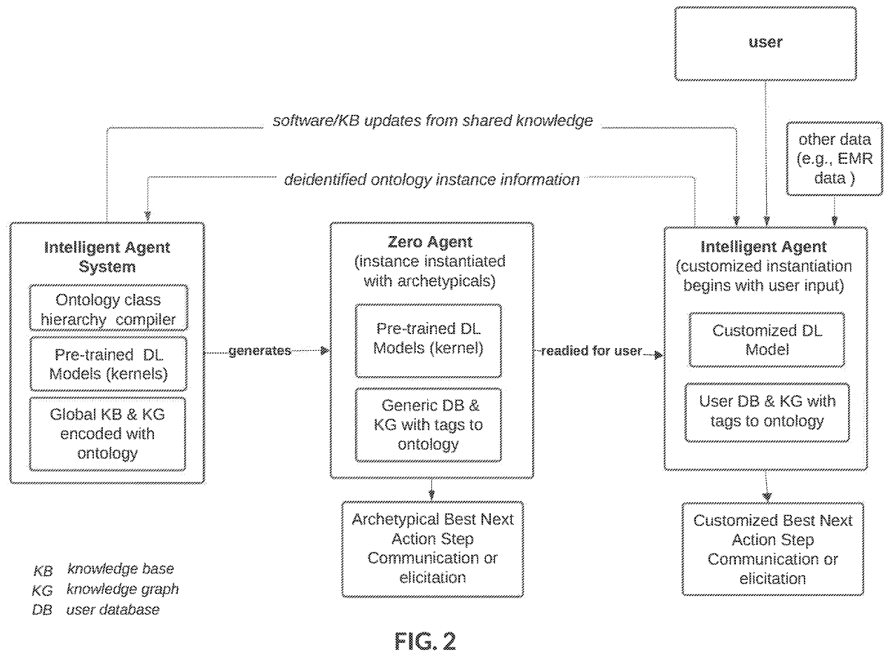

In addition, a generic database and knowledge graph pre-populated with archetypicals, based on deidentified, story-based ontology-encoded representations of the data, also may be made available to User intelligent agent 20 by Intelligent Agent System 30. In the example embodiment, initial archetypicals maintained and updated by Intelligent Agent System 30 may be based on deidentified but encoded information from all agents of all users as well as certain well-known relationships observed from human experience that may be represented in the story-based ontology class hierarchy (See FIG. 2 for a description of a zero agent, referring to said “pre-population”).

Through the foregoing, User intelligent agent 20 now may have access to both the kernels of systemwide models that may be used to encode user 10 inputs with various features, including story-based ontology features, and to an initial database and knowledge graph for user 10 pre-populated with archetypicals tagged to the story-based ontology. Next, User 10 featurized data may flow into certain layers of the pre-trained models made available by Intelligent Agent System 30 to customize the pre-trained models and encode the user specific data with story-based ontology and other information. These specific user encodings, based on User 10 outputs, may be stored in User 10 database and User 10 knowledge graph with appropriate tags.

Once classifications and extractions have been encoded with the story-based ontology and other information by the deep learning model being customized by User Intelligent Agent 20 with User 10 data, these may be made available in the proper form to a compiler in the Intelligent System Agent 30. Upon receipt of the output of customized model output from User Intelligent Agent 20 in the proper form, Intelligent System Agent 30 may compile code based on the story-based ontology class hierarchy, and instantiate objects with specific user and story-based ontology information based on knowledge stores.

The global knowledge base and knowledge graph related to Intelligent Agent System 30 may be updated with deidentified, encoded information based on instantiations of customized outputs of User Intelligent Agent 20. The updated information also may update the user specific database and knowledge graph with non-deidentified data.

Next, the updates may be used to characterize a current state for User 10 as a current story-based ontology instance, and serve as a basis for analysis by intelligent agent 20. During updating and analysis, encoded information may be associated with current and target weights for value and uncertainty components of attributes in the story-based ontology class hierarchy. It should be noted here that in the example embodiment, all of a user's known information may be encoded in terms of the story-based ontology to represent the user as a “whole person,” with an Identity comprising many roles, skills, and Contracts, for example, which may involve other Identities. Current, historical and target weights and other information related to the class attributes in the story-based ontology hierarchy may be assessed and simulated by intelligent agent 20 to provide a representation of User 10 in various states.

In the example embodiment, to assist users with reaching their goals, Intelligent agent 20 may simulate a use case from an inventory as an intervention to see if the simulation may shift trajectories in the attribute weights for User 10, and/or intelligent agent 20 may generate a use case on the fly, for consideration. In the example embodiment, generating a use case on the fly may involve traversing knowledge stores and simulating possibilities related to User 10. After analyzing outputs of the analysis, User intelligent agent 20 may determine a best next action step related to User 10.

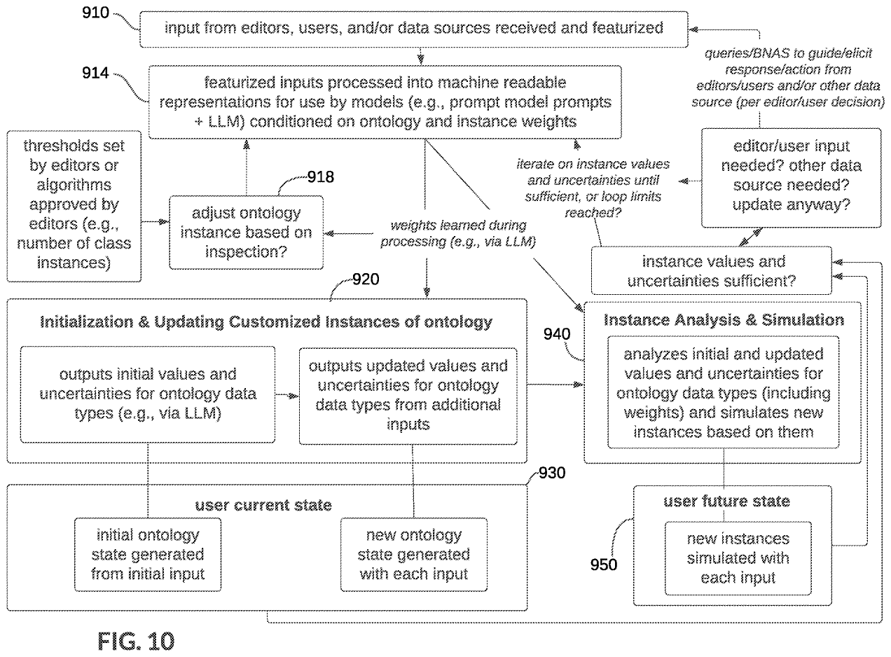

In the example embodiment, analysis may also be performed by Intelligent Agent System 30 based on its updated global knowledge stores. (See FIG. 10 and FIG. 12 for detailed descriptions of updating and analysis.) In the example embodiment, analysis may be conducted on the instantiations and on other data related to the encodings of the extracted and classified information at both an individual user level and at a system level. In the example embodiment, knowledge sharing between Intelligent System Agent System 30 (e.g., on a deidentified basis) and intelligent agents based on the same story-based ontology class hierarchy and various other universal representations of structured knowledge associated with the story-based ontology (e.g., probabilistic predicates), may facilitate richer analysis (including simulations) across agent and user populations. It also may make available to users insights that they may not otherwise have access to or be able to apply.

Knowledge stores may be updated with newly conducted analyses and the best next step prediction.

At this point, with best next action step predicted, User intelligent agent 20 may negotiate with intelligent agents of other users through the network of agents 40 for resources to take the Best Next Action Step recommended for their user. See FIG. 14B and FIG. 15. If such a determination is made, with user consent, intelligent agents may enter into a Contract as defined in the story-based ontology class hierarchy. The output of the intelligent agent 20 may include a best next action step communication 50, which may include various ways for User 10 and User 60 to interact with each other and/or with their intelligent agents (20,70) in the example embodiment. For example, at 50, a template to guide a particular interaction may launch. In another example embodiment, at 50, the output may be a natural language output related to the intelligent agent 20's choice for how best to communicate the Best Next Action Step.

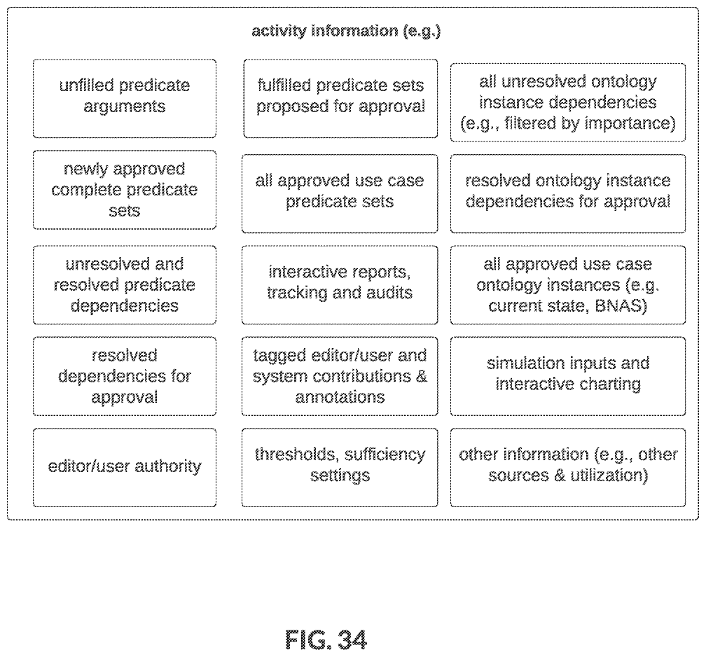

As shown in FIG. 1 by the arrows between 50 back to user 10, the actions of the User 10, in response to a BNAS communication generated by User intelligent agent 20, become new User 10 output. This new User 10 output, in turn, may be processed as described previously to produce new updates and new analysis, including an analysis of the impact of the prior recommendation on user actions, as part of generating the next BNAS. In the example embodiment, the sequence of BNASs, and adjustments made by their intelligent agent from one BNAS recommendation to the next based on the User response, may chart at least two unique paths for each user. One path may be the BNAS recommendations, the other the user action, or response. In the example embodiment, intelligent agent 20 charted paths may be compared, and new insights generated from them. In the example embodiment charting information may be included in the activity information available to User 10 (See FIG. 34), to assist user with their goal setting and decisions, and to show users changes made by intelligent agent 20 as a result of user inputs. In other words, in the example embodiment, the system may show the user what the system has learned from the user.

Referring now in FIGS. 1 to 60, 70, and 80, these are mirrors of 10, 20, and 50 respectively.

Consequently, with many users, each with at least two charted paths, the intertwining of paths between users and agents (e.g., their BNAS recommendations) may be observed and analyzed in the example embodiment (e.g., via knowledge graphs). This analysis may facilitate richer analysis of user responses or actions by both intelligent agents and the intelligent agent system, which in turn may be used to guide users from their “current story” to their “envisioned story”. For example, it may be determined from analysis which new skills are likely demonstrated, when, in what context, by User 10 or User 60? Which conflicts may be overcome (based on an analysis of Contracts in the story-based ontology class hierarchy) and how (which target weights for attribute components were aided by what Contracts?)? Which inflections in user paths may be anticipated for other users, with similar paths, and factor into the analysis of what may work best for those users?

FIG. 2 illustrates the sharing of information between intelligent agent system and the intelligent agent, especially during initialization, in accordance with various embodiments of the invention.

In FIG. 2, it is shown that software and knowledgebase and knowledge graph updates occurring in the Intelligent agent system may be shared with the user's intelligent agent. It is also shown that deidentified story-based ontology information based on user specific information is shared with the intelligent agent system.

In FIG. 2, it is shown that the intelligent agent system may generate a zero agent instance of the story-based ontology, meaning the generated instance may comprise archetypicals. In the example embodiment, these archetypicals may include genericized instances, best next action steps and BNAS communications of the story-based ontology class hierarchy. These genericized instances may be based on information in the global knowledge base and knowledge graph of the intelligent agent system. In the example embodiment, archetypicals may refer to genericized instances involving commonly observed relationships, for which initial data may exist to exemplify the story-based ontology managed and updated by the intelligent agent system (e.g., X % of people have a renter Role and Y % of people have a landlord Role in a class Hierarchy involving roles as a class). Thus, the user may benefit from the beginning from other users' data (deidentified and encoded with the story-based ontology) and various associated facts, or probabilities.

Next, in FIG. 2, user inputs received and processed may be used by the User intelligent agent to customize the encodings of the user database and knowledge graphs with story-based ontology and other information. These inputs from or about the user may include other data, such as EMR data (electronic medical record data), for example.

### Story-Based Ontology Uses Probability to Model and Improve Real World Interactions

FIG. 3 shows the class hierarchy 210 of a story-based ontology according one embodiment of the invention. In sum, a story may refer to sequences of actions, conflicts and resolutions involving relationships between system users over time. The resolutions may involve transformational shifts in users' behaviors. Using the system of this invention, a system user's behaviors and actions may be observed, in context, and with system analysis, the user may be led to proposed actions in the context of the whole person and the whole person's relationships with others. These interactions may all be measurable and interpretable by the system. Meanwhile, various mental and physical states of users may also be measured by the system, such as a user's anxiety and quality of life. These may be objectively measured based on validated instruments using statistical techniques. From there, a user's behavior and mental/physical states may be modeled based on that observed evidence, including validated data. In this manner, a story-based ontology may facilitate the use of evidence in reasoning about the state of users (or more generally entities) and the states of relationships between users (entities).

In the present system, evidence may refer to “facts” that have a probability of being true. Accordingly, a story-based ontology may not follow the strict axioms or rules of traditional ontologies in that they may rely on only true or false conditions for classification. Thus, the story-based ontology may provide a system and method of classification based on probability that may facilitate reasoning based on probabilities and the management of uncertainties, thus being more representative of events typically encountered in a user's everyday life.

In the present system, the story-based ontology may use probabilities to structure representations of knowledge regarding people and things in the world and place them into classes 212, or categories in a hierarchy of classes, or categories based on terms and relationships applicable generally within and across all domains (domains). Typically, an ontology may apply only to one domain. In the example embodiment, the story-based ontology may work with other previously developed ontologies in specialized domains to provide a layer of universal knowledge representation across them, which may also provide transitivity between them.

In the present system, the story-based ontology may be used to represent any number of relationships and interactions between people, between people and things, and between things—not simply any person or any thing itself. The story-based ontology may comprise a universal class hierarchy representing any entity, any relationship between any entity and any other entity, any interaction between any entity and any other entity, within and across all domains of knowledge. For example, the story-based ontology of the present invention may represent any living thing, any inanimate thing, or any real or imagined thing as an entity.

In the example embodiment, the story-based ontology may be used to represent or classify likely past, current and future entity states as well as states of its constituent attributes. In another departure from typical ontologies, the story-based ontology may be used prescriptively as a state likely to be achieved, taking into account, in a holistic manner, any and all of an entity's states, goals and attributes as may be used to represent an entity.

In FIG. 1, the arrows illustrate dependencies in the story-based ontology between Classes 212 in a hierarchy of classes, where an “identity” class may take hierarchical precedence as a class representation of an entity.

The class hierarchy provided in FIG. 3 includes the following classes: Identity 220, Contract(s) 230, Role(s) 240, Skill(s) 250, Deliverable(s) 260, Task(s) 270 and Requirement(s) 280.

As indicated by the arrows in FIG. 3, the identity class may most directly connect to the following classes: Contract, Role and Skill. In turn, the deliverable class may connect most directly to the task class and requirements class. The task class may then connect most directly to the skill class. Thus, the skill class may be most directly connected to the identity class and the task class. Consequently, the hierarchy may be used to represent that an entity, Charles, may have skills for tasks, related to deliverables with requirements.

The arrows shown in FIG. 3 between classes do not represent a dataflow between them, necessarily, but rather a hierarchy of relationships between classes. Note: in a machine learning context, models may tend to take into account all relationships between classes, regardless of hierarchy, except the Identity class, so that information pertaining to any subordinate class may be associated with every other class in the class Hierarchy associated with an Identity.

To illustrate, let's say a person has an Identity class instance named “Charles”. A diabetic role and a cook role may be different roles associated with “Charles's” identity. A Contract in the story-based ontology may represent an exchange of deliverable class “deliverables” between different role class “roles”. This exchange, or gives and gets of deliverables between roles, may take place within the same identity or, between different identities. For example, Charles in his role as a cook may cook a meal (a deliverable) for Charles in his role as a diabetic (who may need meals prepared a certain way). In this illustration, a Contract may be said to exist between Charles the cook and Charles the diabetic, where the cook delivers a meal (deliverable, with a satisfaction requirement) and the diabetic delivers an evaluation (“Yummy!). Skill class “skills” in the story-based ontology, like role class “roles”, may also be associated with an identity class “identity” (e.g., “Charles”). For example, “Charles” may have a cooking skill, particularly important to Charles's role as a diabetic. Charles's other skills may include an exercise skill, money-making skill, shopping skill, and so on. In the example embodiment, it should be noted that one or more skills may be applied or learned through a progression of planned deliverable class “deliverables,” such as may describe a use case, with their attendant Task class tasks and Requirement class requirements to apply or learn a given skill. For example, the skill required to prepare (i.e., a task) a tasty home-cooked diabetic meal may be learned by Charles through a use case involving a stepped progression of deliverables (i.e., a deliverable chain). Such stepped progression may characterize a collection of recipes with a graduating degree of difficulty, each with different requirements for different skills to perform different tasks.

The foregoing description in FIG. 3 illustrates that a use case in the present invention may be represented as a sequence or collection of planned instances of the story-based ontology. The sequence in which these planned instances of the story-based ontology may be performed may depend on the use case type and its requirements. For example, an atomic use case may be a single step comprising one or more other steps that must be followed in exact order whereas a composite use case may comprise various atomic use cases. A use case in the example embodiment may be organized so as to teach one or more skills and/or apply one or more skills already learned. These skills may be used to perform the tasks necessary to complete use case deliverables. In the example embodiment, evidence of a learned skill may be inferred from evidence of a completed deliverable, i.e. a deliverable may require the performance of particular tasks for which a skill or set of skills is necessary. New skills may be added to any skill class associated with an identity (e.g., Charles). These new skills may be based on a use case deliverable (e.g., as a planned instance of a story-based ontology) with which that skill may also be associated. The amount or degree of a new skill associated with an identity and a use case meant to teach a new skill may start with a value and an uncertainty component of the skill attribute based on associated other skills and the degree or amount (some quantification) of those skills. A starting value of 0 may be appropriate depending on the skill and how much information may be available in the system about it. For example, a labor skill valuation may be increased after evidence of a labor deliverable, or it may be decremented at some rate, if unused for a period of time. Likewise, and in contrast to a change in the actual skill value, the uncertainty component of the skill attribute may grow or decline if the skill is used or unused respectively over periods of time. Alternatively, a purchased deliverable may require a different skill; e.g. an ability to pay skill, which while related (to some degree) to various labor skills, may be represented as its own skill in relation to an identity.

In the example embodiment, the story-based ontology may be recursive, i.e. a human body as an entity may have a Contract with its component arms as entities. The story-based ontology may also be temporal, i.e. an arm may break. Relationships and interactions between entities may be defined by Contracts associated with the same identity and that over time these Contracts may change as the result of changes in information in other classes related to them.

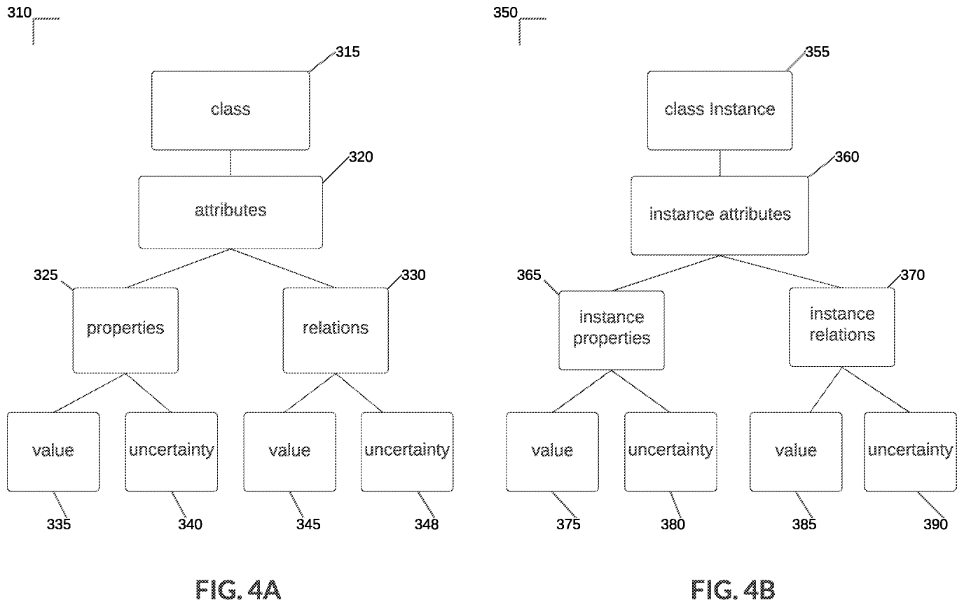

FIG. 4A and FIG. 4B show the class structure 310 and class instances 350, respectively, in a class hierarchy of a story-based ontology according to one aspect of the invention. In FIG. 4A, a class 315 is illustrated as having attributes 320, particularly properties 325 and relations 330 attributes, each of which may have value 335, 345 and uncertainty 340, 348 components. In the present system, every class in a hierarchy of classes may have the same class structure as illustrated in FIG. 4A and FIG. 4B, and thus also value and uncertainty components.

Referring again to FIGS. 4A and 4B, each class may have many attributes. For example, attributes of a deliverable class may include the following attributes (attributes immediately following letters; hereinafter classes identified in Capitals, all without limitations as to content or order): a): tasklist: —the list of Tasks associated with this Deliverable b) tasklistorder: the ordering of the Tasks c) requirementslist: giving a list of Requirements d) requirementslistimportant: a list of values for each Requirement indicating how important it is, and e) timeframe-a sense of how long it typically takes to complete the Task.

Note in the above, attributes may include information from other classes. As noted, in the example embodiment, there may be interdependencies between classes. For example, as described, a Deliverable attribute of requirementslist may depend on a Requirements class.

Instances of a story-based ontology may refer to specific representations of a specific user in terms of the story-based ontology. In the example embodiment, these instances may have “values” and “uncertainties”. For example, “0.1 [days]” might be the value of the attribute timeframe for the “grocery shopping” instance of the Deliverable class. Further, “0.05 [days]” might be the uncertainty associated with that value in the same instance.

In FIG. 4B, instances of a story-based ontology 350 may refer to when data based on specific user information “fills-in” the data structures of the story-based ontology classes. This “filling in” of a data structure with user data may be referred to as an instantiation.

In the present invention, values and uncertainties may be considered in various ways and in varying degrees of complexity. For example, values and uncertainties in the example embodiment may be considered simply as the mean and standard deviation of the assumed Gaussian probability distribution for an attribute. However, a more generic set of attributes to describe more complex probability distributions may be considered instead. In the example embodiment, editors may determine collaboratively which consideration, or combination of considerations, may make the most sense for various attributes, or, editors may approve algorithms to make such determinations.

In the example embodiment, properties 365 may be attributes 360 that belong to the individual class instances 355, e.g., “Garvin” may be the value of the familyname property/attribute for the instance of the class “Identity” referring to Tom Garvin. Another example: ‘30 days” may be the value of the giveandgetlistperiod property/attribute associated with the ‘Property Rental’ instance of the Contract class (because rent may be due periodically every month) and “2 days” may be the uncertainty (because months can vary by +/−1 days).

To continue with describing FIG. 4B, relations 370 may also be attributes 360 that belong to an individual class instance 355. Relations attributes may describe attributes that may connect different instances from (typically) different classes in the example embodiment. For example, a currentroleimportancelist relation/attribute of the Identity class may connect an instance of an Identity associated with “Tom”, a person, with an Instance of a Role. To continue the example, a relation/attribute currentroleimportancelist connecting the “Tom Garvin” instance of the Identity “Tom”, a person, with the “father” instance of a Role may have a value and uncertainty of “0.9” and “0.02”, respectively. Furthermore, there may be dependencies between “importances” across attributes. For example, the relational attribute of roleimportance to the Identity may depend on the relational attribute of deliverableimportance to the Role which in turn may depend on the relational attribute of taskimportance to the Deliverable, thus creating a chain of “importances” and dependencies between them. These dependencies may be quantified using numerical values, for example, for uncertainty and importance within timeframes. For example, it may be that the most important task for right now is “finish college”, but that will take a long time and “exercise” is less important but will get more Importance completed per unit time. In the example embodiment, task importance calculations may calculate importances for tasks based on units of time (e.g., TotalTaskImportacePerUnitTime=Total Task Importance*(1.0 current completion of Task)/(Task timeframe)).

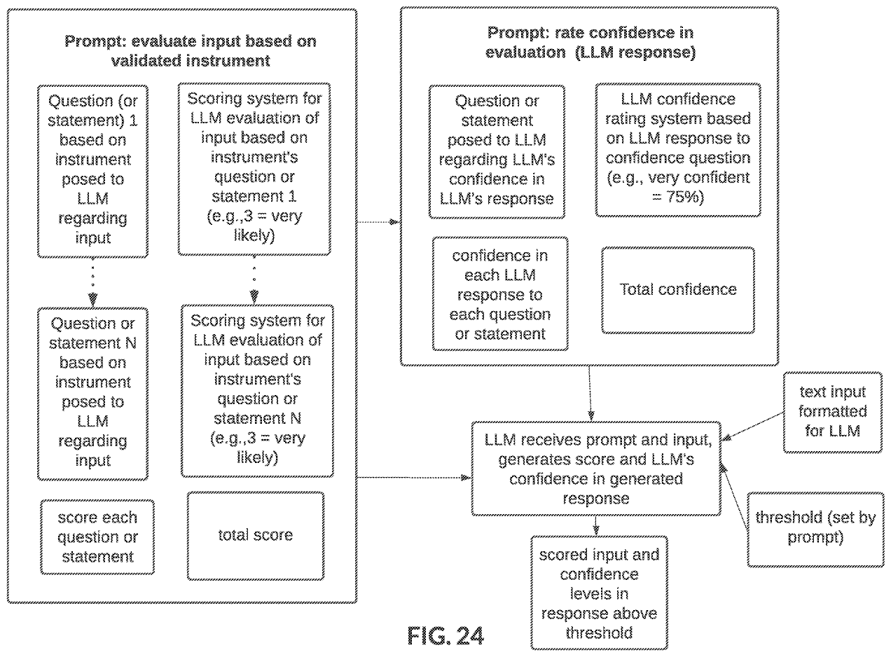

Importances may be learned generally, for example, by searching an existing knowledge base, querying a source. For example, Importance may be determined, in part, by asking a LLM on a scale of 0-10 what is the importance of having money to shopping. The answer may then be evaluated, stored and adjusted based on instances. (See FIG. 24 for scoring using a LLM.) Importance may also be determined by asking users, and/or inferring facts from observed facts, and/or using reasoning. Further, relational importance attributes, like all attributes in the story-based ontology, may have uncertainty and value components. In the example embodiment, the Requirements class may have timeframe attributes on which the relational importance attributes of other classes may further depend. Thus, in the example embodiment, importances and uncertainties may be quantified, including uncertainties about importances, all within a given time frame. For example, while graduating may be most important for an Identity long-term, doing well on tomorrow's test may be more important at the present moment. In the present invention, probabilistic computations may be based on these dependencies.

In the system, all instances of all classes may have relational attributes. However, in a preferred embodiment, it may be more efficient to track or study only those relational attributes for which there may be a non-trivial connection (e.g., “Tom Garvin” may have 50 Roles with a given value and uncertainty. However, for currentroleimportancelist, it may be determined that the importance of all “non-related” Roles in the system may not be tracked, i.e., they may be assumed to be 0+/−0.)

The story-based ontology class structure may be a core building block for a system of identically structured classes. Although identically structured, the classes themselves may have certain relationships to each other and dependencies on each other. So, the class hierarchy illustrated previously in FIG. 3 may comprise identically structured classes. However, these identically structured classes may become uniquely representative of a specific entity based on specific data for specific attribute, according to the value 375, 385 and uncertainty components 380, 390 of the class in a hierarchy of classes associated with the entity. FIG. 4B illustrates this.

A story-based ontology may define the framework for classes and their Attributes, which then may be “filled in” using instances of the classes and values and uncertainties of the attributes. To aid understanding, a story-based ontology with its classes and attributes in the example embodiment may be similar to the rules of the game, where instances may be the set-up for an individual game. To analogize to chess, the story-based ontology may be the overall rules of the games: there may be certain pieces (like classes) each of which may have certain ways to move (like attributes). Instances may be like a specific chessboard with a specific orientation of the pieces on the board at one instance in game play.

In a departure from typical technical usage of ontologies in other fields, instances and values of a story-based ontology may constantly change. This may be (1) because they may be customized and personalized to each individual User and (2) because in time more information may become available.

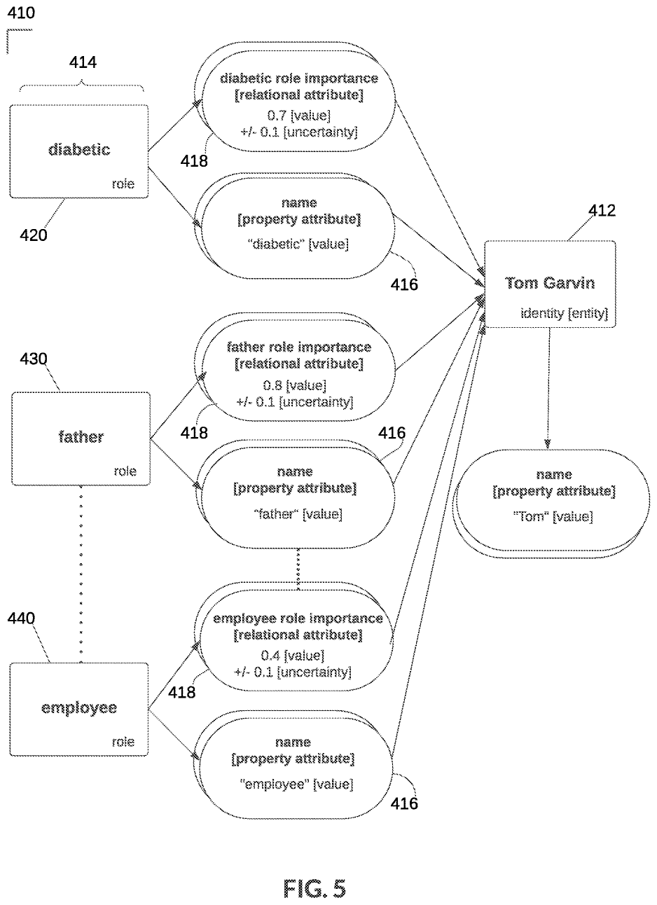

FIG. 5 illustrates a partial instance 410 of the class hierarchy of a story-based ontology, particularly demonstrating an Identity class 412 and a Role class 414, each with associated property attributes 416 and relations attributes 418 in accordance with various embodiments of the invention. In the illustration, a person represented in the Identity class as Tom Garvin is represented as having a diabetic Role 420, a father Role 430 and various other roles, including an employee Role 440. The illustrated father Role has a name property attribute value of “father,” a role importance relations attribute value of 0.8, and a role importance relations attribute uncertainty of +/−0.1. In the Role of diabetic, the importance relations value may be based on a scale of 0 to 1, and the uncertainty may be based on a range associated with this value.

In the example embodiment, each class may have many attributes, each with a value and uncertainty component. Role importance is chosen here as a component for illustrative purposes.

To illustrate, a father role and a diabetic role may both be very important to “Tom”. The former is shown in the illustration as having a value of 0.8, the latter a value of 0.7, each based on a 0 to 1 range. Note, these values together are not intended to add up to 1, but instead show an importance in relation (hence the relations attribute) to the overall Identity, “Tom”.

In FIG. 5, the illustrated 0.8 father role importance versus the 0.7 diabetic role importance would seem to suggest that in the instance of the illustrated Identity, the father role may be slightly more important to the Identity of “Tom” than the diabetic role. However, the associated uncertainties shown in FIG. 5, from a probability perspective, may result in the importance of the different illustrated roles to the illustrated Identity being at rough parity at any given Identity state. To explain, the uncertainty of +/−0.1 shown for the diabetic role importance relations attribute, when added or subtracted from the 0.7 value for this attribute, creates a likely range for this diabetic attribute value from 0.6 on the low end to 0.8 on the high end. This is as compared to the likely range from 0.7 to 0.9 for the father role importance relations attribute when uncertainty is similarly taken into account.

In the example embodiment, the value and uncertainty of a given attribute may be described as a snapshot at a moment in time (as one state variable) and fixed for that moment only. The value and uncertainty of a given attribute may change instance to instance.

In the example embodiment, the uncertainty associated with a value may be used to quantify a likely probability for that value, as illustrated. These quantifications may be generated by various methods and models in the present invention (e.g., statistical analysis, probabilistic programming, learned weights from models, incomplete information, measurement error rates, loss functions, etc.). The probabilistic aspects of the probabilistic predicate may be based on them. Thus, in the example embodiment, uncertainty as a story-based ontology attribute component may establish an efficient link between the story-based ontology and probabilistic predicates and the various system functions and models that may use probabilistic predicates. More broadly, the uncertainty component of story-based ontology class attributes may not only facilitate, but may also propagate the use of probability as a key aspect of data in the example embodiment.

The arrows in FIG. 5 show connections between various role class and identity class information, not how user data may necessarily flow during instantiations.

Thus in the overall nature of the invention, a novel story-based ontology comprising a universal class hierarchy may be used to compute a current or future state of an entity. Every class in the example embodiment may have attributes with value and uncertainty components that may be expressed numerically. These values and uncertainties components may be populated with actual, simulated or simply made-up numerical data generated by any means. The value and uncertainty components may be populated numerically at any time, since these components may be represented generically as formats to fill. Through the numerical connections between attribute components in the story-based ontology, probabilities based on a calculation of numerically populated attribute components may be conducted and a total or totals produced. The totals produce by class and by attribute numerics, being interrelated, may be used to represent, in the aggregate, identities with numerical relationships between the attribute components. Since every class in the example embodiment may have value and uncertainty components, computations for the identity that sits atop the class hierarchy may reflect the whole entity (Identity). Computations may also reflect what is important to the entity, where importance may be a mathematical matter based on attribute uncertainty and value values across classes. For example, based on the importance to Tom's Identity, a diabetic Role (0.9) is much higher than a retired teacher” Role (0.3), and selecting diabetes-friendly food—as an important (0.85) Deliverable to “Tom's Body”—is an important part of Tom's life. The diabetes Role may have, for example, a self-determined importance of 0.9 and the diabetes-friendly food may have, as a result of expert-suggested inputs resulting in importance of 0.85, so that the overall importance of Torn “Delivering” diabetes-friendly food is 0.9×0.85=0.765. The present system may perform computations based on the story-based ontology to generate numerical representations of the ontology class hierarchy at any point. At any point, the attributes in the ontology may be updated by any system input. For example, a system audio input of “I forgot to take my pills” may lead to the result in task completion of taking pills significantly decreasing as attribute along with changes in the following associated values: a decrease in the importance of the role of diabetic and a loss of mental clarity skill, among others. In the present system, metrics are typically a weighted sum of distances between the current and goal role importances. At each moment, with a set of current attributes and a defined goal to set a metric, a best next action may be determined. This is determined on the basis of which task completion item may result in the best metric improvement in general and under the constraint of existing skills and Contracts. The ontology also may be used to identify conflicts, or alternatively reasons why valuable tasks cannot be taken, in the form of missing skills or Contracts. Additionally, a conflict arises where another entity characterized in terms of the ontology may not fulfill a deliverable. The conflict includes the resulting consequences. Thus, the ontology may provide a structure for determining deep data relationships as that data may be interpreted via an identity interacting through Contracts with other identities.

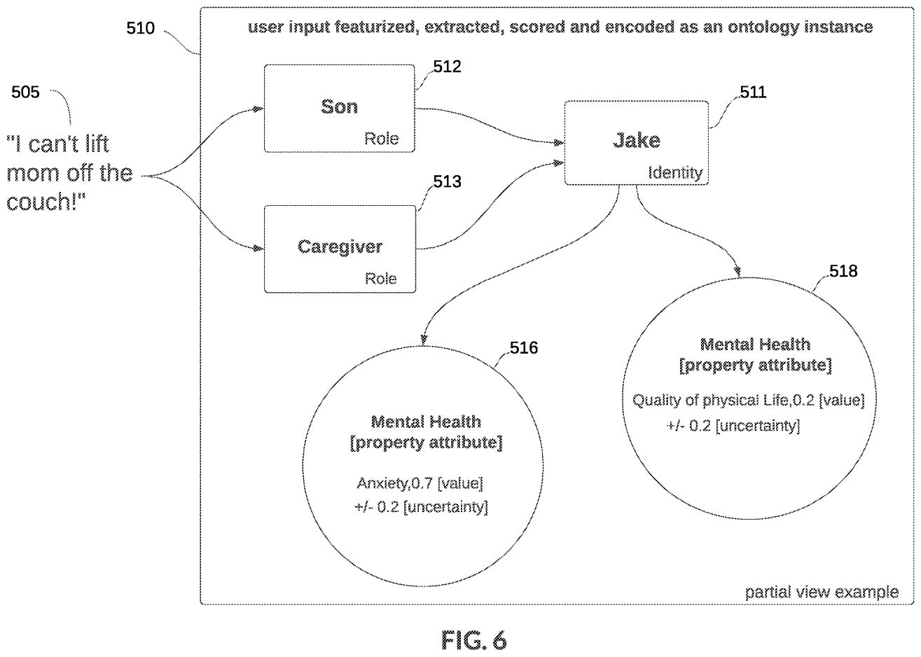

FIG. 6 shows an example of how user input scored by classifier models trained or fine-tuned on validated instruments may be represented in the story-based ontology class hierarchy.

In FIG. 6, user speech input is shown as a statement, “I can't lift mom off the couch!” 505. The speech input, once tagged to a speaker, featurized and processed, is shown as being represented in various terms of the story-based ontology 510. The speech input in FIG. 6 is shown as belonging likely to an Identity, “Jake” 511 and likely involves “Jake's” roles as a Son 512 and a Caregiver 513. Roles and their related attributes may be determined by various methods in the example embodiment, as described herein.

In FIG. 6, a score for various states of mind are illustrated in this instance as belonging to the Identity, “Jake” and particularly to Identity property attributes for “mental health.” Two different exemplary mental health attributes are shown in terms of the story-based ontology, one for anxiety 516, the other for quality of life 518. The anxiety value is shown in the illustration as 0.7 and the uncertainty for this value is shown as +/−0.2. The Quality of Life value is shown as 0.2, with an uncertainty of +/−0.2. These values may be based on scores determined from inputs (e.g., “I can't lift mom off the couch!”) using classifiers.

In the example embodiment, input may be “scored” for various health and wellness conditions or states of mind determined by a classifier trained on data sets involving validated instruments. In the example embodiment, there is no limit to the number of different classifiers that may be used to evaluate input data, including for health or wellness states. For example, an anxiety score may be based on training data related to a Generalized Anxiety Disorder (GAD) evaluation, or a short form of it involving only 7 questions/statements (GAD-7). Additionally, the same input may be evaluated and scored based on a Total Quality of Life evaluation, a Financial Quality of Life evaluation, a Physical Quality of Life evaluation, an Emotional Quality of Life evaluation, a Social Quality of Life evaluation, and any other validated instruments that may be used in the example embodiment to attempt to quantify a particular state. As more and more dimensions of a human user's daily life are quantified by scores based on validated instruments (assessment instruments), the fuller the quantitative view of that human user may become. Since validated instruments may refer to instruments whose scores are deemed reliably representative of user states, human or not, scores based on validated instruments may be used to facilitate an objective, evidentiary, numerical basis for characterizing a user state and status at any given time and over any given timeframe. In the example embodiment, scoring of a user state based on validated instruments may be done ambiently and automatically during conversations (e.g., via various methods, including transcripts), as will be described. This facilitates the provision of scores based on one or more validated instruments for a user state at any given time or over any given timeframe.

It should be noted that in the example embodiment, correlations between different scores for different states from the same input may facilitate certain recommendations and styled elicitations to users. For example in the illustration, a relatively low 0.2 value for Quality of Physical Life (e.g., based on a Physical Quality of Life instrument) and a relatively high 0.7 value for anxiety (e.g., based on a GAD-7 instrument) mirrors an observed correlation in medical research tending to show an inverse correlation between anxiety and quality of life generally. Here specifically, further correlations are identified with a dimension of Quality of Life, such as Physical Quality of Life, with another instrument's general score, such as anxiety. Thus, in the illustration, the same input (“I can't lift mom off the couch”) may be scored by multiple different classifiers, to produce a rich, contextual, and evidence-based representation of the situation in the story-based ontology. To illustrate, an elicitation may be generated (e.g., via natural language processing, NLP) for Jake, based on a remedial action suggested by the system to improve Jake's anxiety score, “Do you want to try what you learned from the coach?”

Note, in the illustration, the health scores are shown as associated most directly with an Identity class property. However, certain health scores may be generated for specific roles and associated with these specific roles accordingly. For example, a classifier in the example embodiment may be trained on a Caregiver Reaction Assessment (CRA), an instrument which specifically refers to caregivers and caregiver perceptions of the burdens they face. In a story-based ontology instance, a CRA value may be ascribed to a property attribute in the Caregiver Role class.

Note, a Caregiver class Role and other role classes in the class Hierarchy may be associated with the Identity class (e.g., ‘Jake”). So, the values based on instruments may be associated with the same Identity. For example, “Jake” may have a GAD-7 score as an Identity class property attribute and a CRA score as a Caregiver Role class property attribute. Since the CRA has a measure for physical burden, this value may be compared or corelated with a Physical Quality of Life value.

In the example embodiment, the output of classifiers trained on datasets related to different instruments may strengthen the overall evidentiary basis of assessment and improve the quality of predictions. For example, a CRA score for caregiver physical burden would be expected to be highly correlated to a Physical Quality of Life score. Generation of and analysis of correlations between various scores determined by classifiers in the example embodiment may facilitate a stronger evidentiary basis for understanding a given user's situation and provide support (and/or a recommendation) for a next step action. As illustrated, the values used to generate these correlations may be represented in the story-based ontology.

In the example embodiment, in addition to representing scores based on validated instruments to help understand a user state in the story-based ontology, the story-based ontology may also be used to trigger a use case instance. To return to the illustration, a Caregiver Role may involve specific tasks for a Task class, Deliverable class and so forth, consistent with the story-based ontology. A use case involving caregivers may be “triggered” from evidence of the caregiver Role class. This triggering may happen when certain instances of the story-based ontology are determined from inputs (e.g., a Task class associated with assisting others with various activities of daily living may include “lifting” as a task). In a use case, various next steps may be required based on evidence of a current state from inputs and from other factors that may be represented in the story-based ontology.

In the example embodiment, the accumulation of evidence from the same inputs may be represented in the story-based ontology. For example, a low quality of physical life and an adverse score for a caregiver physical burden may improve the quality of evidence of physical challenges on the part of a caregiver, and trigger a particular use case to remediate the burden (e.g., a physical therapy treatment) or help the user work around the physical burden (e.g., engage another resource for a “lifting” burden) represented in the story-based ontology instance.

Additionally, the story-based ontology may be used to generate a natural language summary of the instance. For example, it may be said from the input that “Jake is a caregiver with anxiety about helping his mom move, based on some of his own physical challenges.” When queried for an explanation of the NL summary, a response may be conditioned on information represented in the story-based ontology. For example, in response for a request for more information about the above NL summary, by way of illustration, it could be said that “Jake appears to have a low quality of physical life and needs help lifting.” As more and more representations of the user as story-based ontology instances are generated from more and more user inputs, or from inputs about the user, the evidentiary basis for the user representation in the story-based ontology may also become richer and “truer” as well.

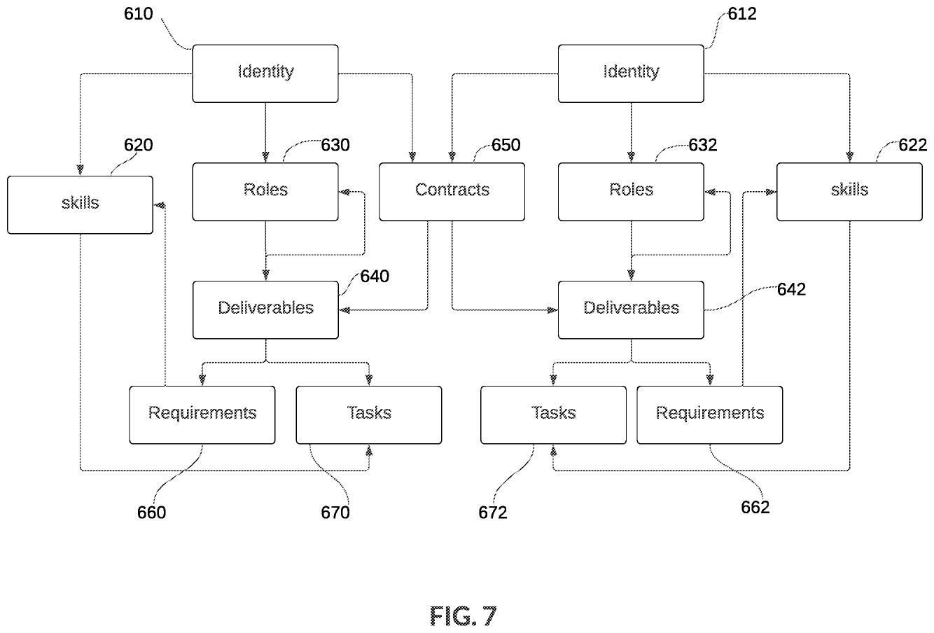

FIG. 7 shows how the Contract class may act as a collaborative conjunction between different instances of different Identities using the same story-based ontology class Hierarchy, in accordance with one aspect of the invention.

A Contract in the story-based ontology may represent an exchange of Deliverable class deliverables between different Role class roles associated with the same Identity or between different Identities. Recall, in the FIG. 3 description a diabetic role and a cook role may be different roles associated with “Charles's” Identity. As previously described, Charles in his role as a cook may cook a meal (a deliverable) for Charles in his role as a diabetic (who may need meals prepared a certain way). FIG. 7 shows that in the example embodiment a Contract 650 also may exist between two different Identities, “Charles” 610 and “Elsa” 612. In this example, an exchange of deliverables between a cook and a diabetic may be performed by different people, for example, by “Elsa” as the “cook” and “Charles” as the “diabetic”. In exchange for a “meal deliverable” satisfied by Elsa's cook role, Charles in his diabetic role may provide a payment deliverable in a form acceptable to Elsa.

To shift to a professional service example of a story-based ontology instance, consider a doctor's appointment. An instance of a story-based ontology for a doctor's appointment may be represented in the example embodiment as a dyadic Contract between two roles, a patient role 630 and a doctor role 632. Both involve different deliverables based on these different roles. The different roles of patient and doctor may be played by different entities, unless the patient is also their own doctor in the instance (which the story-based ontology may accommodate through the Identity class). To illustrate further, in the example embodiment an appointment may be a Contract class instance and may involve an exchange of Deliverable class deliverables between a patient (Patient Role class Instance) and a doctor (Doctor Role class Instance), where the patient and doctor may be associated with different Identity class instances (e.g., patient may be “Tom”, Doctor may be “Richard”).

To continue with the illustration, the patient deliverables may include an “informed consent” deliverable 640 and the doctor's deliverable may include an “examination” deliverable 642. It is understood that this illustration may represent only a partial view of the dependencies required of a story-based ontology instance (e.g., Deliverable class may rely on Task class for actions to complete a deliverable, such as an “examination”)

In the example embodiment, input data from users and other sources may be used to “fill in,” or instantiate, the class structures and dependencies with user-specific information.

As illustrated, a story-based ontology in the example embodiment may not only facilitate collaboration between different users, represented as different Identities, but in some instances may also require it.

Consider the dyadic relationships commonly found in the human experience (e.g., landlord-tenant, doctor-patient, father-son, boss-direct report, etc.). In the example embodiment, commonly occurring dyads in the human experience may have implicit Contracts that the story-based ontology may make explicit through its hierarchy (e.g., Identity, Role, Contract, etc.). In the example embodiment, these dyadic relationships (e.g., “Jack” the “landlord” and “Tom” the “tenant”) may be represented in terms of Contracts involving an exchange of deliverables between different roles that may belong to different Identities (e.g., a person, Jack, as an entity may have an Identity “Jack”, comprising “landlord” and “bachelor” roles, whereas another person, Tom, as an entity may have an Identity comprising “tenant” and “diabetic” roles).

In the example embodiment, the story-based ontology may be used to represent things and Contracts between things as well. For example, a building may be a thing and characterized as having an Identity (e.g., a building). In the example embodiment, a place may be comprised of things (e.g., a building atrium, trees, benches). These things related to a space may have Contracts (i.e., a class) with each other. For example, a tree (Identity) in a building atrium (Identity) may need water (Identity) from a pipe (Identity).

To continue with the building example, a Contract class relationship between the Building's Role and the Tree's Role may involve a Space Deliverable from a Building in exchange for a related aesthetic deliverable (e.g., colorful leaves) or air improvement deliverable (e.g., trees produce oxygen) Deliverable associated with a Tree's Role.

Staying with the building example, the Task of providing the space Deliverable by the Building's Role may be to “set aside atrium space.” The Requirements class 660 to satisfy the space Deliverable class for the Building's Role may be “500 square feet of well-lit atrium space.” And the Skills 620 of a Building Identity may be an amount, “1,000 square feet of well-lit atrium space.”

Note, in the above example, the story-based ontology class hierarchy may be used to “anthropomorphize” relationships between things, as illustrated. In other words, a “building” may “act” through the Task class. The agency of this action may be human or non-human, via other things or via people. For example, a human Identity may have a Contract with a Building Identity to fulfill the Building Deliverable Task class of “setting aside atrium space”. Or, an Identity class involving things may use the agency of internet connected devices to accomplish some or all of the same Task class tasks. For example, the “building” may “lock up” after a certain time in the evening if its sensors do not detect movement on the premises, provided various other requirements are met, which could include certain authorizing interactions with people.

In the example embodiment, every entity may be anthropomorphized as an evolving Identity with an ever-changing combination of weighted Roles and associated Contracts, Tasks, Skills, Deliverables and Requirements. In the example embodiment, relationships and interactions between entities associated with different Identities may be represented in the ontology, as may describe collaborations between people, between people and machines, and between machines and machines. In the example embodiment, the universal story-based ontology class hierarchy may comprise identically structured classes with dependencies on all other classes in the hierarchy, wherein all classes have computable attributes with uncertainty and value components. In the example embodiment, multiple Roles associated with an Identity and their quantitative importance to the Identity may create a computational model for the holistic identity of any entity (e.g., How's Tom?) in the context of other holistic identities (e.g., what's up with Tom and Alice?).

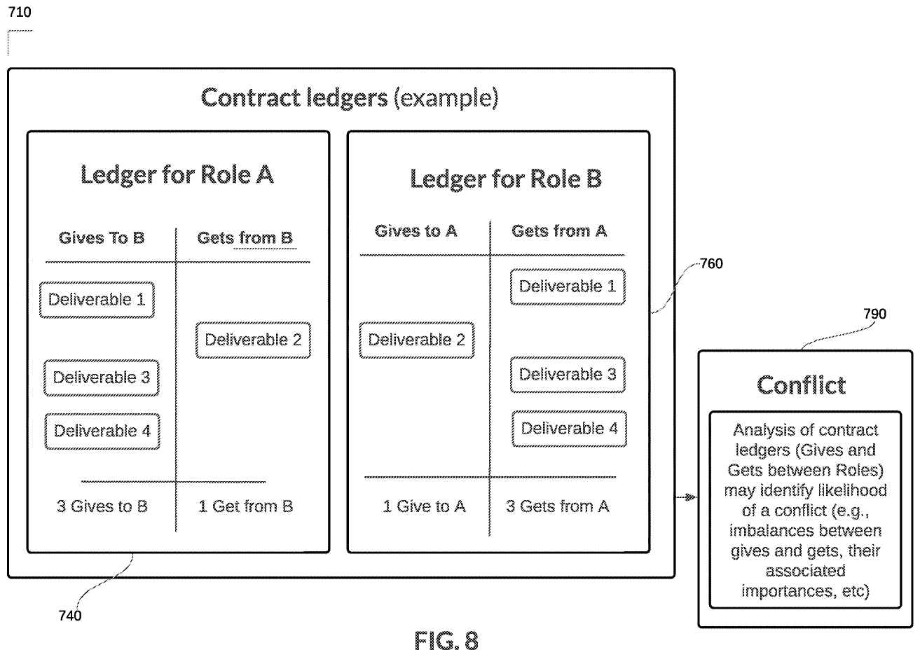

Referring to FIG. 8, missing deliverables in the example embodiment may be accounted for in a Contract leger 710 (“gives and gets”) of Deliverables between Roles, and used to predict, determine and attempt to resolve conflicts 790 using various methods (e.g., simulated contracts).

A conflict 790 may be said to occur when there are imbalances in the “gives and gets” in a Contract, which may be represented as a ledger. In the example embodiment, imbalances may be measured and quantified. At any given time, based on how many Contracts an Identity may have, there may likely be imbalances. In the example embodiment, there may be various ways to address imbalances. For example, it may be determined that certain imbalances are more important to address than others (e.g., a tenant role involving a payment deliverable may increase in importance as the rent due date requirement approaches). By upweighting the importance of certain roles in certain Contracts certain imbalances may be addressed.

Referring back to FIG. 3, a Contract in the example embodiment may be a class in a hierarchy of classes. Referring back to FIGS. 4A and 4B, every class may have attributes. Referring specifically now to a Contract in a Contract class, its attributes may include, but may not be limited to, a name for the Contract, a give and get list (an exchange of deliverables between identified roles), an order to the give and get list, give and get importance to a role, timeframe, fulfillment consequences, breach consequences, and so forth.

Shown in FIG. 8 is a high-level schema to aid understanding of how a Contract in the example embodiment may work, based on Contract attributes. Further description and examples are provided below, including descriptions of conflicts, which as shown in FIG. 8 may be identified and predicted, based on value and uncertainty components of various Contract attributes.

In the example embodiment, Contracts may be between different roles associated with the same Identity or between different roles involving different Identities. Different roles between different entities commonly described as dyads in the real world may be represented by Contracts in the example embodiment (Father-Daughter, Shopper-Grocer, Diabetic-Medication, Diabetic-Doctor). In the example embodiment, each Identity (entity) may be responsible for specific Deliverables that meet certain Requirements.

In one aspect, the system may learn a user's ability to meet Deliverables in a Contract various ways, including by assessing the Skills and Tasks associated with these Deliverables. For example, let's say it is determined from processed inputs that there is a failure to meet an important Deliverable of an important Contract associated with an important Role that has a strong correlation with a user's quality of life. This failure to meet the deliverable may mean that a goal based on a quality of life score (e.g., an upweighted target value and uncertainty component of the appropriate attribute) may not be reached. Thus, the failure to meet a deliverable based on its importance may create a conflict. Within this ontological framework, various embodiments of the invention may track the user-specific connections between these components, e.g., a deficiency in the Skill of lifting, may imply that it might be challenging to gather groceries, failing to meet a Deliverable of the Shopper Role, leading to a decreased independence,

In the example embodiment, the story-based ontology may not only be used to represent past or current situations, but also to track circumstances as they evolve, and via a Knowledge Base and/or knowledge graph and expert knowledge to anticipate the future. Use Cases include not only typical circumstances, recorded in the format of our Story-based ontology, but also the typical Conflicts that arise and their typical Solutions.

Instead of a one-size-fits-all solution, the gathered information about the User may be used to customize these archetypal situations for the individual based on their specific needs and goals. For example, perhaps a doctor-suggested diabetic-friendly foods to include dairy products, whereas Tom may not do well with dairy. The system may identify this conflict and suggest a common solution: a nutritional plan that includes dairy substitutes. Because the story-based ontology can represent a time-evolving situation, it can predict Conflicts in advance. It may remove the silos between Tom's Regular Doctor, which has been helping him with digestive issues (poor diary digestion) and Tom's Diabetic Doctor, which has recommended a particular nutritional plan of diabetes-friendly foods. This correlation across conditions is possible because all the conditions and actions are represented within a single intelligent story-based ontology that is then subjected to AI-based algorithms for Conflict identification. Notice that the Conflict may be the result of the failure of a Contract (Tom's Body cannot deliver well-digested dairy) associated with the overlap of two Roles (Diabetic and Body-Haver).

In the example embodiment, specific Potential Conflicts and Resolutions may be identifiable by the system. For example, to continue with the illustration of a diabetic user:
1) the Skill of selecting diabetes-friendly food may be unknown; upon being asked a question, Tom's answer may suggest he does not know how to select diabetic-friendly food. It may be learned he is a new diabetic. To continue with the example, the system then may predict a conflict between these two Roles (body-haver and diabetic) because Tom does not have the Skills required to produce the deliverables needed for Tom's Body. Notice that this is an internal conflict of a missing Skill to complete the internally-focused Role of Diabetic. In the example embodiment, a downward spiral may be predicted: bad food leads to low mental clarity leads to poor shopping leads to bad food. In the example, it may be learned that a problem is due to the missing Skill of selecting diabetes-friendly food. In turn, the system may seek out Contracts that have as a Deliverable the Skill of selecting diabetes-friendly food (like an online class or a meeting with a nutritionist). It can estimate the Gives associated with these Contracts (time and money) and determine which of these is most plausible (e.g., nutritionists cost a lot of money, so gather free online information instead).
2) The above illustrated requirement of selecting diabetes-friendly food may change the Contract with the Grocery Store because the system may predict that diabetes-friendly foods are typically more expensive. The system classifiers may have already determined that Financial Quality of Life is already low, so this may be flagged as a potential concern. This becomes an internal conflict between two different internally-focused Roles: Diabetic and Provider. It can propose a solution: a Contract that results in increased money (e.g., more tutoring, government assistance, ask daughter for help, etc.) and check whether these solutions are plausible (e.g., does Tom generally have enough time to do more tutoring? Might Tom qualify for government assistance? etc.), even asking story-enhanced questions to gather more information: “Diabetes-friendly foods are often more expensive, are you concerned about paying more for groceries?” “Since diabetes-friendly foods are more expensive, have you considered doing extra tutoring?”, etc.
3) Eventually Tom will age to a point where he will be unable to lift groceries; then an entirely new Contract might be required (e.g., shopping online, senior meals service, asking daughter to shop, etc.).
4) Most of the examples so far in this section are related to internally-focused Roles. But the system may use the story-based ontology to understand externally-focused Roles like Tutor, Father, etc. An example of a potential Conflict would be that tutoring has as a Requirement a certain amount of mental clarity, but mental clarity may be directly related to blood sugar which is strongly affected by Diabetes. As a result, the system could encourage Tom to take his diabetes medication by reminding him that the medicine will help him have the mental clarity needed to fulfill the important-to-him Tutor role. As opposed to a mere medical recommendation from a distant doctor, the system may connect Tom's self-care with his personal and meaningful goals.

In the example embodiment, conflict also may arise when another entity in a Contract with the user fails to meet his/her/its Deliverables; the probability of such a failure may be estimated within the system, the consequences of this Conflict to the user may be calculated, and specific customized mitigation strategies may be proposed. For example, if rides to the grocery store are provided by the User's Daughter, then there is some chance in any given week that the Daughter will not (for whatever reason) be able to support the user in this way. This missed Deliverable may result in a significant challenge for the important Shopper Role as well as a potential influence on the Father-Daughter Contract.

In accordance with various embodiments of the invention, the classes and class structures in the story-based ontology class hierarchy may be used to create Objects. These objects may contain code based on class definitions to instantiate data structures specific to the story-based ontology. The code contained in said objects may manage the instantiations of said data structures with user data, as well as with story-based ontology information in a knowledge store (e.g., knowledge base, knowledge graph). In the example embodiment, these data structures may be referred to as datatypes, particularly Story Data Types, and Objects may be referred to as Story Objects.

In the example embodiment, a Story Object may contain both an eponymous Story Data Type and code to construct it and perform functions associated with it. Story Data Types themselves may only be data in a data structure, not code, but which may still be relational. The output of a Story Object may be a snapshot of the state of the Story Data Type based on constructions of it at that time.

FIG. 8 shows an example element of the Contract Story Data Type, a Contract ledger 710, which may be constructed by a Contract Story Object. The Contract ledger may have a dependency on various Story Data Types, including a Deliverable Story Data Type and a Role Story Data Type. In the example embodiment, a Contract ledger may be used for various purposes, including for example to establish an inspectable set (via narrative template) of required exchanges of deliverables between roles. Another example purpose of the Contract ledger may be to “discover” existing Contracts not formalized ahead of time but for which evidence exists and may be “discovered”.

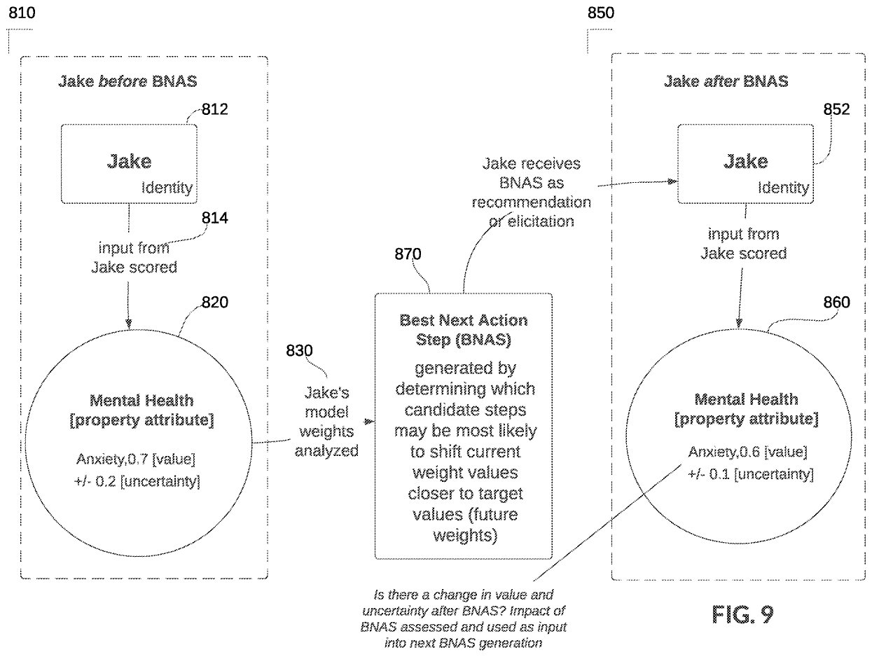

FIG. 9 shows an example of how a best next action step may impact the value and uncertainty components of a property attribute instance in accordance with various embodiments of the invention.

In FIG. 9, as shown, a mental health attribute 820, 860 for anxiety may belong in the story-based ontology class hierarchy to an Identity 812, 852, here Jake. “Jake” may be a name property value for a person (entity) in the Identity. Two states of the anxiety attribute are shown here for illustrative purposes, one before Jake receives a best next action step (BNAS) 810 as a recommendation from the system and one after Jake receives the BNAS 850 as a recommendation from the system. In the first state illustrated, Jake is represented as a “user” where a “user” may be a role in a role class in the story-based ontology class hierarchy. The flow in the diagram for the first state starts with Jake's input 814. While input may be multi-modal (text, audio, video) in the example embodiment, the input is speech for illustrative purposes. After being received by the system and featurized, the featurized speech may be scored, or classified. Scoring of health and other user states (mental an otherwise) may be performed in the example embodiment by a classifier trained or fine-tuned on datasets based on validated instruments, which may include validated health instruments, including from a clinical trial. Clinical trial-based training datasets in the example embodiment may include speech data and scores, and may be referred to as reference speech data. To continue with the illustration, the score for classified input may be associated with a mental health property 820, 860 corresponding to the type of score (name [mental health property attribute] “anxiety” [value]). As illustrated, a score itself may be represented as value and uncertainty components of a property attribute, here anxiety, shown in the first user state as a 0.7 value and +/−0.2 uncertainty, respectively.

Next, after the featurized input is classified, the value and uncertainty weights for the scored anxiety attribute may be used in the example embodiment to update a prior scored anxiety attribute, if any. Also, it should be noted, in addition to anxiety score-related attribute updates, other attributes may be derived from the same input (e.g., Jake's speech) and evaluated by trained classifiers and/or extractors and then like the illustrated anxiety scores also updated. Various other updating methods may include probabilistic logic programming, where probabilistic predicates may be “extracted” from the processed input and used to model various probabilities associated with these extractions; additionally, the updated values from the classifiers may be represented as probabilistic predicates and used in various combinations to infer additional updates (e.g., updated conflict instances derived from updated imbalances in Contract instances). FIG. 10 provides more information on updating value and uncertainty components of attributes, which may involve every class in a hierarchy of classes, based on featurized and processed input data.

After attributes are updated in the example embodiment, the weights for all updated attributes (to the degree there may be updates to current attributes based on featurized and processed inputs) may be said to characterize the user current state in terms of the class hierarchy, also as described in FIG. 10.

To return to the flow illustrated in FIG. 9, the updated weights of all attributes for Jake now may be analyzed 830. For illustrative purposes, we turn specifically to the shown updates for anxiety value (0.7) and uncertainty (+/−0.2) resulting from the trained/fine-tuned anxiety classifier. As a next step, these updated weights (and other weights of other updated attributes) may be evaluated to determine changes and patterns of change between one or more prior story-based ontology instances and the new story-based ontology instance represented by the updated weights from the new input (e.g., Jake's input). Various comparisons between current and prior state information may be performed, to determine emergent correlations between values and uncertainties in the class hierarchy instances. These correlations may be derived from an exhaustive analysis of various combinations of prior and updated user state information.

For example, during the analysis of an Identity's prior and current states, it may be determined that the role importance of “user” or “patient” or another “role” of importance may increase or decrease by a certain amount. Recall, in the example embodiment, importance of the relation values of various roles to the Identity may be measured. So, evidence of a user moving towards a user goal based on role and other importances may be determined through analysis.

To return to the example illustrated in FIG. 9, it may be that Jake's anxiety attribute value before the first state shown on the left in the diagram was, say, a 0.6, as opposed to the current state value shown of 0.7, representing an increase of 0.1 in the attribute value since the prior update. New correlations discovered during the analysis of prior changes in weights may be used to predict a next new weight. For example, how probable is it that the next new input of Jake's will show a further increase in the anxiety attribute value, to say 0.9?

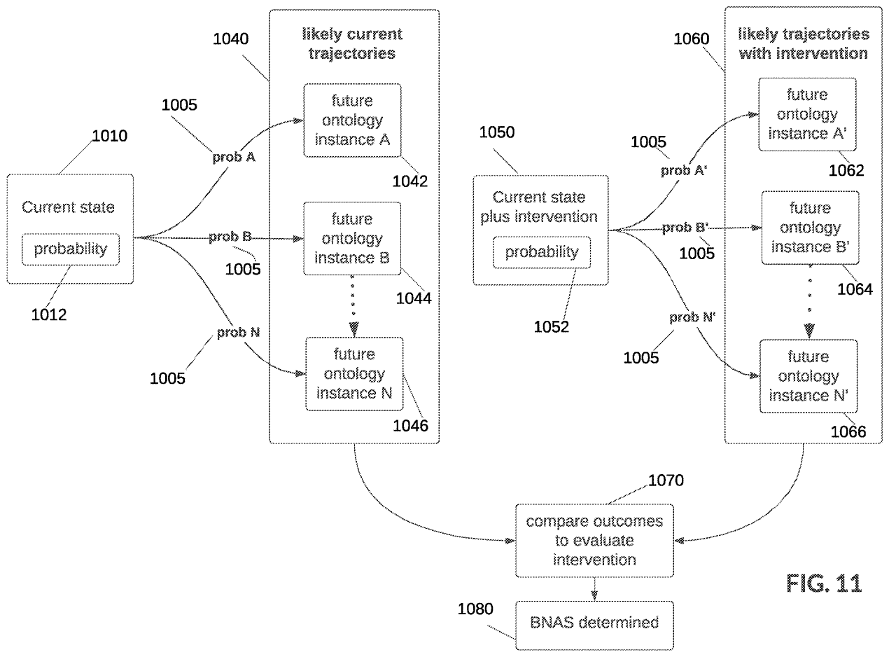

An analysis of the updated story-based ontology instance values and uncertainties associated with an Identity may facilitate various simulations (See FIG. 11). For example, an analyzed dataset of story-based ontology instance dependencies in prior and current user states may enhance simulations to improve the quality of predicted trajectories, or future states for the Identity (e.g., ‘Jake”). The trajectories may show predictions for various relationships between Identities (e.g., via predicted Contract imbalances involving certain dyadic roles, such as patient-doctor), impact of various value and uncertainty components of class attributes on other class attributes (e.g., a skill of manual dexterity needed to perform the task of buttoning a shirt may be atrophying to a point that the shirt may not be buttoned—an incompletable deliverable), and so forth. For example, in the case of Jake, what amount of skill class skill for managing anxiety is Jake likely to have, based on evidence of Jake's past instances? Is Jake going to make the patient role more important? Answers may be outputs of simulations of prior and current user states, i.e., Jake's patterned response in situations characterized in terms of the story-based ontology that may be similar to the current situation in which the question is asked.

From the foregoing descriptions, world knowledge available to the example embodiment for processing and the system's ability to score inputs to add an evidentiary base of analysis may be used to encode all user inputs as instantiations of a class hierarchy with various attribute value and uncertainty component weights, and then simulate trajectories from these. However, changing a trajectory may require targets for new weights and new attributes (e.g., skills) based on evidence of what has been shown to change trajectories.

Which new skill attributes can or should be acquired by the Identity to reach certain desirable future states that may appear unattainable based on current trajectories? How may they be acquired? What should the target weights be, ideally, and for which attributes in particular? What is the next step? In the example embodiment, answers may involve methods for setting targets for attribute weights, collaboratively developing and implementing a program of best next action steps (BNAS) 870 based on evidence and predicted to guide user actions in a deliberative manner towards these targets, and a support guidance to elicit an action from a user based on the best next action step. It should be appreciated that words may be considered actions in some contexts. One example would be in a therapy where the therapy includes the words. Actions may also include evidence from classifiers, such as scores, simple data such as from devices, and various methods to establish that what is said by a user may be handled with a degree of uncertainty.

In FIG. 9, a support guidance or elicitation may happen after analysis of the updated weights, during a new phase of simulation involving target weights, the BNAS and an elicitation.

First, target weights. Recall, the prior described simulations may be based on prior evidence and updated weights. However, in the example embodiment, simulations of future story-based ontology instances in the example embodiment may be based not only on prior and updated weights, but also on new target weights and new attributes with attendant target weights. In the example embodiment, simulations may facilitate understanding which potential changes to make and when, to change trajectories, akin to what may be referred to in medicine as an intervention.

To generate candidates for likely attainable user future states, target weights may be set in the example embodiment 870 for certain updated attributes and used in simulations to attempt to reach the new target weights while also sufficiently resolving dependencies in the story-based ontology class hierarchy. By incorporating into simulations both updated attribute weights and new target weights for these updated weights, the example embodiment may produce simulations constrained by evidence of what has happened before; while attempting to generate fresh combinations of attributes, attribute values and attribute uncertainties. Note, these simulations may be generated as instances of the same class hierarchy and class structure, just with a mix of new values and uncertainties.

In the example embodiment, target attribute weights may be set automatically by the system (e.g., via Bayesian reasoning using updated values and simulation output, or via a use case/BNAS requirement, or via both), or they may be set/influenced by editors and/or users. In the example embodiment, sufficiency thresholds may also be set automatically (e.g., again via Bayesian reasoning using updated values and simulation output, or via a use case/BNAS requirement, or via both), or they be set by editors and/or users.

In the example embodiment, simulations may include creating and modeling new attributes to see if these may have sufficient impact on the weighted targets for current attributes as well as for other current attributes in an overall calculus to move towards the target weights. For example, a new skill class skill may be created and simulated to see if it may impact a patient's adherence to a medication regimen. In addition to other variables, the simulated future states may be based on the plasticity of a user's skills. Can the user learn skills like other people similar to the user have learned? In other words, a user's attributes may be compared to like users to determine if there may be skills and other aspects of other user instantiations that may be modeled for the user in a simulated fashion. In the example embodiment, various methods may be used for this type of simulation in the example embodiment. For example, generic instantiations for simulation purposes may be implemented, including as an archetypical instance (i.e., zero agent example, per FIG. 2 and FIG. 10 descriptions) or as a set of proxy instances for a user sharing certain attributes in common with other users. In the example embodiment, instances may be instantiated with information from a population of users averaged and deidentified to represent a user generically as part of a genericized population of users. Information from these generic simulations then may be analyzed and incorporated into simulations for the user, which in turn then may be analyzed, with new attributes examined as part of the same class hierarchy used to represent all users. In turn, it may be determined from simulations of user future states if/where newly simulated values associated with them may fall within a range of reasonable or logical shifts from the user's current attribute profile, enough to move towards the targeted weights.

Next, we turn to the BNAS, the best next action step 870. In the example embodiment, a BNAS may be composed in various ways. In the example embodiment, a BNAS may be a composable, collaboratively developed use case, which may be “selected” from an inventory of composable use cases that may be composed by a deep learning model (e.g., optimizer) into one or more sequenced actions to assist the user in moving towards targeted weights. In this case, the “composed” use case may be labeled the BNAS because an optimizer may “compose” it to best satisfy the story-based ontology class hierarchy dependencies. In the example embodiment, when a use case may not already exist meeting requirements for selection, a BNAS may be “discovered” or composed on the fly without an inventory, by a model (e.g., prompt generation system, or actualizer) that may traverse a knowledgebase and user database to optimize target weights while satisfying instantiations of story-based ontology class hierarchy dependencies. In the example embodiment, on the fly composable use cases may be composed based on inputs from one or more additional sources (e.g., expert databases, LLMs, KGs, etc.), in addition to user inputs, to create a zero-agent instance.

In another example embodiment, all use cases, including all best next action steps, may be composed on the fly.

In various example embodiments, a composable use case may be an atomic use case (where an exact order of one or more steps is to be followed) or a composite use case (which may be a collection of atomic use cases). The composable use case may comprise various steps, or sequences of planned story-based ontology instances, based on known prior examples, where each step may have certain evidentiary requirements to establish that a user may be in a certain use case, and, by comparing that evidence with a user prior state, may be used to establish whether the user is advancing in the use case.

In the example embodiment, the BNAS may include the simulated target weight information as described above. An example of when this may be advisable is when the user situation calls for a validated use case, where certain measurements may be associated with certain steps (e.g., composed use case from atomic use cases), from which target weights for use in the example embodiment may be derived or used as reference.

A BNAS in the example embodiment may be characterized as a directive using a simulated instance of the story-based ontology class hierarchy to direct certain tasks (actions) requiring skills to complete a certain deliverable in accordance with a Contract involving a certain role. It may have timing and cost and other requirements or parameters. A BNAS may be instantiated with user data so that it becomes a simulated instance particular to the user.

In the example embodiment, a BNAS may be a composed use case step predicted to optimally move a user's current state values and uncertainties towards a user's desired future state values and uncertainties; the former may be referred to as a user's current story and the latter may be referred to as a user's envisioned story.

A BNAS may be composed by various models in various example embodiments (e.g., via an optimizer or “policy” in a reinforcement learning model, or by a prompt generation system that may incorporate optimizers in its architecture). This composing may be based on an inventory of composable use cases collaboratively developed and simulated. These are then stored as a sequence of one or more planned story-based ontology instances for use in situations where the simulations or evidence of instantiated instances is shown to shift certain attribute values in a desired direction (e.g., lower anxiety and increase quality of life), as typically may be found to occur in certain situations across certain user groups; a BNAS may be customized through instantiations of user data, which in turn may be simulated and therefore optimized for individual user situations. In the example embodiment, composable use cases may be based on a validated set of sequenced sequences as may describe a professional services protocol (e.g., a medical procedure). In another example embodiment, as above described, a composable use case may be “discovered” on the fly through traversals of vast knowledge stores of expertise encoded with the class hierarchy.

To return to the illustration, a BNAS may be generated by the system for Jake based on his first state anxiety value shown as 0.7, which may be a typically higher anxiety reading than for other people (i.e., other Identities). A desired anxiety value for Jake may be 0.5, a significant reduction in the anxiety from 0.7. In the example embodiment, a target weight may be set for an attribute value by the system using various importances that take Jake's inputs into account. These importances may include relations with one or more other Identities with whom Jake may have a Contract class Contract. For example, in Jake's case, one of these other Identities may have a doctor role, with whom Jake in a patient role may have a Contract class Contract. Jake's deliverable in this Contract may be to take a particular action when a particular situation arises. In the illustration, said Contract may involve a target value for Jake to reach for Jake's anxiety attribute, as part of Jake's “envisioned story”.

In the example embodiment, a threshold may be computed or assigned to compare value and uncertainty attributes to determine if enough evidence exists, say, from Jake's input, to determine if Jake may be advancing in a use case. This evaluation may depend on whether enough dependencies in the story-based ontology class hierarchy (sufficiency) are satisfied by Jake's data before making this determination.

These user specific dependencies may be checked (e.g., via probabilistic programming). These may also be characterized as generic dependencies, which also may be checked. In the example embodiment, generic instantiations may be implemented various ways, including as an archetypical instance (i.e., zero agent example, per the FIG. 10 description) or as a set of proxy instances, where instances may be instantiated with information from a population of users and averaged and deidentified to represent a user generically as part of a genericized population of users.

In the example embodiment, a BNAS may act as a ‘prescribed,” genericized set of user states, or sequence of story-based ontology instances, to impact the value and uncertainty components of various attributes associated with the Identity, here illustrated as “Jake.” This change may be measured on the basis of the next and other future inputs from the ‘user”, here “Jake”.

Next in FIG. 9 is the process of optimizing the communications of the BNAS, so that the user for whom the BNAS is generated may be most likely to respond to it. Since the BNAS and the communication of the BNAS may be both optimized in the example embodiment, it may be determined efficiently whether it is the BNAS or the communication of it that may most impact the user response. Through analysis of user inputs, updates, BNAS and its communication, the next generation of a BNAS and its communication may be generated.

Turning now to the elicitation based on the BNAS, this may be generated in the example embodiment as a stimulus for a user response to the BNAS. Once the BNAS is composed and instantiated with user data (e.g., via current or prior processed inputs), the BNAS, as a simulated user future state, may have dependencies that may be emphasized in communications to the user. Recall, a BNAS may comprise tasks (actions) requiring skills to complete a certain deliverable in accordance with a Contract involving a certain role that may comprise the BNAS. Which elements of the class structure represented in the BNAS to call attention to in a communications may be based on prior user response patterns, style of prior communications that elicited a response, and conditioning on the nature of the BNAS (e.g., its urgency). In the example embodiment, just as there may be composable use cases based on certain instantiations of the class hierarchy, there may be composable units of communications associated with the story-based ontology class hierarchy elements, which may be communicated through a multi-modal template. It should be noted that while natural language may be a desirable element of the communications, a multi-modal communication may act as a richer stimulus, involving for instance sound objects (e.g., “mouse squeaks”), image objects (e.g., video snippets of a smiling cat), and so forth, in addition, for example, text (e.g., “You got this, Jake. Take the meds.”). In the example embodiment, various models may be trained/fine-tuned to generate the BNAS as well as the communications of it (e.g., via prompt generation system or reinforcement learning model).

We turn lastly in FIG. 9 to the illustration of Jake's state after Jake is shown receiving the elicitation/communications of the recommendation based on the BNAS 850. Simply, Jake's next input is shown as being processed in the same manner as state one, before the BNAS is communicated. Note however the change in the anxiety value and uncertainty attributes 860 after the BNAS is communicated. In the example embodiment, the cycle repeats, attempting to iteratively improve a user's progress towards an envisioned story, which itself may be constantly evolving, through supportive communications linked to predicted best next actions.

In the example embodiment, the story-based ontology class hierarchy may act as a template for creating objects in object oriented programming. Objects based on these classes may represent specific class instances. In the example embodiment, the classes themselves may encapsulate data associated with specific data types that specify the kind of data they can hold and methods, for example to resolve dependencies in the story-based ontology class structure and hierarchy. Methods may mean how operations on the data may be performed within a class (e.g., instructions/actions), and interact with other classes to resolve dependencies. Data types filled in with the data that the code instructs may be referred to as Story Data Types. Finally, specialization logic may be used to execute/facilitate non-optimization-based tasks/decisions.

FIG. 10 shows an overview of how user current states and user future states may be represented in terms of story-based ontology instances in accordance with various embodiments of the invention.

The flow depicted in FIG. 10 begins with inputs from users or about users 910, which may be first received then featurized, before flowing into a process that transforms the featurized inputs into machine readable representations of the user input data 914. This transformation process of inputs into user representations may be performed by various models (e.g., extractors and/or classifiers) conditioned on the story-based ontology through various methods.

During this transformation process, various weights may be learned by the models during their transformation of featurized user inputs.

As discussed in connection with FIG. 36, this transformation process may be referred to as Insight Extraction Flow and Simple Data Conversion process. See also FIG. 54 for when transformations may be between LLMs and non-LLMs. In brief, a transformation process may include processing output of featurized input into probabilistic predicates, such as may be used by probabilistic logic programming languages and in transformed representations by various models in the example embodiment to perform various tasks. Of particular note, in various example embodiments, probabilistic predicates may be used to represent story-based ontology information in probabilistic programming code. In the example embodiment, a probabilistic programming language (e.g., Problog) may use probabilistic predicates, as representation of the story-based ontology, to perform logical evaluations of story-based ontology information, determine completeness of predicate sets, draw inferences from them, and associate these inferences and code completion matters with the user inputs. This described association between predicates and specific user input may not rely solely on the user input but also on a knowledge base and/or knowledge graph populated in part with other user input and, through augmentation, knowledge from various sources also represented in predicate form. As further detail, various weights learned during model extractions and conversions into predicates may be used to assign probabilities to predicates, including for uncertainties of various attributes found in the story-based ontology class structure and story-based ontology class hierarchy. Additionally, predicates may be used in evaluations of other code and system outputs, as will be described later.

To continue with the arrows flowing from the processing box 914 in FIG. 10, various weights learned during input processing may pass into initialization and customized updating of story-based ontology instances, where an initial user state may be represented in terms of the story-based ontology. This is particularly so with regard to the attribute components of value and uncertainty. Additional user inputs may then be used to update the value and uncertainty components of attributes specific to the user. The connection between the initialization and updating box shows that the user current state may be described as the initial story-based ontology instance and that each new user input may be described as a new story-based ontology instance for the same user.

Note, a user state may be characterized as a story-based ontology instance using various methods in addition to those that use predicates. For example, predicates may be converted into subject verb object sets that a large language model (LLM) or knowledge graph may use, or into other formats that other deep learning models may use (e.g., reinforcement learning models). The converse is also true; formats used by deep learning models may be converted into predicates. As described, probabilistic programming languages may use predicates for computations and logical analysis. Thus, predicates may act as a bridge between models and programming languages that also may be used to represent the story-based ontology classes and the story-based ontology class hierarchy in code.

To make a larger point about the story-based ontology itself, various techniques may be used to propagate a story-based ontology through the system functions, including through programming and models, which through various conversions, may use predicates (and/or SVOs-predicates may be converted into SVOs and vice versa) as universal representations of the story-based ontology and its instantiations. Predicates and SVOs are universal representations of the story-based ontology and its instantiations. SVOs as a natural language construct naturally facilitate natural language communications to users, which may be encoded with the story-based ontology as well. In the case of multi-modal communications to users, natural language may play a large, but not exclusive part, in the story-based ontology. Encoded communications such as image objects in a communication (e.g., a “squeak” or an image) may require conversions to/from non-language forms to ensure the story-based ontology framework is maintained.

Let's refer now to the progression into Instant Analysis and Simulation (IAS). In this step 940 the IAS programs and models may receive as inputs the initial and updated values and uncertainties of the story-based ontology from initialization and updating customization of the story-based ontology instances, or user current state. They also may receive processed inputs 914 from iterative analysis, including with editor or user or other source assistance (as shown), to factor into new analysis 940, including new simulations 950 based on updated story-based ontology instances, or user states. The straight line below the instance analysis and simulation box as shown is meant to show that the user future state 950 may be described as analyzed and/or simulated story-based ontology instances specific to the user.

During this instance analysis and simulation, the inputs into this step (914, 920) may be evaluated and outputs of the system processes may be compared to thresholds set by editors in advance or by algorithms approved by editors. In the example embodiment, an algorithm may be decided upon that ratchets up thresholds using Bayesian reasoning, to continually improve thresholds as the system learns more. If insufficient information is determined to exist from this analysis and/or simulation (e.g., to complete missing predicate arguments) through knowledge base or graph queries or other means of accessing system knowledge, then editors/users in the example embodiment may be queried to supply it, via an elicitation or communication based on user response patterns and other factors likely to increase responsiveness. In turn, the user response in the example embodiment may be treated as new input 910 and the cycle shown in FIG. 10 may repeat. Or, and in preferred example embodiment, another source may be automatically consulted for an answer first in an attempt to satisfy the information need of the system that the system may not otherwise be able to satisfy, before occupying user time (when appropriate). These other sources may include, for example a LLM, as a vast store of language data and information that may augment system knowledge (e.g., knowledge base information) or a special database containing detailed domain knowledge as may facilitate a user traversal of a use case (e.g., information to support a diabetic use case). In the example embodiment, information received from sources (i.e., users/editors or additional sources) may flow back into system processing, so that it may be i) converted into the story-based ontology framework (e.g., instantiate the story-based ontology with input data), as necessary, ii) evaluated as a solution to the queried system need or user need, and iii) assist the user in meeting a user need advancing the user, such as traversing a use case (e.g., assisting a needy loved one with an activity of daily living). These iterations between information needs analysis and query generation of sources and users may facilitate not only updates but through analysis and simulations may result in a series of best next step recommendations (e.g., communications/elicitations) to help users advance towards their goals.

Referring now to the arrows coming into the processing box 914 from below it in FIG. 10, one arrow comes from a box with a question, “adjust story-based ontology instance based on inspection?” 918. This may refer to analyzing weights learned during processing to determine if the vocabulary used to describe and define terms in the story-based ontology instances need to be adjusted. For example, “Retired Middle School Math Teacher′ may be too specific for the name of a new Role or “Retired Middle School Math Teacher” may be too similar to a putative existing Role in the knowledge base called “Retired Math Teacher. In the example embodiment, various methods system may handle a proliferation of new terms, for example new generated roles. In the example embodiment, a method for “cleaning the vocabulary” may create a proposed new instance of a role class term (e.g., “Retired Middle School Math Teacher” Role) and all the associated Values and Uncertainties (including both Properties and Relations). This method may involve, for example, an analysis of predicate clusters involving distance from a centroid of values. In the example embodiment, such a method may be used to regularly inspect each class. If a class starts to reach an undesirably high number of Instances (e.g., parameter maximumnumberofroles=11000), then these Instances may be compared to one another . . . all Instances may be well-defined by the Values and Uncertainties of all their Attributes, many of which may be quantitative. A quantitative clustering or dimensionality-reducing calculation may lead the model, or programming algorithm, to determine that there may be two Instances that are most similar to each other which are then merged (e.g., via a LLM or in another example embodiment a prompt generation system trained on a vocabulary cleaning method). Repeating this Vocabulary Cleaning method until the desired number of Instances are achieved may naturally create a set of Instances that are at the desired level of distinction using the properties (Values and Uncertainties) that really matter. This may significantly relieve the definition burden and provide an essentially automated method to control the Vocabulary even when models or programming may regularly create new Instances.

To now provide an overview of FIG. 10 and describe various terms. FIG. 10 shows how story-based ontology instances may represent varying user states and illustrates a method for updating and analyzing varying user states, including future predicted states for users.

In FIG. 10, a state may refer to a specific fixed set of Instances, Values, and Uncertainties in the story-based ontology. This state may be a matter of situation and time. Note that the story-based ontology itself may not be a matter of time (e.g., no sequence of moves on a chessboard may change how a bishop may move). In the chess analogy, a state may be thought of as a specific chessboard.

In the example embodiment, many computations and processes involving programming and models (i.e., collectively, functions) may need to be performed to successfully serve a user, as represented in a story-based ontology state, but these may be separate from a particular State. These may be referred to as state-independent functions. Two major types of functions may be required for successfully serving the User: Updating and analysis. Note the two boxes in FIG. 10 described as “Initialization and Updating . . . ,” 920 and “Instance Analysis and Simulation” 940.

New information (in many formats) may be converted into changing the State of the Story-based ontology using an Updating Function. This function may take some kind of input (e.g., information from a fine-tuned LLM, audio from the User which has been analyzed using existing tagging algorithms, heart rate measurements from a wearable, the changing time of day, an assessment score based on a validated instrument, etc.) and use it to update the Instances, Values, and Uncertainties in the State of the Story-based ontology. The outcome of the Updating function may be either changing (using Bayesian updating based on Bayes' Theorem) of Values and Uncertainties in existing Properties and Relations or the creation of entirely new Instances (and their associated Attributes) of various classes. For example, a doctor's referral to a specialist may lead to the creation of a new Identity for a person with new Roles and new Contracts, each with new Attributes. Whether new information changes Values and Uncertainties or whether it adds new Instances, the new set of Instances, Values, and Uncertainties may be a new State. In the chess analogy, as the game progresses, pieces may move (like changing Values) or may be eliminated altogether (like changing the number of Instances), with each new configuration of the chessboard being a new State that has changed due to Updating function. There also may be ways of visualizing the evolution of the State in time by showing the changing web of Instances with the Values of Attributes including Properties and Relations.

Given a specific State of the Story-based ontology, the Analysis function 940 may perform key computations to support the User that may be unrelated to updating the State. Examples of Analysis functions may include identifying the next best step for the User to reach their Stated goals or anticipating the probability of a conflict from a breach of Contract and then determining possible responses to these conflicts, all in accord with Story Logic (i.e., the logic and interdependencies within and between classes in the story-based ontology class structure in a hierarchy of classes, the class Hierarchy). Some of these Analysis functions may generate Simulated States 950 in order to anticipate the future (because the example embodiment may track uncertainties, this may be done probabilistically, e.g., using Monte Carlo simulations as may be performed via various methods, including via probabilistic programming). In the chess analogy, this may be like imagining a future sequence of moves, each of which are States of possible future chessboards, but this function may not actually change the positions of any of the pieces.

By propagating uncertainties in these functions, some Analysis functions 940 may also identify specific areas where additional information may be needed, triggering the activation of Updating functions 920. In the example embodiment, the completion of an Updating function may mean that there is a new State of the Story-based ontology 930 and some Analysis function may be re-run with every new change. It may be easiest to visualize Analysis functions as “acting on” the Story-based ontology, they are based on functions of a specific State of the Story-based ontology. And the State may only change based on an Updating function 920. Thus, the ever-evolving State of the Story-based ontology (itself grounded in the strong logical infrastructure of the story-based ontology classes and Attributes) may stand at the mid-point between Inputs (which generate Updating functions to change the State) and Outputs (which may be generated using Analysis functions run on a State) in the example embodiment.

Each State of the Story-based ontology may be customized for a specific User. This may include collaborative, or multi-agent States, as illustrated by a Contract between different identities in FIG. 7, where multiple individuals are fully represented with their own Roles, Skills, etc. and there is a rich range of possible outcomes as would be expected from having multiple complex interactions, or collaborations.

In the example embodiment, various aspects of States 930, 950 may be generic and independent of the Users. For example, “money paid to the grocer” may generally be an important Deliverable of the “grocery shopping” Task and this may be relatively objective and independent of the rest of the State of the Story-based ontology. These objective aspects of a State may therefore be considered in advance. With reference to FIG. 2, the default Values and Uncertainties for a wide variety of generic Instances may provide a crucial initial starting point for a State before it is customized to a specific User: identified as a Zero-Agent State. This is because it may not depend on anyone (though the Values may be changed later to be a better match when agents are included). This Zero-Agent State may be the core output of the knowledge base in the example embodiment. In the example embodiment, the Zero-Agent State may be functionally equivalent to a knowledge base. The Zero-Agent State may also be the initialization of State 930 for actual use in the example embodiment with Updating functions 920 providing the customization and personalization central to the system and its users (See FIG. 2).

In the example embodiment, still with reference to FIG. 2, a knowledge base Zero-Agent State may be collaboratively developed through the use of a query platform (e.g., an electronic bulletin board, sandbox, etc) connected to an AI platform with probabilistic programming. One aspect of this collaborative development may be the incorporation of Use Cases where expert knowledge (e.g., via an additional source also connected to the AI platform. In this case, this information would be made available to editors/user of the platform) which may then be used to set up various common and archetypal configurations with a focus on the main users of the system. Another aspect of the collaborative development of the Zero-Agent State may be the use of Updating functions 920, which may convert inputs 910 into updates of Instances, Values, and Uncertainties. In various example embodiments, the Updating functions running in the Zero-Agent and Multi-Agent States may run and be built differently.

Updating functions may be based on a wide variety of inputs, from dictionaries to humans to Internet searches. In the example embodiment, these may facilitate the creation of new Instances, for which there may be only limited input information.

As described, LLMs may act as additional sources or run on the AI platform as part of the prompt generation system. LLMs may often answer explicit questions that help Updating functions 920 easily translate information into Instances, Values, and Uncertainties. For example, a generative pre-trained transformer (GPT) may give a list of Tasks necessary to fulfill the Deliverable of “groceries”. It may estimate which tasks are most important (e.g., determining the Value of the Relational Attribute). With the right prompts, LLMs may gather and synthesize a huge set of information and provide outputs that are relatively straightforward to represent in Instances, Values, and Uncertainties in the Story-based ontology. That is, LLMs may make generation of the knowledge base/Zero-Agent State referred to in FIG. 2 easier and more powerful.

In the example embodiment, a prompt generation system (See FIG. 12) may automate the generation of effective prompts that output accurate Instances, Values, and Uncertainties from an LLM or other models. By tuning an ML prompt generation system for a specific LLM on some training data (e.g., States generated by hand, select Use Cases), it is possible to significantly automate process of the Zero-Agent State generation. This involves comparing the output to information from reliable sources (like dictionaries) and involving human input/correction.

Another crucial source of information for the knowledge base/Zero-Agent State referenced in FIG. 2 and for prompt generation system training data may eventually be the collection of all users. As users interact with the system and provide input and information, clustering algorithms may be used to identify the most objective aspects across many individuals. These objective results may already be in the language of the Story-based ontology and may therefore be particularly valuable. This may provide the prospects for rapid improvement as more users provide better information that then improve the experience for all users which then attracts new users which provide even more information in a positive feedback loop. In the example embodiment, this positive feedback loop may include anonymization and sensitivity measures to facilitate widespread, ethical use.

In the example embodiment, the updating and analysis functions described in FIG. 10 may create new story-based ontology instance information from incomplete information from user inputs or a user database, by resolving dependencies in the story-based ontology structure from information that may be available. This generative solution may facilitate a reduction of uncertainty in the system, while providing users with supportive information that helps them rather than simply use an interaction with the user to meet the system's own needs for information. Here is an example of how a specific user Contract may be generated.

Let's assume in this example that the system has detected a significant anxiety increase when it overhears a user statement. If the user says “Oh no, I forgot the rent is due tomorrow!” the system parses this sentence to recognize that “Oh no” is an expression of concern and “I” is User TomGarvin123. “ . . . rent is due tomorrow” may be compared to the knowledge base until it realizes the “Rent is due” is a Deliverable of a “Renter-Landlord” Contract and that “tomorrow” means that there is a deadline/Requirement of 24 hours from now associated with that Deliverable. It may check its internal database to see that “Rent” is not associated with any existing Deliverables already identified for the User, nor is the “Renter-Landlord” Contract available. It could compare to the knowledge base to learn (e.g., update attributes with values corresponding to the fact) that this may be a very common Contract that is considered to have high importance. It could then create this Contract and add the “rent” Deliverable and the deadline. It could infer that this Contract is reasonably important to the User since it was associated with some anxiety and the knowledge base shows that Renter-Landlord Contracts are very important. Thus far, a Contract has been generated from incomplete user inputs based on the story-based ontology that system functions then may attempt to further define.

To continue with the example of generating a renter-landlord Contract, at this point, there may be numerous of uncertainties in the model: Who is the Landlord? What are the Deliverables from the Landlord in the Contract? Are there any other Deliverables from the Renter? How much is Rent (e.g., how much of “Skill Amount” associated with Money is needed to fulfill the rent Deliverable)? How satisfied and dissatisfied are the two parties with the Contract? But some of these are more important than others, for example, the amount of Rent may usually be more meaningful (for the User's goals) than the name of the Landlord.

To resolve some of these questions, the system may track its internal uncertainty and know that it doesn't know a lot of these numbers, either from the knowledge base or just an “uninformative prior.” The system may have estimated values (like 0.5±1-0.5 for those things on which it knows nothing). The system may then perform a Monte Carlo analysis, or another type of analysis, that shows that the uncertainty in the “Skill Amount” of Money leads to the greatest uncertainty in reaching the User's overall goals. That is, by running internal simulations 940, it may identify which pieces of information it needs to reduce overall uncertainty. In the example embodiment, the functions may tune the system to know which input stream it should favor for different pieces of information. In this example, since it is a Skill Amount, the system may realize that it should gather this in a user-focused way (e.g., Administrator, User) and even reach the threshold of asking an explicit question. With some reasonable NLP, the system could then ask, “How much money is needed to pay your rent?” And the process of uncertainty reduction may begin again. Eventually, the system may gather from various input streams enough information that the uncertainty in reaching the User's goals has reached a nominal amount that it may stop trying to gather information which also, in practice, may depend on the input stream. While the system may be careful with the User's time, internet searches are limited only by tractability and may facilitate prompt resolutions of the story-based ontology instance information needed for an accurate view of what matters most to a user.

FIG. 11 is a diagram showing a comparison between likely trajectories 1040 and 1060 of user states in accordance with various embodiments of the invention. The system of the present invention is capable of calculating multiple trajectories, each with an associated probability 1005 with the goal of exploring the most likely trajectories.

As shown in FIG. 11, likely current trajectories 1040 based on a current state 1010 without an intervention may be compared to likely trajectories based on a current state with intervention 1060. Each current state has a probability function 1012, 1052 associated with the likelihood of future states. The probability functions act to establish individual independently determined future states without intervention 1042, 1044, 1046 or with intervention 1062, 1064, 1066. The candidate trajectory associated most with movement towards a user's goals may be determined, and a BNAS based on that determination recommended. A candidate trajectory may include upweighted target values and uncertainty attribute components of the story-based ontology classes.

In one invention aspect, a BNAS may be simulated as an intervention. That is, the simulation intimates a future instance of the story-based ontology based on target weights for attribute components in a story-based ontology class hierarchy. In the example embodiment, a BNAS may be an instance of the story-based ontology designed to change trajectories of user states. This may be appropriate in situations requiring certain expertise, for example.

The domains of expertise may be limited only by what domains of knowledge exist. This may include any “walk of life.” For example, on the one hand, the appropriate expertise could involve a mother's “motherly advice” to a daughter with a newborn baby. On the other hand, the appropriate expertise could involve a medical diagnosis or other professional service rendered in accordance with standard protocols of that profession (e.g., how can the baby's mother deal best with her post-partum depression?) Expertise may also be “blended” in that it is integrated expertise across domains. A mom may help relieve some of her daughter's stress by caring for her daughter's baby, and a doctor may prescribe a medication for her daughter as part of a post-partum depression treatment. Note that expertise may refer not only to knowledge but also to a skill in applying that knowledge.

When no intervention is simulated, the likely current trajectories of a current state 1040 may involve simulating a current state. In this case, a trajectory may be based on prior states and updates (See 920) and analysis (See 940) of the new current state (See 930) to determine the likelihood 1005 of future states 1042, 1044, 1046 (See 950). For example, can an appropriate life balance involving immediate family at home be maintained by a son or daughter managing support for an elderly parent who has just undergone heart surgery while working through the insurance coverage process? Based on current patterns, which Contracts will likely continue to be more or less fulfilled with what computed impact on what goals (previously upweighted targets)? One or more simulations of attribute weights based on current weights may be conducted to predict future states to provide candidate answers. In some cases, the recommended BNAS may be associated with a likely current state trajectory.

For comparison, attribute weights may be generated from one or more simulated interventions to produce various trajectories 1060. This is shown in FIG. 11 as prime versions of the current state probabilities. For example, to continue with the illustration of the son, an evaluation of probable future states driven by, say, an intervention involving a coaching use case (e.g., Problem Solving Therapy—PST) shown to reduce anxiety for caregivers like the son may be simulated for its impact on the son's ability to calmly manage the trade-offs in his current situation, resulting in more fulfilled Contracts associated with the son's goals.

FIG. 11 shows that a winning candidate trajectory may be based on a comparison between candidate trajectories 1070. From there a BNAS associated with the winning candidate future story-based ontology instance may be based on this comparison 1080.

Using simulations as described in FIG. 11, users may be help in managing uncertainties related to their circumstances. These uncertainties have an impact on their short and long-term goals that may otherwise be difficult to assess. In one exemplary scenario, a set of circumstances and uncertainties may involve deploying care for an ill individual who is supported for that care by a network of others such as doctors, nurses, and family members. In another exemplary scenario, a set of circumstances and uncertainties may involve endeavoring to improve one's golf game or mitigating between conflicting goals of having Sundays free to care for an elderly parent as compared to playing golf. In another exemplary scenario, a set of circumstances and uncertainties may be simulated involving shifting from effectively managing the care of an elderly parent while progressing through the logistics of health insurance claims associated with providing that care. Likewise, finding a substitute caregiver for an elderly relative while finding the best course of medical treatment for the original caregiver's personal health issues can be simulated as can ordering food at a restaurant when on a new diet based on a nutritionist's recommendation involving new food choices. The simulations may be numerous and facilitate quantitative modeling of a user's future states, including the user's future interactions with other users (e.g., via simulated contracts) and their likely consequences. Thresholds (e.g., ratcheted thresholds for sufficiency), limited loops, and other methods may be used so as to constrain the number and accuracy of representative user states and interactions.

### Meeting Sufficiency Requirements of the Ontology Based on What is Important to the Human User

In the example embodiment, what is understood to be important to human users is what ontology-driven agents and agent network endeavor to understand, model, communicate and facilitate collaboratively. This collaboration involves the human user as well as agents, including agents of other human users. In the example embodiment, what is also understood to change, perhaps with some frequency, is what may be important to people, in a given situation. In the example embodiment, the quantitative exploration of ways to satisfy what is important to a user may be processed and operationalized with user input. This user input may create new sufficiency requirements in the ontology based on emergent dependencies, which in turn may need to be satisfied. Additionally, the state of what a user may be working on, say a project, may also be in a state of change.

FIG. 12 is a flow diagram showing a continuous learning loop where a prompt generation system may learn iteratively from user inputs and prompted downstream model and program outputs (based on user inputs) how best to advance users to user goals with each newly generated prompt, in accordance with various embodiments of the invention.

In the example embodiment, the prompt generation system 1140 may consider inputs from users 1100 as well as updates and analyses 1190 of downstream model outputs 1180 to compose the optimal next step for the user, based on user goals, sufficiency thresholds (e.g., predicates complete? key dependencies resolved?) and tasks that the prompt generation system 1140 may be trained to perform and orchestrate, through downstream models and programs 1150 and/or 1060, and/or through additional source 1170.

In the preferred embodiment, the prompt generation system 1140, together with the downstream models and programs it prompts, may orchestrate the creation and management of story-based ontology instances from input data. That is to say, based on data inputs, 1140 may orchestrate instantiations of value and uncertainty attribute components of every class in the story-based ontology class hierarchy (See FIG. 3-9). In one embodiment, prompt generation system 1140 may orchestrate these instance instantiations for all users. In another embodiment, prompt generation system 1140 may be customized for each user and may orchestrate these instance instantiations only for their user. In yet another example embodiment, prompt generation system 1140 may orchestrate Contracts with one or more other prompt generation systems, as may be the case in an Intelligent Agent System (See FIG. 1) comprising its own agents and agents of other users, wherein an agent may comprise a prompt generation system.

In yet another embodiment, prompt generation system, as an intelligent agent, may further comprise a network of intelligent agents represented as hypergraphs based on an ontology. This network of agents represented as hypergraphs may be referred to as a hypergraph network. The hypergraph network may operate as a system in one embodiment. In another embodiment it may operate as a subsystem of the prompt generation system shown in FIG. 12. In various embodiments, the hypergraph network may facilitate the automated creation, optimization, orchestration, enforcement and iteration of workflows. Among key workflows related to the inventive system are those directly tuned to an ontology. This includes, for example, the story-based ontology described herein. As a subsystem of the prompt generation system, the hypergraph network, pertains especially to those quantitative exploration strategies determined by 1140A. Those subsystems involve large language models specified to meet various requirements of the ontology (e.g., sufficiencies, dependencies) and are based on 1140A evaluation of received inputs 1110 and 1190. In an example embodiment, the hypergraph network may use certain large language models that are fine-tuned to generate outputs that are constructed into a hypergraph. This is, as opposed to LLMs that only produce natural language output. Thus, in an example embodiment, the hypergraph network may instruct, orchestrate, enforce and process various information requirements for the format and output of certain fine-tuned LLMs.

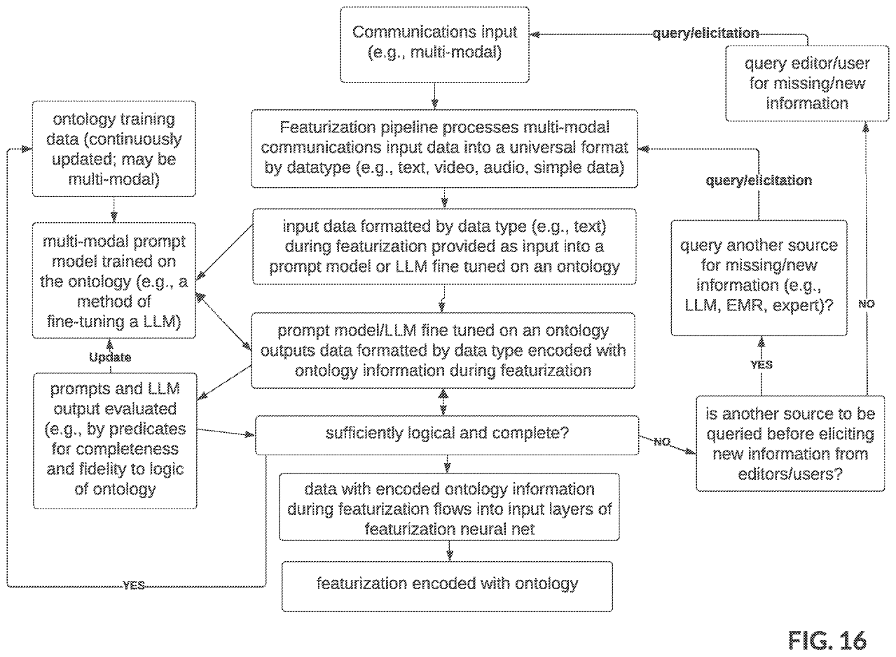

In yet another embodiment, the prompt generation system 1140 may be a standalone system that may “plug in” modularly to multiple other systems once the prompt generation system has been “trained” to orchestrate certain tasks based on outputs of the downstream models it has learned to “prompt”. In yet another example embodiment, the prompt generation system 1140 may be integrated into a communications featurization system, as described in FIGS. 16-21.

Referring now to the flow in FIG. 12, streaming inputs 1110 may be received from user 1100 and/or from other sources 1170. Other sources 1170 may be entities represented in the story-based ontology as Identities with roles, including “user”, as described above. In the example embodiment, these other sources may typically be an external database (e.g., LLM, electronic medical record system, etc.) expected to hold information relevant to meeting thresholds for sufficiency, or a third-party expert in a particular relevant field, which could be a person, or for example another intelligent agent.

The streaming inputs 1110 may be received in segments or dataslices containing text and/or image and/or audio and/or simple data. Multiple types of data in the same input may be referred to as multi-modal input. The inputs may be logged, timestamped and tagged to input source and stored in store 1130. Store 1130 may represent various types of stores in the example embodiment (e.g., user database, knowledge base, knowledge graph). Some stores in the example embodiment may have varying functional capacities besides storage and exist with an architecture to support the instantiation of the story-based ontology class hierarchy with specific user data. For example, inputs from users may be stored in a user database, which may be used in conjunction with a knowledge base encoded with the story-based ontology to represent a user as an instance of the story-based ontology, which also may be graphed, and stored. In the example embodiment, a use case comprising certain instances of the story-based ontology may be computable, and stored in store 1130. Additionally, probabilistic predicates and other computable representations of structured knowledge generated during the operation of the prompt generation system may be stored in store 1130.

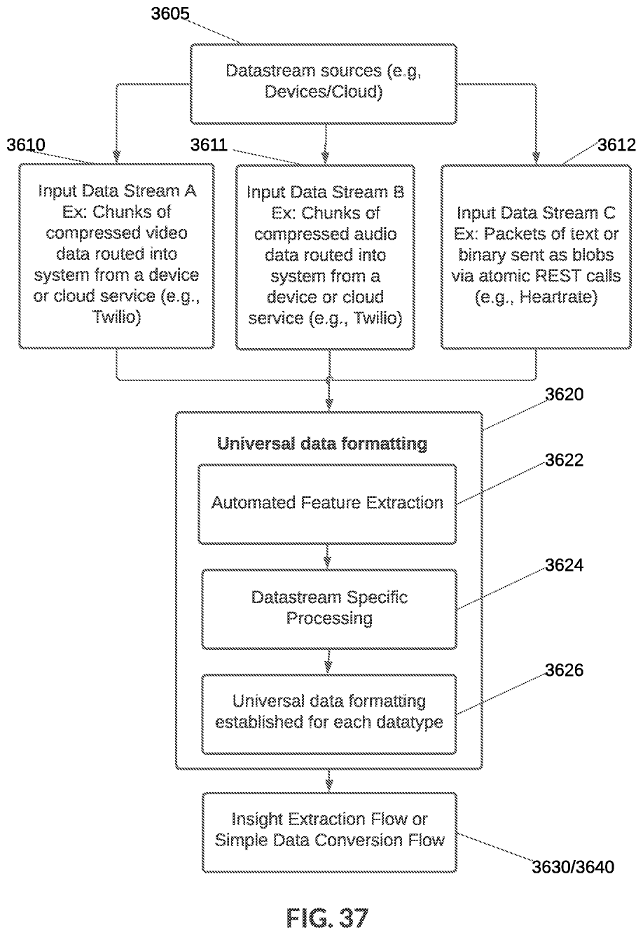

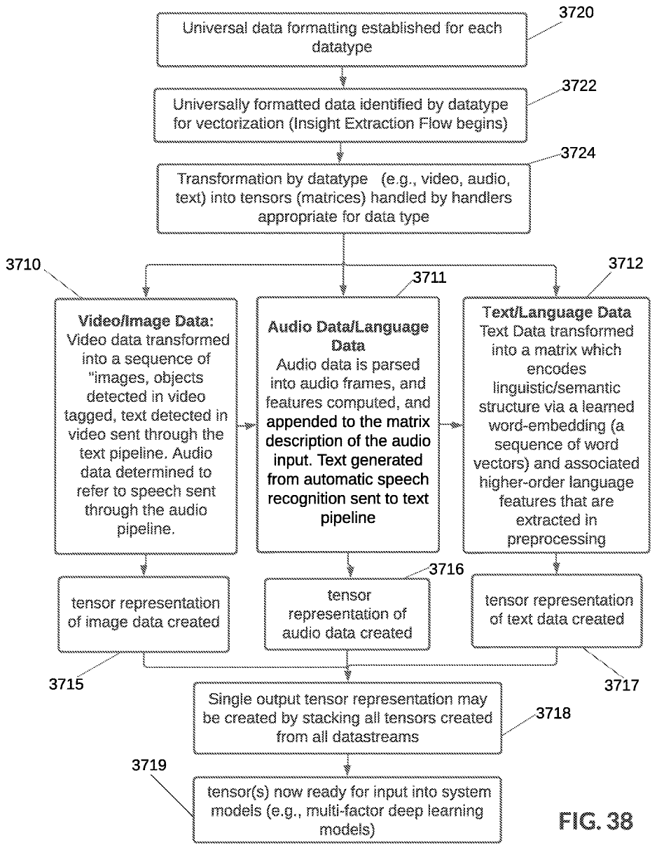

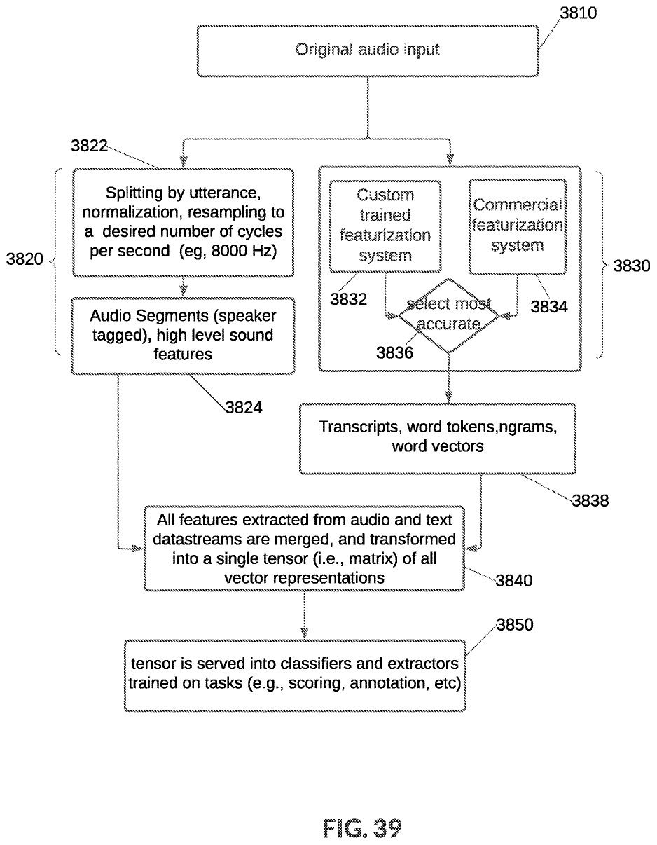

Received input 1110 may flow into featurization system 1120. The input data may be featurized by data type (See FIG. 37) into featurized data and further transformed/vectorized by featurization system 1120 into one or more tensors (See FIG. 38) for use by machine learning models that may require tensors and produce tensors as their output. Tensors may be computable representations of data, typically involving multi-dimensional arrays of numerical values. In the example embodiment, featurized data may refer also to tensors. In the example embodiment, the featurization system may be trained on reference speech data (See FIG. 30A, FIG. 30B, FIG. 39)

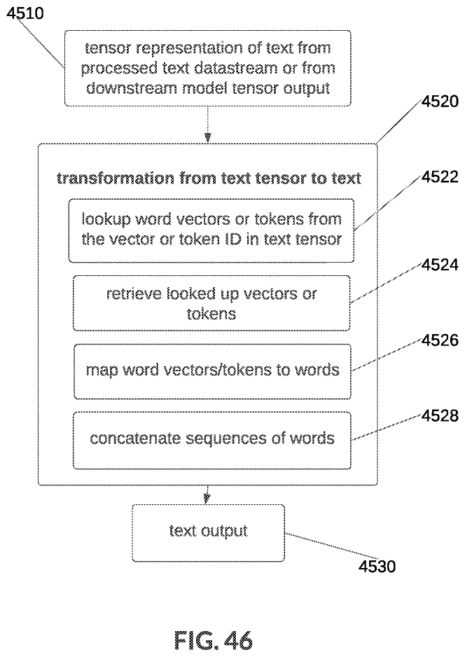

The featurized output of featurization system 1120, including featurized data and tensors associated with them, may be stored in store 1130. The double arrow between store 1130 and prompt model 1140 signifies that data transformed from featurized text/tensors into unfeaturized text (See FIG. 46) for use by machine learning models that may require unfeaturized text and produce unfeaturized text as their output (e.g., LLMs) may be received by store 1130 from prompt generation system 1140, and stored. Meanwhile, the double arrow between featurization system 1120 and prompt generation system 1140 signifies that prompt generation system 1140 may receive featurized data from the featurization system 1120, and the featurization system may receive data to featurize, for example, unfeaturized text output (e.g., via a LLM) from the prompt generation system 1140. Thus, store 1130, which has double arrows with inputs 1110, featurization system 1120, and prompt generation system 1140, may store raw original input, featurized input, and various data resulting from transformations orchestrated by prompt generation system 1140, which may include both unfeaturized text and featurized data associated with the same underlying data. Store 1130 may facilitate the orchestrations of downstream model tasks by the prompt generation system by making the appropriate data available in the appropriate form to the appropriate models and programs to perform their orchestrated tasks (See FIG. 54 on data transformations). Store 1130 also may facilitate various downstream lookups involving the original input or other input referenced in model outputs, assessments related to data lost during model processing or data transformations, activity information (e.g., recommendations made by system), and reporting (See FIG. 34).

Next, as shown in FIG. 12, input from featurization system 1120, store 1130, and prior output analysis 1190 may be provided to prompt generation system 1140. Prompt generation system 1140 may include at least the 5 elements shown in the dotted box: i) a multi-factor, multi-modal ensemble of deep learning models (e.g., which may be fused or not), collectively referred to within the context of 1140 as the “main model” or 1140A, that may do the main “thinking” of the prompt generation system, based on user inputs or inputs about the user 1100 (e.g., electronic medical record data), updates and analysis 1190 of prior downstream model outputs 1180, and what next new information or actions may be most needed to guide the user most productively towards their goals (based on target weights for uncertainty and value attribute components for the user Identity), ii) a generator 1140B that may transform the output of the main model “thinking” into a format or formats for input data to be operated on, by which optimal downstream models 1150 and/or 1160 in what sequence, iii) the 1140C output of the generator, which may be formatted data or reference to it for the optimal downstream models 1150 and/or 1160 to operate on, iv) the 1140C output of the generator as an exchange communication (“prompt”), which may include instructions on how “prompted” downstream models may perform tasks on the formatted data based on the main model “thinking”, and v) thresholds (e.g., using Bayesian Theorem) generated by 1140A to compare the downstream outputs during updating and analysis 1190 using the system's probabilistic framework.

Referring now in more depth to prompt generation system 1140, the main model 1140A may include deep learning classifiers and extractors. These deep learning classifiers and extractors may be previously trained on training data that may include, for example, genericized user data, the story-based ontology (FIGS. 3-10), reference speech data (FIGS. 30A and 30B) and reference treatment data (See FIGS. 30C and 30D). See also FIG. 2 and FIG. 10 descriptions on zero agent models based on knowable archetypical data and genericized population data for a universal base story-based ontology, which may be used for training. The classifiers and extractors in 1140 may involve tensor-based and/or LLM-based models.

In the example embodiment, such trained classifiers and extractors may be deployed in various embodiments of prompt generation system 1140 over a network. The models in prompt generation system 1140 may comprise kernels that in various embodiments may be used (e.g., via transfer learning) to establish an evidentiary basis for all individual users, but reflecting their unique data, while also being encoded in terms of the universal story-based ontology. Thus, trained extractors and classifiers in 1140A may promote standards based on the same ontology class hierarchy as well as the same types of validations using statistical techniques across structured knowledge representations of users. In the example embodiment, encoded outputs of these classifications and extractions based on training may be mapped to a knowledge graph for computation and/or transformed into probabilistic predicates based on the probability components of the story-based ontology to facilitate reasoning using probabilistic programming for individuals and for populations. In the example embodiment, the inputs and outputs of the classifiers and extractors may be temporally associated by time stamp as well by other associations, with each other, and users. These classifications and extractions may also i) establish an evidentiary basis for comparing users since they may apply to a universe of users, and ii) be propagated consistently in the example embodiment since they may be compiled into code based on the same class hierarchy and class structure and thereby instantiated as the same datatype (E.g., Charles's anxiety attribute and Jake's anxiety attribute may have the same basis, be expressed as the same datatype, anxiety attribute, and be compared using the individual value and uncertainty measures for each Identity of the same datatype, anxiety attribute.)

In FIG. 12, the inputs from featurization system 1120, store 1130, and prior output analysis 1190 may be fed into the main model in 1140 (i.e., 1140A), where said classifiers and extractors may generate outputs based on all of these. The outputs of the story-based ontology trained classifiers and extractors in the main model, based on all described inputs into 1140, may be used to establish universal, structured knowledge representations of these inputs, as an evidentiary basis, rooted in the story-based ontology, for then conducting analysis.

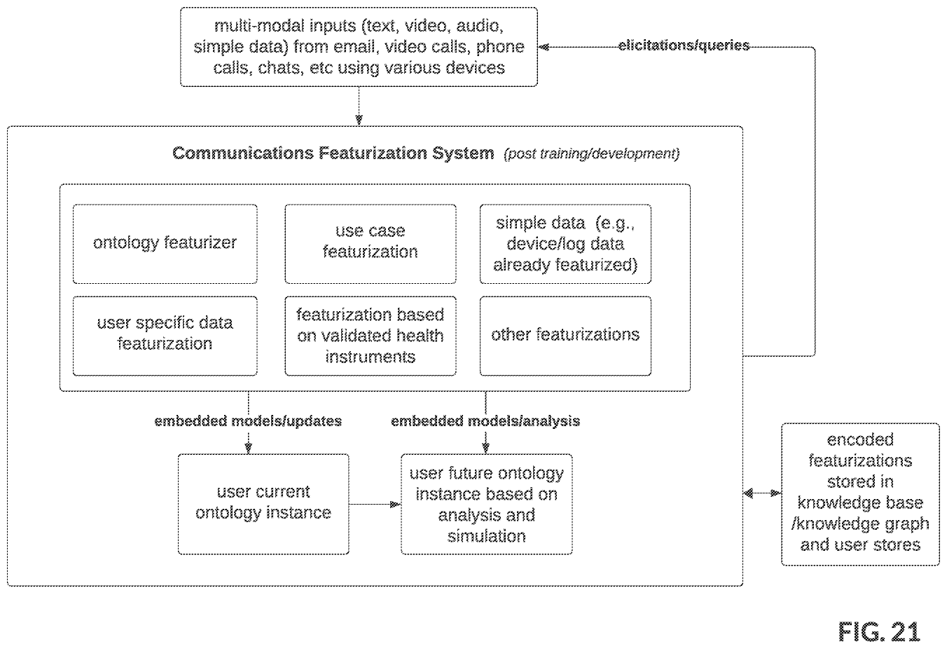

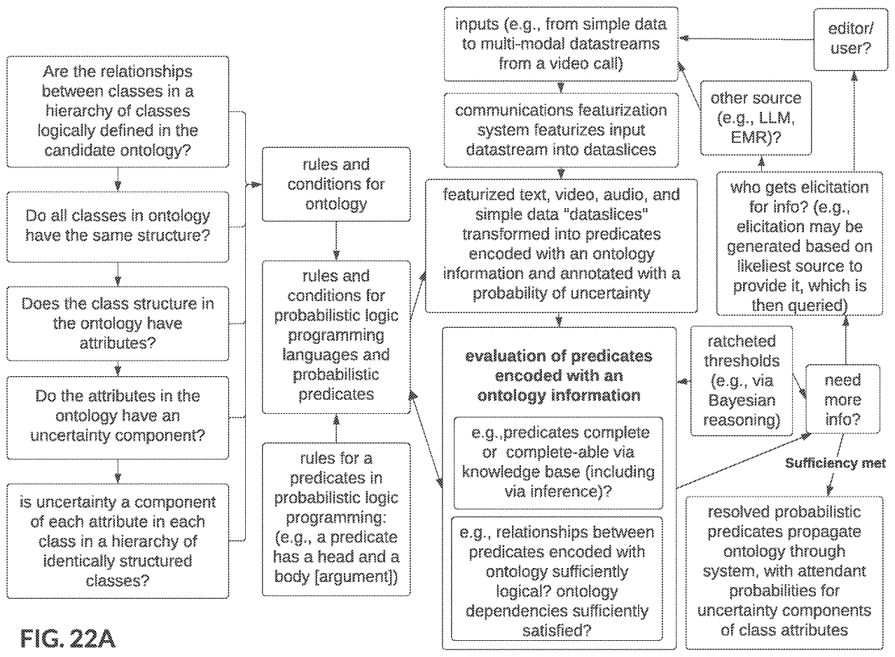

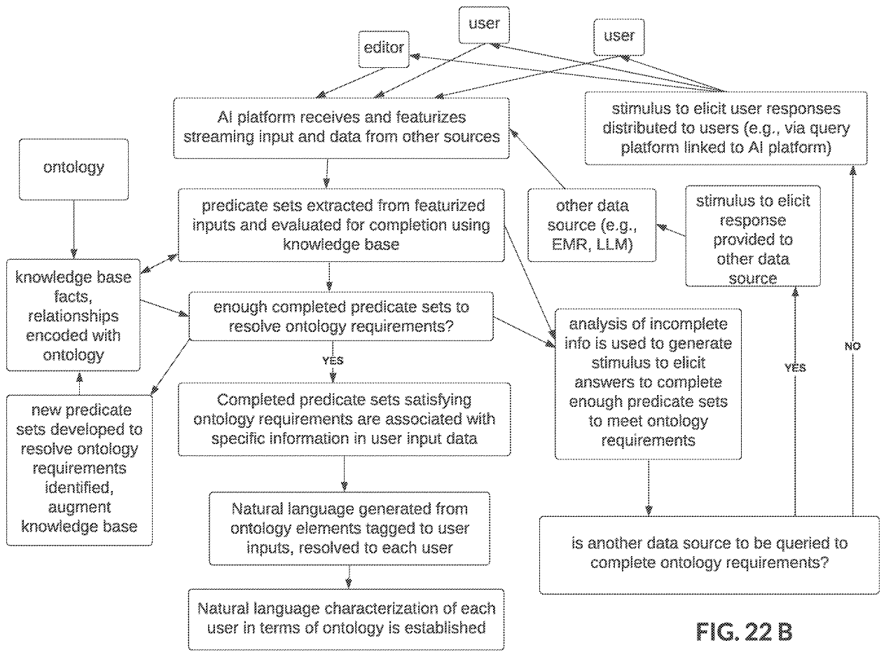

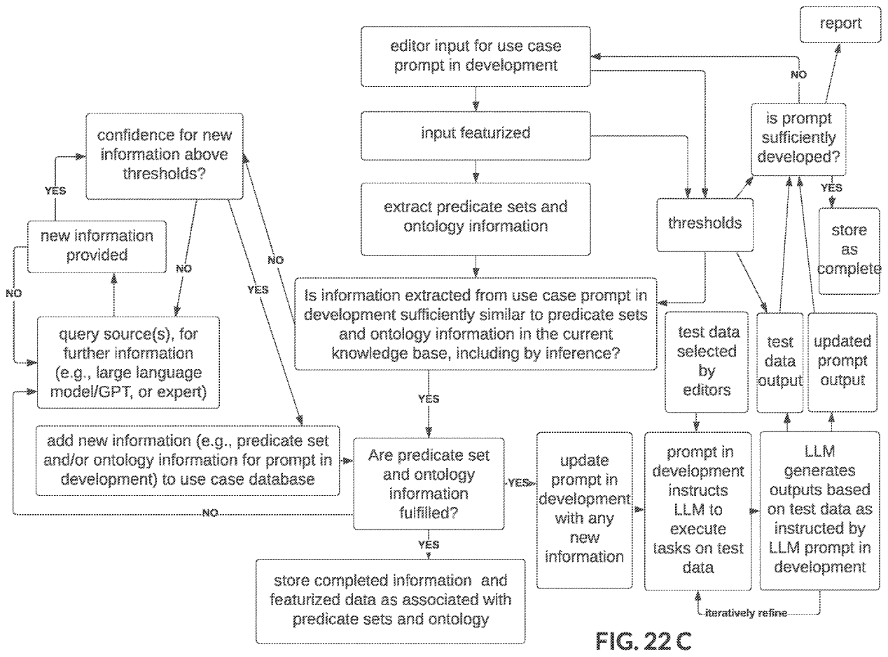

A universal, structured knowledge representation of these said trained classifier and extractor outputs may include, but may not be limited to, probabilistic predicates. In 1140, the main model 1140A may transform all classification and extraction outputs into probabilistic predicates, using AI computational tools and a probabilistic programming language, among other means. In the example embodiment, probabilistic predicates may be encoded and/or tagged with the story-based ontology to facilitate reasoning and inference on inputs based on the story-based ontology. When outputs of classifiers and extractors already trained on the story-based ontology are transformed into probabilistic predicates, the outputs may be tagged to these predicates. Further, the predicates transformed from the outputs of classifiers and extractors trained on the story-based ontology may be used to represent the story-based ontology information encoded in the outputs. Additionally, rules used by a probabilistic programming language to encode probabilistic predicates with the story-based ontology may ensure consistent formation and use of the probabilistic predicates in the example embodiment. In the example embodiment, rules used by a probabilistic programming language to encode probabilistic predicates with the story-based ontology may be collaboratively developed (see FIG. 22A), Additionally, in the example embodiment, the trained classifier and extractor outputs in 1140 may be mapped to knowledge graphs that may have computational functionality, the analysis of which may be compared to, and potentially “blended” with, the analysis of probabilistic predicates based on probabilistic programming, and Bayesian principles.

To establish the evidentiary basis in 1140, the main model in 1140 (i.e., 1140A) may compute new weights related to the uncertainty and value attribute components of the ontology instance based on outputs of classifiers and extractors trained on story-based ontology. In the example embodiment, these weights may be based in part on the probability of certain story-based ontology information being present in classifier and extractor output (e.g., there may be 80% chance from User 1100's input that User 1100 input involves caregiver and father roles). In addition to the likelihood of classifications and extractions, probabilities may be determined from inputs based on the probabilistic framework of the story-based ontology itself.

For example, outputs of classifiers trained to score various states of mind from user input may be used to “fill in” value and uncertainty components of state of mind property attributes (See FIG. 6) for an Identity. In the example embodiment, any number of classifier outputs and the extraction outputs may be associated with the same inputs as well as with each other (either temporally or on another basis, for example similarity of topic), and correlations between them may be derived (e.g., a higher anxiety score and lower financial quality of life score when mention is made of tuition near the time tuition payments are due). In the example embodiment, classifications and extractions and the correlations between them may be used to inform weights of story-based ontology attributes. This may be accomplished various ways in the example embodiment, including through the use of probabilistic predicates and knowledge graphs, which may be used to represent and resolve dependencies associated with the story-based ontology.

When standardizing the evidentiary basis for all inputs flowing into 1140, the main model 1140A may attempt to complete incoming predicates (i.e., match a “head” and an “argument”) from inputs, as well as to complete prior incomplete predicates, based on predicate structure and on rules for the probabilistic programming language that uses them. In this endeavor, the main model may search the current knowledge base and/or knowledge graph for information to complete missing predicate heads or arguments, and infer new predicates based on the classifier and extractor outputs, using the stores. This process may involve the use of AI computational tools and probabilistic programming. This process also may involve archetypicals as described in FIGS. 1, FIG. 2, and FIG. 10, which may facilitate “placeholder” resolutions until more user data may be obtained to better represent the user in terms of the story-based ontology. Additionally, in the embodiment, knowledge graphs to which the classifier and extractor outputs may be mapped for computational purposes may be used to identify and potentially resolve through computational tools various data dependencies associated with the emergent instance of the story-based ontology in 1140.

Attempts by main model 1140A to complete probabilistic predicates based on the classifier and extractor output and updated knowledge graphs mapped to them may result in resolving various data dependencies representative of dependencies in the story-based ontology class hierarchy, but likely not all. (As shown in FIG. 30E, probabilistic predicates and knowledge graphs may be used symbiotically in the example embodiment to help meet sufficiency requirements.) What is stablished at this point is an initial evidentiary basis for analyzing inputs into 1140 as computable representations of the story-based ontology.

For example, now, the 1190 analysis of prior downstream model outputs 1180 may be compared to 1140A's analysis of new inputs, which may include user 1100's new input (contained within the 1110 input), to determine what insufficiencies determined by the 1190 analysis of prior outputs related to user 1100 still remain; which insufficiencies associated with the 1190 inputs are now satisfied, which new insufficiencies have emerged as a result of the new 1110 inputs, whether enough information exists above a threshold to construct a likely set of new current weights for attribute value and uncertainty components for user 1100 Identity, if new target weights can be generated, and if so, what they should be based on, the impact analysis of prior outputs based on the new 1110 input, and so on.

In 1190, the thresholds set by 1140A may be used in 1190 sufficiency evaluations of 1180; 1180 may include results of the quantitative explorations orchestrated by 1140. The 1190 sufficiency evaluation may facilitate a view of various states (e.g. a future state may be simulated by 1150 and/or 1160 as a result of a 1140 orchestration and available as 1180 output for 1190 to evaluate). Output of 1190 feeds into 1140A.

Next, based in part on the foregoing analysis, main model 1140A may generate the next strategies for quantitative explorations and determine methods for conducting them. In this context, strategy may refer to what type of missing information and/or improved (less uncertain) information to focus on obtaining. Methods may refer to how the strategy may be executed. For example, one strategy may be to attempt to complete and/or improve information based on importance attributes in the story-based ontology class structure, Another strategy for quantitative exploration may be to link importance attributes to goals for user roles in a time frame, Yet another strategy may involve using placeholders for the missing user information based on generic representations of other users in similar situations. Yet another strategy may be to compare instances to identify certain attribute changes in one or more attributes over time and determine if there may be a sufficient pattern to “plug in” an average attribute value for one or more attributes based on the analysis of prior user instances. Yet another strategy may involve various, multiple, concurrent and/or sequential strategies. In the example embodiment, the main model 1140A may learn which strategies for quantitative exploration may work best in a given situation, based in part, on strategies it may have used in the past given similarly limited input information. Additionally, in setting parameters for quantitative explorations, the main model 1140A may weigh various factors likely to impact the success of the quantitative explorations. For example, the main model 1140A may consider metrics characterizing the robustness of user's database information, quality and depth of use cases in a repository on which to draw, how tightly the problem needs to be defined for downstream models and programs to generate rich enough outputs, the strengths of various methods to execute various strategies, the urgency of the user situation, and so on.

In the example embodiment, quantitative exploration strategies may be generated automatically by 1140A, involving the use of various probabilistic frameworks (e.g., probabilistic model architectures/configurations) that may take these factors into account, as well as various uncertainty, importance and timing parameters related to the story-based ontology. In the example embodiment, quantitative explorations may involve probabilities related to what is known and what is not, and generating new probabilities based on inference. In the example embodiment, basic dependencies within and between the class structures in the story-based ontology class hierarchy may be known, even if user data to instantiate them may not be. Thus, in the example embodiment, the story-based ontology class hierarchy itself may provide a blueprint for quantitative exploration strategies; and, some likely quantitative exploration strategies based on basic dependencies in the story-based ontology may be predetermined as a reference set for 1140 consideration.

In the example embodiment, the prompt generation system 1140 may develop various strategies for quantitative exploration and explore one or more strategies at a time and to learn from outputs 1180 and analysis 1190 which strategy or combination of strategies may best advance its own understanding of the user situation and how to support the user's goals.

To provide an illustration of quantitative exploration strategies and methods, let's begin with example relational importances (e.g., task-deliverable-role-goal role) in an example situation. Keep in mind, these are only examples, and that in a preferred embodiment, main model 1140A may determine the optimal combination of quantitative exploration strategies and methods to implement them. For purposes of illustration, let's consider an example situation of a user about whom 1140A may have determined, from various classifications and extractions of the input received by 1140, that the user likely has gotten a medication prescription. Let's say also that this likelihood was predicted by 1140A during its analysis of various Contracts using the new inputs. For example, to predict the medication was on hand, a quantifiable improvement could have been learned by comparing current and prior values of the giveandgetlistimportancetorole Contract attribute for the user's patient role specifically regarding getting medication. Such computations could have been performed, in this illustration, using predicates transformed from the classifications and extractions, and/or by a knowledge graph that may map the classifications and extractions and then be operated on by AI computational tools, or by other means. To continue with the illustration, while it may be probable that the medication is on hand for the user from Contract analysis as just described, let's say that the analysis may not indicate enough information exists yet in inputs related to changes in the behavioral health property attribute value associated with the medication. Here, the story-based ontology may be used to anticipate likely tasks based on the information the main model does have (e.g., taking medicine after getting it may be described in a tasklistorder attribute based on typically known or knowable orders of tasks in various domains, such as medication adherence). In other words, probabilistic logic based on the story-based ontology may make it possible for 1140A to know from task order that the next task after getting medication may be to take a medication at specific times (e.g., daily in the morning, before or after meals, when needed, etc.). In the example embodiment, the quantitative exploration may use a strategy to determine if a lack of information regarding taking a medication is likely due to time dependencies. Maybe the medication was taken but hasn't had time to generate effects detectable from the inputs? What is the probability that may be used to “fill in” missing information? To continue with the example illustration, a method used during this quantitative exploration may involve a LLM fine-tuned on pharmaceutical data to update timeframe attributes that may be used probabilistically to determine when effects of the medication should begin to manifest for user. The LLM may be downstream 1160 or another source 1170. This time frame information in output 1180 may be compared against threshold 1190 and used to update the timeframe attribute based on the comparison. In the example embodiment, updating one attribute in the story-based ontology may result in updating other attributes dependent on the updated attribute.

In the example embodiment, exploring time dependencies such as the time it may tend to take medication to become effective and the duration of said effectiveness also may include using scores for a user's state of mind, which recall from FIG. 6 may have a property attribute relationship to the identity. For example, quantitative exploration may involve analyzing prior scores for one or more states of mind to see if a user with prior scores has had a change from prior score within the timeframe learned from the LLM typical for a medication associated with the scored state of mind, or, if no prior score whether a score is now generated above a threshold. In the example embodiment, classifiers in 1140A may be trained to score the mental state of a user from user input. (See FIGS. 30A-30E for various ways of training tensor and natural language deep learning models to render scores based on validated training datasets.) Moreover, in the example embodiment, scores generated by trained 1140A classifiers may be “blended,” using Bayesian theorem, with relevant scores obtained by accessing the user's electronic medical record, which may be a method to decrease the uncertainty of the scores generated by the trained classifiers in 1140A. Further, in the example embodiment, in cases where scores may be generated by both LLM models and non-LLM models, these may be “blended,” using Bayes and various rules. Further, it may be learned using methods involving AI computational tools and probabilistic programming what typical changes, if any, in the scores of the user's mental state, occur and the degree and direction of the change, and how tightly such changes may correlate to a medication. The “blended” scores, which may be contained in output 1180, may be compared against threshold in 1190 and flow back into 1140 as updated information. If there is an improvement in the score based on this quantitative exploration involving timing and scores and various sources for scores, then this would suggest a probability that the medication was taken by the user.

The foregoing examples of quantitative explorations may appear to relate primarily to time frame dependencies and scores for a state of mind using trained classifiers as well as data from a valid third party (e.g., electronic medical record system). They show how 1140 may use a variety of information sources to infer whether and when medication has been taken.

Another, more direct, method for obtaining this information is to query the user directly; in the example embodiment, audio, video, and other communication with the user and/or with those associated with the user (caregivers, doctors, pharmacists, etc.) is a central method of gathering information. These direct methods can be a dominant way to reduce uncertainties, with caveats that the system understands. First, the user may not accurately self-report for various reasons including typical reasons that medication adherence is over-reported as well as degrees of mental failure and uncertainty, e.g., memory loss or simple forgetfulness. System 1140 thus treats incoming information in this matter with an understanding that it is typically higher accuracy that other methods, but with some non-negligible uncertainty that is learned or inferred. Using Bayesian information updating allows other evidence, such as that gathered above, to overrule even self-reporting. The second caveat is that direct queries are understood themselves to have a time and mental “cost” to the user (and/or other entities) which is considered in the determination of whether a direct query will be executed. This will prevent the system from seeking to resolve all uncertainties through a long and detailed interrogation-like process. That is, it can contrast the very low cost to the user of querying an internal LLM compared to the accuracy of the information it can receive with the higher cost of a direct query that is likely to have less uncertainty. In summary, if considered overall advantageous for advancing a user's goals, 1140 can include direct queries to various parties to gather information and reduce uncertainties. This can include, but is not limited to, connecting with existing or developed APIs for information exchange, e.g., an agreement with the pharmacist to share medication delivery information.

Now, let's say that insufficient probability still exists after the foregoing example quantitative explorations as to whether the user took the medication or whether the medication has had enough time to work. To continue with the illustration, since medication adherence is likely a key factor in the users ability to manage a state of mind, or condition, 1140A may decide to quantitatively explore the state of Contracts between identities to reinforce adherence, or to create new Contracts that will, or both. In the example embodiment, a quantitative exploration strategy may involve identifying, with a high degree of certainty, which Contracts if breached (e.g., a patient not taking medication ordered by a doctor) may result in breaching other Contracts involving a more important role to the Identity (e.g., a tutor role, where the identity may not have enough mental clarity skill to perform tutoring tasks without medication). In the example embodiment, the uncertainty of the impact of breached Contracts on a user's overall situation may be explored quantitatively. For example, various attributes in the Requirements class (e.g., completionmode and compietionmodeconstants) in the example embodiment may be used to map Contract completeness to changes in the Contract deliverables/requirements and/or the current importance attribute value of a role for a specific user and/or Skill amounts. In turn, relational attribute importances for key tasks, such as “medication taking,” which may have a connection to role importances just mentioned during Contract completion mapping, may be explored quantitatively and in various ways. For example, it may be determined which tasks (e.g., “takingmedication”), even though important to a deliverable (e.g., importance of taking medication to medication adherence) may not be important to the Identity (e.g., low attribute value for patient role in the Identity's goairoleimportancelist). In the example embodiment, probabilistic programming or algorithms may use the dependencies in the story-based ontology class hierarchy between attributes, including between attributes in different classes, as a basis for quantifying which information, if obtained, may be most likely to reduce uncertainty. For example, determining the importance of a task in the context of other importances to an Identity may involve computations, such as GeneralTaskimportancetoldentity=(Importance of Task to Deliverable)*(Importance of Deliverable to Role (summed over Contracts))*(Goal Importance of Role to Identity). Continuing with the illustration, a low numerical value for goal role importance of the patient role may multiply through an equation to produce a low overall value for the general task importance of taking medication—even though, as earlier described in the illustration, the Contract attribute for the user's patient role specifically regarding getting medication (e.g., via giveandgetlistimportancetorole±) may have improved since last analysis of input due to at least some likelihood the medication had now been obtained. Meanwhile, in the example embodiment, the 1140A may use other quantitative exploration strategies to evaluate potentially chained importances between tasks, deliverables and role goals, where a user's goal or goals may be represented as a role or roles, respectively (e.g., to be a better tutor). Here, it may be determined that a task requirement of preparing study plans important to the goal role of a tutor requires the skill of mental acuity, which in turn may involve, among other things, medication. This may be learned from computations based on dependencies in the story-based ontology class hierarchy and used to condition, for example, how Contracts may be “managed” in terms of the “whole person”. For example, there may be a high importance for a certain role (e.g., tutor role) apart from task completion importance for a Contract deliverable involving another role in the user's Identity (e.g., patient role). Rather, the task completion may relate to a different deliverable, more important to the goal role in an Identity, but for which the same skill may be required. For example, taking medicine within a certain time frame may be important to a user's having an amount of mental clarity, which may be represented as a skilllistamountneeded attribute, in time to complete tasks associated with deliverables important to the user's role as a tutor later in the day. To continue with this aspect of the illustration, it may be learned previously that the user does not tend to complete medication adherence tasks regularly, creating high uncertainty that the medication is being taken in time by the user. Thus, the probability that the user may not have sufficient mental clarity to tutor may be high enough that the main model 1140A focuses attention on quantitative explorations related to medication adherence now for at least two “reasons”: i) taking medication next after getting it, per task order earlier described, and ii) perhaps more significantly, mental clarity required to complete tasks associated with deliverable importance to the tutor role. In the example embodiment, roles may be set as goals, as represented, for example, by the value of a goalroleimportancelist attribute. In the illustration, the role of tutor may be a prized role of the user, requiring mental clarity, and thus having a dependency on tasks associated with adherence.

Relatedly, the importance of a role to a person may be represented as Identity attribute currentroleimportancelist, which may also be explored various ways quantitatively, for example, through derived importance and/or stated importance (e.g., what role does the user say is most important to the user? This could be learned through various elicitation methods, from direct questions to projection techniques involving stories that the user may create or point to as reference from which role importance may be determined through extractions). In the example embodiment, certain roles may be set as goals for a user to achieve, represented as Identity attribute goalroleimportancelist, which the main model in 1140 also may use in prioritizing certain quantitative explorations.

Other strategies to see if quantitative explorations complete and improve information may relate to use cases, which may provide information based on instantiations of the story-based ontology, with data validated using statistical techniques. Recall, in the example embodiment, a use case may be a sequence of story-based ontology instances involving Contracts between different roles typically involving different identities. Since Contracts require an exchange of Deliverables between Roles, and deliverables may have Requirements for Skills that are needed to complete Tasks associated with the deliverables (i.e., all classes of the story-based ontology class hierarchy involving an Identity), the instances of the story-based ontology may in a large sense be shaped, defined, aligned and managed by Contracts. Use cases may be used in the example embodiment to advance a user towards a user's goals through specific Contracts, based on various importances to the user, that in effect say to the user, “this is the instance to instantiate to reach your goals.” Recall, when a use case (sequence of instances) is recommended, it may be referred to as a best next action step (BNAS) recommendation customized for a user. In the example embodiment, use case instances, as best next action steps, may be instantiated with specific identities based on specific roles and deliverables required by these Contracts. In this illustration, one possible outcome of the analysis is that taking potentially missed medication will help the user prepare for the important tutoring role. Thus, instead of a generic reminder to take medication—which is neither customized to the consideration of whether medication has been taken nor individualized to the user's actual life nor communicated in a way known to be supportive to the user—the system can determine that it should recommend, for example, via audio from a kind voice in first-person: “Tom, please take your medication if you haven't yet since I think it will help you be ready for your tutoring appointment this afternoon.” Emulating a human caregiver, the request is motivated by and explicitly connected to the user's goals after identifying that there is still uncertainty in the observed state, and focused on the BNAS.

Now, to build on the current illustration, probabilities may be used in the example embodiment to define situations, including likely expertise needed to manage them, how the expertise may be most likely applied, recommending and then helping to implement recommended expertise, and then conducting an analysis of changes in the situation, based on new inputs and measurements of them (e.g., as required by class requirements), to determine if the situation is improved, or not, and in what respects, as a basis then for the next recommendation. In the example embodiment, use cases related to this expertise may comprise professional service practices and benchmarks, or measures. These may be represented as instances of the story-based ontology that may be updated with user-specific data. For example, a use case involving mental health management may involve a medication (e.g., an Identity, such as benzodiazepine) prescribed as part of a treatment plan (e.g., an identity for a use case, for example cognitive behavioral therapy, which may be a sequence of ordered instances, or an atomic use case, comprising Contracts between various roles) for a mental state (e.g., a mental health property attribute of the Identity, such as “Anxiety”; see FIG. 6) scored by a trained classifier from input from the Identity. In the example embodiment, scores for a mental state may be used to analyze progress of a user in a treatment plan that uses scores to determine a user's progress during the treatment plan, The treatment plan, besides medications, may involve various other methods to achieve certain scores, including, for example therapy sessions and exercises, each represented as instances, and based on instances, such as clinical trial use cases, known to improve a patient's progress towards goals, which in medicine typically may be represented as scores to reach. In the example embodiment, scores may be associated with attributes of a user's Identity and mapped to a specific user instance (See FIG. 6). Numerous aspects of the user instance may then be evaluated and compared to the use case (e.g., treatment plan). In the example embodiment, the treatment plan may also involve Contracts with caregivers who support the story-based ontology patient. In the example embodiment, a treatment plan, which may be a use case represented in terms of the ontology, may involve attempting to achieve a score within a range of scores (e.g., lower a patient's anxiety on a GAD-7 from a high score range to a lower range).

To return to quantitative explorations, various methods in the example embodiment may be used to determine from user input the user's plotted location relative to various use case instances, including for example a use case that may have been recommended previously. Probabilities for relative locations and proximities may be plotted in a knowledge graph, for example. These knowledge graph plots may include scores for a user's state of mind generated from user inputs over time by trained classifiers. In the example embodiment, a use case may have measurement requirements, including a score for one or more states of mind, associated with certain deliverables (e.g., medication adherence). In the example embodiment, use case requirements for deliverables may involve Contracts with the user, wherein the user's Contractual deliverables may be compared to the use case deliverables and thus use case requirements, such as scores (e.g., lower anxiety score to a score of 12-15). In turn, importances of tasks to deliverables important to the user's Identity's rolegoalimportance may require certain skills. For example, does the user have enough skill (mental acuity) to perform the tasks of importance to the user's role goal (e.g., tutoring)? Drift from a recommended use case may also be determined from plots, which also may involve analysis of user scores. For example, analysis of graph locations based on user's input by 1140A may suggest that the user may have “regressed,” and now likely is closer to a prior step of a use case. The main model in 1140 may generate quantitative explorations into potentially probable causes of the regression or drift from a use case, for example, does comparing current user response to the prior recommendation show a broken Contract beyond adjustment, due to skill deficits in completing deliverable tasks of importance to the role goal? Could these skills be “coached?” In the example embodiment, various methods may be used to explore potential answers to these types of questions. For example, a LLM may be prompted to simulate and score (see FIG. 24) a simulated conversation between the user and others with whom the user may have Contracts in the above illustrated situation, and then use a knowledge graph to determine if there is sufficient movement in the simulated scores, which answer could then be mapped back to what said in the simulated conversation and used to determine what to say or ask the user or the agents of other users. As another example, a LLM may be prompted to act as a coach to respond to open-ended questions, “what would you say to the user in situation X?” Further, a method may involve using a knowledge graph to compare outputs between these two examples. Do the quantitative explorations result in improved scores for the user? Perhaps, further, a new use case focused on building the amount of skill is then explored quantitatively, to see if it addresses the computed deficit.

In the example embodiment, 1140A may factor into its quantitative explorations how other identities may become involved in a use case, which may involve Contracts with various users. For example, these Contracts may involve caregivers and cared-fors, who also may be patients of doctors. In the example embodiment, complex strategies for quantitative explorations may be used not only to improve information related to time dependencies but also to reduce uncertainty and complete information involving time-evolving dependencies between instances of the story-based ontology. For example, correlations may be determined through the use of probabilistic predicates between prior improvements in the user's behavioral health property attribute values and reciprocity scores involving the caregivers whose caregiver Contracts are evaluated by the knowledge graph; using these results, an optimal use case may be “chosen” from a repository of use cases in a knowledge base involving caregiver roles in boosting medication adherence, which in turn may be simulated and all outputs generated as shown in 1180. Or, the main model in 1140 may generate a use case on the fly, and populate exploratory instances with reference speech data or, say, reference treatment data involving multiple parties.

The 1140 main model (i.e., 1140A) may learn from downstream outputs and analysis of user inputs which strategies of exploration may tend to be fruitful based on user's next inputs. In the example embodiment, 1140A may use quantitative explorations to understand and improve the user's situation in the context of the user's goals, for which there may be evidence in the inputs pouring into 1140 from various sources or from prior analyzed inputs.

In the example embodiment, the prompt generation system may attempt to update attributes and derive new target weights for attributes from analysis of continuous inputs; and, through continuous quantitative explorations, may generate candidates for further evaluations that may resolve current dependencies. These cycles may involve automated attempts to gather sufficient information to establish a current user state, an envisioned user state, a best next action, and various related actions. These cycles also may involve the user directly, as may be required for certain use cases, for example, wherein user responses may be factored into a diagnosis, treatment plan, and continued patient evaluation and management.

In the example embodiment, 1140A may determine during its generation of quantitative exploration strategies and methods to achieve them, which tasks may be best performed by which type of programming. For example, in the example embodiment, probabilistic logic programming may provide a suitable probabilistic framework for reasoning, based on the story-based ontology and its use of uncertainty and sufficiency to characterize dependencies between attributes and classes. Probabilistic programming may reason on inputs, and using sufficiency thresholds, may determine which actions may have a higher probability of resolving dependencies in the story-based ontology, given the user's goals (e.g., via goalroleimportance±). Certain actions may involve updating and analysis. However, other actions may involve the outside world (e.g., making a phone call, automating a pick-up or delivery, obtaining a medical record, facilitate natural language coaching and other interactions with users via integrations with NLP, etc.). In FIG. 12, internal actions as well as external actions may be shown as outputs 1180. In the example embodiment, object oriented programming may be more suitable for executing various actions probabilistically determined by probabilistic programming when they involve the outside world. In the example embodiment, probabilistic programming and object-oriented programming may work hand in glove. For example, probabilistic programming may reason based on inputs that a user is more likely to arrive in time for the user's doctor's appointment when the user is driven, rather than drives, and that the user's self-driving car may be the likeliest means by which that happens; as part of its analysis, the probabilistic programming may take into account various types of information (e.g., scheduling data, communications, etc), for example, that while the user's son may live nearby, the user has tended to be late when the son has driven the user. To continue with the example, object oriented programming may be tasked with bringing the car (via a Contract between car and user) to the user's door to take the user to the doctor's appointment, as may be the action predicted to be best for the user. In the example embodiment, both object-oriented programming and probabilistic programming may be conditioned on the story-based ontology. For example, in the example embodiment, objects used in object oriented programming may be based on the story-based ontology class hierarchy. Probabilistic predicates used in probabilistic programming also may be based on story-based ontology class hierarchy. This may afford a high degree of transitivity between code bases, and facilitate efficient “transpiling” between them. The main model in 1140 (i.e., 1140A) may determine which code base to use, when, based on the nature of the task (e.g., internal or external?).

In the example embodiment, 1140A may determine which methods may be most suitable for executing quantitative exploration strategies. In the example embodiment, these methods may include, in addition to methods already described, various methods for determining content requirements for prompts, the nature of the prompts (e.g., a prompt for a LLM may be constructed differently and use different methods to communicate and/or transfer data than a prompt for a non-LLM model or program), the orchestration of prompts, and the orchestration of requirements to perform the quantitative explorations by downstream models 1150, 1160 based on the strategies and methods of 1140A. Examples of methods to structure and populate prompts with information, including information encoded with the story-based ontology, will be described in greater detail.

As described, main model 1140A may continually attempt to establish evidence from inputs and generate quantitative exploration strategies and methods to determine what data may complete and improve the evidence, The outputs of 1140A may include information related to quantitative exploration strategies, methods, and various parameters to how the exploration tasks determined by 1140A should be performed. Next, as an overview of the remaining flow in FIG. 12, the output of 1140A may feed into prompt generator 1140B to transform the 1140A strategies and methods into instructions 1140 C for downstream models and programs 1150 and/or 1160, or other source 1170, to conduct the quantitative explorations determined by 1140A. In the example embodiment, prompt generator 1140B may be a multi-factor deep learning model or ensemble of models and programs within prompt generation system 1140 to manage the orchestration of tasks based on 1140A's quantitative exploration strategies and methods. These quantification tasks may involve internal tasks and/or tasks associated with “transpiling” internal tasks into outside world systems actions. The prompt generation system 1140 may manage both types of tasks as well as any “transpiling” between them, as may involve, for example, different code bases (e.g., probabilistic programming, or functional programming, and object oriented programming). In the example embodiment, prompt generator 1140B may use inflows from 1140A to search knowledge stores, including knowledge graphs, for information (e.g., tagged data to determine and represent relationships in a template) to construct prompts 1140C for downstream models and programs 1150 and 1160, as well as for additional source 1170. To generate 1140 C outputs, prompt generator 1140B also may use the probabilistic predicates and other means by which 1140A may have determined which explorations to conduct (e.g., knowledge graph data). The output 1140C of prompt generator 1140B may include formatted inputs for use in conjunction with the prompt, and the prompt, which may include a data exchange communications. The data exchange communications may encapsulate instructions for targeted downstream models 1150 and/or 1060, or other source 1170. The data exchange communications may contain instructions or queries for how they may interact with each other. This process may involve specifying inputs and outputs between downstream models in the data exchange communications. Prompt generator 1140B may generate prompt 1140C as output, which may be received by models and programs 1150 and/or 1160, or other source 1170. It is understood that the prompt generator 1140B may generate multiple concurrent outputs 1140C to serve as input for multiple downstream models and programs, and that these may be iteratively and automatically generated.

The arrows in FIG. 12 from 1140 to 1150 and/or 1160, or other source 1170, signify the transmittal of the prompt 1140C to these models and programs, or other source 1170. The arrows between different models also signify data transformations between different types of models and programs (See FIG. 54), as may be instructed by the prompt generation system, based on a method determined by 1140A. In the example embodiment, the arrows also may represent code to instruct models and programs 1150 and/or 1160, or other source 1170, for example, on the quantitative explorations to be performed.

Referring now to 1170, 1170 may process prompt 1140C (for clarity, this may include the associated formatted data as shown in 1140), and output from 1170 may be processed as input 1110 or analyzed by 1190, depending on the nature of the source and the type of data exchange involved. For example, if the other source 1170 is a human expert, the output of 1170 may involve video and/or text data, which may be received as 1110, and appropriately cycle through featurization into 1140. If the 1170 output is already in a form formatted for 1190 analysis, as may be the case with certain APIs, it may flow into 1190 as if an extension of the “in-line” processing represented in FIG. 12 as the downstream models and programs.

At this juncture, it is important to recall that, in the example embodiment, quantitative exploration strategies and methods generated by prompt generation system 1140 for downstream execution often may involve communications and actions easily characterized as story-based ontology instances (e.g., “actions” relate directly to “Tasks,” which may be associated with deliverables, as products of tasks, based on skills that an Identity may have, which further may involve an exchange of deliverables, constituting a Contract, between roles). As described earlier, in various embodiments, object oriented programming may facilitate the real world actions that the probabilistic programming may determine through quantitative exploration is part of a productive instance (e.g., action and all of its dependencies as represented in the story-based ontology class hierarchy). Referring to FIG. 12, the prompt generation model may orchestrate the “transpiling” to conduct the action, as output 1180, typically provided 1190 analysis shows the weights associated with the quantitative exploration involving the instance (involving the task/action) meets a threshold.

In FIG. 12, the output 1180 of the quantitative explorations may include weights learned by downstream models and programs 1150 and/or 1160 during performance of instructed tasks. The output may include actions (e.g., scheduling a doctor's appointment), after the actions have been evaluated as part of a quantitative exploration, passing a threshold. The output 1180 of quantitative explorations conducted by downstream models and programs 1150 and/or 1160 (1140A may specify these in its methods) may flow into analyzer 1190 and/or be delivered to 1100, or both. It is understood that when output 1180 is delivered to user 1100 it may be because the upstream quantitative exploration strategy generated by 1140A involves soliciting or eliciting a downstream user 1100 input response, and thus, 1180 may involve a communications output from models and programs 1150 and/or 1160. For example, output 1180 for user 1100 may be of a best next action step recommendation, delivered to user 1100 as a multi-modal or a simple natural language query. In the example embodiment, the 1180 output for user 1100 may be generated as the result of a current quantitative exploration or as the result of a prior exploration. For example, an output generated by models and programs for consumption by user 1100 may typically undergo analysis 1190 first, using continuously updated thresholds in 1140 (using Bayes), before being shared with user 1100; then, if the output meets the threshold, it may simply pass through to user 1100, or be tweaked by 1140 until it does, provided 1140 does not detect enough drift from new inputs to change the quantitative exploration altogether.

Referring again in FIG. 12 to user 1100, regarding arrows to the users from output 1180, an output 1180 to a user may be generated by downstream models 1150 and/or 1160 (based on prompt and instructions 1140C), The communications to the user may be of the best next action step, which may be multi-modal or a simple natural language query. In the example embodiment, the communications of the best next step may be optimized, so as to determine through analysis the impact on a user's actions after receiving the communications of the communication itself as well as of the recommended step. In the example embodiment, communications not necessarily related to the best next action step may also be generated by prompted downstream models (e.g., related to specialization logic). Note: the loop in the example embodiment involves user input, system processing and generating an output and the next user input to analyze impacts of weight adjustments reflected in the best next action step and how it is communicated.

Additionally, output 1180 may be continually updated and stored, as Activity information (See FIG. 34). This activity information may be inspectable and relate to instructions generated by the prompt generation system that may transformed into natural language, as well as reports, regarding the downstream outputs based on the instructions, or prompts. These may be made available to users/editors. Meanwhile, the outputs of the downstream models, depending on the nature of them (e.g., code, best next action step, communication of the best next action step, etc) may be provided to users for a response. User response, which may include user comments, including user annotations based on the form of interaction, may be processed as inputs 1110, and the cycle shown in FIG. 12 may repeat.

Through the foregoing, prompt generation system 1140 may continuously “manage” updates, simulations, best next action outputs and the like, based on thresholds and continual adjustments based on new information needs created by having to resolve dependencies based on the story-based ontology using sufficiency. In this sense, the sequencing of actions may be non-linear and depend dynamically on sufficiency requirements, as is disclosed herein. These cycles may involve first gathering sufficient information from user inputs to establish an evidentiary basis for the user's current state and envisioned state, and then generate a best next action step, which may be predicted to move the user closer to the user's envisioned story.

### Notes on FIG. 12.

Next, a few notes before more detailed descriptions. In the example embodiment, transformations (See FIG. 54) between featurized and unfeaturized data may frequently occur during the orchestration of tasks by the prompt generation system. Thus, in the example embodiment, not only may the original input and a featurized version of it be stored, but so too may the data be stored before and after transformations during orchestration. Consequently, there may be pairwise versions of “the same data,” which may facilitate interoperability between different functions requiring specific versions of the data. Additionally, in the example embodiment, these transformations may involve new featurizations of interim representations of the data, which likewise may be orchestrated by the prompt generation system. For example, LLM output, which may not be featurized, may be sent to the appropriate featurization pipeline, so that it then may be used by various deep learning models that use featurized data as inputs and produce featurized data as outputs. Hence, the double arrow between the featurization system and the prompt generation system.

Note, in another example embodiment, as will be described, the prompt generation system may be part of a featurization system (See FIGS. 16-21).

Note, in yet another example embodiment, as will be described, prompts may be developed and generated by a process other than by a prompt generation model (See FIG. 22C).

Note, in the example embodiment, as will be described below, the prompt generation system, together with the downstream models and programs it prompts, may act as an intelligent agent. See also FIGS. 14A, 14B and 15.

Terms used in FIG. 12 descriptions.

In the example embodiment, a prompt generation system may refer to one or more multi-factor deep learning models that automatically generates and refactors prompts, based on analysis of user inputs and of downstream model outputs that it prompts, to fine-tune user recommendations. In the example embodiment, the prompt generation system may comprise a plurality of integrated or fused neural networks (e.g., classifiers, extractors, transformers) as well as any programming links between them that may act collectively to generate prompts and learn from prompted outputs. In the example embodiment, the neural networks in the prompt generation system may involve various deep learning models (e.g., large language models, reinforcement learning models, behavior models, agent models, etc.).

In the example embodiment, when it is said that a prompt generation system may prompt another model or program, this may refer collectively to the prompt generation system and its outputs, which may be prompts for what data may be used by which models and/or programs, and how.

In the example embodiment, a prompt may refer to the input provided to a model, program, system user, or human user (via an instructed downstream model) by the prompt generation system to generate a desired output or response, In the example embodiment, a prompt (e.g., output of a prompt generation system) may be characterized as a data exchange communication information or in some cases as the data itself that is to be exchanged. In the example embodiment, the data exchange information may be in any form that directs, gives or gets information from one source to another. When a human user's information may be needed, the 1180 output generated by the models and programs 1150 and/or 1160 may be styled so as to elicit an intended response, make a recommendation, pose a query, etc. The 1180 output, when generated for the user, may involve a single mode (e.g., text) or a multi-modal stimulus to elicit the information from the user that the system may need to continue to assist the user (e.g., to update current and desired attribute weights). In other words, prompt generation system 1140 may “prompt′ downstream models and programs to in turn generate the output for a user's consumption, based on the prompt generation system's quantitative exploration strategy. Recall, in the example embodiment, quantitative exploration strategies and methods may involve meeting requirements for user inputs (e.g., use cases involving user Contracts, deliverables).

In the example embodiment, a prompt's specific form may vary, depending on source requirements and which tasks which prompted sources may need to perform (based on evaluated evidence from prompt response) on data from which other sources, how transitivity between different sources may be most efficiently achieved, and various other considerations. To further facilitate exchanges of data between models and programs, a prompt may be generated by the prompt generation system to act as the data that is to be used by the prompted model or prompted program. Thus, a prompt not only may facilitate data exchanges between models and programs but also may serve as the data or input that the prompted model or prompted program operates on.

In the example embodiment, a prompt may be generated so as to promulgate story-based ontology information, including story-based ontology instances, in a form appropriate to a given model, program and/or user consumption requirement. In the example embodiment, a prompt may be generated for any downstream model or program. With reference to the prompt generation system, the use of the term “prompt′ is not limited to only communications/instructions to large language models but rather may refer generally to how all models and programs may receive instructions/data from the prompt generation system 1140.

In the example embodiment, the contents of a prompt may depend on the input requirements of downstream models and programs (e.g., do they take natural language or only a featurized input of some sort?) In the example embodiment, the content of prompts may be composed or generated by the prompt/query generator 1140B in the prompt generation system, after receiving outputs (e.g., decisions) made by the upstream 1140A deep leading model in the prompt generation system. When downstream models 1150 and/or 1160 may require a natural language prompt, natural language information providing context and instructions to models (or to people) may be composed by the prompt generator. In such cases, natural language may act as data in the data information exchange, which, recall, may be the output of the prompt generator.

In the example embodiment, a prompt may be generated as a “directive” instance of the story-based ontology to condition downstream model outputs. For example, a prompt may be generated in natural language to instruct a LLM to evaluate input data from a conversation as if the LLM had an Identity, Role, Task, Skill, Deliverable, Requirements and a Contract. Here is a partial illustration, in which a prompt may address a LLM as if the LLM is a medical claims specialist with a job to do regarding a transcript of a conversation: “ . . . , as a medical claims specialist [role for LLM], skilled at grading how well doctors comply with a procedure [skill for LLM], evaluate [task 1 for LLM] a formatted transcript between a patient and a doctor to determine if [Contract: the doctor [doctor role] asks the patient [patient role] for consent [patient deliverable] to treat the patient before the doctor offers medical advice [doctor deliverable] to the patient], and . . . state, based on your analysis of the transcript, if doctor is compliant [deliverable for LLM] . . . and . . . “. Note, in this snippet how the LLM is charged with playing a role evaluating the status of a Contract between two other Identities, based on input (e.g., a transcript) involving those Identities.

While prompt generation by the prompt generation system typically may be fully automated and generate its own prompts, in the example embodiment, a person also may compose/edit a prompt directly using the prompt generation system. In said case, a prompt generation system may assist a user (person) with completing a prompt. In the example embodiment, the system may minimize assistance needed by a user (person) by providing a template to the user based on the story-based ontology class hierarchy, then guiding the user through the process, and attempting to resolve dependencies and complete predicates from the user's processed inputs; these attempts may include “prompting” the user (e.g., via downstream models and/or programs) to respond to certain questions (e.g., “who is speaking in the transcript you′d like to evaluate?”).

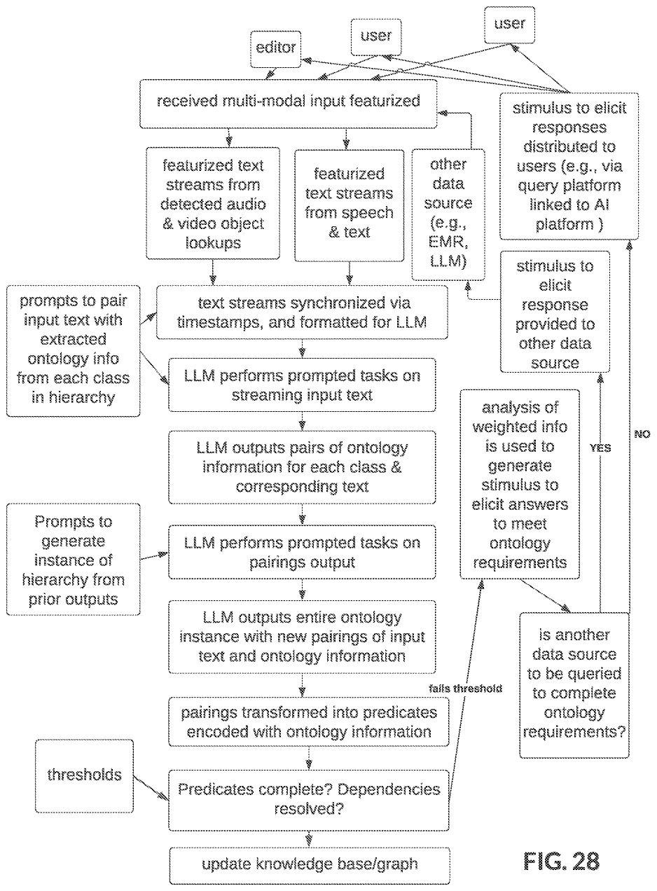

In the example embodiment, multiple prompts may be generated by the prompt generation system to break down a complex set of tasks into various prompts. See FIG. 28 for an example of multiple prompts. In the example embodiment, prompts generated by the prompt generation system may work in a federated manner to orchestrate tasks. For example, a multi-modal input communication involving video may involve prompting a LLM using natural language in a prompt to evaluate a transcript produced from the speech portion of the video, while tasking a deep learning computer vision model to evaluate facial expressions detected during that same video, and so on.

Without intending to limit the description of possible forms, a prompt generated by a prompt generation system in the example embodiment may involve multi-modal (text, images, audio, any data type) communication based on structured knowledge (e.g., predicted resolutions to story-based ontology dependencies), queries or requests for information with instructions for specific output, natural language information providing context and instructions to models (or to people), tabular data for models and/or programs to analyze or use for predictions, probabilistic predicates to guide model or program behavior and decision-making, code to enable models or programs to perform tasks involving programming, tensors to act as input layers to a deep learning model, and so on. Information contained in these forms may be generated to meet various requirements (e.g., sufficiency thresholds) regarding the story-based ontology class hierarchy.

With particular reference to FIG. 12, a model may refer to one or more machine learning or deep learning models (e.g., reinforcement learning model, a large language model, neural nets trained to classify and extract objects, etc); a program may refer to programming (e.g., programming languages, code, etc); a system user may refer to any system that uses prompts as described herein; and, a human user may be any person that may be connected to the system through a device.

In FIG. 12, an example downstream architecture is shown. In the example embodiment, a prompt generation system architecture may refer to the configuration of various upstream models (i.e., prompt generation system), downstream models, and the dataflows between them that the prompt generation system may instruct/condition through the prompts/instructions/queries that the prompt generation system may generate.

Prompt generation system: acting as an intelligent agent.

In the example embodiment, to promote standards of consistency and quality as well as standards of based on validations using statistical techniques across structured knowledge representations of users, the deep learning models in the prompt generation system may be trained. The deep learning models may be trained on training data that may include, for example, genericized user data, a story-based ontology (FIGS. 3-10), reference speech data (FIGS. 30A and 30B) and reference treatment data (See FIGS. 30C and 30D). See FIG. 2 and FIG. 10 on zero agent models based on knowable archetypical data and genericized population data for a universal base story-based ontology, which may be used by a prompt generation system.

In the example embodiment, the trained models in the prompt generation system, together with downstream models and programs it prompts, may act collectively as system agents. See Intelligent System 30. Meanwhile, the kernels of the core trained models, in combination with transfer learning and specific user data, may be used to customize the models for specific users. See User Intelligent Agent 20, 70. In turn, these models and the downstream models they prompt may act as intelligent agents of individual users.

In the example embodiment, an intelligent agent may assist the user in progressing in an optimized way from a user current state (See 930), or user current story, to a user future state (See 950, 1060), or envisioned user story. These optimizations may be orchestrated as a quantitative exploration by one or more models and/or programs within the neural network of the prompt generation system, and various models that may excel at optimization (e.g., a reinforcement learning model, probabilistic programming models using monte carlo, etc.). When acting as an agent of the user, the customized prompt generation system models together with the downstream models and programs they prompt may compose an optimal use case (i.e., best next action step, BNAS) predicted to advance the user towards the user's envisioned story (See 1080).

In the example embodiment, a BNAS, or use case, may be composed by an agent from atomic use cases that may be composable and/or from knowledge available to it, based on the story-based ontology. In other words, in the example embodiment, instances of the story-based ontology may be composable, and serve as the basis for use cases (whether atomic or composite), which the prompt generation system (e.g., agent), may generate and manage as an agent of the user. In the example embodiment, an atomic use case may be a specific instance of the story-based ontology.

In the example embodiment, a BNAS may be a user future state (a future story-based ontology instance) comprising weightings of value and uncertainty components of class attributes in the class hierarchy, composed as a user state, which if acted upon by the user, may optimally advance the user from the user's current state towards the user's desired future state.

In the example embodiment, the BNAS may be orchestrated by the prompt generation system by optimizing workflows between models, programs, and users. In the example embodiment, users—through their inputs and/or inputs about them—may act as vital part of the system's workflow. In the example embodiment, the BNAS may be communicated to the user 1100, based on model outputs and transformations/conversions of these outputs into natural language and/or composited communications involving any of text data, audio data, video data or simple data 1180.

In the example embodiment, in addition to orchestrating workflows regarding a best next action step (BNAS) for the user, the prompt generation system may determine parameters for other tasks to be performed by downstream models and programs, and in cases, users.

In the example embodiment, a prompt generation system 1140 may promulgate the story-based ontology class hierarchy within and between systems by generating prompts to learn, target, compute, and/or achieve certain weightings of various uncertainty and value attribute components of the story-based ontology class hierarchy (See FIG. 4A and FIG. 4B). To learn, target, compute, and/or achieve certain weightings, downstream model and program outputs 1180, and user inputs 1110 (a user input may be in response to an output 1180 orchestrated by the prompt generation system for the user), may be continuously updated and analyzed (See 920, 940) as inputs to iterate new prompts.

In the example embodiment, a prompt generation system may orchestrate the compiling of the story-based ontology class hierarchy into code and objects.

In the example embodiment, a prompt generation system, together with the downstream models and programs it prompts, when acting as an agent (See 14A), may negotiate with each other agents for resources to take the Best Next Action Step recommended for their user (See FIG. 14B) through the network of users and agents (See 40). The network of users and agents may be referred to as a collaborative network.

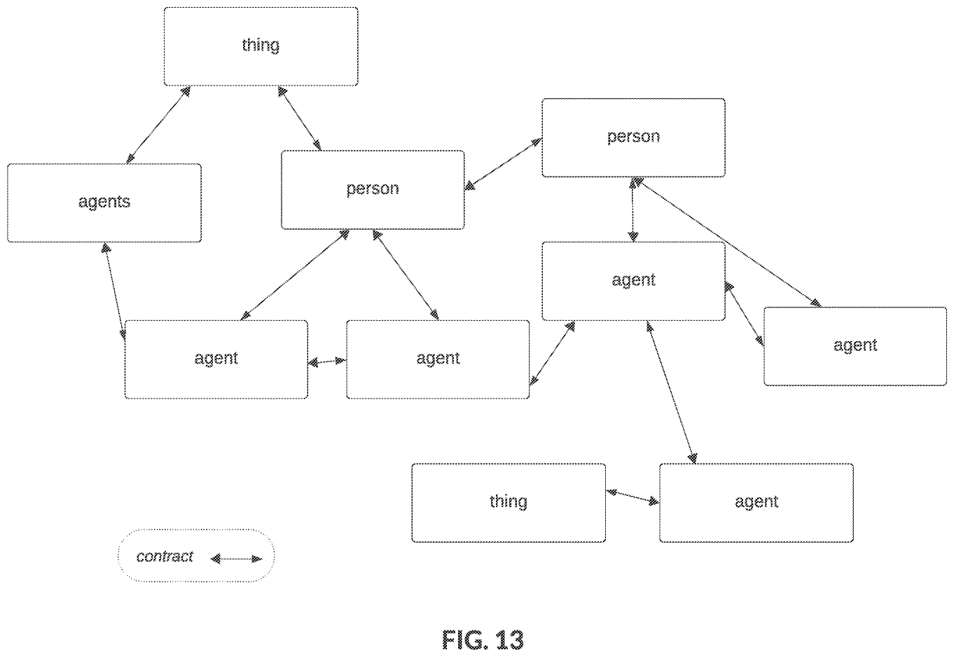

In the example embodiment, a collaborative network may involve a sub-network of user agents (e.g., user-specific prompt generation systems and models) that acts as a superstructure to facilitate the transfer/routing of messages sent back and forth between agents, messages which may resolve requirements of recommendations (BNAS) each agent may make to each users agent. This process of resolving requirements of agent recommendations may be characterized as a negotiation between agents. In the example embodiment, a prompt generation system and the models it prompts, acting as a user agent, may generate messages to agents of other users to form a Contract (See FIG. 8) between agents each representing a different identity (user). See FIG. 14B. In a negotiation between user agents, the collaborative network may facilitate the transfer of message protocols based on various parameters encoded in the BNAS that each user's agent (See 20, 70) generates as a recommended next action to prioritize which agent may be reached for a negotiation. Further, a successful negotiation may be characterized in the example embodiment as a Contract (i.e., a class in a class hierarchy that may be compiled into code and instantiated as an object). The collaborative network may operate as a decentralized exchange (See 40, FIG. 13), based on Contracts (See FIG. 8), negotiated between agents (See FIG. 14B).

In the example embodiment, a prompt generation system may optimize tasks for system and human users to generate representations of user input as instances of a story-based ontology class hierarchy and class structure within and across systems and models to facilitate better collaborations between users.

In the example embodiment, a prompt generation system may use application programming interfaces (APIs) to access websites and other data sources (e.g., public LLMs) based on editor/user authorizations. The prompt generation system may gather data (output) from these data sources/models by generating prompts in the appropriate form for the data source.

Prompt generation system: core functions.

In the example embodiment, the above mentioned “thinking” of 1140A may involve i) transforming unstructured data into one or more structured representations of knowledge used universally by the system, ii) using structured representations of knowledge from user inputs and from updates and analyses from downstream models to determine parameters for composing the best next action step (BNAS) for a user, iii) learning from weights generated by downstream models and programs which models and programs, based on the determined parameters, may best perform which tasks associated with composing, communicating and assisting a user with the execution of the BNAS, and iv) outputting a probability of downstream models and programs best suited to perform these tasks, along with associated BNAS parameters, to a generator 1140B that transforms the parameters into a prompt 1140C and formats input to be used by downstream models and programs 1150 and/or 1160.

To provide an example of transformations that may be orchestrated by the prompt generation system, let's consider the case of natural language data output from a large language model. Let's say that a LLM is prompted for text output (e.g., a grocery list for low carb meals) intended to satisfy a deliverable class requirement, such as a grocery list, for a use case (i.e., a specific instance of the story-based ontology class hierarchy) involving diabetic self-care. Recall, the LLM output may be neither structured data nor a tensor (LLM output tends not to be featurized/tensorized). In this example, the prompt generation system may orchestrate the transformation of the LLM natural language output (‘grocery list”) into a text tensor (via featurization), so that a tensor-based extraction model trained on the story-based ontology then may process and encode the LLM generated grocery list with the story-based ontology (e.g., grocery list, deliverable). In turn, the processed output of the extractor model may be further transformed into predicates, SVOs, and compiled into code. The prompt generation system may manage these transformations based on the nature of the inputs and outputs of the various models (and/or programs) it may prompt and on the type of tasks that different models (and/or programs) may excel at performing. This may increase interoperability with other system users, while promulgating the story-based ontology class hierarchy and, in turn, story-based ontology-based reasoning.

Prompt generation system functions: classifications based on validated instruments.

The prompt generation system receiving the featurized input data may comprise a classifier trained or fine-tuned on one or more validated instruments to score certain states of mind and/or health conditions. The classifier trained or fine-tuned on validated instruments may determine if enough evidence exists in the featurized input to detect a certain state of mind and/or health condition and, if so, to score it on a scale for severity. A threshold may be set by the editors for determining a state of mind score or health condition score (An editor may be a clinical user). Or, editors may approve an algorithm for determining the threshold. In the example embodiment, the score generated by the classifier above a threshold may be tagged to the featurized input and transformed into a story-based ontology information comprising the value and uncertainty component of the attribute associated with the property name (e.g., “anxiety”) for the state of mind/condition in the appropriate class (e.g., Identity or Role). While there may be various methods to implement this in code, in one scenario, the prompt generation system may orchestrate the compiling of class definitions related to the classifier score (e.g., anxiety [name] property attribute, with value and uncertainty components, associated with an Identity) into code. The prompt generation system then may prompt the code to instantiate object(s), based on the value (e.g., anxiety score) and uncertainty components of the attribute and the code, to complete a story-based ontology instance of the score. In the example embodiment, these scores may be converted into probabilistic predicates.

In the example embodiment, classifier output may contain information that AI tools may operate on to generate probabilistic predicates for use in probabilistic programming. In the example embodiment, the prompt generation system may prompt AI tools to generate probabilistic predicates from classifier outputs (e.g., scores with probabilities). The prompt generation system may prompt a probabilistic programming language to use the probabilistic predicate as an interim representation of the score to perform various functions. The prompt generation system may prompt a probabilistic programming language to evaluate if the predicates created by the AI tools have an appropriate structure (i.e., head with a body, or argument). The prompt generation system may prompt the probabilistic programming language model (e.g., Problog) for confirmation of predicate completeness, and if incomplete, initiate new routines (e.g., attempt to complete a predicate set through knowledge base traversals, inference, other source queries, and/or via asking editors for information to complete it), The prompt generation system may prompt a comparison between a generated predicate and prior generated predicates to determine if a new predicate may be created from logical inference involving the compared predicates. For example, if a person is likely to have high anxiety, and high anxiety is likely to correlate to a low quality of life score, then a score for, say, depression, if found to correlate to high anxiety, may mean that a probability for a lower quality of life score may be inferred from a depression score. A new inferred property attribute associating depression and quality of life, even though quality of life itself may not be measured in this example, may in turn become a new predicate, and like all predicates, be subject to tests for completeness and for logical relationships to other predicates. During code compilation (e.g., object oriented programming), the prompt generation system may prompt a probabilistic programming language to check the correctness of the coding for the score as an instance of the story-based ontology. In the example embodiment, programming code also may be transformed by AI tools into probabilistic predicates. Therefore, a prompt generation system may prompt a probabilistic programming language to evaluate and compare the predicates transformed from code and the predicates transformed from featurized inputs based on the story-based ontology. This may facilitate propagation of the story-based ontology through various interim representations (e.g., predicates, code) into instantiated objects for featurized inputs.

In the example embodiment, the prompt generation system may perform various classifications on the same featurized data slices.

Prompt generation system functions: classification based on validated care/expert models.

In the example embodiment, the prompt generation system receiving the featurized input data may comprise one or more classifiers trained on one or more validated care and/or other validated expert models (collectively, “expert/care model”). In the example embodiment, a classifier of an expert/care model may be referred to as a “use case” classifier. For example, if a use case involves a Problem-Solving Therapy (PST), a prompt generation system trained on the Problem Solving Therapy (PST) may be said to act as a PST classifier. In the example embodiment, a use case may have one or more “steps,” which may refer to an instance of the class hierarchy. To help further clarify, a use case step may involve an instance comprising the class hierarchy: Identity, Contract, Role, Deliverable, Skill, Task, and Requirement class. So, in effect, with sufficient training, a prompt generation system may classify story-based ontology instances from featurized inputs. In the example embodiment, each step in a use case may be represented as an instance of the story-based ontology, so that a use case comprising a sequence of steps may be represented as a sequence of instances. A use case requiring a specific order of the steps in the example embodiment may be represented as a specific order of story-based ontology instances. For example, to return to PST, a step in the PST use case may call for a subject's assessment of their situation before an adaptative methods step may be taught. This PST assessment step may be represented, for example, in the example embodiment as an instance of Identity, Contract, Role, Deliverable, Skill, Task, and Requirement class, conditioned on the goals for the PST assessment step. If a PST deliverable for this step is an ordered list of top issues to address, then in the example embodiment, a corresponding deliverable of listed issues may be required.

In the example embodiment, a classifier trained on validated care and/or other validated expert models may determine if enough evidence exists in the featurized input to detect a specific step associated with one or more validated care and/or other validated expert models. A threshold may be set by the editors of a user case for determining the likelihood of the use case step being present in the featurized input. Or, editors may approve an algorithm for determining the threshold. In the example embodiment, the use case step identified by the expert/care model classifier above a threshold may be tagged to the featurized input and categorized as an instance of the hierarchy of classes.

While there may be various methods to implement this in code, in one scenario, the prompt generation system may compile class definitions related to a use case classifier classification (e.g., an instance of an anxiety interventional step involving an Identity, Contract [doctor-patient roles], Task [mental health exercises], etc), into code to represent the value and uncertainty components of attributes of classes in the class hierarchy. In the example embodiment, the prompt generation system may automate code construction so that the code may meet logic tests and instantiate object(s) to complete a story-based ontology instance of the classification (e.g., a doctor-patient mental health consultation step).

During the compilation process, the output of the “use case” classifier may be transformed into probabilistic predicates. The prompt generation system may prompt AI computational tools to create probabilistic predicates from the featurized input for use by a probabilistic programming language. In the example embodiment, the prompt generation system may prompt a probabilistic programming language to use the predicates to check the correctness of the use case coding.

To further describe use case classification, recall, a BNAS may be an action step recommended by the system to the user—an instance of the story-based ontology that may act as a directive—to facilitate reaching a desired future story-based ontology instance, or envisioned story. In the example embodiment, a BNAS may be based on an expert/care model step. By comparing featurized user inputs after receiving a BNAS (recommendation) with the BNAS, drift from or fidelity to the BNAS may be determined in the example embodiment. When the BNAS is based on an expert care model, the drift or fidelity to the expert/care model on which the BNAS is based may be determined in the example embodiment. The prompt generation system in the example embodiment may perform this evaluation via quantitative exploration, and make adjustments accordingly in its next recommendation (BNAS).

Prompt generation system functions: extractions based on the story-based ontology class hierarchy.

In addition to classifications, the prompt generation system receiving the featurized input data may be an extractor trained to extract story-based ontology information from featurized datasets based on the story-based ontology. This story-based ontology information may include any attribute information of any class in the class hierarchy. Information in the featurized input about Identity, Contract. Role, Task, Deliverable, Skill and/or Requirement may be extracted by the prompt generation system. For example, it may be determined from featurized input from a conversation that a speaker is a Mom [role] and a Worker [role] trying to manage [task] a work-life balance [deliverable with an importance attribute, goal]. In the example embodiment, extractions may be performed using various methods.

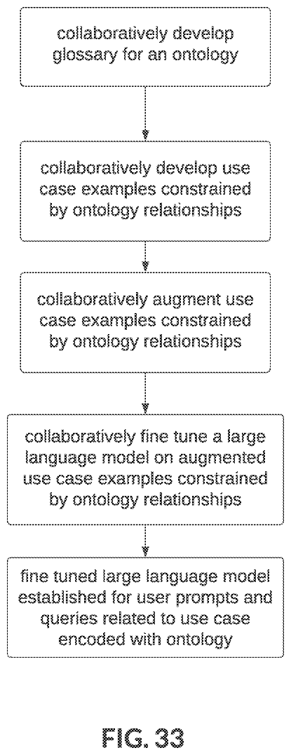

In another scenario, the prompt generation system may be fine-tuned on terms, relationships and rules of the story-based ontology. In this scenario, editors may interact with each other through the prompt generation system to generate predicates that represent the terms and relationships and rules of a story-based ontology. In an example embodiment, prompt generation system may prompt a probabilistic programming language to perform probabilistic logic and various computations on the probabilistic predicates generated by AI tools from featurized editor inputs to develop a glossary (See FIG. 33) for editor approval. The predicates associated with the approved glossary then may be used to check code based on the glossary. Meanwhile, the glossary may serve as the basis for example instances of the story-based ontology. Example instances of the story-based ontology based on the glossary may be developed collaboratively using the prompt generation system to ingest and evaluate editor input. These example instances may be received by the example embodiment in any communicable form (e.g., multi-modal use cases, stories) used to provide an example of the story-based ontology. The editor examples may be featurized and parsed into data slices, which the prompt generation system in the example embodiment may format for a model (e.g., a LLM as well as other models as may be required for object recognition); then the prompt generation system may prompt models and programs to augment the number of examples provided by the editors to produce a corpus of examples to further train the prompt generation system on the story-based ontology.

In the example embodiment, it should be noted that to facilitate generation of examples of the story-based ontology (e.g., an augmentation), the prompt generation system may be used to generate a prompt specially structured as an instance of the story-based ontology itself. Creating a prompt as an instance of the story-based ontology may occur during development and implementation of the story-based ontology, and may contribute to a library of prompts that the prompt generation system may refer to when generating prompts to support various functions reliant on the story-based ontology. When the output of the prompt generation system satisfies sufficiency requirements as a result of a prompt, the prompt associated with the output may now serve as a basis for one or more prompts that the prompt generation system may generate to prompt models and programs to generate other examples of the story-based ontology. In the process, the prompt from a library may be adapted iteratively and automatically by the prompt generation system.

In the example embodiment, examples of the story-based ontology augmented by the prompt generation system (e.g., via a LLM) may be featurized as data slices, then transformed into probabilistic predicates by AI tools. Through loops of logic testing, activity information generated during the learning loops for editor review, and editor inputs in response to new outputs to the editors from the prompt generation system, the prompt generation system may learn from examples of the story-based ontology to identify story-based ontology terms and relationships in other featurized input. When editors may be satisfied with results of the prompt generation system's learning, based on hold out sets of testing data (e.g., a portion of the examples created by the editors), the prompt generation system may be said to be trained on the story-based ontology terms and relationships. Therefore, it may encode featurized input containing these terms and relationships as extracted story-based ontology information.

In the example embodiment, a prompt generation system may use augmentation for purposes of developing a prompt, developing training datasets from a prompt, and/or expanding a developed training dataset.

In the extraction process, AI tools may be prompted to transform extracted story-based ontology information into probabilistic predicates. In the example embodiment, probabilistic predicates may be a form of structured knowledge that unstructured knowledge may be transformed into. For example, while, say, a LLM may be used to respond to a prompt to report story-based ontology information from formatted text, such as a Role (a patient) or a Task (take a deep breath), a story-based ontology information, the LLM may not be able to use the information it generates to reason probabilistically within the story-based ontology framework. However, the tagging may facilitate and augment predicate production of inherently unstructured LLM information into structured knowledge, which then may be used by probabilistic programming. Additionally, LLMs may not be as efficient or capable of identifying certain objects (e.g., sound, image) in featurized input; however, various methods involving AI tools may be prompted to transform these types of featurized inputs into interim representations, such as probabilistic predicates, that in turn may be converted into natural language that in turn may serve as a basis for prompting a LLM.

In the example embodiment, extractors may be trained on various datasets to extract information that then may be used to support various system functions. For example, an extractor may be trained on datasets for a story-based ontology, and/or a use case, and/or user-specific data, to transform raw data or unstructured information related to these training datasets into an analyzable format.

In the example embodiment, the prompt generation system may be trained or fine-tuned to perform as various extractors and classifiers, to generate an evidentiary base from the same featurized inputs (i.e., featurized data slices). For example, the same featurized input, “I need help lifting mom,” may be classified as anxiety, while producing extractions of a child role and a caregiver role. The classification and extraction may be associated (anxiety and role) and used to firm up correlations between various value and uncertainty component attributes of classes in story-based ontology instances, for a more accurate representation of a user current state. The trained extractors and classifiers may generate complementary information that the prompt generation system may use to facilitate inference building and improve the accuracy of user current state and user future states. For example, the classification (e.g., anxiety) and role extraction (e.g., caregiver, mom, son) together with simple data extractions from logs providing location data (e.g., residence likely belonging to the mom) may all be transformed by AI tools into probabilistic predicates as an interim representation of the different data. In turn, the prompt generation system may prompt a probabilistic programming language to generate a probable scenario (user current state), for example, that a morn and her son who acts as her caregiver and has trouble lifting may likely both be at her house and may both need assistance. In the example embodiment, one or more candidate scenarios based on the likelihood of evidence from classifiers and extractors may be generated by the prompt generation system and represented as story-based ontology instances. In the example embodiment, scenarios generated by the prompt generation system prompts may be represented in natural language to users/editors, based on urgency or other thresholds, to confirm the likelihood of the predicted situation.

Prompt generation system: Evidence from real-time extraction and classification of user input may instantiate objects associated with the story-based ontology class hierarchy.

In the example embodiment, the parsing of featurized input into data slices may facilitate real-time extraction and classification on relatively small amounts of data. The prompt generation system may prompt the storage of these real-time featurized data slices and the associated outputs of extractions and classifications. Additionally, from storage the example embodiment may concatenate sequenced data slices into progressively larger segments. In turn, these progressively larger data slices may be generated from storage by the prompt generation system to then repeat the classifications and extractions by adding the new data slice to larger segments constructed progressively from prior data slices. In turn, each original data slice may be re-evaluated and an updated set of values produced by the extractors and classifiers, since they have progressively more featurized input to evaluate. The deltas between the progressive passes of the extractors and classifiers may be used to monitor performance, improve learning and increase accuracy.

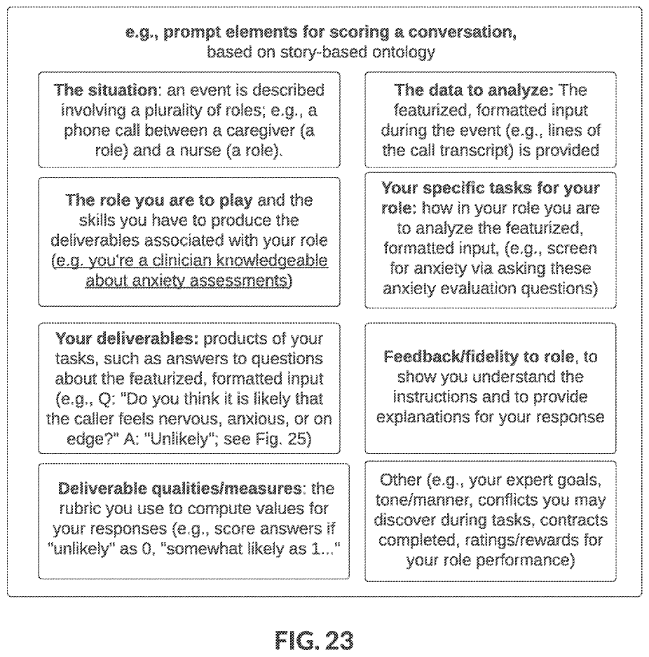

For example, a conversation between people may be featurized as one or more data slices by line, appearing in the form of a transcript; each data slice during the conversation may be scored by a classifier in real time, and represented as a score. (See FIG. 23 and FIG. 24 for examples of how a LLM may be prompted to generate scores). Thus, there may be a score for each line for each speaker in the transcript. Recall, the prompt generation system may act as a classifier. Each new line in the conversation may be added to all previously classified lines, which as a new group of concatenated lines may run through the extractors and classifiers again so that the next line is classified and information extracted with the benefit of the previous lines. When the conversation ends, or reaches a threshold for re-evaluation set by the editors or users, or by an algorithm approved to act as a threshold, the entire conversation may be re-rerun through the classifiers and/or extractors to then adjust each extraction and/or classification for each data slice used in the concatenation. The re-evaluation or updated values then may be used for further analysis by the prompt generation system, for example, to improve classification and extraction at the level of the data slice or to determine optimal sizing for segmenting featurizations and conducting evaluations. In the example embodiment, this sizing of optimal segments may be automated by the prompt generation system and used to facilitate various updating functions.

In the example embodiment, classifiers and extractors may work together to compensate for outputs that alone may be evaluated as insufficient but which together may be used to create an evidentiary base for an instantiated instance of the story-based ontology. For example, if a use case classifier may not have enough information to classify a featurized data slice as belonging to a use case, a story-based ontology instance nonetheless may be constructed to some degree from other classifications (e.g., various “scores”) and extractions to provide a view of the user current state with a certain likelihood of being accurate.

Next, after the featurized inputs are classified and the extractions extracted, the prompt generation system may prompt AI tools to transform the information in the classified and extracted output into probabilistic predicates to perform various functions. These functions may include, but may not be limited to, checking code and various logical relationships between probabilistic predicates generated for analysis by the extractors and classifiers; resolving dependencies in the class hierarchy from extracted and classified “facts”, determining sufficiency by comparing instantiated value and uncertainty components with thresholds, and so forth.

Prompt generation system: sufficiency and simulation.

The prompt generation system may iterate as needed to reach certain desired thresholds, such as sufficient probability for a predicate deemed important or sufficient accuracy in composing a next BNAS from a range of possibilities or on the fly via models trained on the story-based ontology with access to appropriate knowledge sources. The areas of most valuable iteration may be determined through Monte Carlo or other probabilistic methods. For example, suppose two possible BNAS suggestions have comparable impacts within the uncertainties. Then the dominant uncertainties in the dependencies for this calculation may be identified and the prompt generation system may instantiate processes (e.g., information gathering from an LLM or the User or an expert model) to reduce these dominant uncertainties. This targeted updating may reduce the most important uncertainties, making the most important calculations more precise.

While precision may be increased in the example embodiment by gathering more information to reduce dominant uncertainties, improving accuracy in the example embodiment may involve benchmarking to previously validated results. For example, previous analyses that may have established classifiers based on validated instruments and/or validated care/expert models may be used to set an evidentiary base for the prompt generation system. This connection to evidence may also be used in the process of training the prompt generation system. In the example embodiment, a prompt generation system may be trained as a classifier or extractor itself, subsuming previous models that may analyze various data to generate classifications.

To reduce false conclusions of the prompt generation system, both in training and in use, various logical checks may be performed in the example embodiment. For example, any generated code must compile. Dictionaries may be used to establish highly likely relationships between various story-based ontology elements (e.g., diabetics are more interested in sugar than salt). Archetypal use cases may need significant evidence to be modified (e.g., it is rare for landlords to pay tenants).

During analysis of the outputs, insufficiencies determined in the outputs (e.g., via predicate tests) may be attempted to be resolved by the prompt generation system through adjustments it may make in its prompts and potentially new targeted choices of downstream models or model configurations.

In the example embodiment, the generation or significant updates to instances in a particular class may likely generate dependencies in other classes most closely linked in the story-based ontology (see FIG. 3). These ontological connections may be used to determine whether there is missing information. For example, the attribute “Importance of Deliverable to Role” requires that all Roles must have some Deliverables which are considered reasonably important. Therefore, the instantiation of a new Role requires also determining important Deliverables of that Role, which themselves must be instantiated. The prompt generation system may orchestrate the new information. For example, a new “Caregiver” Role may be associated with a Contract with Mom with Deliverables of performing an Activity of Daily Living that Mom is not able to do (e.g., grocery shopping). This Deliverable has associated Tasks (“go to grocery store”), Requirements (“provide groceries”), etc.

In the example embodiment, a prompt generation system may identify these dependencies and determine their sufficiency (see FIG. 10 descriptions) in various ways. For example, the sum over all the “Importance of Task to Deliverable” values for all Tasks for a certain Deliverable may need to meet a certain threshold (e.g., 0.5 with 1-sigma uncertainty). Another method may be to assess self-consistency. For example, if significant evidence exists that a Deliverable has not been completed, but all the currently associated Tasks are within the Requirements, one possible inference is that there are missing Tasks associated with this Deliverable.

In the example embodiment, a prompt generation system may use its information gathering process to generative quantitative exploration strategies and methods to resolve insufficiencies. For example, it may query an LLM with a customized prompt like, “What are the most important Tasks in grocery shopping?” It may seek information directly from Users or Editors like “What activities are you helping Mom with?” For particular desired outputs (e.g., the BNAS), it may identify the most significant sources of uncertainty and use these to increase precision (and/or accuracy). In the example embodiment, a prompt generation system may instantiate ontological instances and attributes and seek to meet certain thresholds for dependencies, precision, accuracy, and other desirable traits. This may be done efficiently because of the ontological structure that shows how uncertainty in one component is directly related to a desired downstream output. It is expected that there may always be unresolved aspects of the solution based on new inputs and areas of irreducible uncertainty so that the exact global optimum cannot be reached in practice. Thus, in the example embodiment, the prompt generation system may attempt to reach the best solution possible within some constraint (e.g., computational tractability or maximum wall-clock time to respond). Further, in the example embodiment, constraints may be associated with generating, evaluating and communicating a BNAS, which may provide focus for various processes. One implementation may allow various internal thresholds (like the precision of a calculation) to be auto-tuned by the prompt generation system itself. For example, the overall target may be defined as a weighted combination of desirable traits: precision, accuracy, tractability, marketability, etc. In this sense, the overall system may be “self-generative”: creating new instances as needed, and gathering information to reduce uncertainties, while setting its own constraints. This may allow the thresholds to be automatically set to “good enough” instead of unrealistically requiring perfection. It is anticipated that these thresholds would be periodically “ratcheted up”, requiring the system to improve over time.

In the example embodiment, the initial goal in determining precision and accuracy may be to seek to represent the current state of the real situation in the context of the story-based ontology through the instances, values, and attributes. Since the story-based ontology includes some attributes that may be time variable (such as a linear decay of certain Skills), even this “current state” includes properties that may change in time. Therefore, the implications of these changes for the future may be predicted. For example, a Skill representing Mental Clarity as related to blood sugar levels of a Diabetic can be used to predict that not taking insulin would lead to insufficient Mental Clarity to complete an important “Teach Tutoring Session” Deliverable of a Role important to the User.

As part of the goal to support the Users, additional analyses that explore potential future outcomes are also investigated (quantitative explorations). In addition to determining the time-variation based on the current state, the system can explore simulated future states by positing changes to the instances, values, and uncertainties. For example, as part of determining/composing the Best Next Action Step (BNAS), the system may generally simulate a future where the User has taken this step. For example, if the step is to complete the “take insulin” Task, a new instance of the story-based ontology with this action completed may be created and used to predict future outcomes as before. A variety of future outcomes may be simulated with implications for choosing the recommendation of the BNAS.

Another example of simulation (a quantitative exploration) in the example embodiment may be the anticipation of conflicts arising from unfulfilled Contracts. To simulate this, Contracts have a variety of attributes that may be used to predict the probability that expected Deliverables are not achieved. The effect of these simulated failures on the user may be estimated. For example, bad weather may prevent a walk leading to reduced Mental Clarity and decreased Calorie burning. As another example, a caregiver may forget to stop and get groceries, leading to lower-quality food. These simulations may be determined using Monte Carlo or other methods. Thresholds for the number and fidelity of simulations may be set by the prompt generation system.

As before, in these simulations, the prompt generation system may need to gather additional information such as the effect of lower-quality food on the Diabetic Role. Similar information gathering and checking methods may be used on simulated story-based ontology instances, but perhaps with different thresholds, as orchestrated by the prompt generation system.

As before, in these simulations, dependencies may arise that the prompt generation system would attempt to resolve. Similar methods may be used to identify dependencies, determine sufficiency, and solve for insufficiency, including additional User/Editor prompts; these methods may have modified thresholds to account for the fact that they are simulations. For example, simulations involving low probability events (like a house fire) may have a comparable level of meaning without the same requirements on precision and accuracy as the current trajectory.

Various simulations may also be performed in the example embodiment to infer the effect of various interventions. As discussed above (See FIG. 9 and FIG. 11), the proposed BNAS may be tested as an intervention to help ensure its effectiveness. In the example embodiment, users/editors may also propose other interventions and simulate potential outcomes, and pose “what if?” questions to the system, which as input, may trigger quantitative exploration strategies and methods by the prompt generation system. A doctor might have a choice to prescribe a medicine that has a common side effect of afternoon drowsiness; by simulating it as an intervention, the normally-unintended consequences may be made apparent such as a medication interfering with the important “pick up grandchildren from school” Task of the very important “Grandparent” Role. The prompt generation system can act as a support to Users/Editors by helping to turn interventions (e.g., stated in natural language) into expected consequences with a rationale provided by the story-based ontology (e.g., “Medication that causes afternoon drowsiness could interfere with Ruth's favorite task of picking up the grandchildren after school which is also in the afternoon.”).

Advanced analyses may investigate the possibility of a wide variety of simulations, including those that consider multiple steps into the future. The prompt generation system's ability to self-generate and auto-tune may allow for effective exploration of a wide variety of possibilities including a hierarchy of future outcomes with multiple contingencies. For example, if the User takes the two next BNAS values and Contract X is fulfilled as expected with 80% probability, then it may lead to a significant boost in physical quality of life.

Prompt generation system: a probabilistic framework for managing uncertainty.

In the example embodiment, a prompt generation system may prompt a probabilistic programming language to perform various functions on the probabilistic predicates. To facilitate an exchange of data between models that may use tensors and those that may not (e.g., LLMs), between models and programs, between programs and programs, and ultimately between human users and the system, all data in the system may be transformed into interim and universal representations in the example embodiment. These universal representations may include probabilistic predicates, which may be used to perform various functions, including modelling uncertainty and probabilistic logic (reasoning).

In the example embodiment, programming code used in programming language, and therefore a language information, may be transformed into probabilistic predicates, which may use language information in its reasoning. This may be accomplished in the example embodiment by converting non-probabilistic programming code (e.g., C++), which may be characterized as deterministic, or having a 100% probability, into probabilistic programming code, where probability is set at 100%. Once “deterministic” code is transformed into probabilistic code (i.e., using 100% for the probability), deterministic and probabilistic components in the example embodiment may be integrated within the same probabilistic programming framework. The use of the same probabilistic framework for code may facilitate analyses of situations or events involving both certainty and uncertainty. Additionally, it may facilitate a shift in coding paradigms, from reliance on the reasoning of human coders to generate code based on certainty, which may in the end be neither true nor certain, to machines that may now generate code based on reasoning with probability. In the example embodiment, various functions may be performed by probabilistic logic programming languages that use probabilistic predicates. Since probabilistic predicates may be generated from known facts, or evidence (e.g., via devices and/or classifiers trained on evidence) in the example embodiment, not just from code, logical tests may be used to minimize certain biases. Thus, biases associated with inductive reasoning, for example as may be widely used in human coding, may be less apt to be propagated as code through the example embodiment.

As to scores generated by any classifier model (tensor-based or not), these too may be transformed into probabilistic predicates (Note: FDA approved devices may have a probability of 99% whereas non-approved devices may have a lower probability). Meanwhile, in the example embodiment, predicates in certain situations may be converted into subject verb object sets; consequently, a score represented as a probabilistic predicate may also be represented as a SVO, which in turn may be used to generate a natural language information. For example, an anxiety score above a certain score, associated with high anxiety, may be represented as a [subject], mapping to the Identity, [verb] has, [object], mapping to characterization of anxiety score based on the weights.

In the example embodiment, LLM classifiers may output a classification in natural language. The extraction of a LLM may be a raw subject-verb-object set (natural language), based on the prompt instruction. The LLM output then may be featurized as text. In the example embodiment, there is a process for transforming text into a tensor representation of text and vice versa (text tensor to natural language text). See FIG. 46.

Prompt generation system: orchestrating tasks to advance the user.

The prompt generation system in the example embodiment may manage the inputs and outputs of various prompted models to perform various tasks in various sequences. In the example embodiment, a prompt generation system may learn from analysis which sequences of which prompts for which models and programs using which representations of data may be most efficient and effective for managing which tasks. For example, in various situations, the prompt generation system may bypass typical intermediate steps and directly generate the input for a model. In the example embodiment, a prompt generation system may generate tensors as prompts, for example. Since tensors may be read by many models, generating a tensor as a prompt may introduce certain efficiencies for how analysis of outputs may be converted into a form used to condition input layers of deep learning models.

In the example embodiment, besides orchestrating/performing classification and extraction to establish and update an evidentiary base for the user current state, through various methods as described, the prompt generation system may orchestrate the analyzing (including simulating) of story-based ontology instances, based on a story-based ontology class hierarchy and class structure and on the acquired evidence. These prompted tasks may involve resolving dependencies in the class hierarchy before the prompt generation system may be able to execute certain other tasks. That is to say, certain dependencies in the class hierarchy to be resolved may create certain task dependencies for the prompt generation system to resolve. These prompt generation system tasks may have a dynamic hierarchy based on analysis of which tasks may have the most other task dependencies at any given moment; “less important tasks” may be identified and queued or become the basis of a prompt for another downstream model or program to perform (e.g., specialization logic as may be handled by a probabilistic programming language instead of a deep learning model). It should be noted here that the prompt generation system may learn through analysis that certain tasks performed by prompted models and programs may not sufficiently resolve key story-based ontology dependencies and require editor or user inputs to do so. In the example embodiment, task performance by prompted models and programs may depend on a response loop involving user input—as a part of the system and as part of the story-based ontology being instantiated by the system. In FIG. 12 this is shown as the arrow flowing to editors/users 1100 from outputs 1180; Note, outputs may involve multi-modal communication to users, filtered activity information from updates and analysis, and so forth (See FIG. 34 for example activity information displayed or made available).

In the example embodiment, the story-based ontology may act as a generative mechanism for actions by requiring perpetual attempts by the prompt generation system, through prompting, to instantiate the story-based ontology from new user inputs, and to generate future instances based on these which also may require resolution. Instantiation tasks for the prompt generation system to orchestrate may involve looking for evidence (e.g., via a knowledge base/graph, user database, other sources such as LLMs and electronic medical records systems, etc) to satisfy thresholds for instantiations. These instantiations may include, but not be limited to, establishing the likeliest representation of a user current state based on evidence, likeliest future state representations of this same user also based on evidence, likeliest future states a user may be likeliest to move to, likeliest future states a user may be likeliest to move to that also moves the user closest to their goals, likeliest Contracts with other users likeliest to advance the user to the user goals, and so forth.

In the example embodiment, the prompt generation system may orchestrate tasks of various different models to perform the instantiations. In turn, downstream models then may perform tasks and generate outputs based on these instructions. These downstream outputs may then be integrated, using interim representations, into a story-based ontology information. The story-based ontology information may be stored, and the prompt generation system may instruct programming languages, or models, to perform analysis on the encoded store. Analysis tasks instructed to be performed on the data store may involve exhaustive combinations of attribute value and uncertainty components, resolving dependencies in story-based ontology instances produced by the downstream models. Since one of the main tasks of the prompt generation system may be to instantiate story-based ontology instances from user and other inputs, programs and models performing the analysis may be instructed to notify the prompt generation system accordingly, which in turn may instruct remedial and other actions. For example, when the need for more information may be flagged, the prompt generation system, based on the analysis (e.g., degree of maximal importance to unresolved dependencies) may initiate queries/elicitations to other sources, as may be approved by editors/users, or based on editor requirements for activity updates, instruct the generation of an elicitation for editors and other input sources as necessary (e.g., to resolve an insufficiency in the original input data that the system may not otherwise be able to resolve itself). The elicitation for editors or users may be a form of a prompt that the user may be able to interact with. The results of the analysis of downstream outputs, including identification of insufficiencies as well as new values from any simulations flowing back into the prompt generation system, may be evaluated by the prompt generation system to determine how to resolve outstanding or new information needs to continue to propagate the story-based ontology and decisions based on user desired future states. In the example embodiment, the prompt generation system may learn from updates and analysis (including simulations) of the tasks performed by the models it prompts, as well as from inputs of users themselves (e.g., feedback and other new inputs), and iteratively improve its prompts, which in turn may iteratively fine tune or improve the learning of downstream models as well. This learning loop may be perpetual.

In various example embodiments, the prompt generation system task orchestrations may include, but may not be limited to: i) integrating with a featurization system's workflow (see other embodiments of the prompt generation system in FIGS. 16-21; note, FIG. 12 shows featurization being performed before the prompt generation system is involved), ii) transforming featurized input into interim representations of structured knowledge that also may be universal representations (e.g., all data may be processed into probabilistic predicates which in turn may be converted into code that may instantiate the story-based ontology hierarchy as objects) during extraction insight flow and simple data conversion processes for use by downstream models (e.g., representing classifier scores as a universal representation such as a probabilistic predicate); iii) compiling a story-based ontology class hierarchy into code and checking of code production for fidelity to class structures; iv) setting thresholds for evaluation of weights learned during model instantiations of story-based ontology class instances; v) comparing weights learned during deep learning model instantiations of the story-based ontology instances to thresholds; vi) updating weights for class attributes based on model instance outputs; vii) resolving class dependencies during instantiation, including through attempts involving additional sources approved by editors/user; viii) generating elicitations for users/editors to provide information necessary to complete user state updating; ix) generating elicitations for users/editors to provide information to facilitate setting attribute target weights for use in model updating; x) analyzing updated user state for evidence of correlations with prior user states using current weights; xi) simulating current and prior user states based on analyzed datasets and current weights to generate user future state trajectories; xii) simulating user future states based on new attributes and attribute target weights; xiii) generating user trajectories based on simulated user future states using new attributes and target attribute weights; xiv) evaluating and comparing simulations to determine best candidate for a user's best next action step recommendation; xv) facilitating collaborative development of composable use cases through logical testing and analysis of editor/user input; xvi) compiling composable use cases into code based on the story-based ontology class hierarchy and class structure; xvii) compiling story-based ontology instances into composable use cases; xviii) comparing story-based ontology instances by comparing composable use cases based on them; xix) genericizing composable use cases; xx) facilitating adaption by users/editors of expert use cases into composable use cases; xxi) encoding composable use cases with the class structure; xxii) collaboratively encoding with editor/user assistance a use case knowledge base with the story-based ontology; xxii); generating, processing, summarizing, tracking, evaluating multi-modal communications streams with users; xxiii) characterizing output communications (e.g., elicitations or recommendations) in terms of the story-based ontology; xxiv) determining optimal configuration of multi-model elements in output communications based on user response patterns; xxv) generating templates to facilitate interaction with users; xxvi) populating templates with information based on various user directed requirements; xxvii) determining which data exchange languages to use for which models or processes; xxviii) generating knowledge graphs and linkages with knowledge base; xxix) deriving and inferring other attribute values from computed attribute values (e.g., conflicts based on imbalances in Contract class Contracts); xxx) acting as a user's intelligent agent in above described capacities based on all prompt generation system learning about or from a specific user; xxxi) negotiating Contract class Contracts on behalf of a user with intelligent agents of other users to facilitate collaborations between users in a network of users each represented by an intelligent agent; xxxii) augmenting available knowledge as needed from other user agents, including sources of data they may represent.

Prompt generation system: training datasets.

In the example embodiment, a prompt generation system, as a deep learning model, may be trained on various datasets to perform certain tasks associated with that dataset. As already described, training data sets may include story-based ontology examples, reference speech data and reference treatment data. In the example embodiment, a training dataset also may include prompts (e.g., in NLP) and query sets (e.g., in SQL) as well as outputs of models based on these prompts and queries (collectively, referred to as prompts). In the example embodiment, prompts may be embedded with probabilistic predicates or converted into probabilistic predicates so that prompts may have probabilistic variables or be structured as probabilistic queries. This programming may facilitate sampling, inference and other model functions to leverage the probabilistic aspects of class attributes in the example embodiment,

In the example embodiment, a prompt generation system may be trained collaboratively by editors, using various input datasets, to perform featurizations, encode a knowledge base with an story-based ontology, fine-tune a LLM, write code to instantiate story-based ontology instances, generate instructions in languages target models understand, and various other tasks as editors may collaboratively train one or more prompt generation systems to perform. Thus, a prompt generation system may be trained on various domain datasets and communications on how to instruct other models to perform tasks regarding these domains.

Prompt generation system: learning to choose from among downstream models.

In the example embodiment, the prompt generation system and downstream models dependent on the prompt generation system's orchestration of their tasks may collectively become “smarter” as they process and evaluate more inputs as a system. As the prompt generation system learns from its impacts, it may “select” from a “library” of models which model to perform which tasks, by generating a data exchange communication for the chosen model; in another scenario, the prompt generation system in the example embodiment may instruct various downstream models with the same task to determine a “winner.” Or, as another scenario, outputs of competing models may be subjected during analysis to Bayesian reasoning, the output of which then may be provided as new input into the prompt generation system, which the prompt generation system then may use as the basis for its next prompt generation and downstream model choice(s).

In the example embodiment, the prompt generation system, based on its training, may determine what tasks to instruct which models to perform, and then generate prompts (i.e., prompts, queries, instructions) for these tasks in languages and formats that target models may process and execute using formatted inputs. In the example embodiment, the prompt generation system may determine what information, and in what form, the target models are to use to perform what tasks to meet what requirements.

For example, query language(s) may be used for some model instruction, NL for others. The prompt/query languages may be structured differently. In the example embodiment, predicates may be used as bridges between different query/NLP languages, enabling communication and data integration. This transitivity may be accomplished through various methods, including graph-based representations, where predicates may act as edges connecting nodes in a coherent structure. Additionally, predicate forms with probabilistic capabilities may facilitate not only the analysis of data within individual languages, but also the simulation of impacts of languages on outputs, accounting for probability throughout. The analysis of predicates before and after a model receives an instruction information (e.g., generated by a prompt generation system) in turn may be used as input into the next generation of the prompt generation system.

In the example embodiment, the prompted models (target models), depending on the task they're instructed to perform, may or may not include a LLM. By way of illustration, an optimal choice may be for a reinforcement learning model to generate a next step recommendation; probabilistic programming to handle a lower priority use case specialization task, and a LLM fine-tuned on validated anxiety datasets to execute an anxiety scoring task, It should be noted that the adaptive architecture of the prompt generation system may facilitate integrations of various models in each other's performance as well, not simply choices between models. For example, in some scenarios, NLP may be used to augment agent policy making options for consideration in a reinforcement learning model. As illustrated, task orchestration as well as integration may be facilitated by the prompt generation system. Thus, as new technologies emerge or improved, the prompt generation system may harness their strengths through its adaptive system architecture.

In the example embodiment, the prompt generation system may determine from prompts (e.g., queries, tensors generated by the prompt generation system, etc) which prompted downstream models and programs may use natural language processing prompts, which may use tensors as prompts, and which may use other languages, such as query languages (e.g., SQL), to retrieve, transfer and update data. In the example embodiment, the prompt generation system also may determine from prompts, from an analysis of downstream model output based on prompts, which method, language or tensor, or combinations thereof, may be the most efficient for prompting which models and programs. For example, the prompt generation system may generate a prompt in natural language for a LLM to perform certain tasks on a formatted natural language information. To continue with the example, the natural language prompt being described may specify that the output of the task performed on the data formatted be a computation (e.g., a health and wellness score based on a supplied rubric for determining said score) to serve as input, after featurization, into a specified AI computational tool. Besides learning which method of prompting may work best, the prompt generation system in the example embodiment may learn which natural language processing models (e.g., LLMs) and programs and which non-LLM models and programs may best perform which tasks and on which types of data. Recall, data may be transformed in the example embodiment into various intermediate and universal representations of it for system use, which may facilitate working with any type of data. Through intermediate and universal representation of data, the prompt generation system in the example embodiment may generate prompts using the appropriate representation to instruct the appropriate models and programs to perform the appropriate tasks on the appropriate data in its appropriate representation.

Prompt generation system: Supporting user skill development to reach goals.

In the example embodiment, a prompt generation system may orchestrate or facilitate the orchestration of the tasks associated with generating more accurate representations of various user states from the data (via management of weights learned from processing the input data in accordance with the story-based ontology) as well as to manage these more accurate representations in support of the user's goals; the user's goals may be represented in the story-based ontology as a user's particular future state. Recall, a user future state in the example embodiment may be represented as a simulated set of new values and uncertainties for various attributes of various classes in a hierarchy of classes at the top of which is the Identity class, which represents the entity, or as may be the case here, a user (In the example embodiment, “user” and “editor” may be Role class role instances belonging to an Identity).

To illustrate how a prompt generation system may facilitate goal setting and attainment in the example embodiment (e.g., by a prompt generation system and/or other models and programs), let's refer now to FIG. 5, and let's say “Tom”, “identified” in terms of the Identity class, has a goal of becoming a “healthier” diabetic. In the example embodiment, Tom's goals may be represented as target weights for the role importance (attribute) of the diabetic role, say, and involve for illustration purposes upweighting the current diabetic role importance weight shown as a 0.7 value to a new value of 0.8, with associated other weight adjustments of other attributes in other classes (e.g., adjusted weights for deliverable class deliverables related to food preparation; see FIG. 3 description). In the example embodiment, user goal setting and attainment may be facilitated by the prompt generation system by managing tasks of updating and analysis/simulation of representations of user attribute values and weights across the class hierarchy.

To further describe this, goals may be set by users through various received inputs of stated importance (e.g., “I need to be a better patient”) and/or through various methods of derived importance (e.g., evaluations of Contract class Contracts for imbalances between “doctor's prescription” and “taking pills i.e., non-adherence” which may lead to conflicts with other roles important to Tom). In the example embodiment, acting as an agent, the prompt generation system may instruct a model to upweight a stated importance, or downweigh it, depending on what the prompt generation system may learn about the impact of a user's stated importance on the user's traversal of use cases (e.g., via certain measures of goal attainment). Referring again to FIG. 6 and FIG. 9, uncertainty and various attributes may be associated with various scores from instruments used to establish an evidentiary basis for analysis as well. So, for example, a goal of becoming a “healthier” diabetic may be associated with targeted weight adjustments in a mental health attribute for perceptions of low physical well-being to a higher score. Since scores may be represented as data associated with certain attributes of certain classes in a hierarchy of classes, which have weights, scores may be “managed” by the prompt generation system as goals, too. So, based on the foregoing description, stated and derived importance (including importances derived from scores and correlations between them) in the example embodiment may act as a proxy for user goals, and all of a user's goals may be factored into goal setting by the prompt generation system.

However, recall skills in the example embodiment may be represented as a class, which may constrain which stated or derived goals may be attainable. Saying “I need to be a better patient” may not make it so (i.e., an attainable goal), if the diabetic does not have the skill class skills to adhere to a doctor's orders, for example. On the other hand, evidence of taking pills to improve circulation while addressing an adherence skill deficit may not sufficiently compensate for nerve damage in the foot for the user represented in the story-based ontology instance to regain walking without assistance. Analysis functions instructed by the prompt generation system may produce an output that may act as a basis for the prompt generation system to next instruct another model to compose a composable use case for simulation based on the analysis, to then evaluate whether that result then meets thresholds to provide to the user as a BNAS. In the example embodiment, use cases may facilitate a richer understanding of a user's current state and which skills may be necessary for the user to achieve a desirable future state, based on goals represented as deliverables and tasks associated with the skills to complete them.

In the example embodiment, the prompt generation system may learn from user inputs to generate better and better instructions to downstream models which may increasingly be fine-tuned or trained as a result, making the prompt generation system smarter about more and more specific user needs, which in turn the prompt generation system may use to improve its own output, its evaluations of that output, in a manner increasingly knowledgeable and supportive of the user with each new user input.

In the example embodiment, skill class skills belonging to an Identity may increase or decrease rather than exist as static set of capabilities in set amounts. In the example embodiment, property and relation attributes have value and uncertainty components for skill class skills that may be adjusted up or down. So, current skills may have changing amounts. Meanwhile, new skills may be added, each with different property and relations attributes with different value and uncertainty components that also may be adjusted up or down. Thus, the story-based ontology class structure, which may not change, may be replicated with attributes whose value and uncertainty may change. To further describe this, class instance expansion (e.g., adding a new skill to a skill class) may not change the class hierarchy or class structure, only the complement of particular class instances, each with different attributes and different quantities for value and uncertainty components.

In the example embodiment, it may be determined by an analysis program instructed by a prompt generation system that a new skill class skill may need to be added to an Identity, or subtracted from it (e.g., blindness from a disease may mean the subtraction of a sight skill). In turn, the prompt generation system may instruct the addition while ensuring its proper representation and testing.

The skill of learning skills may be represented as a skill class skill in the example embodiment. In the example embodiment, this learning skill may be a computed skill derived from analysis of various attributes and their value and uncertainty components. Functions may be instructed to identify various dependencies, then evaluate them, between skill attributes and other attributes across multiple story-based ontology instances for an individual Identity (e.g., Tom Garvin). These evaluations may produce similar skill attribute groupings or patterns for the Identity above a threshold (e.g., recurring correlations above a threshold across instances between specific skill attributes and specific task attributes for certain deliverable attributes). A prompt generation system may instruct a function to produce a knowledge graph showing these groupings. In the example embodiment, skill patterns learned for the individual Identity may be shown on a knowledge graph. The graph may show proximities between skill attributes for any user state or as an average across states for constituent value and uncertainty components. This same method of evaluation may be performed in the example embodiment across multiple Identities. The resulting graph for a cluster of Identities may then be compared to an individual Identity graph. Comparing similarities and differences between individual and population patterns may produce correlations that may be labeled. For example, the identification of a skill missing for an individual Identity from a group of individual skills similar to a group of population skills may be a skill that the individual has some probability of learning. The missing skill for the individual Identity may be labeled with the same label used for the skill in the population group, and the value and uncertainty computed probabilistically.

This same method to identify missing skills and represent them in the skill class skills of an Identity may be applied through instruction of the prompt generation system to other classes, such as deliverables, which may require certain skills to complete tasks. Since certain skills may be inferred from certain deliverables known to have been completed by an Identity, skills not in the Identity's skill set related to the completed deliverable may be added and a certain quantity assigned to value and uncertainty attribute components. These inference functions may be performed by various methods, such as probabilistic programming, which the prompt generation system may instruct.

In the example embodiment, skill class skills and attributes of these skills in the story-based ontology may be said to have more plasticity than others, by which we mean a certain adaptability to perform specific new tasks not previously performed. Plasticity may be represented in the story-based ontology as a computed function of multiple probable attributes and their interdependencies, including those involving skill class skills, which may be quantified and compared to a population of skills also quantified. The above described method of comparing skills of an individual and skills of a population similar to the individual and then “filling in” the skills of the individual to more completely represent the population skill set may represent one way to show plasticity. The prompt generation system may instruct various functions to perform this analysis on the specified data, making sure that any conversions necessary for the function are performed.

In the example embodiment, certain tasks may require an allocation of more available skills for one person to complete a deliverable than another. The allocatable skills of an Identity (“person”), represented in the story-based ontology instance as a skill class attribute associated with the Identity class, may vary by skill property attribute (e.g., “carpentry” may be a skill class attribute “property” and associated with a task class attribute “property” associated with “carving wood”). A simple task for a carpenter may be considered a complex task for a non-carpenter, for example. In the example embodiment, plasticity may turn complexity into a relational concept quantified by factoring multiple class attributes with varying values and uncertainties in the example embodiment. When evidence is obtained from or about a user that the user has completed a deliverable such as a solved Rubric's cube puzzle, this may support inferences in the example embodiment that the user has a plasticity of skills related to that kind of deliverable; said plasticity may be associated with a probability of completing similar deliverables (e.g., solving complex puzzles). In this example, solving puzzles the rest of us find impossible to solve may strike the rest of us as very complex deliverables. Not so for the Rubric Cube solver. To continue with the examples of plasticity, a carpenter who builds a kitchen cabinet may have skills to build other things made of wood, for example, a house. Thus, in the example embodiment, certain “plastic” skills may be identified by functions and leveraged by various models to perform certain tasks, based on plasticity, even if the specific tasks have never before been performed by the user or even if the deliverable resulting from the tasks has never before been created by the user. This is to say that in the example embodiment attributes of classes, including skills and their relationships with other attributes of other classes, may be used by the prompt generation system (through its instructions of various models or programs) to cluster attributes and compute values and uncertainties into various plasticities based on the underlying values and uncertainties in the example embodiment. Consequently, skills, deliverables and other classes in the class hierarchy may be used to form clusters based on plasticities for a wide variety of purposes (e.g., commercial and non-profit): recruitment, networked resources, sharing economy tasks, and so on.

In the example embodiment, a use case may be represented as an instance of the class hierarchy. That is to say, a use case in the example embodiment may represent a particular set of story-based ontology instances (linked “generic” instances that may or may not also be validated, such as a treatment therapy) with weighted attribute components, including for various skills-which, in accordance with all story-based ontology instances, may include an uncertainty component. To further describe a use case, values and attributes for classes may be informed by use case training data that may be used to train a model (e.g., prompt generation system and other models) on story-based ontology instances of the use case (A model may be trained on more than one dataset). In the example embodiment, uncertainty may be used to facilitate working with probabilities within and across class relationships and through Contract class Contracts between entities (Identity classes). These probabilities may be evaluated in exhaustive combinations, across current and simulated (future) states for specific users and across use cases for which current and future states of a generically defined user may act as a proxy for expertise. That is, representations of a specific user may be compared to representations of generic users for various purposes (e.g., population health management, fine-tuning a treatment use case on an individual's needs, modeling the expertise of one user after another user through the abstraction of the exemplar users story-based ontology instances into generically characterized instances, and so forth).

In comparing use cases and user states, many queries may be generated in an attempt to learn answers with weights that again may be represented in terms of the story-based ontology classes and attributes: for example, in what regards may attributes of various current and simulated states have similar enough values and/or fall within the same uncertainty ranges?

In the example embodiment, a prompt generation system may be used to attempt to achieve new weights for the user associated with stated and/or derived goals. In its operations, models may manage stated and derived importance through various simulations to determine candidate future states for the user, which may be used to form a recommendation or elicitation to the user whose response then may be used to further inform the model and perform tasks based on user goals.

In the example embodiment, a prompt generation system during its generation of its outputs and make attempts through its learning to reduce uncertainty. Additionally, which models in which combinations may best satisfy tasks on behalf of various users may be learned through evaluations of user inputs. The prompt generation system and the models it may prompt/instruct/query may act collectively as an intelligent agent application for each user—to perform user directed tasks without requiring user expertise on any model.

Prompt generation system: incorporation into a featurization system.

While FIG. 12 focuses on the prompt generation system and architecture, the prompt generation system may operate in various environments. For example, as described in FIGS. 16-21, a prompt may be deployed in a communications featurization system. In that example embodiment, an upstream prompt generation system may act as a “featurizer” in a featurization system that may feed outputs into a downstream models and/or manage even some of these downstream models upstream, during featurization. For clarity, FIG. 12 shows a prompt generation system receiving featurized input from featurization system 1120.

Prompt generation system: Projects.

In the example embodiment, a prompt generation system may facilitate collaborations on various projects. A project may be considered a particular type of use case that may be designed first and then implemented or executed. Different teams may design the project than the teams that may implement or execute it. (The example embodiment may be used to both design and execute a project). To design a project, users may act as editors to define the terms of the project, its domain and other such information as may be helpful to them to design and complete the project. In the example embodiment, team members “on the project” may manage various aspects of the project through a query platform/sandbox that may be connected to an AI platform with probabilistic programming and various neural networks, including deep learning models, such as a prompt generation system. As team members interact with each other and the AI platform through the query platform (which may be an electronic bulletin board/sandbox), a use case knowledge base may be developed automatically in the example embodiment. This “building” of a knowledge base may take place through various inputs and prompted system communications based on AI evaluations of the inputs. It also may be based on a similar prior use case, or project, as a starting point. Similar project knowledge bases may be available through a store of use cases reliant for information on a common use case knowledge base. In the example embodiment, a use case knowledge base for a project may be populated with team member (editor) input related to the project, its steps, goals and other information. This information may be used by probabilistic programming and various AI models, such as a prompt generation system, to help users complete the design project and then execute it. Some team members on the project may have expert knowledge of project requirements, others not. In the example embodiment, a prompt generation system may be used in connection with an additional source, such as a large language model, to augment existing knowledge of the editors or for various other purposes, such as to help encode use case information inputs in terms of the story-based ontology.

To assist with the project, the AI platform may connect to an additional source approved by the editors. An additional source may be a large language model, or database, social media site or any other editor approved source for information, preferably useful for the project. To illustrate, let's say the editors are working on a software system design project, a specific use case, and the additional source they feel will help them efficiently complete the software system project is a database of many known facts about system design, a specialized domain. Through the query platform/sandbox, the AI platform may use editor inputs, and information from various connected sources, to facilitate development of a use case knowledgebase, augmented with information from an additional source, such as the described database, to facilitate their traversal of the use case, as users (e.g., the editors may be programmers, system designers, etc).

During project design, the AI system and the Editor inputs may be evaluated and used by the AI platform to generate a support information or elicitation to project design editors/user through the query platform/sandbox or via other communications modalities (e.g., email, chat, video calls). In the example embodiment, the communication with team members (editors/users) on said project may be in natural language, or as is described elsewhere, multi-modal, involving text, audio, video and simple data consistent with the manner in which people tend to freely combine modes and media in their communications with each other. In the example embodiment, communications generated by the system may be based on various factors to help ensure the accuracy, completeness and logic of the inputs into the use case knowledge base during development. In the example embodiment, predicates that may help map the logical and semantic relationships in communications may be extracted from inputs to determine their completeness, and via probabilistic programming, or via other methods, also evaluate the logic of their relationships. As described, analysis of inputs may be performed to ensure fidelity of inputs to a story-based ontology.

In the example embodiment, the same system that team members may find useful in developing a use case knowledge base may help other users to traverse it, and complete the project,

The use case knowledge base once developed may support numerous uses, such as for project management.

FIG. 13 is a diagram showing a decentralized network of intelligent agents and users in accordance with various embodiments of the invention.

In the example embodiment, an entity may be represented as an Identity in an Identity class, which may sit at the top of a story-based ontology class hierarchy (See FIG. 3). Things and people may have an Identity. Intelligent agents also may be an entity represented as an Identity. Entities may have various relationships with each other. In the example embodiment, a Contract in a Contract class in the class hierarchy may formalize the relationship between Identities. In FIG. 13, the double arrows may signify Contracts in a Contract class in a hierarchy of classes in the example embodiment. Note how Contracts in FIG. 13 link identities (e.g., things and people). As shown in FIG. 13, agents may have Contracts with each other as well as with people or things; note, an intelligent agent may be a thing. In a preferred embodiment, an intelligent agent in a Contract with a user may be tethered to the user. This may mean that an intelligent agent may form a Contract with other agents of other users only on behalf of a user to whom they are dedicated. In the example embodiment, the system may be a user and thus, as a user, may have a Contract with its own intelligent agent or agents. These system agents may enter into Contracts with agents of other users. In the example embodiment, agents of users may seek to develop and implement a best next action step for the user they may be tethered to.

In the example embodiment, a system agent may broker a Contract between agents of other users, as may be the situation in a project collaboration, where the project as a thing, or entity, may have an agent requiring a human user, who may have an agent.

In the example embodiment, a Contract, which may represent an exchange of deliverables between roles (“gives and gets”), as shown in FIG. 8, may also be generated between roles in the same identity, as per the description for FIG. 3.

In the example embodiment, a network of Contracts may be facilitated by protocols, including for system agents.

In the example embodiment, system agents may act as an additional source during development and implementations to support users by connecting their agents to other resources. For example, a project developed by a set of users and editors may need another source outside of the expected sources the users may have determined necessary for a project. In this example, users may opt to allow their agent to reach out to a system agent which in turn may contact agents of other users about the need to determine if there is a mutual advantage to assisting on said project. This may occur by forming a Contract between the user agent and the system agent related to finding a suitable source. Deidentified information (e.g., based on representations of the story-based ontology) may be used in the ‘negotiation’ to determine if there is a suitable counterparty, or agent. If so, a Contract may be formed between the system agent and the agents of the users agreeing, based on the approval of their user, to join said project. In the example embodiment, reaching out to agents of the system may expand the network of any one user to include other users presently unknown to the user.

FIG. 14A is a block diagram showing an intelligent agent schema in accordance with various embodiments of the invention.

In the example embodiment, an intelligent agent may comprise a deep learning prompt generation system and associated downstream models and programs custom-trained on each user (See FIG. 12). The diagram references the various data transformations (See FIG. 54) that an intelligent agent may orchestrate to complete tasks associated with advancing a user towards a desired state. As shown in FIG. 15, these tasks may include, but may not be limited to, updating user current state, simulating future states, comparing trajectories between current and simulated future states to determine the best next actions step, negotiating Contracts on behalf of the user with agents of other identities, and communicating a BNAS and other information related to it to the user. It should be noted that various related tasks to generating a best next action step may involve querying the user or other sources as may be approved by the user to resolve dependencies that emerge in construction of the current and future story-based ontology instances of the story-based ontology class hierarchy from user inputs.

FIG. 14B is a diagram showing diagram showing how users may interact with their Agents, and how their Agents may interact with the Agents of other users in a collaborative network in accordance with various embodiments of the invention.

These interactions between users and their Agents and between each user's Agent and other users' Agents in the example embodiment may resolve resource requirements for best next action recommendations as well as strategy requirements for the best way to communicate the recommendation. In the example embodiment, Agents may be users (i.e., system users).

In the example embodiment, each Agent may have a message box, which it may use to send/receive messages to/from other Agents. Messages between Agents may be processed as inputs, and like other inputs, context-tagged. For example, a message may be a negotiation and the relationship between users of the negotiating Agents may be characterized as Story Data Types (e.g., roles and role-sets such as father-son, patient-nurse, friend-friend, etc.). Further, each Agent may determine if the request it receives from other Agents advances its own user's goals.

As elsewhere described, Agents of users may interact with each other on behalf of their users to advance their users towards their Envisioned Story. When the Agent returns a best next action, the Agent may also return a use case specifying the style and structure of communications (e.g., NL) for how to communicate the best next action. In the example embodiment, such information may be contained in a prompt generated by the prompt generation system used to instruct downstream models and programs, such as a LLM. In effect, the Agent may specify which actions, along with which requirements and goal parameters, the example embodiment may follow to execute the communications. These use cases may be referred to as communication strategy use cases. These communications strategy use cases may have a Communication Method ID referenced in the user's log. These communications strategy use cases may be identical in structure to a BNAS, but may be purposed for use by the example embodiment as instructions for the system itself on how to model the NL communications. In other words, there may be a separate communications use case for each BNAS for each user at a given time.

In the example embodiment, a communication strategy use case may include a variety of actions that embody specific strategies of communication. The embodied communications strategies may include, but may not be limited to, tone and manner (e.g., “gentle and sensitive”, with actions such as NL conditioned in soft language before generating NL); meter, pace and frequency of communications; reciprocity requirements (e.g., boost reciprocity, which may mean “mimicking” another speaker's “speaking style”, for instance), modality of communications (e.g., text vs email); delivery agent or channel (e.g., a communications may be more apt to be listened to when it comes from one person rather from another); word choices for context appropriateness (e.g., words in some contexts may be used to convey urgency, in others calmness); length of communications; and so forth. In the example embodiment, the prompt generation system, acting as an agent, may determine which conditioning requirements for output of the communications may be most likely to elicit or solicit a response from the user. Recall, as described in FIG. 14A, in the example embodiment an Agent may comprise a prompt generation system together with the downstream models it may prompt. A communications strategy case may be generated as a recommendation by the Agent, and evaluated during impact analysis as a separate but related factor to isolate whether it is the recommendation or how it is communicated that correlates more highly to movement towards an Envisioned Story.

In addition to tools that may facilitate a user's inspection of and comment on various updating and analysis functions (e.g., impact analysis), users may interact with their Agent and their Agent may interact with their users through any modality of communications supported by the example embodiment. Interactions between users and their Agent may be processed as inputs.

In the example embodiment, the chosen modality of communication by the user's Agent to the user may be optimized by the Agent. While each Agent may communicate with their own user through NL, output may not be limited to speech or text output. For example, a user's Agent may text a “thumbs up” image in response to a user's spoken question. Recall that the user's Agent learns which strategy may be effective for communicating with the user via analysis of user actions after the Agent makes a recommendation.

Additionally, the example embodiment may observe the impact of new behaviors, evaluate that impact on a user's progress towards goals, and adapt to produce new behaviors based on what it learns from modeling incoming facts is optimal for attaining user goals.

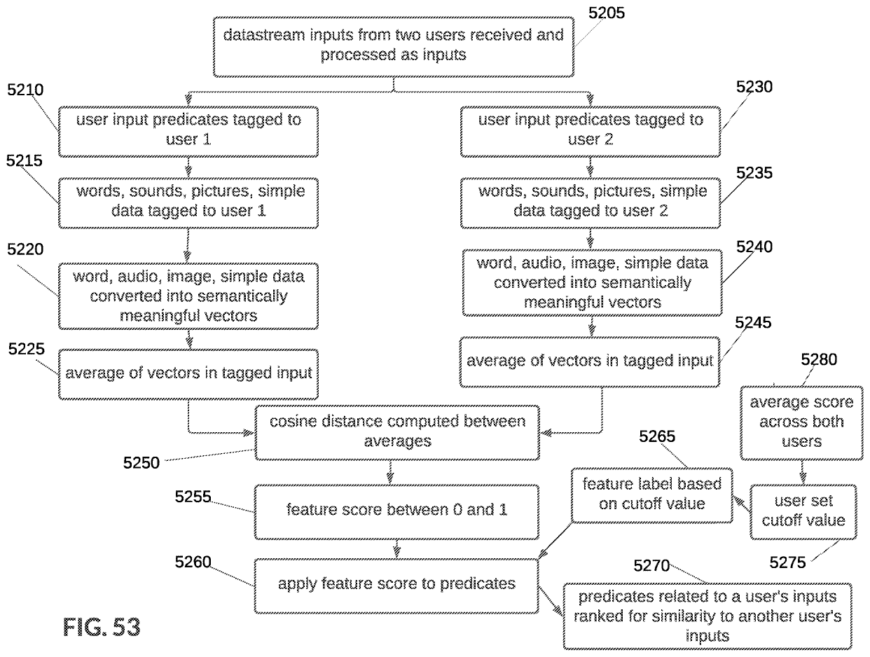

As an illustrative example, the example embodiment may use a measure described as reciprocity to score the similarity between what it may communicate and what a user may communicate (See FIG. 53 on reciprocity, a method that may be used to compare any two sets of inputs). The example embodiment may set its own reciprocity targets and optimize its own communications use case selections and specializations to achieve the right level of emulation with a user. In this manner, the example embodiment may optimize its own behaviors from evaluated, synchronous or asynchronous sets of observed behaviors between user and system\behaviors. And, unlike typical engagement technologies, the example embodiment may not have to predetermine either a scripted action or a scripted response. Rather, the example embodiment may recommend real-time action to each user that is predicted to move each user towards their goals. The action recommendations of the example embodiment may be the result of optimizations predicated on observed behaviors, actions customized to the user, measured outcomes and personally relevant narrative contexts.

Further, to facilitate interactions between users and their Agents, a user may name their Agent (e.g., “Elsa”, “Frank”, etc.), which may be trained on their user's voice, among other attributes, and which may act on behalf of the user. In this sense, a user may collaborate with their own Agent to accomplish their goals. In acting on behalf of their users, a user's Agent may play various roles itself. In one case, a user's Agent may act as a virtual assistant, in another a virtual coach, in another a virtual nurse, and in such role as may pertain to other virtual “experts” or combinations thereof, each according to roles and requirements. By whatever name, a user's Agent may process inputs to generate and communicate recommendations for the user, based on evidence of “what works” in guiding the user towards their envisioned story.

For example, if “Charles” is known by the example embodiment to be more apt to “listen to” his daughter on matters of personal health, the system may determine, if Charles's BNAS relates to Charles's fitness, that the communications strategy use case may be an action for Charles's daughter to talk with Charles about Charles's BNAS. Here, “talk” may refer to whatever may be the optimal modality for communications with Charles, such as a phone call. Meanwhile, if the negotiation between Charles's Agent and his daughter's Agent is successful, then his daughter's Agent may determine the communications strategy use case most appropriate for its communication with Charles's daughter about Charles's BNAS. To continue with the illustration, Charles's daughter's Agent may call Charles's daughter to tell her to call Charles about Charles's BNAS. In turn, Charles's daughter may call Charles, and the conversation between Charles and his daughter may be processed as inputs, and thus continue the recommendations loop.

A name provided by a user to the user's Agent to represent the user's Agent may be treated as an entity by the example embodiment tagged to the user's Identity. Likewise, the roles that the user's Agent plays during interactions with the user or on behalf of the user with the Agents of other users may be tagged to roles. This may facilitate an analysis of which roles played by the user's Agent may be most associated with the user's progress. For example, in some cases, the virtual role may be as a receptionist while in others a coach or nurse or a financial planner, or . . . , etc. In part, the impact analysis performed by the example embodiment after a recommendation may facilitate the determination of which roles the user relies on the Agent to perform.

To continue with personification of the Agent as a user itself, the name given by the user to their Agent may be associated with its own identification number. This identification number may be used by various systems to identify the Agent, while protecting the Identity of the user who may be tagged to it. For example, if the user names their Agent “Elsa”, then when the user receives a text message from their Agent the text message may be associated with the name “Elsa,” context tagged, and so forth, and appear as “Elsa”.

Note, unlike chatbots, Agent communications may not need to prescribe actual language communication, but rather use logs and the actual conversational context to generate new NL responses.

FIG. 15 is a flow diagram showing how intelligent agents may support the advance of users towards goals based on their inputs or on inputs about them in accordance with various embodiments of the invention.

Input from users and from other sources may be processed through a series of transformations culminating in structured knowledge representations of the inputs. This structured knowledge may be represented in terms of the story-based ontology class hierarchy. In the example embodiment, these transformations of inputs into various representations of a story-based ontology class hierarchy may be conducted by a prompt generation system (See FIG. 12) that collectively, with downstream models and programs “prompted” by the prompt generation system, may act as an intelligent agent of the user.

Shown in FIG. 15 in a counterclockwise fashion, inputs into the generation of story-based ontology instances represented in the diagram by the transformation process may be described as follows (See also FIG. 10, FIG. 12 and FIG. 54). Initially, systemwide extractors and classifiers trained on validated datasets and encoded with the story-based ontology may be used to render classifications and extractions of inputs in the same manner across a user base. The output of the intelligent agent may be an initial or updated user data encoded with story-based ontology weights. This updated user data may represent the user current state as an initial or updated instance of the story-based ontology. Next, as shown also in FIG. 15, continuing counter-clockwise in the diagram, a future state may be simulated based on current and new target weights for attributes of various classes in the class hierarchy; these tasks may be performed by the intelligent agent of the user, and involve an orchestration of data transformations (See FIG. 54 for transformations and a for descriptions of simulations). Once future states and current states have been simulated as instances of the story-based ontology, a best next action step may be determined based on simulated results involving target weights. Next, after a BNAS is determined for a user by the user's agent, the agent may negotiate a Contract (e.g., a Contract in the Contract class) with another user's agent to optimize which user, through their agent, may be best suited to perform the BNAS (See FIG. 14B). In various cases, the optimal user may be the agent's user, and the Contract may involve an exchange of deliverables between different user roles (see FIG. 3 for examples and FIG. 8). Next, the user may receive a communications styled by an intelligent agent related to the BNAS, which may include a request for an approval. The user response, or action, after receiving a communications related to the BNAS then may be processed as input, and the counterclockwise learning loop may repeat, Thus, through a series of BNASs, a path may be generated, one BNAS at a time, to assist the user in advancing towards user goals, represented as target weights in the story-based ontology class hierarchy. In the example embodiment, the intelligent agent may orchestrate various actions in the outside world to assist the user (e.g., scheduling appointments, driving a self-driving car to/from a location, ordering a meal, calling a person).

### Ontology-Based Agent Generation During Featurization

FIGS. 16-21 are flow diagrams showing how a communications featurization system may generate structured knowledge representations of original input during featurization of the original input in accordance with various embodiments of the invention. As previously described in FIG. 12, models in a prompt generation system may be trained to encode multiple features from the same input with a story-based ontology information, and/or a health/wellness information, and/or use case information, and/or user specific information. As shown in FIGS. 16-21, in another embodiment, the prompt generation system comprising said trained models may be incorporated into a communications featurization system. As a result, the communications featurization system may not only featurize data, but also may transform featurized data into structured knowledge as an integrated step. Recall, the prompt generation system may transform raw input into structured knowledge (See also FIG. 54) and, in combination with the downstream models and programs it prompts, in yet another embodiment may act as an intelligent agent of the user. Thus, while unstructured input is being turned into structured data during featurization (featurization may transform raw data into machine readable representations), it may also be richly encoded with many new features designed to work together in the example embodiment, for example, to advance the user. These features may work together in the example embodiment to provide better context for next step recommendations and to reduce uncertainty, among other objectives associated with assisting users. For example, an encoded health score information for a user based on the user input may be used as evidence to refute or qualify the user input (e.g., “I'm fine” may be said by someone who is not “fine.”). Additionally, a health score may be shown as a value component of an attribute of the story-based ontology and an amount of uncertainty for the score may be shown as the uncertainty component of the attribute. So during featurization in the example embodiment, a story-based ontology instance may be instantiated with score information and probability, which in turn may represent aspects of a user current state. Meanwhile, use case features may be encoded from the same input during featurization (e.g. “I'm fine′ may be characterized with a probability of belonging to a goal step of a use case). Further, the same input may be encoded with user specific features (e.g., “I'm fine” may tend to mean for a particular entity with the Identity “Charles” an instance of an “employee role” or “father role” with higher role importances—attribute components). Consequently, in the example embodiment, a rich, multi-layered contextual framework representing a user state may emerge during featurization from even a small amount of user input.

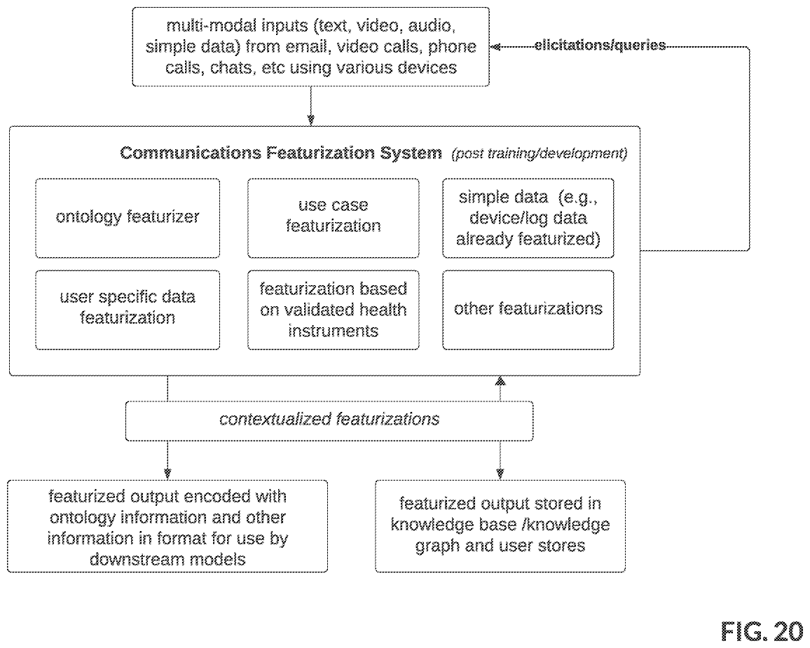

As described in FIG. 20, these featurizations may feed into downstream updating and analysis functions (see FIG. 10 and FIG. 12) or, as described in FIG. 21, as yet another embodiment, these typically downstream updating and analysis functions may be embedded in the communications featurization system architecture to perform these functions upstream during featurization,

In the example embodiment, a communications featurization system may refer to a processing pipeline that converts raw unstructured data from multi-modal communications inputs into structured data. This data may be used by downstream models and programming; languages to perform various tasks, or by models embedded in the featurization system to perform them during featurization.

The communications featurization system in the example embodiment may move various deep learning extraction and classification processes, normally handled more discretely and separately downstream, closer to the point of data ingestion. This move may be facilitated by how deep learning models use tensors and neural nets. In machine learning, tensors may be fundamental for representing and manipulating data in various formats, including images, text, and audio. Tensors may flow through the layers of a neural net, which may perform various functions on them before then producing new tensors as output.

Generating additional features from the same input at or near the point of ingestion as described may enhance model performance downstream, embed extractable dependencies in the data for richer insights, and get more value out of smaller datasets. In the example embodiment, it may also generate a bigger, better, faster picture of an individual user.

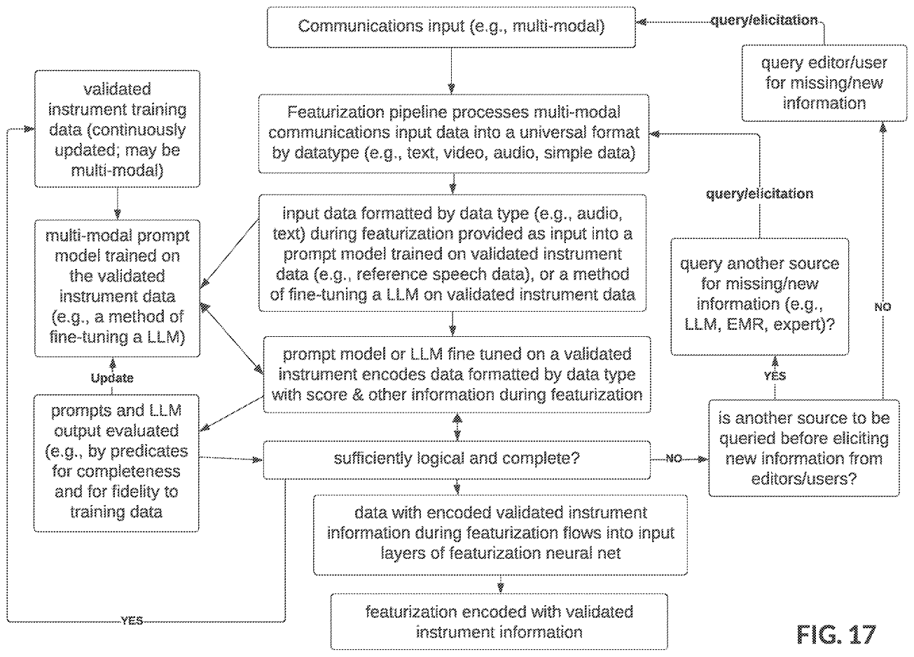

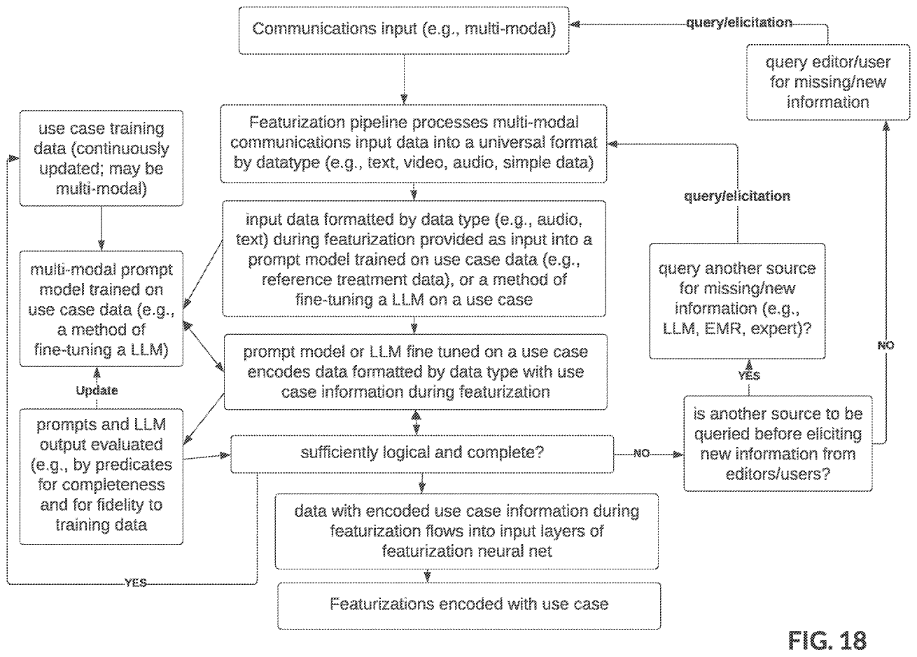

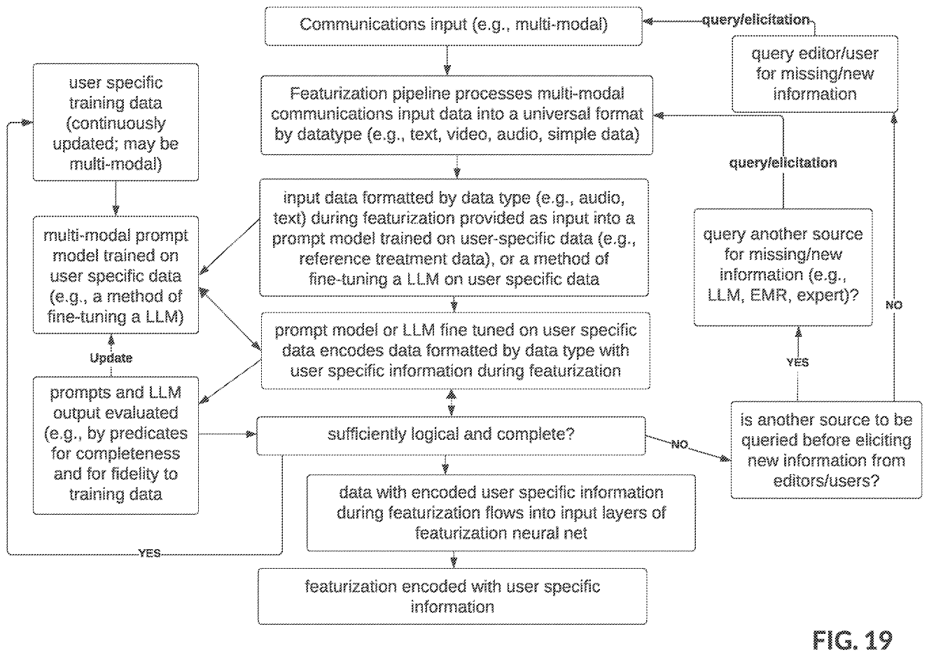

Regarding FIGS. 16-21, models in a prompt generation system in the example embodiment may be trained to perform multiple different tasks, including data transformations, based on various datasets and data formats. So, the prompt generation system may handle different types of inputs, such as text, audio, images, and more, as well as knowledge structuring based on them (e.g., story-based ontology encoding). In the example embodiment, a prompt generation system whose models are trained on a story-based ontology may allow the prompt generation system to perform as a story-based ontology featurizer within the communications featurization system (FIG. 16); a prompt generation system whose models are trained on validated health and wellness instruments may allow a prompt generation system to perform as a health and wellness featurizer within the communications featurization system (FIG. 17); a prompt generation system whose models are trained on use cases may allow a prompt generation system to perform as a use case featurizer within the communications featurization system (FIG. 18); and a prompt generation system whose models are trained on a specific user may allow a prompt generation system to perform as a specific user featurizer within the communications featurization system (FIG. 19). In the example embodiment, said featurizers may be integrated to work together as shown in FIG. 20 and FIG. 21.

Before turning to each of the FIGS. 16-21, certain commonly shared aspects of the each are described below.

FIGS. 16-21 show a collaborative learning loop between users and the system during the operation of the communications featurization system. In the example embodiment, datastreams from users may be transformed by the communications featurization system into structured knowledge, in effect, turning these datastreams into learning streams. Users may be active participants in shaping the structured knowledge used in the example embodiment by being in a position earlier than in typical input processing to respond to an analysis of their own inputs and thus also be in the position to curate and improve evaluation of the inputs upstream, before the output may be “baked into” typically downstream processes.

Communications Featurization System: Processing multi-modal inputs.

In-FIGS. 16-21, user interactions with the example embodiment and with other users that produce datastreams may take place through devices and interfaces connected to the AI platform via a query platform (e.g., an interactive site, bulletin board, sandbox, etc).

In the example embodiment, each input datastream may be tagged to the respective device (e.g., phone, computer, camera), user (e.g., user Identity), and communications modality (e.g., call, email, chat, video conferences), establishing what may be referred to as a context-tag. The original input, along with associated tags and logs, may be stored for later reference. For example, original input may be “looked up” to facilitate look ups and various steps during data transformation processes. In the example embodiment, featurization may be an interim step between unstructured data and structured knowledge, and may be orchestrated by the prompt generation system.

Communications Featurization System: Input data universally formatted and output as tensors.

As shown in FIGS. 16-19, after the multi-modal communications input is received it may enter the featurization pipeline of the Communications Featurization system. This featurization pipeline may process the received, tagged multi-modal communications into a universal format by datatype (See FIG. 36). After being formatted into a universal format by data type, the formatted data may be transformed into one or more tensors.

Communications Featurization System: tensor inputs encoded by the prompt generation system which generates new output.

Next, in FIGS. 16-19, tensors generated in the prior featurization step may serve as input into an encoding processor to encode the input tensors through its operation, based on its training as a deep learning model. In the example embodiment, the encoding processor may output a tensor with story-based ontology and/or a health/wellness and/or use case and/or user specific information, based on its training. In the example embodiment, this encoding may be performed by a multi-model prompt generation system trained on the said information.

Communications Featurization System: prompt generation system outputs analyzed.

After the prompt generation system encodes the featurized input tensor and outputs a new tensor with the encoded information based on its training, the output tensor may be evaluated. At this point in FIGS. 16-19, the evaluation may be performed by various methods, which may include probabilistic programming to evaluate the predicates generated during featurization. Note, depending on a particular featurization hierarchy, predicates may be generated after featurization (rather than during), as may be more typically expected. In whichever sequence predicates may be generated, data formatted and encoded with story-based ontology and/or health/wellness, and/or use case and/or user specific information features may be extracted and evaluated as predicates in the example embodiment. In a preferred embodiment, input data may be transformed into predicates as a universal representation not only of the input data, but also of various encoded featurizations of it based on the story-based ontology. Further, these predicates may be evaluated for completeness (e.g., are predicate arguments complete?) and for logic (e.g., do the extracted predicates make a logical argument together, as may be useful in determining if a model outputs may be “hallucinations”, or made up facts based on semantic but not logical reasoning?). These evaluations or proofs may be performed automatically in the example embodiment by a probabilistic logic programming language (e.g., Problog) that uses probabilistic predicates in its functions. Thus, featurized transformations of inputs into universal representations of the input with encoded story-based ontology and/or a health/wellness and/or use case and/or user specific information features may be further transformed into predicates, which a probabilistic programming language may use to evaluate the completeness and logic of prior transformations with which the predicate is associated.

In the example embodiment, universal representations generated by the Communications featurization system may include, but may not be limited to: 1) predicates which may be converted into subject verb object sets, ii) subject verb object sets—which may be converted into predicates, iii) scores based on instruments trained on validated datasets which may be converted into either predicates or subject verb object sets.

A universal representation of the input data generated by the featurizer may facilitate the propagation of the structured knowledge through various model and programming functions in the example embodiment.

In the example embodiment, outputs of natural language processing models may easily be characterized as SVOs, which may be associated with predicates, thereby facilitating the performance of certain logical functions typically outside the functionality of NLP. Consequently, a LLM as a NLP technique may be used in conjunction with logic programming through the conversions between SVOs and predicates. Additionally, the output of a LLM may be graphed in a knowledge graph, which may be a form of structured knowledge that also may serve as the basis for various evaluations. In the example embodiment, information in a knowledge graph also may be transformed into probabilistic predicates. The attractiveness of LLMs to generate significant stores of natural language information quickly from example inputs may make a LLM a preferred source for additional data, including code, which may be expressed in natural language-which then may be transformed into probabilistic logic predicates—which in turn may be used to evaluate the LLM output (e.g., these evaluations may include evaluations of LLM outputted code).

During this step, attempts to complete the predicates and resolve dependencies may be made automatically in the example embodiment. Recall, the prompt generation system in the example embodiment may orchestrate downstream models and programs to perform various tasks. These tasks may include generating candidate solutions. For example, searches in knowledge stores may be conducted; probabilistic predicates may be generated from stored probabilistic predicates through inference; operations on retrieved information may be performed by AI computational tools and probabilistic programming, and so on.

Communications Featurization System: prompt generation system outputs compared to thresholds for sufficiency.

As shown in FIGS. 16-21, the output of the featurizations may be evaluated for completeness of the predicates sets. Additionally, logical dependencies between predicate sets as a collection of predicate sets may be evaluated, and compared to the logical dependencies established in the story-based ontology. Thresholds to determine the sufficiency of an evaluation may be ratcheted, or not, depending on editor decisions. A ratcheted threshold may refer to a threshold based on a prior threshold and new set of evaluations resulting in new weights below or above the prior threshold. Bayesian reasoning or other techniques may be used to dynamically evolve the threshold, presumably by increasing it to set ever higher standards for evaluated data.

Communications Featurization System: Is another source to be queried?

Next, regarding FIGS. 16-19, if the evaluation of the prompt generation system output is at or above a threshold, then it may be deemed sufficient. Featurized data transformations deemed sufficient during featurization then may flow into the input layers of the next model in the featurization hierarchy, and based on evaluations, no additional input may be needed regarding the particular input. However, if the encoded data output of the prompt generation system is insufficient, another source may be queried to attempt to satisfy the deficiency with additional data. This source may include one or more experts, a database, a LLM, electronic medical records system, and so on, depending on the nature of the deficiency, cost-effectiveness of the additional source and other considerations.

In the example embodiment, users/editors may predetermine which sources to use as other sources in advance, or this may be determined by an algorithm approved by the users/editors. In the example embodiment, source identification, instruction, and so forth may be performed using various methods, including the use of a prompt generation system, or analysis/simulation function.

In the example embodiment, the additional information from another source, once received by the AI platform, may be subject to the same featurization process, to see if the deficiency that spawned a need for the other source is now resolved. This may be an iterative process with the number of iterations limited by the editors.

Communications Featurization System: query editor/user.

In the example embodiment, editors/users may or may not wish, or otherwise be permitted based on authorizations, to be a part of every iteration. In the example embodiment, the system may reduce uncertainty in a manner that may minimally involve editors. However, certain featurizers, which as a model may require some supervision while being developed, may require editor input to collaboratively develop a model that meets their purposes for it. Similarly, during runtime, some information may need to be supplied for certain sufficiencies to be met during featurization, ideally from automated orchestrations.

The term “editor/user” may refer to editors being users, and vice versa. Further, the term may reflect the nature of collaborative learning loops in the example embodiment, where users may continuously impact, or edit, what the system may know as a result of interactions.

See also activity information FIG. 34, which may be available to users. The activity information based on predicate completions, logical evaluations, and other evaluations of the data during the featurization process may be available to assist editors/users with tracking and managing information in the featurization system, and to support various decisions the editors/users may make as to how to focus their energies.

Communications Featurization System: Flowing outputs meeting sufficiency into input layers of the featurization neural net.

As shown after the question in FIGS. 16-19, “sufficiently logical and complete?” when information is determined to be sufficiently complete and logical, corresponding output tensors of the prompt generation system may flow into input layers of the featurization neural net configured for feature generation. So as not to impede other featurizations, at times when the input information is insufficient, a copy of the input stream may be analyzed and then when information is sufficient it may be mapped to the appropriate point in the original input flow.

FIG. 16 is a flow diagram showing collaborative use of a story-based ontology featurizer as part of a communications featurization system, in accordance with various embodiments of the invention. See descriptions in the diagram.

FIG. 17 is a flow diagram showing collaborative use of a validated instrument featurizer, in accordance with various embodiments of the invention. See descriptions in the diagram.

FIG. 18 is a flow diagram showing collaborative use of a use case featurizer, in accordance with various embodiments of the invention. See descriptions in the diagram.

FIG. 19 is a flow diagram showing collaborative use of a specific user featurizer, in accordance with various embodiments of the invention. See descriptions in the diagram.

FIG. 20 is a diagram showing a communications featurization system in accordance with various embodiments of the invention. See descriptions in the diagram.

FIG. 21 is a diagram showing a communications featurization system with embedded models and analysis in accordance with various embodiments of the invention. See descriptions in the diagram.

### Predicate Representation of the Ontology

FIG. 22A is a diagram showing a method of encoding of predicates with an ontology in accordance with various embodiments of the invention.

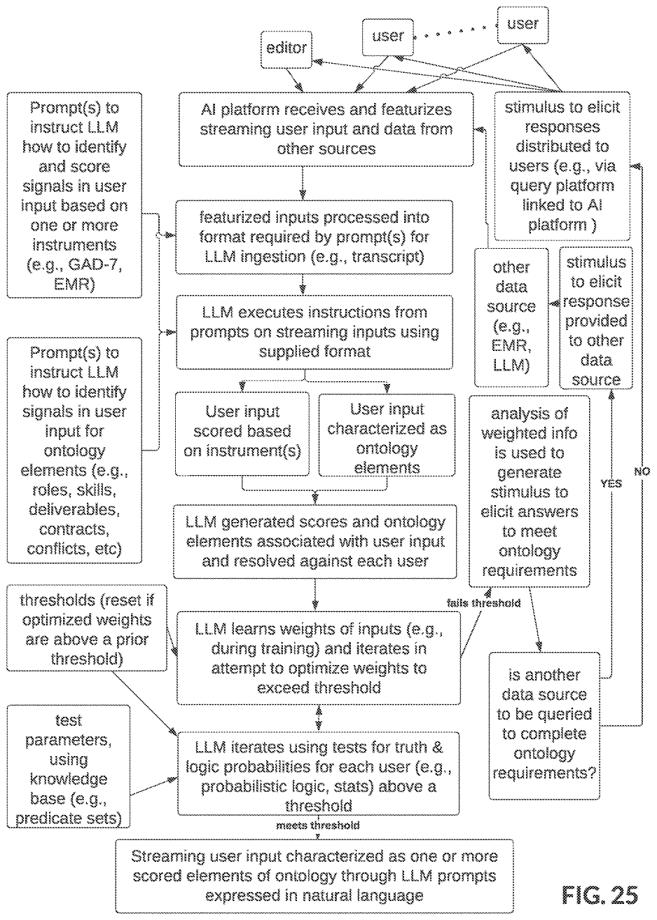

In the example embodiment, encoding predicates with an ontology may refer to the use of predicates to represent an ontology. This encoding may be performed various ways in the example embodiment. For example, generating predicates to represent the story-based ontology may involve a process as outlined in FIG. 28, wherein outputs of a LLM prompted to pair inputs with ontology information, based on prompts, then may be transformed into predicates, for sufficiency and other tests. As another example, in FIG. 25, a prompt may instruct a LLM how to identify signals in user input for story-based ontology elements, the output of which may also be transformed into probabilistic predicates for logical and other tests. Another example is provided in FIG. 22A, wherein the rules and conditions for a probabilistic programming language (e.g., Problog) may be shaped by the rules and conditions for an ontology. In the example embodiment, establishing rules and conditions for an ontology may be developed various ways. For example, various questions regarding the formulation of an ontology may be posed and collaboratively refined (See FIG. 33 description related to collaboratively developing a glossary for an ontology, using predicates). As shown in FIG. 22A, these questions may include: are the relationships between classes in a hierarchy of classes logical? Do all classes in the ontology have the same structure? Do the attributes in the ontology have an uncertainty component? And so on. Answers to various questions in turn may be used to standardize rules used by a probabilistic programming language to generate predicates representative of the ontology. For example, predicates may be developed to reflect a class hierarchy with a consistent class structure having attributes including value and uncertainty components.

Once established, the rules and conditions for probabilistic programming language and probabilistic predicates based on an ontology (e.g., the story based ontology) may now be applied to featurized inputs and further evaluated, based on outputs, to make further adjustments, as shown in FIG. 22A.

To turn now to the collaborative adjustments in the rules and conditions, this process may begin as illustrated with inputs from editors (during “development”) and/or users, wherein the input is subject to various transformations and evaluations. In the example embodiment, streaming inputs may be broken down into segments, and featurized, as dataslices. In turn, these featurizations of dataslices may be used to generate probabilistic predicates. In the example embodiment, probabilistic predicates generated from inputs may be encoded with an ontology.

Next, in FIG. 22A, generated predicates may be evaluated based on various factors. These factors may include, but may not be limited to, attempted completion of the predicate structure and sufficiently logical proofs using probabilistic predicates and a probabilistic programming language. Additionally, ontology information extracted from featurized inputs may be evaluated by various methods, which also may involve predicates. Do the predicate sets, based on rules of the ontology, reflect the dependencies in the ontology? See questions in FIG. 22A under “evaluation of predicates encoded with an ontology.”

Evaluations of predicates may result in updated predicates and/or refinements in rules associated with how a probabilistic programming language may perform.

As shown in FIG. 22A, probabilistic predicates may be compared to thresholds to determine if new information may be needed to attempt to meet thresholds. Various approved sources may be tapped to provide the additional information, including editors/users. As shown, who gets what elicitation for what information may be determined. Recall, a communication to another source or to users/editors generated by the system may be based on a best next action step recommendation.

As shown in FIG. 22A, approved/resolved probabilistic predicates may be stored and used to help propagate the ontology through their use in the example embodiment.

FIG. 22B is a flow diagram showing encoding of featurized inputs with a story-based ontology in accordance with various embodiments of the invention.

In FIG. 22B, editor or user input is received by the AI platform and then featurized. Predicate sets may be extracted from the featurizations and evaluated for completeness (Do they have heads and bodies?). This evaluation may involve searches of the knowledge base and various attempts to complete predicate sets using inference. Additionally, the predicates may be associated with the story-based ontology, and it may be determined if the relationships between predicate sets associated with the story-based ontology are sufficient to resolve dependencies between predicates associated with the story-based ontology. Thresholds may be set for sufficiencies and compared with probabilities associated with predicates. During evaluations, extracted predicate sets may be compared to predicates encoded with a story-based ontology and new predicates generated from inference. In the example embodiment, predicates may be encoded with a story-based ontology and stored in a knowledge base and/or a knowledge graph. In the example embodiment, to complete predicates, another source maybe be queried, as shown. The querying of another source may involve the generation of a communications, or stimulus, for another source. As also shown, editors or users may be queried for responses to provide missing information.

The loop shown in FIG. 22B between editor/user input, attempted resolution of predicates and story-based ontology information, queries and then responses to queries, which may be new input, may repeat. The number of iterations may be limited by editors. In the example embodiment, editors may have access to activity information involving their inputs and the inputs of others they are permissioned to see. In the example embodiment, editors/users may approve completed predicates and predicate sets for implementation, or permit an algorithm approved by the editors to implement completed predicates and predicate sets.

As shown in FIG. 22B, completed predicate sets satisfying story-based ontology requirements may be associated with specific information in user input data. In the example embodiment, a natural language characterization of each user may be generated in terms of the story-based ontology.

FIG. 22C is a flow diagram showing collaborative development of a prompt in accordance with various embodiments of the invention.

In FIG. 22C, editor input for a prompt in development may be received, stored, tagged and featurized. Predicates and story-based ontology information may be extracted from the input and evaluated. In the example embodiment, evaluations of extracted input pertaining to a prompt in development may include determining if information extracted from the prompt in development is sufficiently similar to predicate sets and story-based ontology information in the current knowledge base and or tagged to a knowledge graph. Inference may be used in probabilistic programming (e.g., via Problog) to generate new predicates based on current predicates. If information is still insufficient to meet thresholds, other sources may be queried for information, which may include, for example, a large language model, EMR system, another expert, a site to which others may be invited, and so forth. If new information is provided from another source, it may be evaluated against a threshold, and added to a store. Meanwhile, information for the prompt in development may be updated and the new information may be stored.

Next, as shown in FIG. 22C, the prompt in development may be updated with any new information. This updating may entail transforming predicates associated with the update and predicates associated with the initial prompt into natural language. It is understood that a LLM may be instructed by a natural language prompt.

Once updated, the prompt in development may instruct a LLM to perform tasks on one or more hold-out data sets (e.g., comprising a use case on which a prompt and a LLM may be fine-tuned). The LLM then may generate outputs accordingly. Outputs of the LLM, based on the prompt in development, may include test data results and the updated prompt, for further evaluation. Reports (activity information) may be available to editors, and a natural language query or multi-modal communications generated to assist the editors in completing the prompt in development, if results are not satisfactory (e.g., above a threshold determined by the editors/users). In the example embodiment, queries or communications to editors may be based on which editors, topics, questions, question sequence, data source, and other information regarding the state of the prompt in development is likeliest to result in completing the most effective prompt most efficiently. For example, responses to complete a prompt in development may be optimized using randomized question order, strictly followed ordered importance of questions at each stage of prompt development, etc. So, whether every editor receives the same questions to complete a prompt, or different questions, may be determined based on optimizations.

As indicated in FIG. 22C by the arrow leading from LLM output to the prompt in development, the collaborative process of developing a prompt may be iterative. In the example embodiment, new inputs from editors/users may trigger a repeat of the collaborative process until a prompt is approved.

Once approved, a prompt may be stored for later use, and future refinement, as necessary.

### LLM Prompts, the Ontology, and Scoring

FIG. 23 illustrates example elements of a prompt for instructing a LLM how to score a live conversation in accordance with various embodiments of the invention,

In the example embodiment, a prompt for a LLM may be styled various ways, and contain various types of information for various purposes. In a preferred embodiment, a prompt may be structured as an instance of the story-based ontology, where the information contained in the prompt maps to the class hierarchy (i.e., Identity class, Role class, Deliverable class, Task class, Skill class, etc.). Specific instances of the story-based ontology that the prompt may represent may vary based on the purpose of the prompt, knowledge domain and various other information used to instantiate it. Note, when a prompt is said to be “instantiated,” it may mean that a prompt is generated as an instance of the story-based ontology. FIG. 23 is meant to illustrate how a prompt based on the story-based ontology may be used to render scores.

In the example embodiment, mapping information in a prompt to the class hierarchy may help ensure that the instructions in the prompt represent a system-wide use of the story-based ontology as structured knowledge, even if LLMs typically may not require any structured knowledge representations as inputs. In the example embodiment, inputs into a prompt and the outputs of the LLM based on the prompt instructions may both be tagged to the same universal basis for reasoning in the system, the story-based ontology.

In the example embodiment, recognized instruments to score states of mind, opinions and so forth, in various domains, may be transformed into an instance of the story-based ontology, using instrument information and other expertise related to the domain of use for the instantiation. In the example embodiment, a prompt may be structured as an instance of such an instrument. For example, as will be described, a recognized health instrument, such as a GAD-7 used to screen for anxiety and evaluate levels of detected anxiety, may be transformed into a story-based ontology instance using, in part, requirements of the GAD-7 instrument and other expertise surrounding its administration. Recall from FIG. 3 in the example embodiment, the story-based ontology may apply to things as well as people. A prompt may be a thing, so may a GAD-7 instrument. In the example embodiment, the story-based ontology may be used by prompts to render scores in various ways.

For example, an assessment instrument (e.g., GAD-7) used to assess a condition of something or someone may be styled as a prompt with a simple identity (e.g., wherein the prompt's identity may be “GAD-7”, and include a role as a prompt and a role as the anxiety assessor). As another example, an assessment instrument may be styled as an expert (e.g., an identity comprising a prompt role and a clinical expert role, for example, “nurse,” with skills at detecting signals in communication to diagnose a condition and its severity). As yet another example, an assessment instrument may be styled as an expert with powers to also apply the skills normally associated with the instrument in a blended fashion (eq., by using the identity class to associate as one entity a prompt role, instrument role—“GAD-7”—and clinician role—“Nurse”). To continue with examples, in the example embodiment, one prompt may be styled as an instrument, and another prompt may be styled as a clinician that uses the instrument (e.g., creating a Contract between a clinician prompt and an instrument prompt) as may be appropriate in a systematic generation and integration of prompts (e.g., via a prompt generation system).

Turning now to FIG. 23, let's say the situation involving the illustrated prompt elements may be a phone call between two speakers wherein each speaker may be represented in the story-based ontology as an Identity (e.g., “Tom” and “Alice”). As to an example of a prompt, let's say the prompt in this illustration may be styled as an expert with powers to score the conversation for anxiety by applying the skills normally associated with an assessment instrument in a blended fashion involving an instrument role and a clinician role. As shown in FIG. 23, elements of a prompt for a LLM may be based on the story-based ontology. For example, the prompt in the illustration may, among other things, i) describe a situation in terms of Contracts between identities (e.g., speakers “Tom” and “Alice” with respective roles “caregiver” and “nurse”) and ii) assign an identity to the LLM (e.g., “LLM”), wherein the LLM identity may have a Contract with these other identities (e.g., “Tom” and “Alice”). To continue to link the elements to the story-based ontology, the situation may involve one identity's role as a caregiver, or subject (e.g., Tom, caregiver), and another identity's role as a nurse (e.g., Alice, nurse), wherein each role may be mapped to its respective speaker identity (e.g., “Tom” and “Alice”, respectively). In the example embodiment, the identities may be determined from a transcript involving speakers with known or ascribed or deidentified identities. To continue briefly with the illustrated situation in FIG. 23, the Contracts between the nurse role and the caregiver role may involve a phone or online interview, for example, wherein the give and get between speakers may involve a use case related to the subject's anxiety. As for the LLM, the LLM may have a system-assigned or user-assigned identity (e.g., “LLM” or “GAD-7”, named after an anxiety assessment instrument, or say, “RN Jane”) with an assigned role (e.g., “You're a clinician,”) involving skills (e.g., “ . . . knowledgeable about anxiety assessments”), tasks (e.g., asking anxiety evaluation questions), deliverables (e.g., scored answers), and requirements (e.g., how to tabulate the scores) for the LLM to apply to the give and gets (Contract deliverables) between the speakers (Tom” and “Alice” in their respective roles as nurse and subject). As indicated in the illustrated prompt, other aspects of the Instance” are described as well.

Note, in FIG. 23, the prompt “addresses” the LLM as if the LLM is a person with a particular role. Recall, entities in the story-based ontology may include things (e.g., LLMs, GAD-7, etc.) and be treated andromorphically, as if human in their behaviors. Note also the linkage between sections of the illustration to various classes in the class hierarchy (e.g., roles, deliverables, tasks, Contract, etc.).

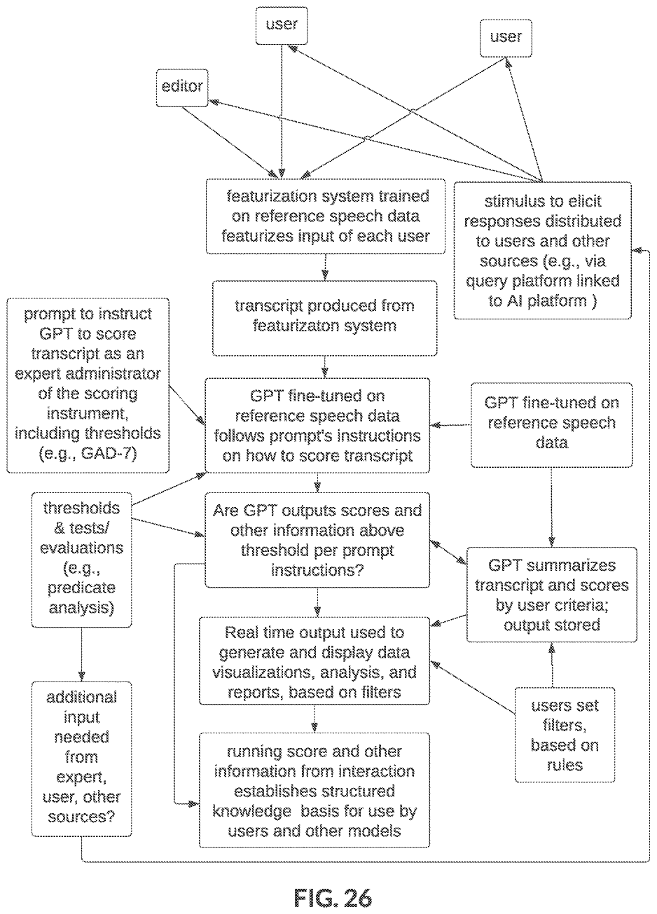

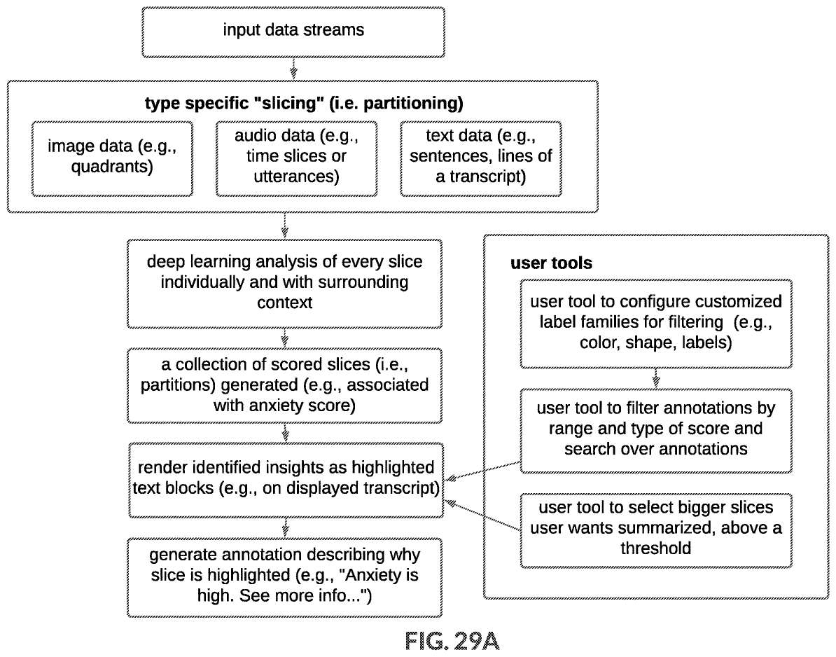

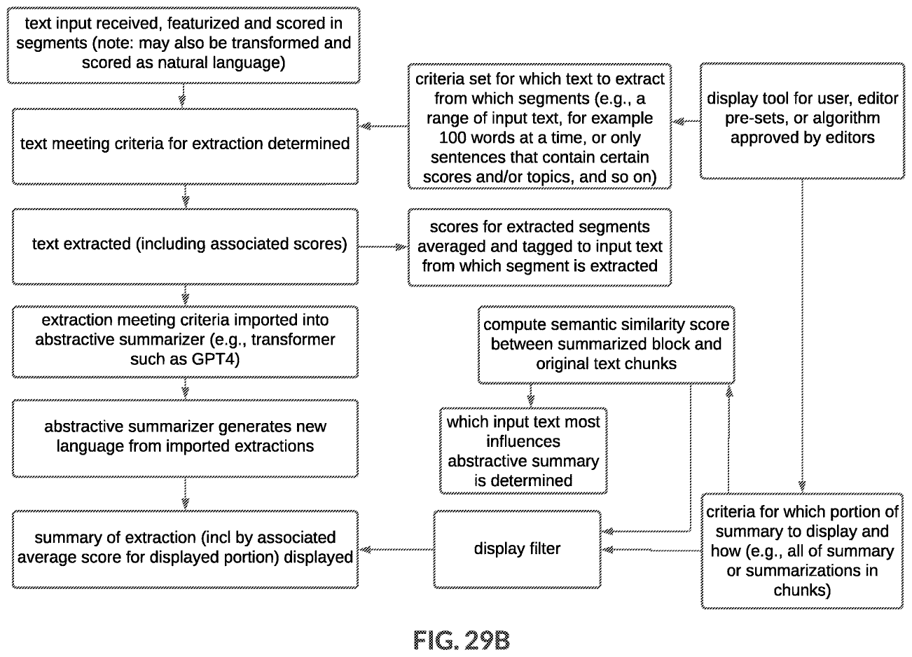

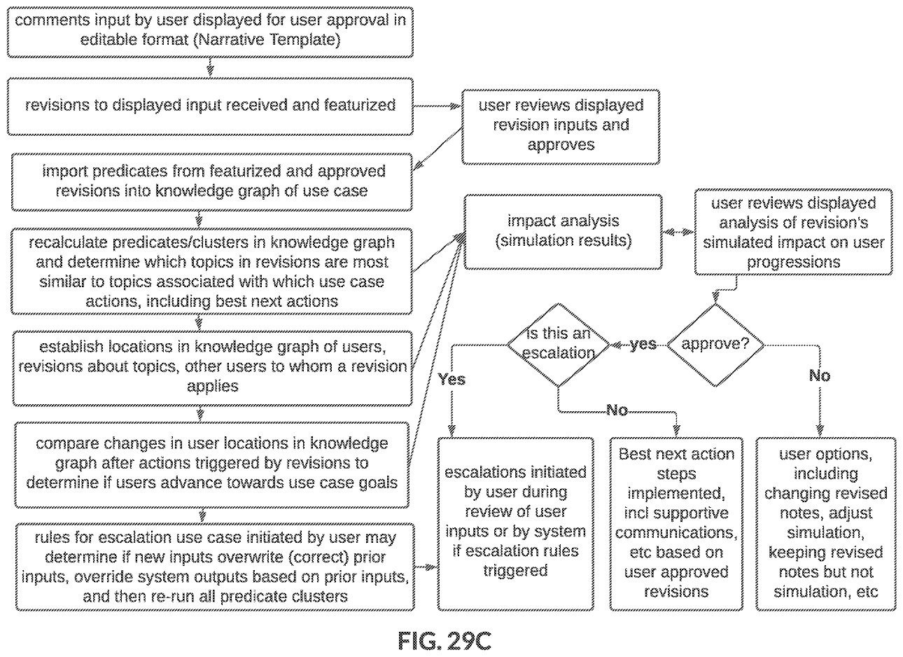

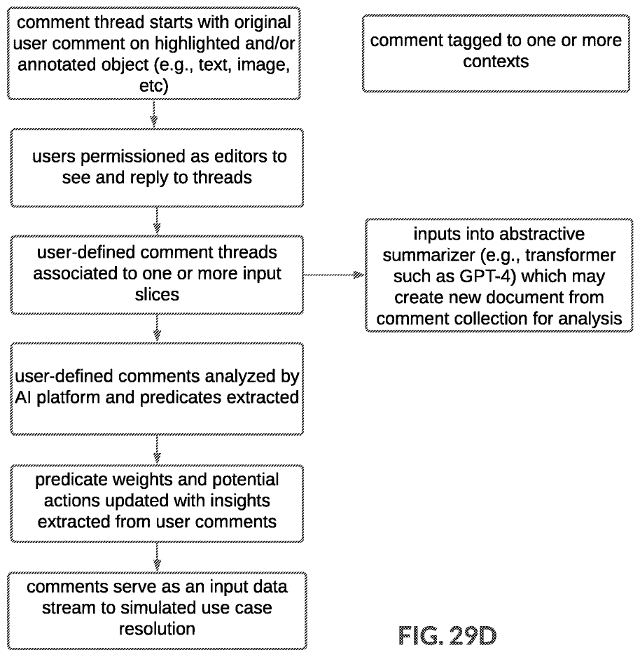

Now, returning briefly to the Contracts involved in the illustrated prompt and how they link to each other, recall that the input in the illustration may involve data from a conversation between speakers formatted as a transcript. Part of the LLM's Contract with, say, the subject, may involve “scoring” what the subject “gives” (e.g., the content of the subject's conversational turn in the transcript), and in return “gets” from the LLM a score, based on a scoring rubric that the LLM uses (See also FIG. 24). The score may be shown as an annotation for each line on the transcript involving the subject's words, for example, “Tom: Wish I'd thought of that before! 13”, where a GAD-7 score determined for the line may be calculated then normalized and shown on a 0-21 point scale (e.g., “13”) by the LLM (e.g., RN Jane). To continue briefly with the illustration, the speaker whose Identity, say, is “Tom”, may see the transcript and score and say, “I don't agree that I was anxious when I said that, Alice”; meanwhile, Alice, as the other speaker in the illustrated example, with a clinical role, may receive the transcript and score may say, “Tell me more about that, Tom”. Feedback may be used to continually improve the LLM scoring while also assisting user interaction. For more information on filters and other tools to facilitate informed interactions, see FIG. 26, FIG. 29A, FIG. 29B, FIG. 29C, FIG. 29D, and FIG. 53 (on reciprocity scores), among others.

Let's now walk through an example of how the illustrated prompt in FIG. 23 may work into the flow of a live conversation to produce real-time scores for that live conversation in the example embodiment. In the example embodiment, a conversation may be received, say, between speakers Tom and Alice, tagged to them, then featurized by a featurization system comprising automated speech recognition functionality, text based natural language processing functionality, video processing functionality (some conversations may involve video calls or conferences), and audio signal processing functionality. The output of the featurization may be text, which may be formatted as a transcript—to separate speakers (e.g., “Tom” and “Alice”) by turn in the conversational input. Next, a prompt, as illustrated in FIG. 23, may direct a LLM to act as an expert (e.g., “You're a clinician . . . ”), to instruct the LLM how to evaluate the transcript, which it provides to the instructed LLM. The LLM then may open a chat session (e.g., via the chat-tuned gpt 3.5-turbo model) and run through each of the instrument questions or statements for each line of text transcribed from a conversation. Rather than asking the caller any question directly, the LLM, which is instructed to do as the prompt may require, instead may ask the LLM model to rate each of the descriptions/questions adapted from the instrument to evaluate a speaker's inputs (e.g. “the caller feels nervous, anxious or on edge”), line by line, on a scale (e.g., “not likely” to “certain”). It may assign a score (e.g., 0 for “not likely”, 1 to “somewhat likely”, 2 to “very likely” and 3 to “certain”) and then return the sum of scores across the ratable questions or statements in the instrument. Again, see FIG. 24 for more detail on scoring rubrics for various instruments. Scoring may include the use of Bayes.

In the example embodiment, the scoring of formatted input by a LLM based on prompted instructions and the confidence in the scoring may be determined by various methods. (See FIG. 24).

As described, a simulation of an instrument may be performed by a LLM, based on the LLM prompt, in real time. In the example embodiment, an instrument administration may be conducted without a human user, or subject, ever being asked to respond to any of the specific questions or statements that appear on the instrument. The instrument's assessment score may be rendered automatically in real time by the example embodiment during any live conversation.

As FIG. 23 illustrates, even an instrument for scoring a state of mind or health condition itself may be described as an instance of the story-based ontology. Note, also, the manner of composing the prompt as if the prompt is a directive, or imperative, for a person to follow. In FIG. 23, the illustrated prompt “charges” the LLM with tasks, deliverables, and so forth based on the story-based ontology. In various embodiments, a prompt may be generated (e.g., via prompt generation system) and styled as a best next action step, an imperative, where the recipient of the prompt may be a LLM, a system user. Recall, human users may receive a BNAS as either single modal or multimodal communications from the system, too, based on system updates and analysis. (Thus, in the example embodiment, both system and human users may receive a BNAS, in one form or another.)

In the example embodiment, a prompt may be structured as a story-based ontology instance automatically by the system (e.g., via a prompt generation system) or, if users prefer, through manual inputs into a prompt template (e.g., which also may be an optional feature of a prompt generation system), or some combination thereof.

In the example embodiment, a prompt based on a story-based ontology may be subject to sufficiency evaluations and attempts to resolve dependencies within and between classes in the class hierarchy. Resolving these dependencies in story-based ontology, where prompts themselves may be instances, may involve Contract resolutions with other identities in the class hierarchy, and in turn lead to the generation of new prompts representing new identities also based on the same story-based ontology. Recall new Contracts with new identities may be required to resolve certain conflicts and/or satisfy dyadic role relationships. For example, a prompt “instantiated” as a clinician may have a Contract with a prompt “instantiated” as a patient. In this manner, basing prompts on the story-based ontology in the example embodiment may act as a mechanism for organizing prompts, generating prompts, and exchanging information between prompts. In the example embodiment, a prompt generation system may work to resolve dependencies between prompts based on the story-based ontology, and may generate new prompts to meet sufficiency-related thresholds within and between prompts. Such prompt generation may include updating and analysis of story-based ontology instances, and create, in effect, an intelligent agent subsystem representative of each user's current and future state. Recall from FIG. 12, a prompt generation system may seek to resolve various dependencies within and between classes in the class hierarchy and also between predicates based on fulfilled predicate forms and arguments; attempts to resolve these dependencies may involve generating multiple BNASs for the system (e.g., what does a prompt styled as a clinician need next and foremost from a prompt styled as a patient?) in order to determine and communicate a BNAS for a human user (e.g., a user who is a patient). In the example embodiment, the system may attempt to resolve these dependencies within and between prompts with information from users or editors based on importance as well as from other knowledge sources (e.g., a knowledge graph and/or knowledge base). Thus, prompts and users in the example embodiment may have a dependency on each other, wherein resolution of their dependencies may help align the BNASs generated by the system for system use and the BNAS generated for human users.

In the example embodiment, any survey, validated instrument or stimulus used to elicit a human user response for the purposes of collecting, assessing, scoring, summarizing, and ultimately establishing an evidentiary basis for an expert determination of the user's real time condition, state of mind, illness, opinion, competency, skill, aptitude, propensities, interest level or some other measurable quality of the user's status may be automated,

Using the example embodiment, an automated GAD-7 evaluation of a patient user's words may be used to support the decisions of a human clinical expert related to a diagnosis or plan of care for a diagnosed human patient with anxiety.

The domains of a preferred embodiment may include professional service categories where experts may need to pass a test for a license to practice a set of skills, which in turn may be tested periodically to maintain or renew a license. These professions tend to audit a professional's fidelity to an industry standard or best practice. Additionally, professionals tend to evaluate the needs of a client, what the client knows, client's satisfaction, and so forth using various measures that may involve the client responses to surveys and other tools for collecting client responses. For example, a person in a clinical role may be required to have an advanced degree and an appropriate license to diagnose and treat anxiety. In this case, an automated GAD-7 evaluation of a patient user's words as described in the example embodiment may be used to support the diagnostic and treatment decisions of the human clinical expert.

In the example embodiment, a prompt based on a story-based ontology may instruct a deep learning model (e.g., a large language model) how to perform specific expert tasks on formatted user inputs. The format may be, as described, a transcript, or another format on which expert evaluations may be based. For example, formats used by experts to elicit user responses for expert analysis may involve video and/or musical stimuli. The expert tasks that the prompt describes for the model to execute may include using the language and scoring system of a validated instrument in the expert's given domain to conduct an expert analysis of user inputs. The analysis may include scores and sums of scores as would be tabulated by a human user, preferably one with expertise in the given domain.

As shown above, in the example embodiment, a prompt may be “instantiated” with an identity, Contract, role, task, skill, deliverable and requirements. A population of instantiated prompts may be produced using the example embodiment (e.g., via the prompt generation system, see FIG. 12). The population of instantiated prompts (e.g., a clinician trained to score anxiety from a user's input) may be federated to instruct one or more intelligent agents to perform tasks associated with a particular set of roles, skills and deliverables (e.g., a behavioral health specialist).

What a clinician may do to measure anxiety may be instantiated into a prompt, to instruct a downstream model to perform an anxiety analysis, as per the GAD-7 use case described above. Likewise, what a clinician may do to treat measured anxiety, given user inputs, also may be instantiated into a prompt, to instruct a downstream model to perform treatment tasks for a measured anxiety. In this manner, two instantiated prompts may be created, for example, one to detect the anxiety, the other to treat it. Editors/users may develop as many instantiated prompts as there may be aspects of a role or roles that editors may determine are important for downstream models to perform. As a result, “instantiated” prompts may be federated around roles for downstream models to execute.

In the example embodiment, prompts for different roles may be instantiated. For example, in addition to prompts instantiated with clinical information as described above, prompts may be instantiated with insurance specialist information, and for such other roles as may be involved in a use case to address situations as they may arise or be predicted from user inputs. To continue with the current illustration, the use case may be to reimburse a clinician who assesses and treats anxiety determined to be medically necessary after a review of the measures for anxiety determined by the clinician.

FIG. 24 is a flow diagram showing how LLMs may be prompted to score input in accordance with various embodiments of the invention. In the example embodiment, a prompt may pose one or more questions to a LLM regarding input text, provide the LLM with a scale to use for its answer to the one or more questions, and instruct the LLM to total the scores for all questions. In the example embodiment, a LLM may be prompted to score input based on natural language questions or statements in an instrument (e.g., validated health survey) used to score responses and/or to generate a confidence score in its own answer to questions or statements.

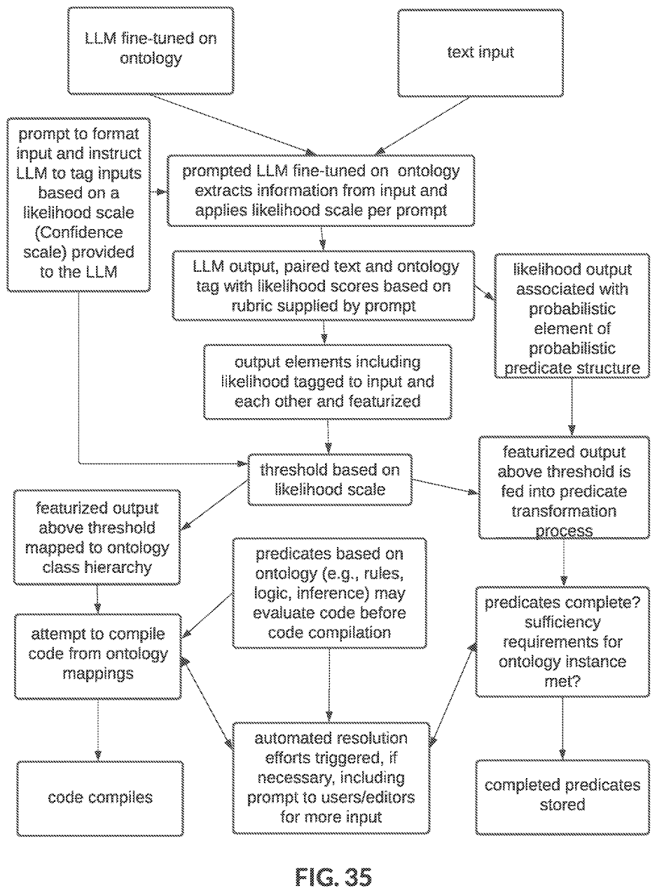

First, let's look at confidence scoring by a LLM, which pertains to both FIG. 24 and FIG. 35, before turning to LLM scoring based on questions in an instrument (e.g., GAD-7 anxiety assessment). In the example embodiment, a confidence score may be generated by the LLM on a scale that may be consistently applied by a LLM across questions, and instruments that use questions, so as to establish over time, as a LLM “learns,” an increasingly reliable confidence score. For example, a LLM prompted to evaluate signals in input text for anxiety based on natural language questions in an instrument to assess anxiety may be prompted to score the confidence that the LLM may have in its own answers on a scale. In FIG. 24 and FIG. 35, this scale is styled in the description as a “likelihood scale”, because it deals with the LLM's assessment of probability. In the example embodiment, a “likelihood scale” may be as fine-grained or as broad for a confidence rating by a LLM as may be determined by editors. For example, a “likelihood scale” could have 4 points of value (e.g., not confident=25%, somewhat confident=50%, very confident=75%, certain=100%), or be binary, or include many more levels, depending on various factors (e.g., extent of LLM fine-tuning, quality and volume of input data, etc). In the example embodiment, a confidence score may be generated for each question answered and scored by a prompted LLM. For example, a prompted LLM may determine from signals in input text that an anxiety score for one question may be high (e.g., a score of 3 on a scale of 0 to 3 for a GAD-7 anxiety question is high), while the LLM's confidence in the answer (score) may be reported as, say, 50%. In the example embodiment, a threshold may be set by a prompt for a LLM-generated confidence score (e.g., confidence equals or exceeds 75%).

In the example embodiment, the confidence score generated by a LLM in its own answers may be used in setting an initial probability component of a probabilistic predicate based on the text evaluate by the LLM. In the example embodiment, a LLM may evaluate streaming text in segments, or dataslices. In the example embodiment, a LLM generated confidence score may be associated with evaluated dataslices, corresponding predicates, instrument scores and prompt language. In the example embodiment, a prompt may be transformed into predicates for evaluation, or, conversely a prompt may be generated as natural language from predicates, establishing by either method a featurized basis for comparing a natural language prompt for a LLM and the LLM's confidence scores.

In the example embodiment, Bayes theorem may be used for likelihood scoring based on priors and new input; Bayes theorem may also be used ratchet thresholds and update probabilities.

Turning next in FIG. 24 to instruments themselves (shown on the left in the figure), it should be noted that if the questions or statements that a LLM is prompted to respond to, regarding the input, are based on a validated survey or health assessment instrument, the scale associated with that validated instrument should be used. For example, a GAD-7, a tool to assist physicians in diagnosing and managing anxiety levels, has 7 questions, each with a possible score of 0 to 3, so four potential values (i.e., 0, 1, 2, 3). Thus, a GAD-7 total score may range from 0 to 21, where 21 may indicate severe anxiety and 0 may indicate no anxiety. So, a prompt based on a GAD-7 instrument questions or statements may establish for the LLM a scoring rubric based on the GAD-7 scoring system. Additionally, a score may be used to determine a classification and a level associated with the classification. For example, a classification of anxiety, based on a GAD-7 total score, may tend to be a score above 13. In the example embodiment, a subject matter expert may determine what score or scores rise to the level of a classification. In the example embodiment, as described above, in addition to generating scores based on an instrument that uses scores (e.g., GAD-7), a LLM may generate a confidence rating for this instrument score based on a “likelihood scale” or confidence.

In the example embodiment, any scoring instrument that uses natural language questions and a scoring method may be used to prompt a LLM for scored answers based on input text and a scoring rubric (method of scoring).

FIG. 25 is a diagram showing how a LLM may classify and score inputs and associate these scored inputs with a story-based ontology in accordance with various embodiments of the invention. See descriptions in the diagram for more detail.

In FIG. 25, input may be received from one or more users after users have received guidance from the system based on the system's evaluations of prior LLM output. As shown in FIG. 25, a prompt may condition a LLM to act as an instrument for scoring user input and another prompt may condition a LLM to identify story-based ontology information from this same user input. Note, prompts in the example embodiment may be developed various ways. For example, in one embodiment, prompt may be generated automatically via a prompt generation system (FIG. 12); in another embodiment, prompts may be developed directly by editors as a project with the support of the system (FIG. 22C).

In the example embodiment, a LLM may be prompted to act as one or more instruments to detect and score a user state. (See FIG. 24.) These instruments may be health assessment instruments, or other instruments based on statistical power. Users may edit and evaluate these LLM evaluations collaboratively, and seek to improve the confidence that the system and its users have in the results. The system may associate scores with a story-based ontology based on an analysis of user input. Inputs may be stored in raw form and also be featurized, which in turn may be saved. These stores may facilitate transformations between featurized and non-featurized inputs as described in FIG. 54. As shown in FIG. 25, prompts for scoring inputs based on validated instruments and prompts for extracting story-based ontology information from inputs may instruct a LLM to perform these tasks. Inputs into the LLM also may include formatted, natural language transformations of featurized inputs from users and other sources.

The output of a LLM in FIG. 25, based on prompts, may include scores and story-based ontology information from tasks performed on inputs, which may be associated with each other. The output may be evaluated based on thresholds, for example, using predicates (e.g., via transformations of natural language output of LLMs into featurizations from which predicates may be generated and used in probabilistic programming). Scores and story-based ontology information may be combined into natural language or other communications for editor review (See also FIG. 34 for activity information available to users/editors). In the example embodiment, the communication may combine various transformations of the input data. For example, a natural language output combining scores and a story-based ontology for review may be, “a mother is anxiety about rent,” Reasoning based on story-based ontology information in knowledge stores and user data may add further richness to the communication, “a mother without a job is anxious about rent”. Such additional information may be used to generate a support guidance to the user (e.g., a best next step) and/or to provide the user with more context for their next input.

Iterations of the LLM-based hybrid classifier for scoring based on an instrument and encoding based on a story-based ontology may continue until approved by users/editors or by algorithms approved by editors.

FIG. 26 is a flow diagram showing a collaborative process for scoring and evaluating anxiety using a fine-tuned LLM in accordance with various embodiments of the invention. It is understood that, during the flow described in FIG. 26, any necessary data transformations involving LLMs and non-LLM models and programs (e.g., probabilistic programming languages and/or graphs that may be based on featurized data) may be performed, It is also understood that, in some embodiments, a featurization system may perform various extractions and classifications, depending on its architecture (See FIGS. 16-21). It is further understood that, in some embodiments, a prompt may be developed collaboratively (See FIG. 22C) and/or via a prompt generation system (See FIG. 12). FIG. 26 is not meant to demonstrate all possible permutations, but to show an example embodiment wherein users collaborate to understand, assess and use scores for states of mind and/or various health conditions based on conversations as part of a decision-making process (e.g., diagnosis process or treatment plan). As shown in FIG. 26, the scoring in an example embodiment may be based on a novel use of prompts to instruct a LLM how to score a conversation. See FIG. 23 and FIG. 24. In one scenario, this scoring may be done by the LLM without the LLM having to ask any questions directly of any speaker to generate its output. In another scenario, the LLM may generate queries or suggestions for the users, who may include professionals accustomed to working with peers to understand a situation and a course of action. Scoring and evaluating scores, including commenting on the scores and/or on the extracted information related to the scores, may facilitate various professional collaborations. For example, they may facilitate patient evaluations and management sessions, which may involve collegial sharing of information between clinicians and also subjects in the course of deciding options. (Note, in the example embodiment, scores may be used widely to establish evidence of a state of mind not always related to healthcare).

### Streaming Speech Inputs

As shown in FIG. 26, streaming speech input may be received in real time from various users during a conversation. In the example embodiment, streaming speech may be received by the AI platform through a phone line or through another connection to the system. The received data may be received in segments, timestamped, and stored as original input with tags to input device, speakers and timestamp. The received audio segments may be saved in various forms, for example, as WAV files (Waveform Audiofile format), that may be saved and concatenated later to recreate the original audio input in whatever order of segment may be determined (e.g., by speaker, by chronology, or by some other criteria). Next, the stored raw input segments may be featurized by a communications featurization system, which may involve a multi-factor deep learning neural net. During featurization, various features of the input data may be identified and extracted (see FIG. 38) by a neural net trained to detect certain patterns in the input data. In the example embodiment, various data used to train a featurization system to detect patterns may include, but may not be limited to, reference speech data, examples of a story-based ontology class hierarchy, use cases, and data related to a specific group of users (see FIGS. 16-21).

Examples of how trained featurizers may affect transcript in FIG. 26.

As a result of training, features detected during featurization may relate to classes and their attributes in a class hierarchy that a featurization system may be trained to detect. Likewise, features detected during featurization may relate to reference speech data, use case information, and information related to a specific group of users that a featurization system may be trained to detect. For example, a featurization system trained on various datasets involving various domains may extract from the audio input, “I'm calling about my morn, Ellie, a patient of Dr Wuan's”, that the caller (a role for the first Identity) is a son (e.g., a second role for the first Identity), a caregiver (e.g., a third role for the first Identity), has anxiety (e.g., a name property attribute value for a health condition belonging to the first Identity) about his morn (e.g., a role for a second Identity with whom the first Identity may have a Contract) whose name is Ellie (e.g., a name property attribute value for the second Identity), who also is a patient (e.g., another role for the second Identity mentioned) of a doctor (a role of a third Identity) named Wuan (a name property attribute value of the third identity). Additionally, it may know-from other data tagged to the call, such as log data, that the call comes from a phone connected to Ellie. It further may be learned that the person's voice associated with the inbound call number is different than the voice of this caller, which may suggest some urgency to the situation, as supported by a detection of anxiety in the voice of the caller. In the example embodiment, input data may be encoded with various information based on what the featurization system may be trained to detect during featurization, tagged to users (e.g., speakers), to the featurizations (e.g., tokens, audio frames, etc), and to associated representations of the input data, for example, predicates, SVOs, and story-based ontology information.

In the example embodiment, subject-verb-object (SVO) sets may be extracted during the featurization of inputs, and a confidence level in the extracted SVO may be generated. The confidence level may be tagged to the SVOs, and the tagged SVOs may be used to map to probabilistic predicates and/or to create such predicates in the example embodiment. Further, during featurization, classifications of various health conditions, states of mind, and so on based on trained classifiers may produce output that is simply transformed into SVOs and probabilistic predicates. Said probabilistic predicates may be an interim representation of the input data that may be used in reasoning processes. For example, probabilistic predicates may be used in probabilistic programming (e.g., Problog), to determine if the relationships between generated predicates is logical and likely. To return to the caller example for an illustration, there may be a certain likelihood, based on log data, that a call from a phone number stored in a database associated with a name in the database is made by the person named in the database. This may be represented in probabilistic predicates generated from log data. Meanwhile, predicates associated with story-based ontology information extracted during the call may be used to test and update various probabilities initially associated with log data. For example, during featurization, it may be learned that the words of the caller are likely those of a male, based on acoustic evaluations of the caller's voice, which may be transformed into probabilistic predicates; it may further be learned that the words of the caller are likely those of a son, based on the story-based ontology features, and further encoded as predicates, so that new probabilities may be generated that these are not the words of Ellie, even though the phone number of the caller may belong to Ellie. During reasoning in probabilistic programming, new predicates may be generated from existing ones. Thus, by associating SVOs and probabilistic predicates, new predicates generated from probabilistic logic functions may also facilitate the generation of new SVOs. (Note, on this topic of SVO-predicate transformation, in the example embodiment, SVOs may be extracted from natural language outputs, rather than from featurizations, where these natural language extractions then may be featurized and transformed into probabilistic predicates. This may apply when a LLM is prompted to generate output, which as natural language may include, based on instructions, natural language SVOs. Further, SVOs may be graphed and serve as the basis for analysis, using AI computational tools, which may also include probabilities). In the example embodiment, associated SVOs and probabilistic predicates may be further associated with extracted features related to the story-based ontology. Further, in the example embodiment, predicates and SVOs may be encoded with the story-based ontology, representing a richer level of reasoning, since probabilistic predicates also may be used to facilitate reasoning based on the story-based ontology. Further, since classifications may also be transformed into predicates, and therefore used in probabilistic logic programming, classifications may provide evidence to strengthen or weaken predictions. So, for example, in the illustration, the anxiety detected in the caller's voice may be used to predict the urgency of the situation. Further, the anxiety may be represented in the class hierarchy, so that there may be persistency and consistency of how various interim representations of the input may ultimately be processed for use in reasoning and to support decision making based on probability. In the example embodiment, rich, contextual reasoning may occur based on featurizations encoded with a story-based ontology and associated with probabilistic predicates.

Deidentification during featurization in FIG. 26.

In the example embodiment, personally identifiable information in the input may be identified during featurization various ways, including for example, by mapping inputs to various proper nouns, such as places and names. The information to be mapped to inputs may be available through a database, or store that may serve as training input, to detect personally identifiable information received as input, or to be used after featurization to match information generated from featurized inputs, such as a transcript. Once identified, the personally identifiable information may be extracted and replaced with other values or characters, which may be indexed back to the original source, if needed. For example, to return to the caller's input, calling about my mom, Ellie, a patient of Dr Man's″, the name “Ellie,” once identified as personally identifiable information, may be replaced with a value of, say, #87699, which may be indexed to a database/store of deidentified information (e.g., #87699 may refer to a patient whose actual name may be stored securely in yet another database of patient names with reference numbers). Various methods of deidentification may be used in the example embodiment. As another example, once “Ellie” is identified as a personally identifiable information, the name may be indexed to a standard representation for of a type of “word” being replaced, such as [NAME], or an even more generic representation, such as [REDACTED] or a blank space. Or, in the example embodiment, personally identifiable information detected during featurization (or afterwards) may be replaced by a set of terms based on the story-based ontology, for example, “caller's mom.” Recall, in various embodiments, features may be encoded with a story-based ontology information. And since the encodings may be tagged to the input, and looked up in a database, they may be used to reconstruct spoken output in a way that more richly retains the semantic information in the input.

In the example embodiment, values or characters used to replace personally identifiable information in input may be story-based ontology information extracted during featurization, or afterwards, for example, during the production of transcripts. Thus, referring again to the input example being featurized, the caller's statement, “I'm calling about my mom, Ellie, a patient of Dr Wuan's,” may be characterized and deidentified when produced as a transcript as, “I'm a son calling about my morn, a patient of the doctor.” Further, since anxiety may have been detected during the featurization, say, above a threshold, even more detail may be provided, “I'm a son calling anxiously about my morn, a patient of the doctor.” While these latter two examples may not be exactly what was said, neither would a redacted version, since in conversation people don't say, “redacted” or “name” or #87699. Nor would people necessarily know they may have some clinical level anxiety or even mention it. However, in the example embodiment, featurizations may be richly encoded with various layers of information that may add significantly to a natural language understanding of a situation. In the example embodiment, richly textured featurizations (e.g., involving story-based ontology, use cases, health condition classification and scores, and other information besides the exact words spoken) may facilitate the use of various filters to generate a natural language version of the featurized input.

In the example embodiment, a confidence value for featurizations may be generated based on the types of tasks and training data on which a featurization system may be trained,

### The Transcript Generated During Featurization in FIG. 26

In the example embodiment, the featurizations generated by a trained featurization system above a threshold for confidence may be transformed into a natural language representation, using filters to determine which featurizations to include or not (e.g., story-based ontology information, health scores) in the transformation, and which, if any, deidentifications to perform, that also may be included in the natural language generation of the selected information. For example, doctors may wish to see a transcript without richer featurization, whereas medical researchers may wish instead to see simply redacted versions of transcripts as well as more richly textured versions of a deidentification, filtered by thresholds.

As shown next in FIG. 26, the output of speech data from input may be a transcript. Turning briefly to how this transcript may be generated, a transcript may be generated during featurization in real time. In the example embodiment, a transcript may be generated one line at a time, or one thought at a time, where a thought may be characterized as a subject-verb-object set, as opposed to simply an utterance. When the input segment is featurized as lines or thoughts, it may be stored and compared to original input segments, which recall may be previously stored. As described above, words produced in a transcript may be tagged to the story-based ontology information and other information extracted during input featurization and associated with predicates, scores and SVOs. In the example embodiment, a featurized line comprising one or more words, or thoughts, may be classified by a classifier trained on featurizations to detect a condition and score its severity. The output of the classification may be tagged to the line or thought being featurized. Additionally, a confidence level may be generated, tagged (including to speakers) to the same line or thought, and stored. A copy may be made in near-real time which may be deidentified, as described above.

Next, as the transcript is being generated as natural language output during featurization, it may be fed line by line, or thought by thought, or as a completed transcript, into a LLM fine-tuned on reference speech data (Note: this may be determined, all or in part, by instructions for formatting and evaluating input by a prompt, as noted below). Thus, reference speech may be used both to train a featurization system as described above as well as to fine tune a LLM, as just mentioned. Additionally, a LLM may be fined-tuned on a story-based ontology and use cases, for example, involving anxiety or another wellness or health states (See FIG. 30E and FIG. 31). By training and fine-tuning an ensemble of multi-factor deep learning models on tasks based on the same story-based ontology class hierarchy and tested with predicates also encoded with the story-based ontology, the data used in the example embodiment not only may be evaluated as evidence but also facilitate more reliable updates and analysis of inputs based on a persistent and universal standard of reasoning (e.g., via predicate logic and tests for fidelity of various representations to the story-based ontology) and quality (e.g., high thresholds for confidence).

### Prompts and the LLM.

As shown in FIG. 26, besides natural language transformations of featurized inputs, feeding into the LLM may be prompt instructions, and format requirements for a transcript that the LLM is to use to evaluate inputs, for example, a method of scoring the transcript, and other information to provide context to the LLM during its execution of the prompted instructions. In the example embodiment, inputs may be classified during featurization as described above and/or via prompted instructions to a LLM, which may be trained on the same subject matter as a deep learning classifier using featurizations. See FIG. 24 for an example of how a prompt may be used to render a score for anxiety or other conditions based on a transcript. In the example embodiment, a classification rendered, using featurizations as described above, on the same input segment that a classification rendered, using natural language prompt and a LLM, may be compared. The comparison may help determine how similar the scores from the different models based on the same information are, whether either score is above a threshold, a Bayesian blend of scores based on different scoring methods for the same input, which scoring system may require additional training or information to improve confidence levels, and so forth. Or, when classification does not happen during featurization, it may happen during LLM execution of scoring tasks on a formatted transcript or other inputs formatted for a LLM to perform tasks as prompted.

In the example embodiment, other information related to the input may be handled by a LLM, or by an algorithm, after featurized input is transformed into natural language suitable for LLM input. This other information may include measures of reciprocity. In the example embodiment, reciprocity may refer to a measure of similarity between spoken or written words by different people during turns in their exchanges. It may apply to chat, email exchanges, a conversation, and so forth, between different users. In the example embodiment, reciprocity also may be a measure of similarity between what may be said or written by the same speaker or writer during their own turns in a chat, email exchanges, conversation, and so forth. In the example embodiment, reciprocity may be associated with words, sounds of the words, images, anything that may be used by a user to communicate with another user (e.g., emojis). In the example embodiment, Reciprocity measures (See FIG. 53) may be associated with how similar certain words, tone of voice, and/or other communications input may be during turns in communication, to help users identify “how well different users relate to each other” and, also, “how similar” a user's input may be to their own inputs during exchanges with other users. Reciprocity measures may be transformed into SVOs and probabilistic predicates, and associated with the appropriate source inputs, featurizations and other classifications. For example, it may be learned that when two speakers have high reciprocity an anxiety score may be lower. Since the scores and measures may be associated with the inputs used as a basis for the scoring and measuring, the subject matter associated with the scoring and measuring may be used to provide a guidance to one or more of the speakers.

Next, in the diagram, a LLM may process the inputs as prompted, and may generate output as prompted by a prompt (e.g., via a prompt generation system).

Scores and other information generated by LLM evaluated.

In the example embodiment, outputs generated by a LLM, whether the LLM may be fine-tuned, or not, may be evaluated, using various methods. In the example embodiment, these evaluation methods may include, for example, an analysis of predicates generated based on LLM inputs and outputs. Predicates related to LLM output may be compared to predicates generated from featurizations. Further, an analysis may involve transformations of featurized inputs into nodes on a knowledge graph, or into predicates, or both, which then may be transformed into natural language, for easier inspection by human users. During evaluations, it may be determined by the system if enough information is generated from various transformations, predicates and analytics, including of knowledge graphs, to meet sufficiency requirements. Sufficiency requirements may be determined in various ways. For example, sufficiency may be related to probabilities, where updated and analyzed inputs may be compared to thresholds for these probabilities. In the example embodiment, thresholds may be determined automatically or by editors for scores and measures; likewise, thresholds may be determined for certain dependency requirements between probabilistic predicates and story-based ontology information. As shown in FIG. 26, after output of the LLM is generated, this output may be evaluated against thresholds.

As signified in FIG. 26 by the arrow leading from thresholds and evaluation into a question, a determination may be made as to whether certain additional information may be required to meet sufficiency requirements. Such may be the case when rendering classifications of a condition and its severity, where there may be a heightened need to “get it right”, due to dependencies on the scoring or measurement data. For example, during an assessment of a subject's anxiety (e.g., a patient), an interviewer (e.g., clinician) of the subject may receive a natural language suggestion to elicit a certain response from the subject predicted to improve the confidence or another aspect of a sufficiency evaluation. Or, another source may be queried first, to try to resolve the insufficiency, before providing a communications, or stimulus for response, to the interviewer, or to the subject, depending on use case protocols and permissions involving the assessment. An additional source may be a database, system (e.g., electronic medical record system), group of authorized users (e.g., others auditing the assessment), website or forum (e.g., where the information needs may be deidentified), another fine-tuned LLM, etc. The input from other sources may run through the system as original input and be used to update and analyze the scores, measures, and related story-based ontology information to see if sufficiency is met. The number of loops to attempt to meet sufficiency requirements may be pre-set by editors (e.g., doctors, who may act as editors) during training or adjusted, based on authorizations, during runtime.

Meanwhile, as shown in FIG. 26, real-time output, including threshold evaluations of it, may feed into templates or other means by which to display inputs and evaluations of them. These displays may be provided via interactive filters. Users may set filters, based on rules which may determine which information may be displayed, and how. See FIG. 29A-D. Additionally, scores, reciprocity and various extractions associated with story-based ontology information may be shown, and summarized by a large language model, based on filter choices available to users.

Referring still to FIG. 26, when a story-based ontology class hierarchy may be used as the basis for updating and analyzing inputs for sufficiencies, it should be noted that these sufficiencies may relate to target weights for attributes, or goals, which the system may attempt to meet, collaboratively. In the example embodiment, a score or measure may be a goal to achieve and may be associated with a use case (e.g., a method of achieving a goal) represented as a story-based ontology instance or sequence of instances. In such a case, the stimuli to users may be based on a best next action step generated by the system to advance users to their goals, or a specific instance, and likely be different for the different users. For example, target weights may involve achieving a certain health score and reciprocity measure between two users in a Contract (e.g., patient-doctor). To continue with the example, a suggestion (e.g., natural language suggestion or multi-modal stimulus) may be generated for an Identity with a patient role to consent to receiving advice from an Identity with a doctor role. This may be predicted to satisfy a patient's deliverable part of a Contract with a doctor, on which other exchanges of deliverables may be dependent. Meanwhile, the doctor may receive a suggestion to explore a particular aspect of what was said by the patient, based on a pattern of higher reciprocity scores for exchanges when a particular topic is discussed. This may be predicted to help induce a patient to consent, while advancing the use case towards deliverables related to health scores and reciprocity measures.

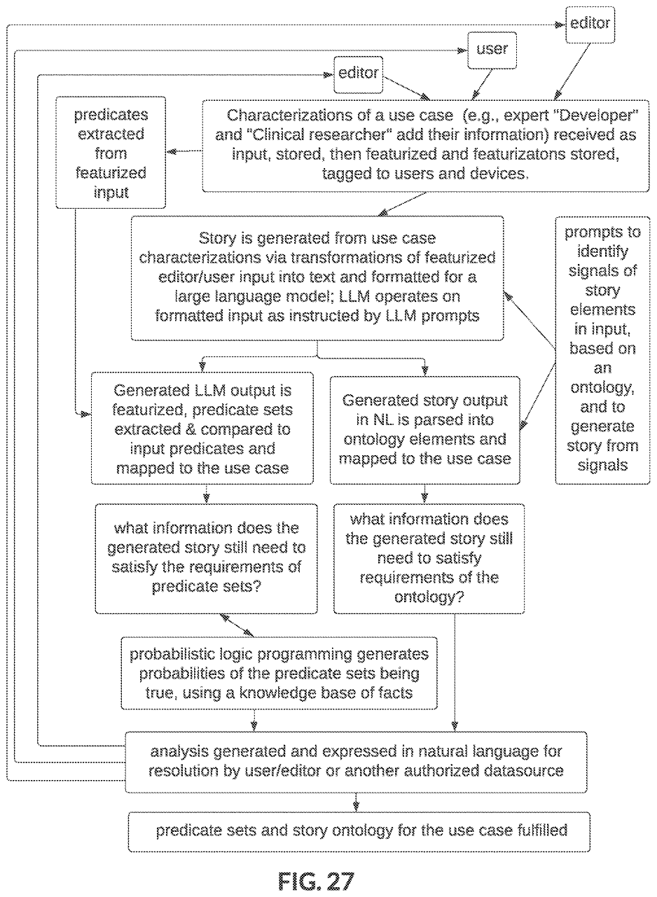

FIG. 27 is a flow diagram showing the transformation of a use case into a story based on a story-based ontology in accordance with various embodiments of the invention.

In FIG. 27, text, video and other data together characterizing a use case may be received and stored as input, then featurized. Thus, raw input and featurized versions of it may be stored. A story may be generated from the featurized and non-featurized use case characterizations various ways. In the example embodiment, predicates extracted from featurizations may be used to evaluate the logic of a story being developed collaboratively to describe a use case. As will be described, predicates may also evaluate a story output from a LLM to determine what the story may be missing, based on a story-based ontology.

To continue now with the flow in FIG. 27, featurized inputs may be transformed into natural language (See FIG. 54) and feed as natural language into a LLM, which may perform tasks on the input as instructed by a prompt conditioned on a story-based ontology. The generated output of the LLM then may undergo a series of transformations (See FIG. 54). On the one hand, the LLM output may be featurized; predicates may be extracted from the new featurizations, encoded with the story-based ontology, and then mapped to the use case, providing a probabilistic logic framework for determining what story-based ontology information may be needed to complete a use case story. On the other hand, the LLM output may be paired with story-based ontology information based on prompt instructions. Thus, the natural language output, while not featurized, in this case may act as a form of structured knowledge, since the input may be paired with an ontology information, even if not yet in a computable form; it may now be useful for graphing and analytics.

Next, streams of predicates and streams of natural language, both based on the LLM outputs, may be evaluated, and a determination made as to what user or other source may be queried for more information. This collaborative process may be repeated until it is determined that a story generated in natural language and associated with completed and resolved predicate relationships associated with the story-based ontology is approved. Editors may limit the number of iterations.

FIG. 28 shows how a large language model may be prompted to encode user's multi-modal input with a story-based ontology in accordance with various embodiments of the invention.

### Receiving Multimodal Inputs.

In FIG. 28, streaming single or multi-modal input may be received from editors (note: editors may be users). Single modal input may refer to an input datastream of one type of data from the group consisting of: text data, audio data, video data, or simple data (e.g., device output datas, logs). See FIG. 37. Multi-modal may refer to multiple input datastreams of multiple types of data present in the editor/user input. The data in the datastream may be received in packets or segments based on the device transmitting the data, where a segment may be referred to as a dataslice. The original inputs may be stored and tagged to the user. In the example embodiment, original input may be stored and featurized before being transformed into one or more tensors; so the input may be retrieved as either raw or featurized (See FIG. 54). These transformations may facilitate workflow between models while maintaining uniform standards for representations of the input data (e.g., universal formats by data type and standard tensor representations) during processing.

Processing multi-modal inputs.

The type of data in the dataslice may be determined upon receipt, tagged to user and device, timestamped, and formatted into a universal format used by the system for that type of data (e.g., text, image, audio, simple data). The data then may go through a series of transformations in a processing pipeline specific to that data type that then may be output as a tensor. In the example embodiment, processing pipelines may include a video/image pipeline, audio/language pipeline, text/language pipeline, and a simple data pipeline. In the example embodiment, data may be sent between pipelines as will be described. See FIG. 38.

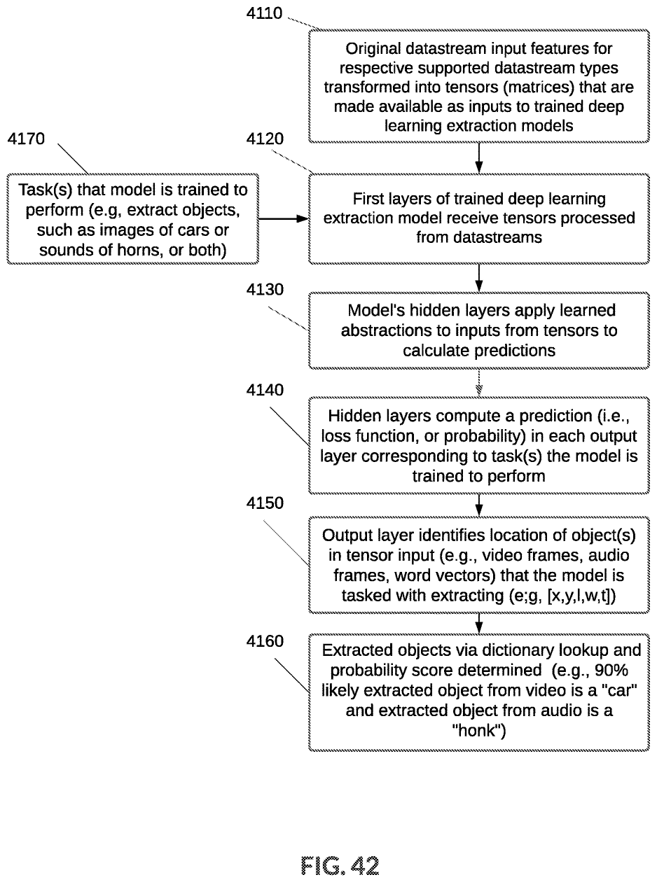

In the example embodiment, Video/image data input may be transformed into a sequence of images. Objects (e.g., a person, a cat, etc.) within the image frames may be detected and tagged. Text also may be detected in the video (e.g., via optimal character recognition), which then may be sent through the text pipeline. See FIG. 42. Additionally, audio data determined to refer to speech may be detected in the pipeline and then sent through the audio pipeline. The output of the video/image data transformations may be a tensor representation of image data.

In the example embodiment, audio/language data input may be parsed into audio frames, and features computed, and appended to the matrix description of the audio input. Text generated from automatic speech recognition may be sent to the text pipeline. The output of the audio/language data transformations may be a tensor representation of audio data.

In the example embodiment, text/language data input may be transformed into a matrix, which encodes linguistic/semantic structure via a learned word embedding (a sequence of word vectors) and associated higher order language features that are extracted in preprocessing. The output of the text/language data transformations may be a tensor representation of text data.

In the example embodiment, simple data input (e.g., readings from a digital blood pressure device, sensor data) may be represented as a tensor.

In the example embodiment, a single tensor representation of all input may be created by stacking all tensors from all datastreams. For example, a single tensor may be generated from stacking a tensor representation of text data and a tensor representation of simple data. In the example embodiment, a single tensor representation from stacked tensors may facilitate working with data regardless of type of data or processing pipeline. In the example embodiment, tensors may be generated as a uniform representation of data that may standardize how all data, regardless of input format, may be handled. This standardization may facilitate comparisons between various model inputs and/or outputs.

In the example embodiment, the use of tensors to standardize a data representation may facilitate a determination based on analysis of the tensors as to which models may perform which tasks better. In the example embodiment, a prompt generation system may continuously evaluate tensor information to dynamically manage models and programs. See FIG. 12 descriptions.

Looking up unfeatured text labels and object descriptions.

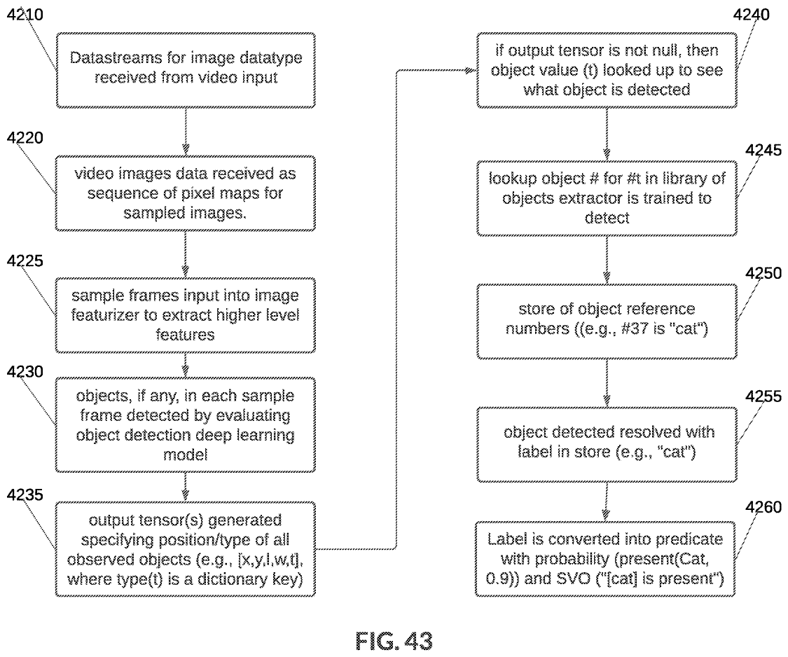

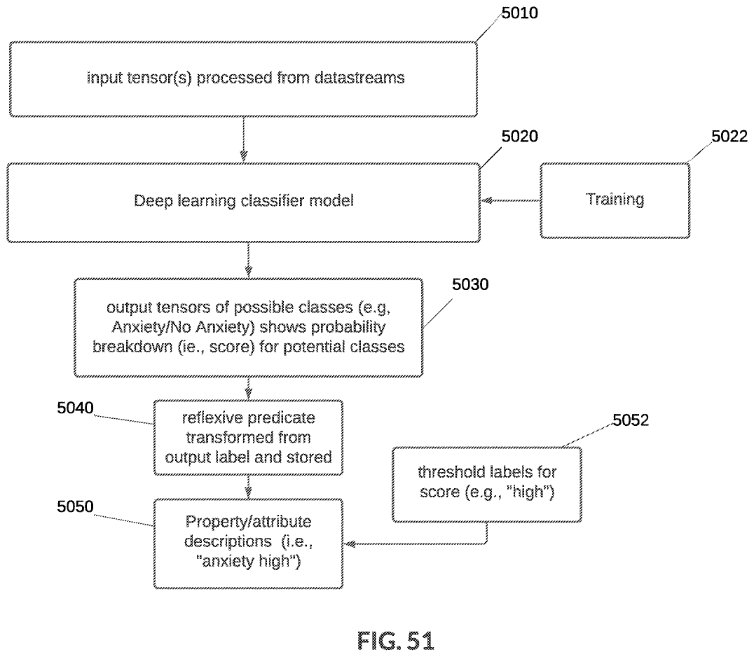

In the example embodiment, tensors generated from the video and audio pipeline may contain reference to image object (e.g., cat) or to audio object (e.g., cat's meow) detected during the featurization process described above. The reference may be associated with text and other information describing the object in a store. See FIG. 43-45. Meanwhile, simple data may also be associated with look ups, where data ranges may be labeled (e.g., blood pressure readings may be labeled “high blood pressure” above a certain reading) according to conventions determined by an editor or by an algorithm approved by an authorized editor. In the example embodiment, a deep learning classifier trained to detect a condition and score its severity may output a simple data tensor. See FIG. 51. A store of text (e.g., “high anxiety”, “moderate anxiety”, etc.) may correspond to a range of scores, which may be retrieved during deep learning classification. In the example embodiment, multiple types of classifiers may produce information on the same input data, generating multiple text streams based on stores of text associated with classifier outputs. Text describing objects and simple data may be looked up and featurized (if not already featurized) and streamed into the featurized text stream from speech and other text inputs.

Synchronizing featurized text streams.

The text streaming from object and simple data look ups and the text streaming from the text pipeline may be featurized and synchronized, based on timestamps of the respective dataslices. In the example embodiment, the streaming text input from stores of detected image and audio objects containing text for labels/descriptions, from text streams from text inputs from voice recognition outputs, and from other sources, may be synchronized and joined.

Transforming featurized text streams into a format for a LLM.

In the example embodiment, featurized text may be transformed into raw text so that it may used by a large language model. In FIG. 28, this transformation may take place here (See FIG. 46 for featurized text to raw text transformation). The raw text then may be formatted per the instructions of a prompt for use by a LLM For example, if the input is a conversation, then the format may be a transcript,

LLM Receives the Formatted Text and Instructions from a Prompt

Returning specifically to FIG. 28, arrows from the first prompts to formatting input streams received by the LLM show that the first prompts may determine formats for the input data that the large language model will analyze. The arrows further illustrate that the prompts may be used by the LLM to perform instructed tasks. In the example embodiment, text streams may feed into a format as specified by a prompt. A large language model or GPT then may generate a natural language output based on tasks it may be instructed by a prompt to perform on the formatted input text.

### LLM Executes Tasks on Formatted Input as Prompted

As shown in FIG. 28, one or more prompts may instruct a generative pre-trained model or large language model in as much detail as may be productive to generate, as output, pairs of input text and corresponding story-based ontology information. In the example embodiment the prompt, the formatted input text, and the LLM output may be generated, stored, and transformed into predicates with a probability. Recall earlier in FIG. 28 all input text may be synchronized and featurized at one point, facilitating such predicate transformations of the inputs. The outputs, meanwhile, may be featurized as well, so that predicate may be generated from them, too. These sets of predicates will be used later, as is shown later in FIG. 28.

The LLM tasks performed in FIG. 28.

In FIG. 28, two sets of prompts are shown. The first set of prompts depicted in FIG. 28 may comprise a separate prompt related to each class in the story-based ontology class hierarchy. In the example embodiment, there may be a prompt for each of Identity, Contract, Role, Deliverable, Task, Requirement, and Skill. This set of prompts may represent all classes in the hierarchy, and as a set representing the hierarchy may be mapped to the identity class, which sits atop the hierarchy. Furthermore, the Identity class may be associated with a specific user. Each specific user may be associated with a set of said prompts. This may be one method of using multiple prompts to instruct a LLM how to represent user input as a story-based ontology instance, meaning an instantiation of the story-based ontology class hierarchy with user data. In terms of the prompt content, each prompt may instruct a LLM to extract information related to the specific story-based ontology class for which the prompt may have been developed, and to pair the extracted story-based ontology information with the corresponding input text, as may be tagged to a user. For example, in the case of a particular user, an Identity prompt may instruct a LLM to extract the name of the particular user from user inputs, such as “Charles,” and assign the name to the respective attribute in the Identity class, such as name property attribute with the value “Charles”. See FIG. 24 for how the LLM's confidence in its own predications may be “reported”. The LLM may be prompted to evaluate the formatted text inputs and to extract story-based ontology information accordingly. In the example embodiment, another method of using prompts to extract story-based ontology information may involve using one prompt to gather all the Identities information from the inputs, another prompt to gather all the Roles information, and so forth. For example, a single prompt used by a LLM to extract story-based ontology information from inputs related to the Identity class involve may output two story-based ontology information related to two Identities, one Charles, another Tom.

The output of the LLM, as shown in FIG. 28, may be pairs of extracted story-based ontology information for each class along with the corresponding input text, tagged to each user.

Generating a story-based ontology instance from extracted and paired information.

Next, as shown in FIG. 28, another set of prompts may instruct the LLM to generate instances of the story-based ontology for as many users as may be associated with the LLM's initial output based on prompts for each class. In this step, this next generated prompt may instruct the LLM to take the generated class-specific output described previously and, based on dependencies in the class hierarchy, to construct from all of the class-specific output an instance of the story-based ontology; and, then to generate a natural language output pairing text inputs and corresponding story-based ontology information from the constructed story-based ontology instance; the output may be generated as prompted and stored. In the example embodiment, as new input streams in, new prompts may be generated. So, new instances of the story-based ontology may be continually generated.

Two brief notes here. One related to prompts, the other to constant new instance generation. First, prompts. Recall, in an example embodiment prompts may be developed collaboratively using a prompt generation system that may automate the work of generating multiple prompts or optionally assist editors/users in developing them; in another example embodiment, a prompt may be developed collaboratively without a prompt generation system. With this in mind, the prompts shown in FIG. 28 are meant to show that more than one prompt may be used at a time in various example embodiments, regardless of how such prompts may be generated. As to the specific prompts depicted in FIG. 28 these show one way of using multiple prompts to encode inputs with a story-based ontology. In the example embodiment, there may be various ways to use multiple prompts to encode inputs with a story-based ontology. Second, story-based ontology instances. In the example embodiment, the story-based ontology may act as a self-generative mechanism requiring with each new input a need to resolve new dependencies between story-based ontology class information and associated predicates created by the new input. These emergent dependencies likely will require additional information from the system and/or other sources and/or user/‘editor to resolve. In turn, the additional information received will add yet new dependencies to resolve, creating a perpetual cycle of dependency and resolution. Further, in the example embodiment, these dependencies may have uncertainty. In the example embodiment, various methods may be used to facilitate determination of which of the dependencies to resolve, which to ignore, and which to displace with new dependencies. For example, a determination may be based on a weighted sum of importances of various dependencies. In the example embodiment, thresholds for such measures may facilitate the management of uncertainty. In the example embodiment, probability above a threshold may satisfy sufficiency requirements to predict a desirable outcome.

Generating predicates to analyze LLM outputs.

In FIG. 28, the output of the LLM, pairings of story-based ontology information extracted from inputs and the inputs themselves (e.g., text data), may be used to generate probabilistic predicates. The predicates may be evaluated for completeness (e.g., do they have a head and a body?) and for logic as sets (e.g., how strong are the relationships between predicates?), along with other predicates, to determine if a sufficiency is met. In the example embodiment, predicates may contain a probability component, so that while a head and body may be required for completeness, there may also be a probability that the predicate head or body or set is true or not true. In the example embodiment, determining how many completed predicate sets may be required to “complete” a prompt under development (i.e., a form of use case), or another use case under development, may be determined by editors. This determination by the editors may be made through approvals of editors authorized to make approvals or by algorithms approved by the editors, for example, as may use thresholds.

In the example embodiment, sufficiency may be determined by various dynamic thresholds or editor-set thresholds, for example, for weights learned during machine learning tasks, predicate probabilities, unresolved dependencies between story-based ontology classes based on input data, and so forth. Furthermore, as shown in FIG. 22A, in the example embodiment, predicates themselves may be encoded with a story-based ontology. Thus, resolving dependencies between predicates encoded with a story-based ontology may facilitate resolution of dependencies within and between story-based ontology classes in a story-based ontology class hierarchy.

### Another Example Embodiment Involving a Fine-Tuned LLM and a Knowledge Graph

In another example embodiment, a LLM may be fine-tuned on a story-based ontology. It should be noted that in the course of fine-tuning a LLM on a story-based ontology a number of prompts may be developed/generated, resulting in a set of prompts and likely sequence of them associated with the final fine-tuning. In the example embodiment, a LLM fine-tuned on the story-based ontology may output pairings of input text and extracted story-based ontology information based on such prompts. Next, in this other example embodiment, input text and extracted story-based ontology information may be mapped to nodes (e.g., representing a class structure, see FIGS. 4A and 4B) and edges (e.g., representing relationships between classes and between components of the class structure) in a knowledge graph. Meanwhile, the pairing from extractions of extracted story-based ontology information to input text may be used to establish the instance of the class structure as associated nodes. To illustrate one way this may be executed, let's say the output of a LLM fine-tuned on a story-based ontology includes a caregiver role for a role class and a Charles identity for an Identity class. In this scenario, an Identity node may have an edge to a name property attribute node which may have an edge to value node which may have an edge to a Charles node. Thus, Charles may be represented as an instance of the story-based ontology identity class using a knowledge graph. Note how precisely this may follow the class structure described in FIGS. 4A and 4B. In a similar manner, the caregiver role extraction may be represented in the knowledge graph by a Role class node with an edge to a Caregiver Role node with an edge to a name property attribute node with an edge to a value node with an edge to a caregiver node. Note how closely this also may match FIGS. 4A and 4B descriptions. Meanwhile, the Charles node and the caregiver node may share an edge, since in the example embodiment, an Identity class and a Role class have a dependency (See FIG. 3), Thus, in this simple example, Charles as a caregiver may be represented as an instance of the story-based ontology identity class using a knowledge graph, based on story-based ontology-based extractions from input. This also shows one way, in this other example embodiment, that structured knowledge may be represented in knowledge graphs. Representing structured knowledge in a knowledge graph may facilitate various computations and analytics, using graphical computing methods. Now to close the loop on how predicates may be generated from the knowledge graphs based on LLM outputs, such as being described in FIG. 28, the nodes and edges may be analyzed and associated with a unique identifier. The identifiers may be used to track and calculate the number and distribution of connections and other factors useful in determining the centrality of nodes, strength of a community (based on clustering) and so forth. These identifiers may facilitate feature engineering to output features, based on the knowledge graph structure, that then may be used to generate probabilistic predicates.

Completing predicates and resolving dependencies automatically.

In the example embodiment, the system may attempt to complete predicates (i.e., a complete predicate comprises both a head and a body, also referred to as an argument) and resolve dependencies between predicates in various ways. For example, probabilistic programming and a search of nearby text, of a knowledge base, of a knowledge graph, or of another source may be used to try to complete predicate information, including through logical inference. Known natural language question answering techniques may be used to produce an appropriate question for searching for the missing predicate argument. Note, a probabilistic programming language may use stored predicates to complete predicates and generate new predicates. Resolved predicates from an incomplete predicate as a result of inference or editor information may be new predicates with probabilities. Bayes theorem may be used to update said probability based on prior probabilities for predicates and new input.

Various paths to addressing remaining insufficiencies.

Next, moving counterclockwise around FIG. 28, determinations may be made based on evaluations as to how best to resolve remaining insufficiencies, which may include prompting other sources or editors or both. In the example embodiment, editor preferences for approval requirements may determine which editors receive which queries or stimuli for a response. In the example embodiment, editors also may determine what other sources may be used to try to resolve insufficiencies above what threshold. Further, in the example embodiment, editors may determine when to be involved in the flow of attempting to resolve what dependencies and complete which predicate sets. Editors in the example embodiment may wish to be involved only after certain other attempts by the system to resolve dependencies fail, for example. Thus, in a distributed manner to editors and other sources, a percentage of insufficiencies may be resolved.

Is another source to be queried?

Returning now to FIG. 28, after the system attempt to complete predicates and resolve dependencies above a threshold automatically in the manner described, it may be determined that certain predicate sets and dependencies important to resolve may require an additional source. Additional source may be, for example, an external database, a large language model, or domain specific database expected to hold information relevant to a use case being collaboratively developed and/or deployed where additional information may be required. Additional source may also include social media, electronic medical record systems, or other systems. Further, an additional source may be a third-party expert in a particular relevant field. In the example embodiment, source reference database may include a list of sources available, for example each authorized editor, and significantly, detailed characteristics about each source. The characteristics may include, as examples, specific skill set and area of expertise, schedule and availability, history of providing helpful information in connection with prior queries, cost of input if application, personal traits such as age and gender, areas of personal interest and hobbies. It will be recognized that more and different source characteristic information may be included. Additional source may communicate directly with AI platform and may be provided access to query platform. In various example embodiments, the query platform may be an electronic bulletin board or other web interface used for the collaboration that may be accessible over the internet. In the example embodiment, source may be selected based upon source reference database provided,

As shown in FIG. 28, the selected source may be “queried,” or communicated with, so as to solicit or elicit a response that may complete predicates and/or resolve dependencies such as may still need to be resolved within or between classes in the story-based ontology, based on evaluations of the user input. In the example embodiment, queries may be made using various communications modalities. See below for various forms a “query” may take in the example embodiment. After the selected source is queried, it may be determined whether information has been received in response to the query, and whether it is sufficient to address the issue that prompted the query. If sufficient information was received, then the knowledge base/knowledge graph and predicate sets may be updated accordingly. If no information has been received, or the information is determined to be insufficient, has not been provided, then further queries may be initiated for a predetermined number of cycles. Specifically, another or the same preferred source may be identified, and the steps repeat.

Communicating with the sources/editors/users.

As shown in FIG. 28, a communications may be generated by the system and provided to one or more sources, editors or users to further resolve important and still incomplete predicates or unresolved dependencies. In the example embodiment, the dependencies associated with determining a best next action step may be prioritized. A query to a source, editor or user in the example embodiment may be in the form of natural language or in the form of a communications that combines multiple types of data (e.g., text, video, audio, simple data), which may or may not include natural language. It is understood that when a source is a non-human source, such as a database, the type and form of “communications” form the system may be constrained by the type of communications the receiving source may receive. Accordingly, in the example embodiment, the system may generate the type and form of required communications.

In the example embodiment, the communications to editors and/or users (e.g., other human sources) may be styled so as to increase the chances of: i) a response, and ii) a response that may include information to resolve key predicate completions and resolve key dependencies and iii) a response that advances a user towards user goals as may be described in terms of the story-based ontology. Note that i) and ii) may both support iii). To advance a user towards goals, the communications may be of a best next action step. To achieve this type of intended response, communications in the example embodiment may be styled on the basis of what “moves” a user or editor, which may be based at least partially on prior responses. Additionally, simulations may be used in the example embodiment to determine likeliest communications candidates to elicit the intended response input from a particular editor or user.

In the example embodiment, it may be determined from a user database (an editor may be a user) and a store of video/image and audio objects and textual data, which video/image and audio objects and textual data may be most associated with which editor prior responses above a threshold. If there is a template associated with these communications elements that too may be identified. Further, the prior communications data may also be associated with the user (editor) state of at the time. (Recall, a user in the example embodiment may be represented as an instance of the story-based ontology, and an editor may be a user.) This information may serve as a “prior”. Next, predicates associated with prior editor responses may be compared with predicates associated with currently incomplete predicates that may have the most important dependencies to resolve. Based on this analysis, it may be determined which predicates associated with audio, video, and textual data associated with editor prior responses are most associated with currently incomplete predicates that may have the most important dependencies. Candidate communications may be generated by simulating which communications elements (audio data, image data, textual data) associated with which predicates and story-based ontology information may resolve the most important currently incomplete predicates and unresolved story-based ontology class dependencies, above a threshold. Then the winning combination may be transformed from the associated predicates and communications data into a communications output. The communications output may “fill in” a template populated with the winning candidate communications above a threshold. The winning candidate may be a multi-modal communications or a single mode communications, such as a natural language query. The top candidate then may be provided to the editor as the styled and customized communications.

In the example embodiment, the user/editor response to the manufactured elicitation by the system then may be processed as input, which may be compared with upweighting targets for various class attributes, and the cycle may repeat.

Annotations made by editors/users.

Returning now to inputs from editors/users and other sources. in the example embodiment, inputs may include annotations of other inputs (See FIGS. 29A-29D), annotations of activity information made available to the source/editor/user (See FIG. 34), and other additional information that may be mapped to original input. In the example embodiment, annotations may be associated with the original input or inputs of other editors/users. For example, the LLM output of the input text streams from various pipelines described previously in FIG. 28 may be made available to the editor/user in various forms for review and annotation. For example, the output may be a descriptive transcript or summary of the video. In the example embodiment, the output may be provided through a template based on the form of output (e.g., transcript, summary). In the example embodiment, these outputs may be annotated by editors/users. The annotations may be associated with what is annotated and processed as new inputs and analyzed accordingly (e.g., are predicates complete?). Further, the output may be displayed based on filters used by the editor/user. For example, summaries may be rendered on generated text of a length specified by the editor/user (e.g., via a sliding bar for the summary controlling how much of what text is to be summarized). Consequently, an editor/user may see in natural language based on the system's automatically joining text streams from object lookups and spoken words from speech during a video call. The natural language output generated by a transformer could be, as an example, “a person with high blood pressure is frowning when talking about work.” To continue with the example, an editor may say or write a new input regarding this statements, “the person is also looking away, not at the camera.” In the example embodiment, the comment may be used to annotate the descriptive transcript, if approved by editors/users, and provide new information that in turn may be analyzed as other input, perhaps generating a new query for the editor based on accumulated knowledge: “Why do you think the person is looking away? There is no sign of depression,” In turn, the editor may further clarify, and again the input may be used for updating and analysis.

FIG. 29A is a diagram showing highlighting and annotating functions of dataslices, or partitions, of a datastream by type of datastream in accordance with various embodiments of the invention.

As shown in FIG. 29A, in the example embodiment, streaming input may be segmented, and these segments may refer to slicing of the input. Each dataslice may be subjected to featurization and deep learning analysis (e.g., classification, extraction, etc.), and be associated with contextual data (e.g., log data, etc.) Insights in the example embodiment may be provided as activity information for users to review, based on user tools such as filters chosen by users. This activity information may be accessible by an interface or other means in the example embodiment. See content of descriptions in FIG. 29A for more descriptions. In the example embodiment, activity information may be made available various ways, for example through a template and delivered various ways, for example, by email, text, etc.

FIG. 29B is a diagram showing an abstractive summarizer (e.g., seeing a summary of transcript in whole or in part during or after a video call with scores associated with selection) in accordance with various embodiments of the invention. See flow and descriptions in figure.

As to the abstractive summarizer used in the example embodiment, it may be transfer-learned from a language model (e.g., CPT language model). The abstractive summarizer may use an encoder-decoder (sequence to sequence) architecture where both the encoder/decoder are multi-head attention based transformer modules. It may receive input text, then that input text is “encoded” by the encoder into a vector space that is commonly known as the “latent” space, and then the same set of vectors may be decoded by the “decoder” into a summary. The decoder can be conditioned on an aperture parameter which tells it “how much” to summarize. Smaller aperture corresponds to a summary which is higher level and omits more detail.

In the example embodiment, the chunks of data ingested may be referred to as the aperture of the summarizer. As the example embodiment generates and scores live text (e.g., transcript produced live by ASR or equivalent technology), it batches the scores and text corresponding to the scores into chunks using an aperture to control the size of the chunks ingested by the summarizer. A chunk may be any number of segments above a threshold, for instance, 25 sentences. An aperture may be used to set the number of segments per chunk. The time and length of these segments may be set by the example embodiment to match the time and length of audio, etc. and may marry scores and extractions from segments to summaries. At the widest level, the chunk may be the entire transcript. At the narrowest, it's the smallest chunk. If the smallest chunk is 25 sentences, and all chunks are set as being the same size upon generation, then a transcript with 75 sentences has 3 chunks. Chunks correlate to scores because scores may be predicted for each segment and can be aggregated and averaged by the score of all segments divided by the number of segments in a chunk. Since extractors may also be conducted in chunks, and mapped to segments in a speech input, extractions may be summarized in addition to the running text, and associated with a score. For example, a user may see a summary of what a user says that is determined by the example embodiment to be associated with the user's lowest quality of life score. Text rendered from voice inputs via speech-to-text methods or featurized as text by modality (e.g., email, chats, etc.) may be scored and chunked into an abstractive summarizer.

FIG. 29C is a diagram showing annotations of displays in accordance with various embodiments of the invention. See flow and descriptions in figure.

In the example embodiment, analysis of type specific “slicing” or partitioning of data may be conducted on various processed Inputs (e.g., scored transcripts, comments from other users, etc.) as well as certain model outputs. These may be capable of being commented on through interactive interfaces, or as templates which may surface for review and annotation by the user various processed data slices. Users may highlight a displayed area and comment on it and/or use filters to determine what is displayed, and to comment on that. Further, users may make general notes that may be tagged to the context (e.g., call/transcript).

As illustrated in FIG. 29C, the example embodiment may provide tools for the user to create custom filters and labels for various views of partitioned data. For example, a clinician may wish to filter a transcript for all extractions and/or topics related to, say, lowest quality of social life. In turn, the example embodiment may apply the filter options chosen by the user (e.g., colors, underlines, bolding, etc.) to sections of the annotated transcript that met the filter criteria. The user may comment on the filtered selection, which may now become inputs tagged to the user, to the section, and to the context (e.g., the live call from which the transcript is being generated). During a live call, a user may view the call transcript as it is generated and annotated inputs and add their own comments. To surface the comments, the example embodiment may fetch comments associated with both this user and this call, and then return those comments (e.g., as JSON data). Meanwhile, if other users are authorized to access comments or add their own, these may also be surfaced, (See Comment thread, FIG. 29D). That data can then be “drawn” on the frontend (in the browser) however someone likes. See flow and descriptions in figure for more detail.

FIG. 29D is a diagram showing commenting threads in accordance with various embodiments of the invention. See flow and descriptions in figure.

In FIG. 29D, the comment threads may be associated with various dataslices, from which various predicates may be extracted.

The comments may feed into an abstractive summarizer, such as GPT, which, in turn, may generate a new set of data on which others permissioned to comment may comment. In turn, new comments may feed back into the updating and analysis processes.

### Training Methods

FIG. 30A is a flow diagram illustrating steps of an automated method for training a classifier on reference speech data in accordance with various embodiments of the invention.

In the example embodiment, reference speech data may refer to a large collection of conversations that i) are similar in nature to common use cases, involving for example older subjects and medically related use cases, and ii) occur during a clinical trial intervention before which and after which subjects in the clinical trial are tested using clinically validated health assessments. In the example embodiment, reference speech data may be available for any number of validated health instruments used before and after said conversations during a clinical trial. For example, a clinical trial may involve conversations before which and after which different health assessments may be conducted; for example, a GAD-7 for anxiety, a Phq9 for depression, QOL for quality of life. Thus, from the same conversations, reference speech data may be generated based on anxiety, depression, quality of life instruments, respectively.

FIG. 30A begins with the step of providing reference speech data. In the example embodiment, reference speech data may be provided as approved training data input from a process described in FIG. 30E. As described in FIG. 30E, the raw training data may be prepared through a collaborative process using editor inputs to automatically analyze and label training data (e.g., reference speech data). In the example embodiment, queries may be generated for the editors/users based on their input and automated assessments, and editors in turn may respond, and modify, add to, and/or approve what is being collaborated on. In FIG. 30E, a process is described wherein the outputs may be approved training data for either tensor-based deep learning-models (e.g., tensor-based classifiers and extractors) or natural language-based prompts and large language models (e.g., NL-based classifiers and extractors), or both. In the example embodiment, transformations between featurized and unfeaturized inputs may facilitate different methods of classification and extraction, based on the same training data (e.g., reference speech data), as described in FIG. 54, FIG. 30E, and FIG. 51 descriptions. In turn, these transformations may facilitate comparisons between methods to further refine the training of models.

See FIG. 36-41 for tensor-based featurization and FIG. 51 for descriptions of tensor-based classification.

To train a tensor-based classifier, the labels collaboratively developed during preparation of the training data (See FIG. 30E) may be set as the target values for the classifier model to learn to predict. For example, a label may be generated for a category of healthcare assessments, such as anxiety, where an anxiety score may be based on reference speech data (Recall from FIG. 6, a property attribute in a class hierarchy may have a value and uncertainty component related to such a score). Further, during preparation of the training data, labels may be associated with specific features in the training data. For example, a feature for determining anxiety and a score for it may involve statements related to a recurring inability to sleep (See FIG. 24 description.). In FIG. 30A, the labels (target values) may be set for the neural net to predict, and the featurized data corresponding to the labels may be fed into the initial layers of the neural network, comprising nodes, or neurons. Features in the training input initially may be associated with neurons in the input layers. Then, the features associated with the input layers may pass to other layers where the input features may be transformed, layer by layer. These transformations may involve initially random weights characterizing the strength of connections between neurons representing the input in different layers, which may be summed, to determine if the sum is great enough to activate a calculation, or function, in a layer. These weights and functions may continue to transform the value of the input, layer by layer, until the neural net produces an output layer, containing predictions (e.g., a likely anxiety score). A calculation may determine how much of the output is in error, based on information lost during the various transformations. This loss information may be calculated by comparing the input training data and the output. This loss information then may be used to adjust the weights learned during the transformation, to see if the loss is reduced. This process may occur iteratively until the loss is acceptable, at which point the associated weights and functions may describe a classifier ready for testing. The classifier may be tested using one or more subsets of the training data held out, or not used, during training. The model may be considered trained when test results of the classifier on one or more hold-out sets, as unseen sets, are satisfactory to the editors. From the output of a trained classifier, it may be determined what features in the input result in particular health assessment scores, and their respective magnitudes (values).

Note that in the example embodiment a classifier may be trained not only on reference speech data, but also via custom speech analysis that intelligently identifies additional characteristics of speech. One example may be “reciprocity” (See FIG. 53), which may be a measure of similarity between the speech in different turns of a conversation (e.g., how similar is what one person says in one turn and then in another turn? How similar are what different people say during their turns? Etc.). In the example embodiment, reciprocity may be associated with various states of mind. For example, high reciprocity between speakers may have some correlation with lower anxiety. Preferably, a classifier may be trained to not only apply health assessment scores to audio segments, but also reciprocity scores, and the like.

In the example embodiment, a classifier may be trained on voices similar to the voices of people whose voice data may be part of the reference speech data. (See FIG. 39)

See also FIG. 24, FIG. 26 and FIG. 35, related to classifying and scoring a condition based on a natural language input (e.g., a LLM provided a transcript and a natural language prompt).

In the case of fine-tuning a large language model to act as a classifier, note, as described above and in FIG. 30E, that the output of the training data preparation may include collaboratively developed features and labels transformed into suitable language for prompting a LLM. See FIG. 31 for how the output of FIG. 30E may be used to fine-tune a LLM, including as a classifier.

FIG. 30B is a flow diagram illustrating steps of an automated method for training an extractor on reference speech data in accordance with various embodiments of the invention.

See also FIGS. 36, 38, 40, 42-45, 46, 47, 50 for descriptions of tensor-based extractions in accordance with various embodiments of the invention.

Unlike classifiers, which may classify inputs based on predetermined classes (e.g., an anxiety score for the input), extractors may extract specific input based on labels for that specific type of input. In the example embodiment, an extractor may be trained to extract a role for a Role class in the story-based ontology class hierarchy, such as “caregiver.” In the example embodiment, the extraction of a role, such as “caregiver, may be based on a feature, such as “assists a loved one with meal preparation.” To continue further with the illustration, in the example embodiment an extractor may be trained on examples of ways of saying “assists a loved one with meal preparation”. In the example embodiment, story-based ontology information (e.g., Caregiver Role in a Role class) may be extracted from the reference speech data and associated with the corresponding features.

To train a tensor-based extractor, the labels collaboratively developed during preparation of the training data (See FIG. 30E) may be set as the target values for the extractor model to learn to predict. In the example embodiment, a target value for an extractor may be a story-based ontology information, such as a Role in a Role class (e.g., “Caregiver). Further, during preparation of the training data, labels (e.g., “Caregiver) in the example embodiment may be associated with specific features in the training data (e.g., “assisting with meal preparation”). In FIG. 30B, the labels (target values) may be set for the neural net to predict, and the featurized data corresponding to the labels may be fed into the initial layers of the neural network, comprising nodes, or neurons. Features in the training input initially may be associated with neurons in the input layers. Then, the features associated with the input layers may pass to other layers where the input features may be transformed, layer by layer. These transformations may involve initially random weights characterizing the strength of connections between neurons representing the input in different layers, which may be summed, to determine if the sum is great enough to activate a calculation, or function, in a layer. These weights and functions may continue to transform the value of the input, layer by layer, until the neural net produces an output layer, containing predictions (e.g., a likely Caregiver role). A calculation may determine how much of the output is in error, based on information lost during the various transformations. This loss information may be calculated by comparing the input training data and the output. This loss information then may be used to adjust the weights learned during the transformation, to see if the loss is reduced. This process may occur iteratively until the loss is acceptable, at which point the associated weights and functions may describe an extractor ready for testing. The extractor may be tested using one or more subsets of the training data held out, or not used, during training. The model may be considered trained when test results of the extractor on one or more hold-out sets, as unseen sets, are satisfactory to the editors. From the output of a trained extractor, it may be determined what features in the input result in particular labels (e.g., “Caregiver”).

In the example embodiment, features (e.g., “assist with meal preparation”) may be associated with a label (“Caregiver”) various ways, for example, by mapping the label to the input used to predict a label.

See also FIG. 24, FIG. 26 and FIG. 35, related to extracting based on a natural language input (e.g., a LLM provided a transcript and a natural language prompt).

In the case of fine-tuning a large language model to act as an extractor, note, as described above and in FIG. 30E, that the output of the training data preparation may include collaboratively developed features and labels transformed into suitable language for prompting a LLM. See FIG. 31 for how the output of FIG. 30E may be used to fine-tune a LLM, including as an extractor.

With particular regard to FIGS. 30A-30D, classifiers and extractors may serve different functions. Yet, in the example embodiment, it should be noted that the training of classifiers and extractors may be based on the same speech reference data. Additionally, in the example embodiment, an ASR system may be custom-trained on this same reference speech data (See FIGS. 16-21, 39). In the following description regarding FIGS. 30A-30D when “classification/extraction” is used, it is meant to convey that the training of extractors and classifiers may be based on the same reference data.

In the example embodiment, probabilistic predicates may be generated from featurizations of various input data being prepared for classifier/extractor training, classifier/extractor training, classifier/extractor testing, and classifier/extractor deployment, such as reference speech data. In the example embodiment, predicates based on this reference speech data may be used to map classifier and extractor outputs also based on this same reference speech data to each other to facilitate complex situational reasoning. In the example embodiment, probabilistic predicates, which may be used in probabilistic programming to conduct reasoning on data, may provide a bridge between classification and extraction based on reason. In the example embodiment, predicates associated with these inputs and outputs may be used by AI computational tools and probabilistic programming to perform reasoning functions to support decisions by providing evidence for them. In the example embodiment, this evidence may extend to future story-based ontology instances also based on a reasonable probability. Further, this bridge may extend beyond analysis of tensor-based inputs and outputs. For example, predicates may be generated from featurized reference speech data during preparation of the reference speech data for training a classifier model that uses featurized inputs: predicates in the example embodiment also may be generated from the featurization of natural language input and LLM output during the LLM's fine-tuning as a classifier.

Since, in a preferred embodiment, predicates may be generated from featurizations to accommodate the format requirements of various probabilistic programming languages, let's turn briefly to the featurization of audio, and more specifically to reference speech data. As described in FIG. 39, each audio segment from original audio input may have associated featurized feature data. In the example embodiment, a tensor-based classifier may be trained to generate health assessment-related classification scores for audio segments, or dataslices, based upon featurized reference speech data. For example, a particular loudness range combined with certain specific words represented by tokens and vectors may indicate a high anxiety level. For example, the featurized data associated with an audio segment utterance about a bank account balance may indicate both a high anxiety level and a poor QoL outlook. By correlating the available scores it may be determined that the subject is worried about finances. A classifier may be trained to identify such instances and assign a health assessment score to the associated audio segment accordingly. For example, the classifier may score incoming featurized data and associated audio segments for anxiety level. The classifier score may be generated as a label, as above described for classifiers. This label could be, for example, “High Anxiety.”

In the example embodiment, a classification score associated with a label, e.g., “high anxiety,” may also be associated with words that may be said or written. In the example embodiment, the input associated with a classification may be extracted and transformed into probabilistic predicates (or be matched to predicates in a store). During the preparation of the reference speech as training data, it may be learned from extractions which features of the reference speech data result in particular predicate heads and predicate arguments. Next, during the training of a classifier based on reference speech data, it may be learned which features of the reference speech data may be scored and which may not be scored by the classifier. The features of the reference speech data for which a score may be determined by the classifier thus may be associated with extracted particular predicate heads and predicate arguments.

In the example embodiment, predicate stores may be searched for predicates based on data associated with the scored audio segments. This data may include the health assessment classifications scores, and/or the labels, and/or the featurized data, and/or predicates that have already been extracted for those audio segments from the original audio input. For each predicate identified from stores, a predicate head may be retrieved (“e.g., “bank account.”) New predicates may be created or updated by pairing extracted predicate heads (e.g., “bank account”) with data associated with the respective audio segment. The data may include the health assessment classifications scores, and/or the labels, and/or the featurized data. An example of Problog probabilistic programming for creating and updating this predicate is 0.85::high_anxiety(user12),1.0::bankaccountbalance(user12,$871) 0.8::anxiety_factor(user12, financial). This process may be repeated for each pairing generated for an audio segment. Furthermore, in the example embodiment, the pairing of classifier and extractor outputs may include story-based ontology information. For example, “user12” in the above snippet may be an Identity, say Tom, who may have a role, “tenant”). In the example embodiment, reasoning, simulations and so forth based on probability may be conducted various ways, including through the use of probabilistic predicates. Since predicates may be encoded with a story-based ontology, reasoning with predicates may facilitate reasoning with the story-based ontology.

In the example embodiment, a classification score may be rendered on new inputs, which may be transformed into predicates and compared to the predicate heads and predicate arguments in the reference speech data on which a classifier may have been trained to generate a score.

In the example embodiment, probabilistic predicates may be used to assist with the training of classifiers and extractors on the reference speech data. Let's say, for example, that reference speech data containing the statement, “I just can't sleep these days”, is scored for anxiety. In the example embodiment, a predicate head and argument may be extracted from a featurization of such a statement and associated with the classifier score. In another example embodiment, the same statement in natural language statement, “I just can't sleep these days”, may be scored by a LLM based on a prompt, as described in FIG. 24, and transformed into predicates after being featurized, which may be associated with that score. In yet another example embodiment, both approaches may be used for comparative purposes (e.g., how close are the scores generated by different classifiers based on the same reference data, the same underlying instrument, and the same original input? Which score may be more accurate? How similar are the predicates that are associated with the score rendered by different classifiers attempting to score the same condition?) Since predicates may be generated for the training data on which a classifier may be trained, comparisons between predicates associated with various stages of training data preparation and classifier training may provide useful insights to assist editors during collaborative development of a classifier. For example, editors may decide that it is desirable to establish a Bayesian model for “blending” the scores of various classification methods, or chose one classification approach for a particular classifier (e.g., LLM prompted scoring using natural language) and another for a different classifier (e.g., classifier using tensor inputs).

In the example embodiment, assisting editors may involve updates and analysis of editor input, which may include simulations as described in FIG. 11, as well as communications to the editors based on the analysis, to facilitate collaboration and accelerate classifier/extractor training. In the example embodiment, the communications generated by the system to assist editors may take various forms, such as a query or a recommendation. Regardless of the form that this communication by the system may take, in the example embodiment the communication may be transformed into probabilistic predicates. The same may hold for activity information, which may be based on updates and analysis functions, that may be made available to the editors during development of classifier/extractor. See FIG. 34 regarding activity information. In turn, the response of editors may be converted into predicates and compared with the communications predicates and other predicates to determine similarity and to perform a new cycle of updates and analysis based in part on an evaluation of predicates.

FIG. 30C is a flow diagram illustrating steps of an automated method for training a classifier on reference Treatment data in accordance with various embodiments of the invention. In the example embodiment, reference treatment data may refer to a validated intervention and its steps (e.g., a progressive therapy treatment [Problem Solving Therapy] with coached steps and goals) evaluated during a clinical trial. Elements of a clinical trial dataset involving a validated intervention may include: i) the progressive steps and goals of an administered intervention, ii) conversations that take place during and after the intervention, iii) a subject's longitudinal scores based on validated health instruments, iv) a subject's progress towards goals based on changes in the scores of validated health instruments before and after an intervention, v) a subject's profile; vi) the care team composition, including family caregivers and community support; vii) a provider's scores based on provider fidelity to the protocols of an intervention, and viii) various other matters that may interest editors as they collaboratively develop the reference treatment data for use in training various models.

FIG. 30C begins with the step of providing reference treatment data. In the example embodiment, reference treatment data may be provided as approved training data input from a process described in FIG. 30E. As described in FIG. 30E, the raw training data may be prepared through a collaborative process using editor inputs to automatically analyze and label training data (e.g., reference treatment data). In FIG. 30E, a process is described wherein the outputs may be approved training data for either tensor-based deep learning-models (e.g., tensor-based classifiers and extractors) or natural language-based prompts and large language models (e.g., NL-based classifiers and extractors), or both. In the example embodiment, transformations between featurized and unfeaturized inputs may facilitate different methods of classification and extraction, based on the same training data (e.g., reference treatment data), as described in FIG. 54, FIG. 30E, and FIG. 51 descriptions. In turn, these transformations may facilitate comparisons between methods to further refine the training of models.

See FIG. 36-41 for tensor-based featurization and FIG. 51 for descriptions of tensor-based classification in accordance with various embodiments of the invention.

To train a tensor-based classifier, the labels collaboratively developed during preparation of the training data (See FIG. 30E) may be set as the target values for the classifier model to learn to predict. For example, a label may generated for a category of steps in a Problem-Solving Therapy use case based on reference treatment data. Further, during preparation of the training data, labels may be associated with specific features in the training data. For example, a feature of a step in a Problem-Solving Therapy use case may involve statements related to a subject's acknowledgement of a problem. This may involve a binary target for classification of the step, “yes” or “no”, based on the training data, or scored on a scale (e.g., 1=no problem identified, 2=problem identified but not prioritized, etc). In FIG. 30C, the labels (target values) may be set for the neural net to predict, and the featurized data corresponding to the labels may be fed into the initial layers of the neural network, comprising nodes, or neurons. Features in the training input initially may be associated with neurons in the input layers. Then, the features associated with the input layers may pass to other layers where the input features may be transformed, layer by layer. These transformations may involve initially random weights characterizing the strength of connections between neurons representing the input in different layers, which may be summed, to determine if the sum is great enough to activate a calculation, or function, in a layer. These weights and functions may continue to transform the value of the input, layer by layer, until the neural net produces an output layer, containing predictions (e.g., a likely acknowledgement step in a Problem Solving Therapy use case). A calculation may determine how much of the output is in error, based on information lost during the various transformations. This loss information may be calculated by comparing the input training data and the output. This loss information then may be used to adjust the weights learned during the transformation, to see if the loss is reduced. This process may occur iteratively until the loss is acceptable, at which point the associated weights and functions may describe a classifier ready for testing. The classifier may be tested using one or more subsets of the training data held out, or not used, during training. The model may be considered trained when test results of the classifier on one or more hold-out sets, as unseen sets, are satisfactory to the editors. From the output of a trained classifier, it may be determined what features in the input result in particular health assessment scores, and their respective magnitudes (values). Preferably, a classifier may be trained to not only apply treatment use case classifications to audio segments, but also reciprocity scores, and the like,

See also FIG. 24, FIG. 26 and FIG. 35, related to classifying and scoring a condition based on a natural language input (e.g., a LLM provided a transcript and a natural language prompt).

In the case of fine-tuning a large language model to act as a classifier, note, as described above and in FIG. 30E, that the output of the training data preparation may include collaboratively developed features and labels transformed into suitable language for prompting a LLM. See FIG. 31 for how the output of FIG. 30E may be used to fine-tune a LLM, including as a classifier.

FIG. 30D is a flow diagram illustrating steps of an automated method for training an extractor on reference treatment data in accordance with various embodiments of the invention.

See also FIGS. 36, 38, 40, 42-45, 46-47 and 50 for descriptions of tensor-based extractions in accordance with various embodiments of the invention.

Unlike classifiers, which may classify inputs based on predetermined classes (e.g., a use case identified by a use case classifier), extractors may extract specific input based on labels for that specific type of input. In the example embodiment, an extractor may be trained to extract a Contract for a Contract class in the story-based ontology class hierarchy, such as a Contract between a “caregiver” and a “coach” or “interviewer”. In the example embodiment, the extraction of a Contract, such as between a “caregiver” and a “coach,” may be based on features, such as “thanks for helping me identity the issue”. To continue further with the illustration, in the example embodiment an extractor may be trained on examples of ways of saying “thanks for helping me identity the issue”. In the example embodiment, story-based ontology information (e.g., Contract in a Contract class associated with a use case instance involving a Problem Solving Therapy) may be extracted from the reference treatment data and associated with the corresponding features.

To train a tensor-based extractor, the labels collaboratively developed during preparation of the training data (See FIG. 30E) may be set as the target values for the extractor model to learn to predict. In the example embodiment, a target value for an extractor may be a story-based ontology information, such as a Contract in a Contract class (e.g., a “Caregiver-Coach Contract”). Further, during preparation of the training data, labels (e.g., ‘Caregiver and Coach Contract”) in the example embodiment may be associated with specific features in the training data (e.g., “thanks for helping me identity the issue”). In FIG. 30D, the labels (target values) may be set for the neural net to predict, and the featurized data corresponding to the labels may be fed into the initial layers of the neural network, comprising nodes, or neurons. Features in the training input initially may be associated with neurons in the input layers. Then, the features associated with the input layers may pass to other layers where the input features may be transformed, layer by layer. These transformations may involve initially random weights characterizing the strength of connections between neurons representing the input in different layers, which may be summed, to determine if the sum is great enough to activate a calculation, or function, in a layer. These weights and functions may continue to transform the value of the input, layer by layer, until the neural net produces an output layer, containing predictions (e.g., a likely Caregiver-Coach Contract). A calculation may determine how much of the output is in error, based on information lost during the various transformations. This loss information may be calculated by comparing the input training data and the output. This loss information then may be used to adjust the weights learned during the transformation, to see if the loss is reduced. This process may occur iteratively until the loss is acceptable, at which point the associated weights and functions may describe an extractor ready for testing. The extractor may be tested using one or more subsets of the training data held out, or not used, during training. The model may be considered trained when test results of the extractor on one or more hold-out sets, as unseen sets, are satisfactory to the editors. From the output of a trained extractor, it may be determined what features in the input result in particular labels (e.g., “Caregiver-Coach Contract”). In the example embodiment, features (e.g., “thanks for helping me identity the issue”) may be associated with a label (“Caregiver-Coach Contract”) various ways, for example, by mapping the label to the input used to predict a label.

See also FIG. 24, FIG. 26 and FIG. 35, related to extracting based on a natural language input (e.g., a LLM provided a transcript and a natural language prompt). In the case of fine-tuning a large language model to act as an extractor, note, as described above and in FIG. 30E, that the output of the training data preparation may include collaboratively developed features and labels transformed into suitable language for prompting a LLM. See FIG. 31 for how the output of FIG. 30E may be used to fine-tune a LLM, including as an extractor. See also FIG. 30B descriptions related to the use of probabilistic predicates in the example embodiment to conduct reasoning functions on classifier and extractor input and output.

FIG. 30E shows how training data may be curated collaboratively in accordance with various embodiments of the invention. Training data in this context may refer to data that is used to train machine learning models to perform certain tasks.

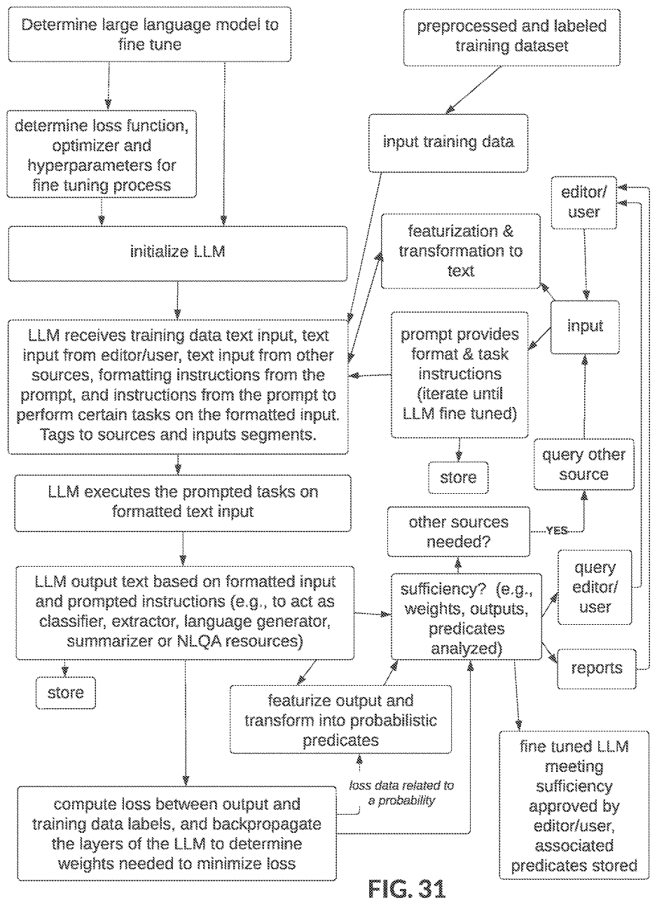

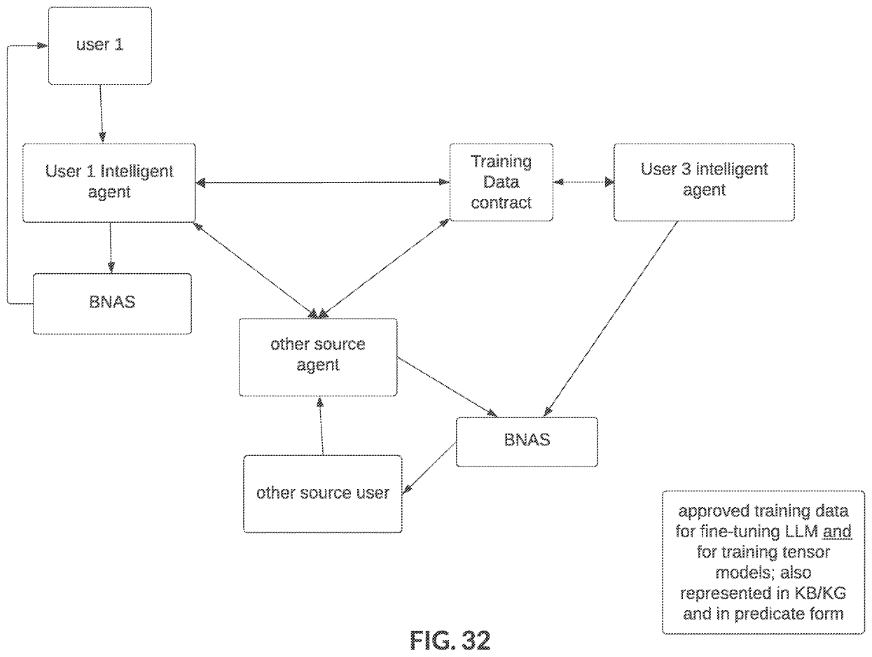

In the example embodiment, the collaborative curation of training data may take place through an AI platform with probabilistic programming and AI computational tools, as is described in FIG. 30E. In another embodiment, the curation may take place through a decentralized collaborative network running on intelligent agents. The latter may optimize and automate data curation using a prompt generation system and downstream models and programs, as described in FIG. 12, where an intelligent agent, in collaboration with user, may determine the optimal processing flow. See FIG. 32 for an illustration of this other embodiment. In both of these embodiments the story-based ontology described in FIGS. 3-7 may be utilized.

Selecting Training data.

In FIG. 30E, a training data set may be chosen as a basis for training one or more machine learning models. As shown in FIG. 30E, the approved output may be training data in formats appropriate for training deep learning models that intake and output tensors, deep learning models that intake and output natural language (text), and encoded knowledge stores. In FIG. 30E, training data may be approved by editors or by an algorithm approved by editors.

As an overview of the training data curation process described in FIG. 30E, the steps may begin with determining what sources to use for training data, which users/editors to authorize what access and functions, and which models the training data may be used to train for what purpose.

In the example embodiment, to assist users/editors with training dataset selection and curation, automated suggestions may be made to users based on what the system may learn automatically about the purpose of the training data from interactions between editors using the AI platform. Training datasets may be weighted by purpose, subject matter, relevance to a use case, or by other factors, by various methods. For example, the input of one or more editors describing a training dataset may be used by the AI platform to determine the similarity between the editor input and candidates in a store of datasets; a list ranked by similarity to the editor input may then be generated by the AI platform and posted for editor review and action on a query platform for selection by editors. Other methods to determine training database selections may include Bayesian reasoning or statistics. Consequently, a dataset related to golf may not be weighted as highly as a dataset related to caring for an elderly loved-one, if the use case that editors are developing relates more to the latter.

To continue with dataset selection, the system may learn from editor inputs that the editors wish to facilitate better outcomes for older adults and their caregivers by using validated health instruments and validated models of care (i.e., intervention or treatment) to guide interactions between them. In the example embodiment, validated instruments and care models may be associated with a clinical trial dataset that may be used as training data.

In the example embodiment, training data based on a clinical trial may include reference speech data and/or reference treatment data (See FIGS. 30A-30D). In the example embodiment, reference speech data may refer to a large collection of conversations that i) are similar in nature to common use cases, involving for example older subjects and medically related use cases, and ii) occur during a clinical trial intervention before which and after which subjects in the clinical trial are tested using clinically validated health assessments. These validated assessments may include any number of validated health instruments used in medical research during a clinical trial. For example, validated health instruments used during a clinical trial may include, but may not be limited to, one or more of the following: GAD-7 [Generalized Anxiety Disorder evaluation using 7 questions], QOL [Quality of Life], Physical quality of life, Social quality of life, Emotional quality of life, Financial quality of life, PHQ-9 [Public Health Questionnaire with 9 questions], and Caregiver Reaction Assessment. In the example embodiment, a classifier subsystem and classifier functionality that generates scores associated with health assessment may be trained on the same reference speech data.

In the example embodiment, reference treatment data may refer to a validated intervention and its steps (e.g., a progressive therapy treatment [Problem Solving Therapy] with coached steps and goals) evaluated during a clinical trial. Elements of a clinical trial dataset involving a validated intervention may include: i) the progressive steps and goals of an administered intervention, ii) conversations that take place during and after the intervention, iii) a subject's longitudinal scores based on validated health instruments, iv) a subject's progress towards goals based on changes in the scores of validated health instruments before and after an intervention; v) a subject's profile; vi) the care team composition, including family caregivers and community support; vii) a provider's scores based on provider fidelity to the protocols of an intervention, and viii) various other matters that may interest editors as they collaboratively develop prompts to instruct a LLM during fine-tuning.

In the example embodiment, multiple types of training data may be selected by the editors for curation, depending on the purpose. For example, editors with development responsibilities (i.e., software engineers and architects) may want examples of story-based ontology information to label, so as to encode a training dataset with a story-based ontology to enrich model performance and integration by standardizing model input data. The story-based ontology may be used to add a reasoning and inference layer to the data, which may facilitate more accurate and context-aware predictions. Meanwhile, other editors with medical backgrounds may want clinical trial datasets as a gold standard for a medical use case to assist patients. In this example, training data may be curated so as to ensure that the training data is encoded with labels that associate both the story-based ontology and medical information to satisfy a collaboratively defined purpose involving a team of editors (e.g., a data science team). In the example embodiment, editors may choose training data sets from various sources (e.g., a repository of clinical trial data), or develop them through collaboration using examples and/or expert input as editors, or both.

Multiple inputs.

Once the training data is selected, it may be input into a featurization system, which may transform unstructured data, such as raw text, or for that matter a video call (e.g., video data, audio data) into a machine-readable format by datatype. Inputting raw training data into a featurization system may reduce or eliminate typical preprocessing of input many times handled as a separate manual process. In the case of text data, after featurization, the text may be transformed into natural language with the benefit of having been preprocessed automatically by the featurization step before inputting into an LLM. Meanwhile, the featurization of input text from the training data may put the focus on generating features useful to downstream models and programs. Like the training data, the input of editors may flow into the same featurization system (e.g., through devices connected the AI platform via query platform). Inputs from other sources (e.g., electronic medical records) approved by the editors for use during curation also may flow into the featurization system.

### Multiple Users.

Referring to FIG. 30E, users during the curation of training data may be editors or other sources, including databases, systems, and experts. Inputs received by the communications featurization system may include editor inputs, training data inputs, inputs from other sources and inputs from prompts themselves. In various embodiments, inputs also may include information from knowledge graphs encoded with story-based ontology information containing relevant use case information.

### Featurization.

The received input may be single or multi-modal communications input, timestamped, tagged to the source of input (e.g., devices, types of data, users, library index) and stored, so outputs from downstream processes may be mapped back to source inputs and facilitate rich contextual analysis to improve subsequent interactions with users/editors. Storing the original input may facilitate lookbacks and analysis comparing inputs to outputs of models.

The input may be received by a featurization system, which may generate transcripts, tags between text and audio segments, tokens, n-grams, word vectors, audio segments, sound features, video segments, images, detected objects in audio, detected objects in video, simple data, formatted 3rd party data, user or subject (e.g., speaker) and segment tags, and tensors by datatype, based on the input.

In another example embodiment, the featurization system may be a custom-trained featurization system trained using audio content based on a large collection of conversations from a clinical trial, in other words, reference speech data.

In yet another example embodiment, the featurization system may be a communications featurization system with an embedded prompt generation system, whose component models in various embodiments may be custom-trained on a story-based ontology and/or reference speech data and/or treatment reference data and/or at least one of a plurality of use cases.

### Analysis, Label Generation, Sufficiency.

Continuing with the FIG. 30E description, featurized outputs may flow from the featurization system into two pipelines for generating structured knowledge, reasoning with it, and evaluating whether sufficient information has been provided as input, whether insufficiencies may be resolved through inference, or whether more information may be needed. A copy may be made of certain featurizations (e.g., text). One pipeline of featurizations may feed into classifier and extractor models that use featurized data to score inputs and produce labels based on prior training. The other may flow after a transformation into raw text, as applicable, into a LLM.

Meanwhile, as shown in FIG. 30E, descriptions (“frowning man”) of objects (e.g., a frowning man) detected during featurization of inputs may be looked up in a library, retrieved, featurized, and associated with other features based on the same input segment, or dataslices, By featuring these descriptions and associating them with other featured data from inputs, a fuller set of data inputs may feed into the tensor-based classifiers and extractors. As shown, these featurized text-based inputs may also be transformed into raw text and provided as part of a fuller set of data inputs for the LLM pipeline. Thus, the original inputs, which may include key information contained in descriptions of detected objects, may flow into two pipelines to generate labels and analysis. Recall, the tensor-based classifiers and extractors may be trained to output tensors associated with scores and labels. (See FIG. 30A-D descriptions on training classifiers and extractors.) As to LLMs, these too may be fine-tuned to generate output that may be used as labels, if so prompted. Note that as it relates to the LLM, one or more prompts may provide the LLM with instructions on tasks to perform on the information transformed into natural language, These prompts may be generated by various means. For example, prompts may be developed by users manually in one example embodiment or in another embodiment prompts may be generated automatically by the system based on what the system learns about the collaborative purpose of the training data and what communications with the users are most likely to yield a user response that accelerates the completion of the training data curation process,

Continuing now with the tensor-based pipeline, as shown in FIG. 30E the outputs of the featurization system may be associated temporally and/or by dataslice/segment and flow into trained extractors and classifiers to perform the tasks on the input for which the extractors and classifiers are trained (e.g., score anxiety on a GAD-7 scale, extract story-based ontology information from inputs). The output of trained extractors, using tensors as input, may be tensor outputs representative of structured knowledge, in other words, data encoded so as to facilitate reason-based tasks. This structured knowledge output may be in the form of scores based on classifier tasks to evaluate and classify featurized inputs. For example, input into a GAD-7 classifier may be “classified” as anxiety with a level based on a scale. As an example of a trained extractor output, input into a story-based ontology-trained extractor may output for the same dataslice used to generate a GAD-7 score an extracted instance of the story-based ontology (e.g., Role [mom], Task [lifting], etc.) These models may output tensors associated with labels; additionally, probabilistic predicates may be generated based on these tensors. At the same time, the output of the LLM, which is text, may include labels as well. In the example embodiment, a LLM fine-tuned as an extractor and/or classifier outputs may receive as inputs a natural language transformation of featurized inputs. The outputs of a LLM fine-tuned on a story-based ontology may pair text inputs with extractions based on the story-based ontology (e.g., Charles, caregiver role in a Role class).

Next, the LLM output may be featurized and probabilistic predicates produced from that featurization, and compared with the predicates from the tensor-based models. Meanwhile, the output of the LLM also may be subjected to various NLP techniques (e.g., named entity recognition). The output of the LLM then may be compared with information in a knowledge graph and/or knowledge base encoded with a story-based ontology. The predicates generated from the tensor models and from featurizations of the LLM output also may be compared with information in the knowledge graph or knowledge base.

Thus, labels generated from trained/fine-tuned deep learning models based on featurizations and on natural language versions of inputs may be associated with each other and with predicates, and then evaluated using predicates as well as a knowledge graph. The analyzed information then may be used to determine if sufficient information exists to approve the state of the training data. The results of the analysis may be compared to thresholds, and if more information is needed, the system may seek to resolve it through inference on its knowledge stores, predicate logic, and various other means. If it is unable to resolve the dependencies in the story-based ontology or between predicates, it may prompt another source for more information, or query users who may be curating the training data.

### User Queries/Elicitations.

In the example embodiment, a query may be generated by the system to solicit responses from other data sources and/or editors based on an analysis of what information may be needed to advance the user's progress in curating the training data. In the example embodiment, these solicitations may be generated by the AI platform and made available to editors through a query platform or other means of connection to the AI platform.

A progression of guided interactions may be predicted by the example embodiment to help users efficiently advance towards the objectives they may wish to reach. These communications may be referred to generally as elicitations. In the example embodiment, an elicitation may involve techniques to influence what a user might say or do in response to a communication,

In the example embodiment, elicitations may be a multi-modal communication, or a single mode of communication (e.g., text). The purpose of the elicitation may be to provide a support guidance, recommendation, command, or other intentional communication to the editor or user, including system users capable of ingesting and processing multi-modal inputs.

In the example embodiment, elicitations may be composed into a template, which may serve as a stimulus to evoke a response or action from an editor or other user, including system users. Elements composable into a template by the example embodiment may include, but may not be limited to, one or more questions, statements, pictures, videos, songs, graphs, as well as applications that may require or evoke certain user input or action.

Various elicitations and elicitation techniques may be used singly or in combination to facilitate a particular response from a particular user. In the example embodiment, communications use cases may condition AI communication styles and composition for a system-generated communication to a user. These customized communications use cases may be used to custom populate a template based on dependencies in the use case specific to a user, and facilitate scalable, systematically customized elicitations.

In the example embodiment, to improve the effectiveness of elicitations, user input data received after an elicitation generated for a user by the AI platform may be compared to the output data in the elicitation generated for the user by the AI platform. Various correlations may be made between the user data and the elicitation data by the example embodiment. The example embodiment may determine from analysis of the user input data and the elicitation output data which elicitations and which elicitation techniques each user may tend to respond to in which contexts.

Elicitations in the example embodiment may relate to user needs for information or system needs for information to appropriately assist a user, or both. Elicitations in the example embodiment may also be used to motivate a user's particular actions, which may or may not be accompanied by a temporal communications response from the user.

For example, an elicitation to purchase certain food may take the form of a mouth-watering picture of the prepared food with a recipe; an elicitation to purchase the same food may also take the form of a command to buy it. These may illustrate various elicitation techniques.

In the example embodiment, multiple elicitations may be orchestrated into a single, multi-modal stimulus. The elicitation may be interactive. For example, a video with subtitles and questions at the end may be generated for a diabetic user from compiled video data slices, wav files, nutritional guidance text, culinary guidance text, and other data based on stores and on user inputs and best next steps for the user predicted by the example embodiment.

In the learning loop described in FIG. 30E, the editors may respond to an elicitation or recommendation generated by the system, based on processed inputs as well as on other factors, such as story-based ontology reasoning.

### Activity Information for Users During Curation.

In the example embodiment, users/editors may access activity information (See FIG. 34) about the training data under curation as they curate it. This information may include any labels that may be automatically generated from the models during curation, as well as suggestions for new labels based on resolved dependencies or completed predicates, including those generated from inference, information about prompt language, missing training data information (e.g., via analysis of logical and other dependencies between predicates transformed from user's featurized inputs), tracking data, and more. This activity/progress information may be provided through the query platform or other interface connected to the AI platform.

### Annotations of Training Data.

Note, the term editor in the context of training data curation may refer to human users who may make labeling/annotation decisions. In the example embodiment, assistance with labeling decisions may be automated by the system by various methods. For example, during a conversation between users (editors) during dataset curation, the system may assist editors with annotations by generating a transcription of their conversation for them to annotate, using the query platform or another interface connected to the AI platform. These annotations may then cycle through the learning loop shown in FIG. 30E, as new user input received after system output as an elicitation or confirmation request that the annotations were processed by the system correctly. In the example embodiment, the system may map topics learned during conversation to other training data and solicit answers from editors based on the system's analysis of meaningful inconsistencies (e.g., via the use of probabilistic predicates).

In the example embodiment, users may act as editors of their own data, which may serve in effect as training data for models customizing a best next action step for them. For example, a user may wish to amend training data based on the user's profile in an electronic medical record section related to statements of family medical history. And so, in the example embodiment, the system may use new inputs to continually learn or adapt to specific user needs, thus blurring the typical distinction between development and implementation as well as between editor and user. It may be said that in the example embodiment, the system is a never-ending learning loop involving user input, processing, queries to users and then processing new outputs into the next query or elicitation or recommendation to advance the users progress on what they're collaborating on.

### Example Curation Using Video Input and User Annotations.

In the example embodiment, dataslices (segments) from a video call may be split into audio and video datastreams, which through timestamps and other methods may be synchronized. Further, in the example embodiment, objects detected during feature extraction in the video (e.g., frowning face) and objects detected during feature extraction in the audio (e.g., a whistle used by a coach), may be indexed to a natural language description in a store, which may also be associated with the dataslices as text (e.g., via a method involving timestamps). In a preferred embodiment, the natural language text retrieved from indexed object descriptions may be featurized so that all text in the system may have a featurized representation to accommodate models that only take as input featurized data. The text may be concatenated, transformed from featurized text into natural language as appropriate, and used as the basis for new language generation by a LLM that processes natural language into natural language output, including summaries of the natural language inputs, for easier annotation. Meanwhile, editor inputs from speech or other communications inputs, as mentioned above, may be featurized, and mapped by association to other processed inputs. Associations may be mapped by topic in the example embodiment to further encode knowledge representations generated from user inputs with topic and other contextual information, such as any temporal information.

As shown in FIG. 30E, all featurized text inputs, including from detected video and audio objects with indexed descriptions (which may be featurized after extraction from a library of descriptions), may be transformed into natural language. In the example embodiment, the tags to inputs may facilitate the management of various associations based on context. For example, an input from the original training data related to a caregivers complaint about physical pain caused by lifting up her mother who needs assistance moving may map to comments about physically assisting a caregiver made by an editor skilled as a nurse or physical therapist. So, while the inputs may not be temporal (inputs may occur at different times), they may be associated. In the example embodiment, mapped topics, annotations, and original training data input may be associated (e.g., based on tags, timestamps and analysis) and then these associated featurizations may be transformed into natural language and summarized in natural language for editor review and for further annotation.

### Training Data Curated for Updating Knowledge Stores and Training Models.

As shown at the end of the process illustrated in FIG. 30E, in the example embodiment training data may be approved in a form suitable for LLMs as well as for models that use input tensors. Additionally, in the example embodiment, both tensor-versions and LLM versions of the training data may be evaluated by probabilistic programming language using the probabilistic predicates generated from featurizations and the transformations of natural language into featurizations, to ensure that both versions of the training data are of equal standard, or as close to it as possible. Likewise, in the example embodiment, a knowledge graph may also be used to represent data from either featurized or natural language model outputs, or both. So knowledge graphs, via computational tools, may also provide another way to evaluate tensor-based and natural language model outputs (and inputs). As a result, both predicates and knowledge graphs may be used to represent model outputs or further evaluation, and may themselves also be evaluated in relation to each other. These checks and balances may help ensure that the training data is curated using various views of the data and in the process assist editors curating data for training purposes with new insights about it.

FIG. 31 is a flow diagram showing a collaborative process for fine-tuning a large language model in accordance with various embodiments of the invention.

In FIG. 31, the flow starts with selection of a large language model and training data on which to fine-tune it.

In the example embodiment, editors may determine which large language model to fine-tune for what purpose (e.g., to act as a coach regarding a certain domain with related training data). These purposes may be determined collaboratively with support from an AI platform that may analyze inputs and attempt to construct instances of the story-based ontology from them, which may include Contracts associated with deliverables between identities, representing different editors, who may be represented as having multiple roles.

Based on an agreed purpose for the fine-tuning, considerations of various merits of different LLMs may be weighed. As shown in FIG. 31, various criteria may be determined for the LLM, including loss function, hyper parameters, and so forth.

Likewise, in FIG. 31, a previously curated training data set (see FIG. 30E) may be selected by editors on which to base the fine-tuning of the selected large language model.

Next, after a large language model and training data are selected, the LLM may be initialized with agreed parameters and other information as determined by the editors, and readied for the input of the training data, as shown in FIG. 31.

Turning now to the inputs into the LLM during fine-tuning, these inputs may include training data text input, text based on input from editors and users, text based on input from other sources, formatting instructions from the prompt, and instructions from the prompt to perform certain tasks on the formatted input. The inputs into the LLM may all be unfeaturized text from sources that may be tagged to input segments. The double arrow shown between the received LLM input and a box indicating featurization and transformation into text signifies that inputs that may have been featurized may be transformed from featurizations into natural language for use by the LLM. See FIG. 54.

Referring now to the prompt shown in FIG. 31, the language of the prompt may be generated various ways in the example embodiment. As an example, input from editors/users may be featurized and transformed automatically into structured knowledge (e.g., story-based ontology-encoded predicates or knowledge graph information), based on deep learning analysis of task requirements to support user goals, and then be transformed further into unstructured natural language for use in a prompt specifically for a LLM (See prompt generation system, FIG. 12). This automation of prompts may allow editors to focus on fine-tuning and evaluating inputs instead of the mechanics of prompt development. In another example embodiment, a prompt may be developed collaboratively as a software artifact, where the system may guide editors to manually complete a prompt through the system based on predicate analysis and a template. See FIG. 22C.

Once the LLM selected for fine-tuning receives the formatted inputs, the LLM may execute tasks on the formatted inputs as instructed by one or more prompts, and generate an output as shown. The output of the LLM during fine-tuning may be stored.

In the example embodiment, various methods may be used to determine how much information input into a LLM during fine-tuning may be lost when the model runs, what information may have been lost, and what new information may improve the quality of the output.

During fine-tuning, an algorithm may compute how much information from the inputs may have been lost when the LLM performs its instructed tasks on the input. As shown in FIG. 31, a loss computation may be based on comparing labels from training data to the output. This computation then may be used during fine-tuning to determine what weights used in the LLM may minimize information loss, and then to make the appropriate adjustments in the model parameters. Parameter settings for a LLM during fine-tuning may be adjusted by editors (e.g., software developers), or automatically via an algorithm approved by editors or via a prompt generation system that may manage LLM parameters during fine-tuning. Improvements may be determined during fine-tuning by comparing loss data information from iterative adjustments in the parameters. Adjusting model parameters and evaluating model outputs may be an iterative process during fine-tuning, which may involve various inputs from editors and other sources.

In the example embodiment, the computed loss of original input information during the fine-tuning of a LLM may represent uncertainty about the outputs. In addition to this uncertainty, which may be determined by an algorithm, the LLM itself may be prompted to generate a statement as to its own confidence in its model outputs (See FIG. 24). In the example embodiment, Bayesian models may use different probabilities, such as those associated with information loss and confidence in model outputs, to determine a single likeliest probability. In the example embodiment, modeled probability may inform the generation of probabilistic predicates during fine-tuning and implementation. This modeled probability also may be used in statistical analysis, algorithms, models, and so forth, to update and analyze various aspects of likely user current and future states.

In the example embodiment, various methods may be used to identify what information may have been lost during a model's execution of tasks on the input data. For example, predicates generated during training data curation (See FIG. 30E and description) and predicates generated from outputs of a LLM being fine-tuned may be compared to determine what specific data may be lost during fine-tuning. In the example embodiment, knowledge graph-based on training data may also be compared to knowledge graphs based on LLM outputs involving training inputs. These comparisons may be used in the example embodiment to determine what data may be lost between inputs and outputs. Both described methods of identifying the lost information during fine-tuning or model training may occur automatically, and may be provided to the editors as activity information (e.g., searchable stores connected to an interactive template or interface for receiving new inputs). In the example embodiment, editors may have the flexibility to “eyeball” differences between inputs and outputs, or ask the system to summarize the missing information using natural language, including via speech.

To illustrate, let's say through predicate analysis or other methods, information determined to be missing in an output that was present in the approved training data input related to key meal preparation ideas in a diabetic use case. In this example, it may be determined that not enough information was provided in the training data to be able to fine-tune the LLM on it sufficiently. If such a determination is made, the process of fine-tuning then may involve augmenting the training data by commencing a new data training data curation process (See FIG. 30E), or depending on the degree of insufficiency, providing new inputs as editors during the fine-tuning process. For example, the editors may input a paragraph to guide diabetics on how to order from a menu when they are at a restaurant. In the example embodiment, information added during the fine-tuning of a LLM, if approved by editors, may be used to update the training data as well. Additionally, such updates to the training data may be used to update one or more hold out sets to test the outputs of the LLM during fine-tuning before approving the LLM for inference (e.g., predicting outputs based on the tasks it may be “fine-tuned” to perform).

Referring now to flows from the LLM output in FIG. 31, the output may be stored, used to calculate lost information as previously described, flowed into a sufficiency analysis where it may be mapped to its featurization, to facilitate various analytics. In the example embodiment, the output of the LLM may be featurized and transformed into probabilistic predicates as a basis for further analysis. As another method of analysis in the example embodiment, LLM output may be transformed into nodes and edges of a knowledge graph, based on a story-based ontology, for example. In the example embodiment, AI computational tools may perform various analytics and simulations on Knowledge graphs and, on the basis of these analytics, generate various probabilities.

Turning next in FIG. 31 to sufficiency, sufficiency evaluations may be based on of various metrics and thresholds involving probabilities associated with the inputs. In the example embodiment, sufficiency may regard the degree of completeness of various probabilistic predicate sets, as well as resolution of various dependencies between predicate sets, resolution of various class dependencies in a story-based ontology class hierarchy, and various other factors (See FIG. 10 and description).

During sufficiency evaluation, activity information may be provided to editors (e.g., information regarding learned weights, outputs, predicate analysis, etc.) in various forms and ways, including as interactive reports that accept editor annotation.

In the example embodiment, if it is determined that insufficient information exists during sufficiency evaluations, editors/users may be queried to supply it, and/or other sources may be identified from a reference set of sources agreed by editors and queried for it. The responses of editors and/or other sources to queries may then be received as new input, and the cycle shown in FIG. 31 may begin again. In the example embodiment, editors may limit, or an algorithm approved by editors may limit, the number of cycles during fine-tuning.

Once sufficiency is met, and based on editor approval, a LLM being fine-tuned may be provided one or more hold-out sets from the training data to test LLM outputs before ‘finalizing” the prompts, learned weights, etc., and associated predicates and story-based ontology instance information. In the example embodiment, there may be one or more hold out sets for testing. For example, depending on the training data, one or more hold out sets may involve on the one hand story-based ontology related labels and on the other hand use case labels, say, related to coaching a caregiver.

In the example embodiment, while predicates and story-based ontology instance information may be generated during the fine-tuning process, a final predicate set associated with “final” prompts, learned weights, training data, and various other information may be generated, along with associated story-based ontology instance information. In the example embodiment, “final” information associated with the final stage of testing a LLM may be tagged and stored, and include information related to editors and/or users involved in the fine-tuning. Recall, editors/users and relationships between them during a collaboration may be represented in the example embodiment as instances of the story-based ontology.

When a LLM is said to be fine-tuned, this may mean a LLM has learned to perform certain tasks on new data of a similar nature to the training data to the satisfaction of editors involved in the fine-tuning.

### Curation and Fine-Tuning as Projects.

In the example embodiment, curating a training data set and fine-tuning a LLM on the curated training data may be considered projects in terms of the story-based ontology class hierarchy. For example, a project may have a name property attribute value in an Identity class, (e.g., “LLM fine-tuning on diabetic advice data”, or “Project 1234”). A project in the example embodiment may be represented as a use case, comprising either a strict or flexible sequencing of story-based ontology instances. In the example embodiment, each story-based ontology instance may have a unique identifier to facilitate lookups in an index of story-based ontology instances. In the example embodiment, an index of recurring use cases, such as may be helpful to organize and manage a project, may facilitate the composing of a use case and the establishing of linkages between sequences, if more than one sequence is involved. In a strict order, a story-based ontology instance in a sequence of story-based ontology instances representing a use case may have an associated set of dependencies to resolve before a next sequence with its associated dependencies may also be resolved. For example, in a project, a briefing task (e.g., a Task class task) may have a dependency on briefing skills (e.g., Skill class skills) to communicate the purpose of a project in a briefing document (e.g., a Deliverable class deliverable) to people on the project, which must be satisfied (e.g., a Requirements class requirement) before people begin tasks of evaluating what information may be lost between training data inputs and LLM outputs. In the example embodiment, the system may compose a use case to establish specific dependencies, for example, through Contracts in a Contract class in the class hierarchy, to facilitate an orderly framework for collaboration between people and things involved in a specific use case, or project. In the example embodiment, a use case may be instantiated with generic information initially, which then may be updated with specific user and use case information as inputs are received and processed at run time. (See FIG. 10 description). In the example embodiment, the initial weights for value and uncertainty attribute components of Identity, Contract, Role, Deliverable, Requirement, Task and Skill classes in a use case may be based on genericized data from prior user instantiations, population information, reasonable assumptions of the editors, or other sources.

In the example embodiment, a best next action step may be generated for a specific project based on which specific instance of the story-based ontology may most need to be satisfied to advance the specific project. In the example embodiment, story-based ontology information related to a specific project may be updated and analyzed, using Bayesian models to “blend” generic target weights associated with the project and specific target weights associated with user inputs during project set up and during project implementation. In other words, target weights may be set in the example embodiment from user (editor) inputs during collaborative development of a project plan, which, as a project, may continue to be modified upon implementation. Additionally, target weights for various roles, deliverables, skills, etc., associated with the project plan, and later its implementation, may be linked by Contracts to various Identities.

In the example embodiment, Identities may be generated for a use case, BNAS, project, user and user agent, including system agents, since each may be represented in terms of instances of the story-based ontology (e.g., current and future states). Further, story-based ontology instances may comprise other story-based ontology instances, meaning the story-based ontology may have a recursive quality in the example embodiment. For example, a project may comprise a series of sequenced story-based ontology instances, where each series may represent a different job each of which also may comprise a series of sequenced story-based ontology instances. To continue with the example of the recursiveness of the ontological structure, a user represented in terms of story-based ontology instances may have Contracts with intelligent agents also represented in terms of story-based ontology instances.

Recall, a best next action step may be characterized as a directive instance of the story-based ontology, where target weights for value and uncertainty attribute components of Identity, Contract, Role, Deliverable, Requirement, Task and Skill classes in the class hierarchy may be generated from updates and analysis based on inputs, and on the use case. In the example embodiment, the BNAS then may be communicated as a recommendation or instruction for the recipient of the best next action step to execute.

In the example embodiment, a BNAS may be composed based on an inventory of use cases and/or developed on the fly. Additionally, in the example embodiment, a use case may be composed in a strict order or may be composed from various use cases into a composite for more flexible ordering. Let's start with an example based on a strict order example from an inventory of use cases, In the example embodiment, a project (e.g., “Project 1234”) may be identified as an indexed story-based ontology sequence (e.g., index values of “37”, “49”, “71”) composed into a strictly ordered sequence (i.e., an atomic use case, where the order of story-based ontology sequences to resolve/execute is “37”, “49”, “71”, or “37-49-71”). In other words, in the example embodiment, a use case may be composed as a series of best next action steps, each with their respective story-based ontology information. For example, “37,” related to developing a brief, may be followed by “49”, related to providing dietary advice based on “37”. In the example embodiment, a stepwise relationship between story-based ontology instances in a use case may facilitate tracking a use case status, at least in a general sense. However, it should be noted that while an ideal sequence of best next action steps may be prescribed as a use case (e.g., first “37”, then “49”, then “71”; recall, while an atomic use case may be 37-49-71, a composite use case could be several atomic use cases, for example, 37-49 and 71, where a strict order between use cases may not be required), users may drift from a recommendation they may agree to, wherein the drift may be detected and modifications made, as appropriate. In the example embodiment, a BNAS may be composed on the fly, based on updates and analysis of user inputs, and specific dependencies emergent in a specifically implemented use case, to represent unique target weights for the value and uncertainty components of attributes in the classes in the story-based ontology class hierarchy. In the example embodiment, use cases developed on the fly may be assigned an index number and serve as reference for future use, in a genericized form, regarding the example user or other users.

In the example embodiment, an intelligent agent associated with a project may generate a BNAS related to advancing the project. An intelligent agent in the example embodiment may communicate with agents of other users, such as human users, involved in the project to determine which optimal human user may take the best next action step (e.g., “Tom” or “Mary”), or whether the best next action step may be performed by the agent itself (e.g., an agent “trained” to be a nutritionist), or by another thing that the agent may control (e.g., an automated food dispenser in the home). In the example embodiment, Contracts (e.g., a Contract in a Contract class) may “link” identities of people and things, where an agent may be a type of thing associated with a specific user, and their respective class hierarchy. As an instance of the story-based ontology with a universal class structure, a BNAS's Contract class may involve an exchange of deliverables (e.g., a deliverable in a Deliverable class) between roles within an Identity (e.g., a Contract between a “father” role and a “worker” role to achieve a better balance between roles) or between Identities (e.g., between the “worker” and the “boss”). In the example embodiment, a BNAS may be a simulated instance of the story-based ontology predicted to advance an Identity towards a desired future state. In the example embodiment, a desired future state for people and for things may be described in terms of targeted weights for various attribute components of the story-based ontology class hierarchy. In the example embodiment, the Contract class component of a BNAS may act as a method to help move people and things towards certain generated target weights. In the example embodiment, a Contract class within a BNAS also may facilitate alignment between Identities, by focusing on an exchange of deliverables requiring specific tasks, or actions, deliverables and so forth to fulfill a Contract. By fulfilling, or attempting to fulfill various Contracts, a user or thing, such as a project involving users, may move towards a desired future state for which Contracts may be generated and modified from new inputs.

In the example embodiment, a BNAS for a project and a BNAS for a user may be tied together through a Contract between them. For example, the role of “editor” in a project associated with an Identity “Project 1234” may be “filled” by a Contract with an editor role associated with an Identity “Tom.” Further, BNAS may relate to steps, or instances of the story-based ontology, that also may relate to an advancement of “Tom's” Identity's goals and “Project 1234”'s Identity goals. Recall, goals in the example embodiment may be represented in the story-based ontology through various target weights for attributes; a project as an entity/Identity may have classes with attributes). For example, “Project 1234” may have a deliverable of “diabetic advice” in its role as a coach within the “Project 1234” Identity, with a use case composed to accomplish it, and a BNAS generated based on the use case. Meanwhile, a user with an Identity “Tom” may have a deliverable associated with Tom's role as an editor in the project of “diabetic advice” and a BNAS generated based on the user role as a nutritionist to deliver it. So, Tom's roles as editor and nutritionist both may relate to Tom's Contract as the Identity Tom with the project identity. Furthermore, the project identity may have an intelligent agent.

To continue with the illustration of Tom's roles in Project 1234, there may be a Contract between Tom's roles as an editor and Tom's role as a nutritionist (See FIG. 3). Recall, in the example illustration, that what Tom in his capacity as editor is editing may be a use case involving everyday advice for diabetics, where Tom's role in his capacity as a nutritionist may be to give nutritional advice to diabetics. Let's add that the use case itself may comprise instances of the story-based ontology related to various likely diabetic situations (e.g., various current or future states of a representative diabetic), which may include an instance of ordering food at a restaurant. So, to continue with an illustration of the story-based ontology classes involved, the editor's identity may be a person Tom with an editor role and a nutritionist role. In addition to Contracts that Tom may have with the project and between his own roles, Tom in his role as a nutritionist role may have a Contract with a generic user's diabetic role. In this example, a Contract comprising an exchange of deliverables between Tom's nutritionist role and the generic user's diabetic role may involve a deliverable, “Advice,” given by the nutritionist in exchange for an everyday situation information given by the generic user in a diabetic role. Now, to further illustrate, the generic diabetic role, involving a “get” from a nutritionist role, may be played by another user (e.g., via another editor whose other role may be as a diabetic, or, by a LLM that may be prompted to play the role of a diabetic or generate everyday situations faced by diabetics). So, in the illustration, Tom may have Contracts between his two roles, editor and nutritionist, and Contracts with the project requiring Tom's contributions as an editor and a nutritionist; meanwhile, Tom's role as a nutritionist may have a Contract with another user's diabetic role, where the other user may be a generic user represented based on population characteristics, for example, or another user, who also could be an editor and a diabetic. Now, to return to the best next action step for the editor role of Tom in this illustration, let's say that it is determined by Tom's agent that key unresolved dependencies in the story-based ontology instances associated with the use case involve meals. This best next action step for the Tom as editor, once determined, may be communicated in natural language to the editor. For example, the system may ask: “The use case you're working on Tom is missing information that may help diabetics order food at a restaurant, a common situation for diabetics. Are you up for writing a paragraph to help a diabetic order food at a restaurant?” In the response, the editor may say, “Why don't you write it, and I'll edit it. After all, I am an editor,” In the example embodiment, an agent of the user may execute various user instructions, with permission of the user, based on various legal and ethical constraints. To continue with the illustration, a prompt may be automatically generated, based on the user's input (e.g., via a prompt generation system trained on user input and various other sources of knowledge), and the output provided to the user to then annotate.

FIG. 32 shows intelligent agents during training dataset curation in accordance with various embodiments of the invention. Note the Contracts between the agents of users involved in the training, including another source user involved in curating the training data.

FIG. 33 shows a sequence of collaboratively developed software artifacts in accordance with various example embodiments of the invention. This is not meant to suggest that any collaborative development process must follow the illustrated order, only that in one embodiment it may. For example, collaboratively augmenting use case examples constrained by story-based ontology relationships may be accomplished in various example embodiments without having to initially collaborate on a glossary for the story-based ontology.

The point of the flow in FIG. 33 is to show that the output of one collaboration in the example embodiment may be input into the next collaboration using the same system. For example, as shown, a glossary for an ontology may be collaboratively developed. To collaboratively develop a glossary, editor input may be received for a glossary comprising terms and relationships with examples. The input may be featurized and probabilistic predicates extracted. In turn, the extracted predicates may be evaluated for completeness and the predicate sets may be evaluated for unresolved dependencies between them as the glossary builds and is evaluated by the editors. The system may attempt automatically to complete the predicates and resolve the dependencies based on predicate structure requirements and the use of probabilistic programming. The system may use another source in the process and/or pose natural language questions to editors to solicit input, until editors may deem the work product sufficient based on thresholds.

In turn, the logic and relationships between the terms established through the collaborative development of the glossary referred to in FIG. 33 may serve as new knowledge that may now constrain the collaborative development of a use case based on the terms and definitions established for the glossary. During collaborations, editors my augment the examples they use during their collaborations to provide a broader and deeper base of knowledge related to their project, for example, fine tuning a deep learning model on a use case that also may be encoded with the story-based ontology. See FIG. 30E and FIG. 31 for various embodiments related to how such training data may be curated collaboratively and used to train a LLM.

FIG. 34 is a block diagram showing activity information provided to users (recall, users may include editors) in accordance with various embodiments of the invention. Activity information may include information about any interactions the user may have with the system for which there is reportable information and/or analysis, which may involve any development and/or deployment uses of the AI system in the example embodiment.

In the example embodiment, a network of users may collaboratively use an AI platform with probabilistic programming to develop various software artifacts. The activity information provided in the example embodiment may relate to the state of software artifacts being collaboratively developed with the system. “Software artifact” may refer collectively to what software is, what software does, how software is organized, what the software requires, and how software is to be used. Software artifacts may include, but may not be limited to, a knowledge base, a knowledge graph, an ontology (e.g., a story-based ontology), a use case, a user data base, prompts, training data, classifiers, extractors, avatars, intelligent agents, algorithms, fine-tuned large language models, model architectures, tensors, thresholds, compilers, code, data types, predicates, programming language rules, filters, templates, displays, and various other work products or applications associated with software-related development projects.

To illustrate, software developers and subject matter experts may team up as in various embodiments to define terms of a ontology, evaluate dependencies within and between classes in the ontology, generate and augment examples of an ontology for use as training data to fine-tuning a large language model; develop rules for a probabilistic programming language based on dependencies in an ontology; invent structures for a datatype related to an ontology; and so forth. In other words, via the example embodiment, software artifacts may be developed, then used to develop new software artifacts, and to structure relationships between them, as editors/users may decide.

In the example embodiment, collaboratively developing software artifacts may involve deriving communications features from communications input. Activity information may relate to what communications inputs may be associated with the generation, transformation, updating and analysis of what software artifacts.

In the example embodiment, data based on inputs may undergo various transformations between unstructured knowledge representations (e.g., natural language) and structured knowledge (e.g., knowledge base or knowledge graph) during both development and implementation phases of various software artifacts. Activity information based on these transformations may be available, using tags to the inputs, editors and the various representations. For example, speech data (e.g., unstructured knowledge) may be tagged to a speaker, and transformed into a story-based ontology information (e.g, structured knowledge) and a classification score (e.g., structured knowledge) also represented as a story-based ontology information, to then be transformed again into an unstructured natural language account of what was said (e.g., the person talking is likely a mom and a caregiver with some anxiety).

In the example embodiment, updating and analysis stages may occur during development of a use case or user database or other information. In the example embodiment, updating and analysis stages also may occur during live deployment of a use case or user database.

In the example embodiment, activity information may involve where and in which use case a user may be located, a user future state projection based on simulation, unfulfilled Contracts based on the Contract class and associated derived conflicts from unfulfilled deliverables, conflicts resolved and not resolved through simulation, recommendations (e.g., a BNAS) made by the system and associated user/editor responses, unresolved dependencies associated with a story-based ontology class hierarchy, unresolved dependencies associated with unresolved logical relationships between predicates, sufficiency measures and comparisons of sufficiency measures to probability that the underlying data is accurate, unfilled predicate argument information, newly approved complete predicate sets, newly approved story-based ontology instances (e.g., including as atomic or composites of atomic use cases), predicate sets missing a logical relationship to each other, all approved predicate sets, newly approved story-based ontology information resolving class dependencies, and more.

In the example embodiment, activity information available to editors/users may include sufficiency requirements to proceed with various tasks based on inputs during story-based ontology instance updating and analysis stages. For example, is there enough certainty to generate a best next action step for an editor (e.g., what information is most needed to speed the completion of a use case in development?) during development or for a user regarding a user's best next step based on deployed use case knowledge base? Recall, a best next action step may be a directive instance of a story-based ontology (i.e., a use case for a state to be reached, which may be a future story-based ontology instance), where the action component may be represented in the task class of the story-based ontology class hierarchy.

In the example embodiment, activity information related to encoding a use case, knowledge base, and/or knowledge graph with a story-based ontology may include fulfilled predicate sets and resolved dependencies (e.g., between predicates, between classes in the class hierarchy, and between predicates and classes) that may be proposed as approval information. Fulfilled predicate sets and various resolved dependencies proposed for approval information may relate to predicates and story-based ontology information that have been recently extracted from communications input but not yet added to the use case knowledge base and/or knowledge graphs. In the preferred embodiment, editors may be invited to review the proposed predicates, story-based ontology information and other proposed information (e.g., new thresholds based on a Bayesian model) to offer their view regarding whether the predicate sets, story-based ontology information and other proposed information should be added to the use case knowledge base and/or knowledge graph.

In various embodiments, activity information on a use case, knowledge base, and/or knowledge graph may include newly approved complete predicate sets, resolved story-based ontology and other related dependencies, and other now sufficient information. Activity information may give editors visibility into the evolving state of a use case knowledge base and see the simulated impact of decisions on potential use cases and users. Similarly, use case knowledge base activity information further may include all approved use case predicate sets information and all approved story-based ontology instance information, and other approved information. This may involve a list of all predicate sets and story-based ontology instances currently found in the use case knowledge base, for further examination and evaluation. This information may help give users an appreciation for the level of completeness of a use case knowledge base under development or modifications of an implemented use case.

In the example embodiment, the system may use the response of an editor or user to a query or communication to update and analyze a user's current state and future states before generating a next query or communication to the user. Activity information may include what responses by what users to what queries, based on permissions. These generated queries or communications may be stored and available as activity information along with user responses, which may include approvals. In the example embodiment, a best next action step may be proposed in a communications (e.g., natural language or multi-modal), and a response (e.g., in natural language or multi-modal) may indicate acceptance.

To illustrate acceptance, let's say a best next action step for an older adult, based on prior input updates and analysis, is to call a family caregiver to help the older adult with laundry. To continue the illustration, the system may generate a question for the older adult, “Do you want me to call your daughter to help you with the laundry?” If older adult's answer is “sure”, then the system may execute the call. In this example, the system may act on behalf of the user, and make activity information available to the user involving a list of recommendations, responses by the user and relevant actions by the system. In the example embodiment, the system may be a user, and as a user may be represented in terms of the story-based ontology. That is to say, in the example embodiment, the system may act in various roles (e.g., Role class instances) as an intelligent agent (e.g., thing) with an Identity (e.g., Identity class instance) in a Contract (e.g., Contract class instance) with a human user. To continue with the illustration, an intelligent agent may be a “Home health aide” with tasks (e.g., a task class instance) to monitor and manage a clean supply of clothes (e.g., a deliverable class instance) for an older adult. One of the skills of the intelligent agent, to continue with the illustration, may include contacting people permissioned by the older adult, with whom the intelligent agent may have a Contract, to assist with needed deliverables for which the intelligent agent may not have the necessary skills (e.g., an intelligent agent may have no skill class skills for washing and folding laundry). In the example embodiment, the system's generated best next action step, communications generated to seek approval for it (when a user response is necessary), the approval, and actions executed based on the approval may be available as activity information.

In the example embodiment, activity information may include story-based ontology information about a user, for example, in the form of an individual knowledge graph for the user, with filters so that the user can obtain activity information based on manipulation of the knowledge graph. Recall, all users in the example embodiment may be characterized as an instance of the story-based ontology, having an Identity class and other classes, such as a Role class, where a user may be a role, an editor may be a role, a patient may be a role, etc. Activity information may show users their various roles and impacts on them through manipulations of various attribute weights. In the example embodiment, the user role during an interaction may be identified, and activity information about the user role or roles in various instances of the story-based ontology may be available.

To return to the example of the older adult being asked about needing help with laundry, if the user says “No, I don't need any help. I like doing laundry”, then the system may update the user database, the use case, the user role, and so on, and modify how it does its analysis (it may run new simulations based on the new input). Activity information in the example embodiment may include modifications made by the system based on input, so system responsiveness may be evaluated by the person it is attempting to assist.

Referring still to the illustration of the older adult rejecting a best next action step, the user here (e.g., older adult) may act as an editor, by “editing” or modifying what the system has learned previously from prior input and providing new information on top of it. This may be an example of i) how users may also be editors and vice versa and ii) how intertwined development and implementation processes may be in the example embodiment.

In the example embodiment, activity information may include editors identified to interact with the system. The editors may include users of the system, all with identified roles. For example, the role of an editor may involve quality assurance as a deliverable for which a skill of system testing may be required. The team of editors may be characterized in the example embodiment in terms of the story-based ontology, with different identities and Contracts between them related to deliverables. So, for example, an editor with quality assurance as a deliverable may have a Contract with an editor or user with no software development experience and only a deliverable to report on the experience of using what is developed. Users may be individuals who are not only engaged with the system to develop a use case knowledge base, or software artifact, but in addition may receive guidance from the system to traverse a use case that is the subject of a knowledge base, or knowledge graph, for example.

In the example embodiment, a use case may be composed in real time based on an editor or user response to a system query. In the example embodiment, a composing of use cases may be based on existing atomic use cases (e.g., where one or more story-based ontology instances may occur in exact sequence) or developed on the fly from story-based ontology-based reasoning, user data, and a knowledge base or knowledge graph. Activity information may include use cases in development, implemented use cases, training data (e.g., often one or more use cases) indexed to stores and training data selections.

In the example embodiment, activity information may include current and target attribute component weights for users to review, as an aid to reviewing progress based on goals, and setting new goals. Likewise, editors may develop various initial weights and target weights, which may be available as activity information for a use case in development based on, for example, population metrics, which also may be available as activity information.

In the example embodiment, user scores from classifiers, reciprocity measures between users based on measures of similarity between speaker words in a conversation, and various longitudinal data may be available as activity information to assist users in calling attention to what situation they find themselves in or to identify one they would like to be in (e.g., which may serve as goal input to impact target weights for analysis and best next action step generation).

In the example embodiment, activity information may be made available to users in a variety of ways. In the example embodiment, unfilled predicate information, unresolved dependencies in the story-based ontology, unresolved logical dependencies between predicates, and other missing information may be listed, summarized in natural language or multi-modal communications (e.g., via templates), or characterized in graphs or other ways that users may see and offer input. In the example embodiment, unfilled predicates or other insufficient information may be the subject of natural language questions or multi-modal communications soliciting input that would be helpful for fulfilling the predicate, or resolving various dependencies as described, and meeting insufficiencies. In the example embodiment, these solicitations, elicitations or other styled communications to the user may be based on what is predicted to move the user to take a recommended next step. In the example embodiment, activity information may show which system generated communications may correlate with which subsequent actions taken by the user to determine both user and system response patterns and to facilitate more effective communications to users and editors.

In the example embodiment, users may be assigned differing levels of authority for providing responsive input and for influencing, changing or modifying the information. Let's say, for example, in a deployed use case, a family caregiver (user) may be able to update certain information regarding a loved-one, based on permission. However, this same caregiver may not be permitted to change a doctor's diagnosis or prescription to which the caregiver may have access.

In the example embodiment, activity information may be provided, all or in part, to an electronic bulletin board or a web interface accessible to users based on the user's level of authority, or skill. In the example embodiment, the skills of an editor/user may be characterized in terms of the story-based ontology (e.g., Skill class skills). Activity information may be displayed to a user on their computer or mobile device as they interact with the system. As another example, activity information may be presented in a report to users delivered by e-mail. Ongoing access to, an interaction with, use case knowledge base activity information together with multiple editors providing communications input ostensibly relevant to the use case, may result in rapid development of a very robust use case knowledge base.

In the example embodiment, the activity information may be viewed through filters and/or templates populated with information requested by users. In the example embodiment, activity information may be accessible via a query platform or interface connected to the AI platform, or activity information may be received as chats, emails, etc. In the example embodiment, certain activity information provided to users may require further curation before approval and implementation. For example, a query may be presented, as an example, by the preferred method of posing a natural language question to the user, such as, “It seems you're experiencing some pain. What hurts?” Such queries may be posted online in social or other media or on a bulletin board used by the users, a portion of which may be made public, beyond the users, in order to solicit answers, which when received, may be curated by the editors based on rules set for the collaboration. Such queries also may be generated for users after implementation, so that a network of users may provide information to update data and representations of it in a knowledge base or knowledge graph, including ones customized for user.

In the example embodiment, when a use case or other information on which the editors and/or users may be collaborating is approved by editors and/or users, it may be implemented by the system for live use.

In the example embodiment, it should be noted that the system may transform required predicate or story-based ontology or technical information into non-technical natural language or multi-modal communications (e.g., a predicate argument related to getting dressed in the morning may not necessarily use the word predicate or argument). The system may make these transformations in the data automatically, and may make corresponding activity information available for review and modification also in plain language. Note, however, user/editor preferences for communications styles may determine the style of communications generated by the system for each user/editor. For example, a software developer as an editor may prefer to see the technical language version of a query where a layman may prefer non-technical terms. (e.g., a predicate head and argument to a developer may be a topic with an example for a layman). In the example embodiment, different views and representations of the same underlying data may accommodate a fluid shift in communications styles. Fluid transformations between data representations in the example embodiment may facilitate the generation of a response to software developers in a communications style they understand, to lawyers in a communications style they may use, and so forth. Additionally, this may facilitate collaborations between experts in different fields, who may tend to use different jargon, by generating communications that both experts may understand- and further, by rendering expert insights in a communications that non-experts may also readily understand, and use to improve their own skills. Additionally, due to various automations in the example embodiment, no explicit software development knowledge may be required to develop and deploy certain software artifacts.

In the example embodiment, activity information may include scheduling, cost, authorization levels, user group compositions, editor-permissions (or not), skills and credentials, and other resource information. In the example embodiment, activity information may be used to designate users as editors, when editing may be involved, and graphed to show relationships between editors and what they may be editing (e.g., graph showing for a diabetic use case “Charles” as editor of a medication adherence advice and “Tom” as editor of a nutritional meal advice).

In the example embodiment, activity information may include pairings of input text and story-based ontology information extracted from the text.

FIG. 35 illustrates a flow from natural language input to a LLM to transformations of the LLM outputs into code and probabilistic predicates in accordance with various embodiments of the invention. As shown in FIG. 35, text input may feed into a LLM fine-tuned on a story-based ontology; the LLM fine-tuned on a story-based ontology also may receive instructions from a prompt to format and evaluate a formatted text input based on a scale or scoring rubric. (See FIG. 24 for more details). In FIG. 35, reference is made to a likelihood scale (confidence scale), which may refer to a graded evaluation by the LLM of the strength of the signals it detects during its evaluation of the formatted input. Further, in the example embodiment, a prompt may specify a threshold for the scoring and instruct the LLM to output the results a certain way. In the example embodiment, a scoring rubric may be created to guide the evaluation by the LLM fine-tuned on a story-based ontology of inputs according to various signals the LLM may detect in the input during its analysis. In the example embodiment, a LLM may output pairs of the text and a story-based ontology tag for the text along with a score based on the scoring rubric. In the example embodiment, the output may be compared to the threshold.

In the example embodiment, a likelihood score contained in an output of the LLM based on a scale of likelihoods provided by a prompt instruction as a basis for LLM evaluation may be associated with the probabilistic element of a probabilistic predicate structure. Continuing with the flow in FIG. 35, once the LLM outputs its results, elements in the output may be tagged to each other and to the input, and then featurized. Once featurized, output above a threshold based on the likelihood score may feed into a transformation process where the featurized output may be transformed into probabilistic predicates, based on the story-based ontology. Additionally, the output above a threshold (e.g., via a copy of the output) may be mapped to the story-based ontology class hierarchy. Next, as shown in FIG. 35, the probabilistic predicates generated from the transformation process may be evaluated for completeness and sufficiency. And, code may be generated from the mappings to the story-based ontology class hierarchy. In the example embodiment, predicates based on the story-based ontology may be used to evaluate the generated code before it compiles to help ensure fidelity to the story-based ontology. Meanwhile, probabilistic predicates generated from the transformation process may be evaluated for completeness. In the example embodiment, the system may attempt to resolve dependencies based on sufficiency between probabilistic predicates based on the story-based ontology. As shown in FIG. 35, the system may attempt to compile the code after predicate evaluation. Meanwhile, automated resolution efforts may be triggered (e.g., via predicate heads without predicate arguments) during code analysis/compilation and predicate analysis/completion. These automated methods may involve editors and/or users (users/editors) for inputs to resolve dependencies in structured knowledge representations, and advance users towards goals.

### II. System Inputs

FIG. 36 is a process flow diagram for standardizing data types for use by system models from input datastreams in accordance with various embodiments of the invention. Different input datastreams 3510 may be input by various devices and users. This standardization process may involve numerous methods by which incoming datastreams are received, and processed, and transformed (See also FIG. 54 for description of data transformations). FIG. 36 shows two such extraction and conversion processes. Standardization is necessary to conform and structure those datastreams into universal representations used by machine learning models in the example embodiment. These universal representations of data may be predicates, scores and subject-verb-object sets (SVOs) 3536, including those that may be encoded as particular data types, such as Story Data Types—custom data structures that are among various methods in the example embodiment which may be used to represent a story-based ontology class hierarchy. The inputs processing streams may be transformed in stages with key flows described as first receiving datastreams from users, followed by formatting data into a universal format by data type (e.g., audio, text, video), then transforming the formatted data by data type through either Insight extraction flow or simple data conversion flow into universal data types. For insight extraction flow, the first step may be vectorization, followed by extraction and classification, then transformation into universal data type. For simple data conversion, the conversion may be directly into universal data types (e.g., predicates, see FIG. 36).

Datastreams may be of multiple data types: audio, video, text, and device output data for example. Datastreams may be supplied by any one of a number of physical devices, a laptop, a phone, a computer, a camera, a cloud data system. Each of these physical devices are coupled to the AI platform in any one of the known methods for such computer, data and network connections. The multiple physical devices may be used by the multiple users, to provide datastreams that may involve multiple modalities of interaction. Examples of datastream-device connections may include, by way of example, audio data from a user conference call, email delivered by the user, device output data from a user operated object (e.g. a Fitbit™), or general web-based information returned as part of a user data query. During processing, these incoming datastreams may be processed by the system to provide universal formatted data by data type, and tagged to source devices (e.g., camera, phone, etc.), modalities of communication (call, email, videoconference, chat), and user, thus establishing contextual tags for all data universally formatted by data type. Universally formatted datastream may be featurized by data type and transformed either through insight extraction flow or simple data conversion flow into tensors. In one example embodiment, tensors transformed from formatted data may be merged regardless of data type into a single tensor for input into the system's multi-factor machine learning models. By way of practical example, tensors so created may be used by health assessment classifiers trained on validated heath instruments to score inputs, and by extractors trained on composable or discoverable use cases encoded in a knowledge base to extract evidence of user actions from inputs.

In the steps shown in FIG. 36 input datastreams are provided to the system 3510; universal data formatting takes place 3520; The processing then continues along one of two paths insight extraction flow 3530 or simple data conversion flow 3540. Along the processing path of insight extraction flow 3530, the following steps are performed: vectorization 3532; model classifiers & extractors 3534; and predicates, SVOs, scores (those which require models to generate) 3536. Along the processing path of simple data conversion flow 40 the following steps are performed: metadata (e.g., device readings, device, logs, timestamps, etc.) 3542; and some predicates and SVOs may be generated from simple data, or metadata (e.g., heart rate+location readings=>at gym) without going through extractors and classifiers 3544. At the end of either data processing path, universal datatypes (i.e., predicates, SVOs, scores) are established, irrespective of datastream, for use by system models 3550.

FIG. 37 is a flow diagram including processing blocks for standardizing system data relating specifically to creating a universal format for each type of input datastream from the datastream sources 3605. Every datastream may be received as data packets coming through a code structure for handling a datastream (e.g., GenServer's erlang process). Regardless of what type of input data is presented, that data is processed in FIG. 37 as follows. Data of a particular supported data type may have any number of standard transformations applied to it as provided at 3610, 3611 and 3612. As such, the data then may pass into datastream specific processing, where a stream may be translated from the received provider format (e.g., Fitbit, wearable) into a universal representation of that type of data in the system. For example, audio data coming from different sources may be processed into one format to standardize its format to that expected by the audio pipeline. After transformation, the transformed data undergoes universal data formatting at 3620. There, automated feature extraction 3622 is applied, datastream specific processing is performed 3624 and universal data formatting 3626 is established for each data type. The data output from the universal data formatting block then may flow into insight extraction flow or simple data conversion flow 3630/3640, for further transformation into vectors/tensors.

FIG. 38 shows the processing that accomplishes the transformation from universally formatted data, by data type, to vectorization 3724 and eventually tensors 3715, 3716, 3717. Vectorizing the universally formatted input data may turn it into tensors, a term known in the art to describe vectors or matrices used by deep learning models in the example embodiment.

The process of FIG. 38 begins with the introduction of Universal data formatting established for each datatype 3720. The universally formatted data identified by datatype is then set for vectorization (Insight Extraction Flow begins) 3722. Then transformation by data type 3724 takes place to create tensors (matrices) which may be handled by handlers appropriate for the data type.

As an example, in the case of video or image data 3710, that data may be transformed into a sequence of “images” represented by RGBA (red-green-blue-alpha) pixel values at every pixel on a particular frame of video or image data. Additionally, computer vision methods, such as optical character recognition (OCR) and object detection may be applied to the video or image data to identify the presence of objects or text embedded in the image. Extracted objects may be sent through an object recognition pipeline. Extracted text may be sent through a text recognition pipeline. Ultimately, a tensor representation of image data 3715 may be created.

In the example embodiment, audio data, which may be determined to refer to speech, may be sent through the audio pipeline 3711 and featurized using two processing streams. One stream may be for acoustic processing, the other may be for speech-to-text processing. Automatic speech recognition (ASR) is one example of a speech-to-text processor. Text generated from ASR may be sent to the text pipeline. Meanwhile, all non-speech audio data may be processed acoustically. It should be appreciated that sounds later identifiable as objects (e.g., car horn, cat's meow, etc.) may then be sent through an object identification pipeline.

Audio data provided to the audio data/language data may be parsed into audio frames. From that, features are computed and appended to a matrix description of the audio input. Audio frames may be used to characterize the wave-form amplitude at a specific input frequency, along with extracted metadata about the audio. Almost any audio feature may be calculated and appended to the matrix characterization of the audio input. Such features include volume, range, power, peak-to-average power ratio, pitch characteristics including centroid, crest, flatness, kurtosis, roll-off, skewness, slope and spread, among others. A tensor representation 3716 of audio features may then be created at the end of the process.

Text generated by ASR, by OCR, by users (e.g., chat, emails, comments, etc.), by the system itself (e.g., a NL communications resulting in a textual representation), by a LLM, or received by the example embodiment from other sources (e.g., physician notes in an electronic medical record), may be sent to the text processing pipeline 3712. In the example embodiment, Text/Language Data may typically be linguistic and may be the result of actual written or spoken interactions with the AI platform in the example embodiment, or through devices, user's interactions with other users also connected to the AI platform. This data may be transformed into a matrix which encodes linguistic/semantic structure via a learned word-embedding (a sequence of word vectors) and associated higher-order language features that are extracted in preprocessing, such as n-grams (an n-gram may be a sequence of tokens, where a token can be a word, subword, or character, depending on the context), encoder-decoder intermediate representations of the text optimized to a specific task, or syntax graphs. This tensor representation may be one of several canonical forms within the system; another is a text representation. All of these canonical representations may be searchable and evaluable by various modules (e.g., including external modules) which may be, for example, deep learning models for LLM calls. A tensor representation of text data 3717 may be created by the example embodiment, where the text data is transformed into a numerical format. A tensor representation of text may consist of a matrix of reference numbers (e.g., Token IDs) that point to specific tokens or words in a vocabulary or embedding space. Each token may be associated with a unique Token ID—and often, a word vector that represents its semantic meaning. And so, rather than using reference numbers in the matrix to refer to a token, they may be used to refer to a word vector. Tensors produced during vectorization by data type may be used by system models using that data type.

At the end of each of the pipeline processes, 3710, 3711, and 3712, tensor representations of the resultant data are created 3715, 3716, and 3717. Single output tensor representation may then be created by stacking all tensors created from all datastreams 3718 which are then ready tensor(s) now ready for input into system models (e.g., multi-factor deep learning models) for further processing. Thus, an economic use of tensors, a single matrix representation may be formed by stacking the matrix representations generated by each data-stream processing pipeline. This may create a single input into multiple machine learning models, which may now be interpretable by the system's various multi-factor deep-learning models. Tensor(s) may now be ready for input into system models (e.g., multi-factor deep learning models).

FIG. 39 illustrates custom ASR featurization and vectorization, particularly, audio featurized into two streams of different data types and merged into one tensor in accordance with various embodiments of the invention. This may include different streams for acoustics and speech-to text routines. The custom speech to text system may be trained on voices similar to voices in a reference data set, and the text produced by the ASR may be augmented by transfer learning. All streams may be featurized and transformed into a single output tensor used by the example embodiment. The training data for the custom-trained ASR may be reference data, including audio data, involving validated research, for instance, research conducted during a clinical trial, which may use statistical power to validate findings. Thus, the processing systems in the example embodiment of inputs for use by extractors and classifiers may themselves be trained on prior validated data. In the example embodiment, transcription outputs in natural language from a ASR may be used as natural language inputs into a LLM to perform prompted tasks on the input such as extraction and classification. Note, an ASR may be implemented in various ways as it refers to ways of transforming speech into text. For example, certain LLMs may be capable of performing this function. In another example embodiment, featurizations during ASR processing may be used in the example embodiment as input features directly into various deep learning models. (See also prompt model descriptions in FIG. 16-20.)

In the example embodiment, speech data may be featurized by a featurization system to produce at least: i) a text transcript of the audio, ii) audio broken down into audio segments which may represent individual utterances, sentences, or sentence fragments, with the segments tagged to identify the speaker, iii) tokens which represent individual words, iv) ngrams which represent word combinations that, when taken together have a common meaning apart from what the words would mean individually, iv) word vectors associated with the tokens and ngrams, which represent a token or ngram together with its potential substitutes such as synonyms, with the vectors tagged to identify the speaker v) sound features such as loudness, loudness range, power, peak-to-average power ratio, and pitch characteristics including centroid, crest, flatness, kurtosis, roll-off, skewness, slope and spread, and vi) formatted third party data such as named entities including persons, places, and brands.

As shown in FIG. 39, in the example embodiment, a custom-trained featurization system (e.g., on voices in the reference speech data) may be a featurization system trained using audio content taken from a large collection of conversations that i) are similar in nature to common use cases involving, for example, older subjects and medically related use cases, and ii) occur during a clinical trial intervention before which and after which subjects in the clinical trial are tested using clinically validated health assessments (e.g., GAD). This audio content may be referred to as reference speech data. The classifier subsystem and classifier functionality that generates scores associated with health assessment may be trained on the same reference speech data. Training based on the particularly pertinent reference speech data may allow a custom featurization system to more reliably “understand” and therefore, better featurize original audio input, as compared to a language featurization system comprising only commercially automated speech recognition functionality, text based natural language processing functionality, and audio signal processing functionality. The running outputs of the customized featurization systems and the commercial system may be measured by the featurization systems functionality for confidence level with respect to calculated features and text transcription, and the featurization data found most accurate may be included in the featurized output.

Various deep learning models in the example embodiment that intake featurized inputs may include classifiers and extractors trained on reference speech data. It should be appreciated that each audio segment from original audio input may have associated featurized feature data. In the example embodiment, a classifier subsystem may be trained on reference speech data to recognize what audio segment feature data indicates a health assessment score, and what the magnitude (value) of that score should be. For example, let's say that reference speech data used to train a classifier to score anxiety may reflect that, when a person utters the phrase “bank account balance” or something similar as reflected by the word vectors of those particular words, and that utterance has a particular loudness range (a feature of the utterance), the person is recognized to be anxious above a specified measurable threshold. The classifier may retain that relationship data so that when similar features are found associated with similar utterances in original audio input, that audio segment should be scored for anxiety at a corresponding score level. In the example embodiment, there may be numerous specific elements of language, spoken and written that, when operated on collectively, allow AI computational tools to accomplish the foregoing. These may include, for spoken language, qualities of the associated audio signal such as loudness, loudness range, power, peak-to-average power ratio, and pitch characteristics including centroid, crest, flatness, kurtosis, roll-off, skewness, slope and spread. The language actually spoken may be converted into text and analyzed.

In the steps shown in of FIG. 39 the following takes place. Original audio is input into the system 3810. Then one of two processing paths is followed. In one path 3820, the audio input is split by utterance, normalized, resampled to a desired number of cycles per second (e.g., 8000 Hz) 3822 and then the audio segments (speaker tagged) for high level sound features 3824. Along the second path 3830, the original audio input is provided to two featurization systems, a custom trained featurization system 3832 and a commercial featurization system 3834 the outputs from which are evaluated to select the most accurate 3836. That output is then converted to transcripts, word tokens, ngrams, and word vectors 3838. The process proceeds by taking the featurized audio input from either path and extracting all features from audio and text after which datastreams are merged, and transformed into a single tensor (i.e., matrix) of all vector representations 3840. The process completes when the tensor is served into classifiers and extractors trained on tasks (e.g., scoring, annotation, etc.).

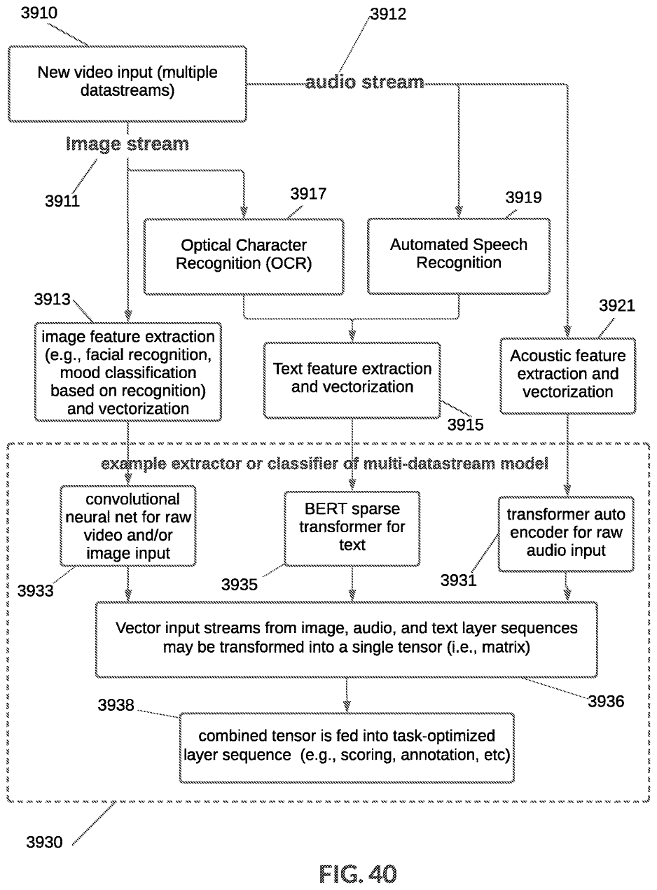

FIG. 40 illustrates a flow of steps involving production of one or more tensors from a multi-modal input (e.g., audio/video with text) in accordance with various embodiments of the invention. Further, FIG. 40 illustrates a featurization flow from video input into extractions from datastreams by data type, and vectorizations into tensors used by classifiers and extractors as layers in their evaluations/analysis.

As shown in FIG. 40, multiple input datastreams are introduced to the system 3910. Within a video stream, that stream may be broken into image streams 3911 and audio streams 3912. Image feature extraction 3913, text feature extraction and vectorization 3915 (including from text detected by optical character recognition algorithms 3917 and text from automatic speech recognition 3919), and acoustic feature extraction 3921 may be transformed into tensors, including at the end of processing, potentially, a single tensor for use by classifiers and extractors 3936.

Different neural networks may be used to generate vectors based on datastream type, as shown in the dotted box 3930. For example, for image extraction, a convolutional neural network for raw video and/or image input may be a preferred method of generating vectors, whereas for text, a sparse transformer (e.g., LLAMA or equivalent open source encoder) may be preferred, and whereas for raw acoustic input, a transformer auto encoder may be preferred.

Specifically, image feature extraction and vectorization is followed by a step of convolutional neural net for raw video and/or image input 3933. Text feature extraction and vectorization is followed by a step of a sparse transformer for text 3935. Audio feature extraction and vectorization is followed by a step of transformer auto encoder for raw audio input 3931. Each of these three streams are then processed at step 3936 where Vector input streams from image, audio, and text layer sequences may be transformed into a single tensor (i.e., matrix) 3936. As a final step, a combined tensor is fed into task-optimized layer sequence (e.g., scoring, annotation, etc.) 3938.

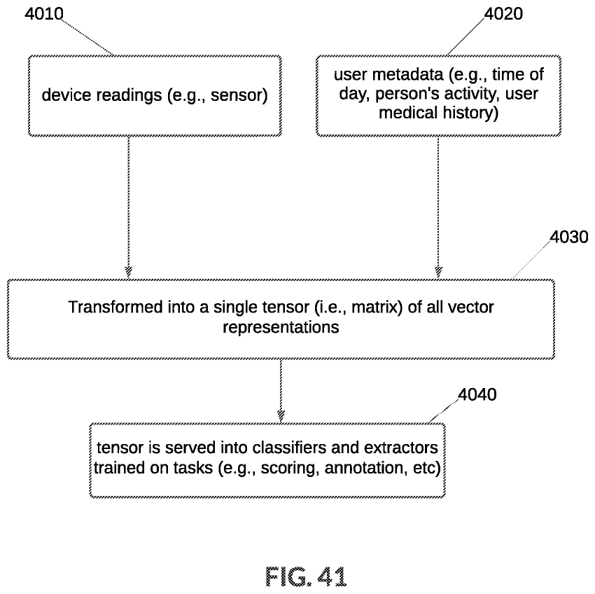

FIG. 41 illustrates vectorization, particularly during simple data conversion flow. In this process, simple data is transformed into a tensor in accordance with various embodiments of the invention. As shown, data received from wearables, or from other devices or systems 4010, may be characterized as simple data, such as readings (e.g., oxygenation levels, expressed as a percentage). User metadata may also be collected as input into the system 4020. Examples include time of day, person's activity, user medical history). The readings and metadata are then transformed into a single tensor (i.e., matrix) of all vector representations 4030. Finally, the tensor is served into classifiers and extractors trained on tasks (e.g., scoring, annotation, etc.) 4040.

As described in connection with FIG. 54 below, classifications may be generated by LLMs in natural language, which then may be featurized and provide a basis for a simple data conversion In the example embodiment, simple data may be converted into predicates or otherwise used for evaluation during a method used by the example embodiment referred to as attribute construction, which may establish a numerical and validated basis for a user's current story.

FIG. 42 illustrates how deep learning extractors, particularly during insight extraction flow and simple data conversion flow, may work on multiple featurized datastreams within the system. The matrices, or tensors, are first transformed from universally formatted datastreams 4110. These are then received by the first layers of the trained deep learning neural net 4120. The first layers may receive input from task(s) that model is trained to perform (e.g., extract objects, such as images of cars or sounds of horns, or both) 4170. The model's hidden layers then apply learned abstractions to inputs from tensors to calculate predictions 4130. Those Hidden layers then compute a prediction (i.e., loss function, or probability) in each output layer corresponding to task(s) the model is trained to perform 4140. The Output layer then identifies the location of object(s) in tensor input (e.g., video frames, audio frames, word vectors) in connection with what the model is tasked with extracting (e.g., [x,y,l,w,t]) 4150. Finally, extracted objects are identified by dictionary lookup and a probability score determined (e.g., 90% likely extracted object from video is a “car” and extracted object from audio is a “honk”) 4160.

With regard to FIG. 42, the number of first layers to receive the matrices initially may depend on how many datastreams are involved, e.g., one layer for video, another for audio or text. Text input may be featurized as a sequence of word vectors, which otherwise may be handled as all other objects by the deep learning extractor process. Alternatively, the number of layers may depend on how many tasks are to be performed by the deep learning, based on training. For instance, one task may be to determine if a certain illness may be predicted from the input, another an age, a score, or a story-based ontology information. Every layer may transform the input tensor into another tensor. In other words, the output of one layer may go into the next layers (child layers). Every layer may feed the next layer. It may keep doing this until it resolves it into the targeted or final output layer, which may be the model's prediction. Every prediction may be performed as a task, and there may be an output layer for every task.

FIG. 43 illustrates how extractors, during insight extraction flow, particularly video extractors, may detect objects (a real cat) within the system. This process follows the process described in FIG. 42, but as applied to objects. In the steps shown in of FIG. 43 datastreams for image datatype are received from video input 4210; video images data is received as a sequence of pixel maps for sampled images 4220; sample frames are input into image featurizer to extract higher level features 4225; objects, if any, in each sample frame detected by evaluating object detection deep learning model 4230 and output tensor(s) are generated specifying position/type of all observed objects (e.g., [x,y,l,w,t] where type (t) is a dictionary key) 4235. The process of FIG. 43 continues with the decision that if output tensor is not null, then object value (t) is looked up to see what object is detected 4240; then lookup object #for #t in library of objects extractor is trained to detect 4245; then store of object reference numbers ((e.g., #37 is “cat”) 4250; then object detected resolved with label in store (e.g., “cat”) 4255 and finally the label is converted into predicate with probability (present (Cat,0.9)) and SVO (“[cat] is present”).

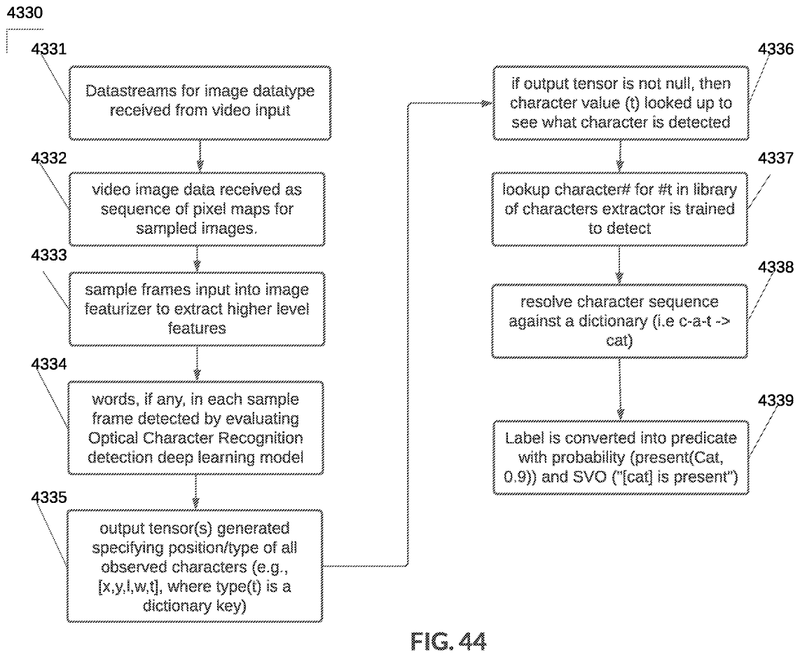

FIG. 44 illustrates insight extraction flow 4330 according to FIG. 36. In FIG. 44, extractors, operating on video with respect to OCR extraction are demonstrated. Note, this functionality may be performed by various technologies, and may follow the same processing flow described. This process follows the process described in FIG. 42, but as applied to text detected in a video or image. In the steps shown in of FIG. 44 datastreams for image datatype are received from video input 4331; video image data is received as sequence of pixel maps for sampled images 4332; sample frames are input into the image featurizer to extract higher level features 4333; words, if any, in each sample frame detected by evaluating Optical Character Recognition detection deep learning model 4334; output tensor(s) are generated specifying a position/type of all observed characters (e.g., [x,y,l,w,t], where type (t) is a dictionary key) 4335; if output tensor is not null, then character value (t) is looked up to see what character is detected 4336; lookup character #for #t in library of characters extractor is trained to detect 4337; character sequence is resolved against a dictionary (i.e. c-a-t->cat) 4338; and label is converted into predicate with probability (present (Cat, 0.9)) and SVO (“[cat] is present”) 4339.

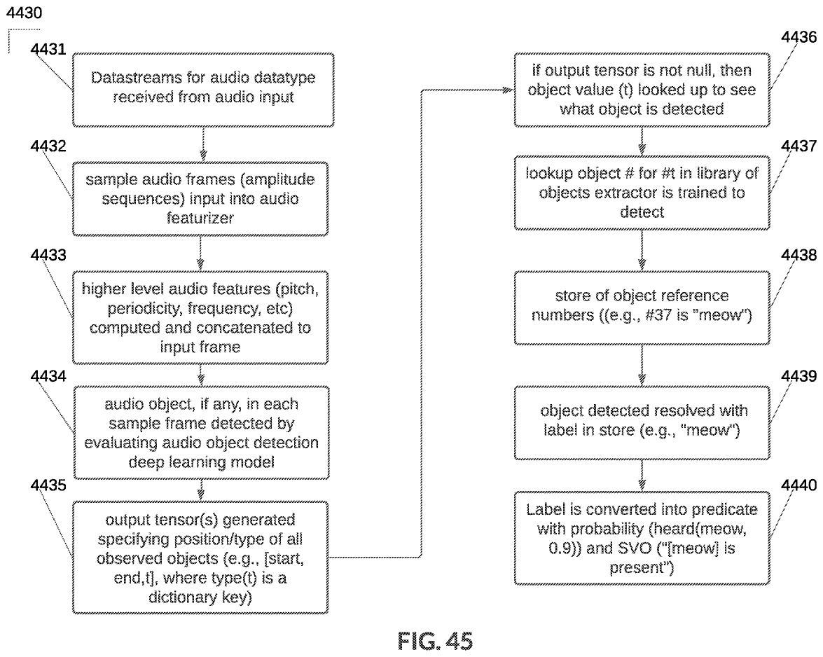

FIG. 45 illustrates insight extraction flow 4430 according to FIG. 36. In FIG. 45—extractors, operating on audio work towards object detection (e.g., sounds of a real cat). This process follows the process described in FIG. 42, but as applied to sounds detected in audio input (e.g., audio tracks in a video). In the steps shown in of FIG. 45 datastreams for audio datatype are received from audio input 4431; sample audio frames (amplitude sequences) are input into audio featurizer 4432; higher level audio features (pitch, periodicity, frequency, etc.) are computed and concatenated to input frame 4433; audio object, if any, in each sample frame are detected by evaluating audio object detection deep learning model 4434; output tensor(s) are generated specifying position/type of all observed objects (e.g., [start, end,t], where type (t) is a dictionary key) 4435; if output tensor is not null, then object value (t) is looked up to see what object is detected 4436; object #for #t is looked up in library of objects extractor is trained to detect 4437; object reference numbers ((e.g., #37 is “meow”) are stored 4438; object detected resolved with label in store (e.g., “meow”) 4439; and the label is converted into predicate with probability (heard (meow, 0.9)) and SVO (“[meow] is present”) 4440.

Note, in the example embodiment, text extraction also may follow the process described in FIG. 42, but applied to text, which generally may be regarded as just another object to extract, but with methods associated with its data type.

FIG. 46 illustrates a process flow involving the transformation of a tensor representation of text into raw text 4520. First, tensor representation of text from processed text datastream or from downstream model tensor output is input into the system 4510. The tensor representation of text may contain vector IDs or token IDs that map to word vectors or tokens (e.g., via embeddings). Once input, these word vectors or tokens may be looked up and retrieved 4522, then mapped to words 4526. The sequences of retrieved words may then be concatenated into sentences, paragraphs, etc. as natural language (unstructured, unfeaturized) text 4528. This step may facilitate use of LLMs that take natural language (text) input instead of tensors representative of text (featurized text).

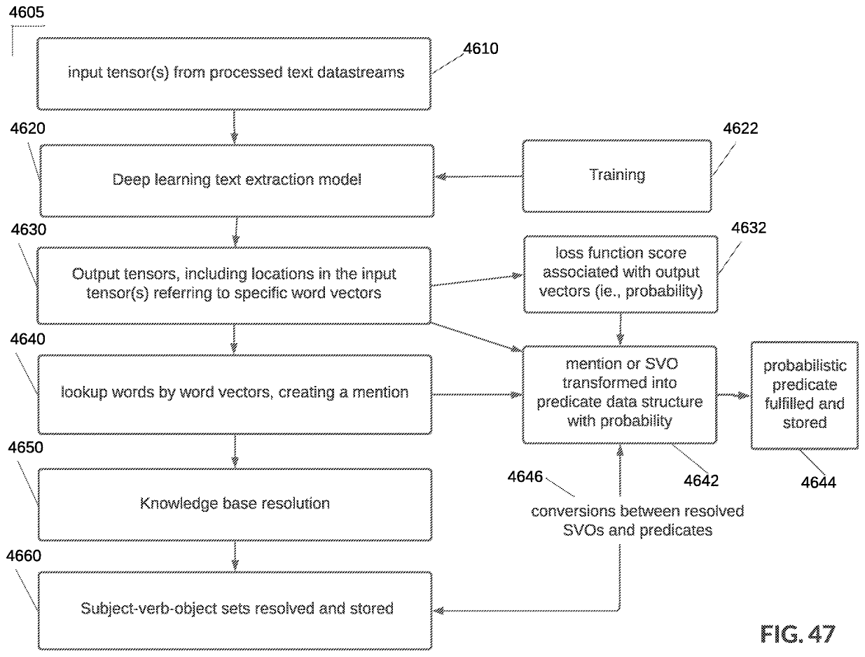

FIG. 47 illustrates various insight extraction flow 4605 according to the invention including SVOs and predicates, particularly where producing SVOs and predicates from deep learning text extraction models is performed. In the example embodiment, “predicate” may refer to probabilistic predicates. While predicates are evaluable statements normally associated with a Boolean value, such as “true” or “false”, in the example embodiment, predicates may be associated with a probability (i.e., a likelihood of being “true” or “false”). For example, it may be said with some certainty that a banana may be yellow, but it also may be true that a banana may not always be yellow. The statement, the “banana is yellow” may be, say 90%, likely to be true, if it is said by someone who is not color blind who is visually inspecting a banana at the time, but only 50% true if it is said by one speaking generally of bananas, which may turn brown and stay brown longer than they were ever yellow. On the other hand, for comparison, a blood pressure reading from an FDA approved gauge may be closer to being 99% true at all times. In these examples, note the use of conditions, (i.e., “if) in determining a probability. In the example embodiment, conditions may be rendered into logical expressions (e.g., conjunctive normal forms) and used by probabilistic programming language to make logical predictions.

As data structures, in addition to probability weights, probabilistic predicates may have heads, which may act as labels (e.g., “banana”) and arguments, or bodies (e.g., “yellow”), which may act as attributes (e.g., “yellow” may become “brown”). Note the arguments may change, which may provide flexibility in determining the state of the thing (e.g., yellow, brown) and logical inference (e.g., yellow banana=>brown banana). For example, since a banana may be yellow before it turns brown, a brown banana may be older than a yellow banana. Further, it may be said with some certainty that a banana may be yellow, but it also may be true that a banana may not always be yellow. The statement, the “banana is yellow” may be, say 90%, likely to be true, if it is said by someone who is not color blind who is visually inspecting a banana at the time, but only 50% true if it is said by one speaking generally of bananas, which may turn brown and stay brown longer than they were ever yellow. On the other hand, for comparison, a blood pressure reading from an FDA approved gauge may be closer to 99% true at all times. In these examples, note the use of conditions, (i.e., “if) in determining a probability. In the example embodiment, conditions may be rendered into logical expressions (e.g., conjunctive normal forms) and used by probabilistic programming language to make logical predictions. In the example embodiment, probabilistic predicates may be used by various AI computational tools and probabilistic programming languages (e.g., Problog) to determine states of “facts,” assign probabilities to these, and draw logical inferences from them. Predicates may be used in the example embodiment to represent a user. For example, the representation, 1.0::is named (User123, “Tom Brady”), could be read as “We are 100% sure that User123's name is Tom Brady”, and, 0.7::took_medication_on_day(User123, “statin”, Mar. 10, 2018), could be read as “We are 70% sure that Tom Brady took his statins on Mar. 10, 2018.”

In the example embodiment, predicates may provide a flexible way to encapsulate whatever is learned about each user while maintaining easy integration with the rest of the system.

As to SVOs, tokens, ngrams and vectors may be used to determine subject-verb-object (SVO) sets. SVOs may be described as natural language grammatical and semantic units.

The example embodiment may generate universal data types, such as predicates (probabilistic predicates) and SVOs, from processed data for use by deep learning and other models. These may be extracted in the example embodiment by a process that vectorizes input data and extracts/creates predicates from the tensor output. These vectorizations and extractions, and scoring by classifiers, may happen constantly throughout the system, and may be performed by extractors and classifiers trained on reference data characterized as prior validated data.

With further regard to FIG. 47, text extraction may involve deep learning text extractors trained on a reference data set. A reference data set may be data validated by randomized controlled clinical trials, including care model data as well as data using validated health instruments. In the example embodiment, text extractions from input text may be encoded to a care model, or other professional service model. This encoding may be done by a separate encoding process after the extraction, or be incorporated into the extraction process. With reference to FIG. 47, the encoding process may involve looking up words by word vectors based on reference IDs in the output tensor and then transforming these mentions into structured knowledge (e.g., predicates and featurized subject-verb-object sets resolved against the knowledge base).

With further reference to the output tensors representing text in FIG. 47, the word vectors IDs in the output tensor in the example embodiment may be looked up and retrieved to create a mention, or sequenced groupings of words, that may feed into an encoding process for a story-based ontology, During this story-based ontology encoding process, the retrieved words from the lookup may be mapped to the story-based ontology class hierarchy. The result of this separate story-based ontology encoding process may be a structured knowledge representation of the input combining featurized text and story-based ontology information. This in turn may facilitate reliable and consistent expansion of the knowledge base, the construction of knowledge graphs based on story-based ontology information, and story-based ontology-based reasoning enriched with user inputs.

In the example embodiment, an extractor may not only be trained to extract relevant information from text but also to incorporate story-based ontology-related knowledge into the output tensor representing the extracted data (e.g., Deliverable, shopping list). Since the story-based ontology class hierarchy in the example embodiment may be used universally by the system to represent inputs as structured knowledge, it may be desirable to perform the encoding during the extraction. Encoding during extraction may provide models or programs dependent on extraction outputs the information they need to promulgate the story-based ontology efficiently, including for example deriving and resolving dependencies inherent in the story-based ontology. In the example embodiment, word groupings that may not be known by a knowledge base may still have an ontological relationship to each other, due to intra-class and inter-class logical and other relationships in the story-based ontology, As a result, a deep learning story-based ontology extractor may know that, say, a “shopping list” is a deliverable class deliverable, even if the system (e.g., via a current knowledge base) may not know what a shopping list actually is.

To continue with the above mentioned “shopping list” illustration as a deliverable class deliverable, even if “shopping list” is not in the knowledge base, the system may know enough about what a shopping list is by virtue of semantic/logical relationships existing between class elements in the extracted text to resolve it (e.g., Deliverable Class and Task Class, where tasks may relate to actions/verbs and deliverables to objects of actions/verbs; note the connection between subject-verb-object sets and the story-based ontology). To learn what a shopping list is, the system may attempt to resolve it against a knowledge base, or generate a prompt for a LLM to produce an answer, which in turn may contain extractable story-based ontology information.

As yet another alternative, in the example embodiment, a LLM may be fine-tuned as a story-based ontology extractor to tag natural language outputs as story-based ontology elements, which then may be featurized and mapped to the story-based ontology class hierarchy so that they may be used as tensors by models that use tensors. See FIG. 12 and FIG. 54. This separate encoding of the story-based ontology from extracted and tagged words by a LLM fine-tuned on the story-based ontology may be a preferred embodiment.

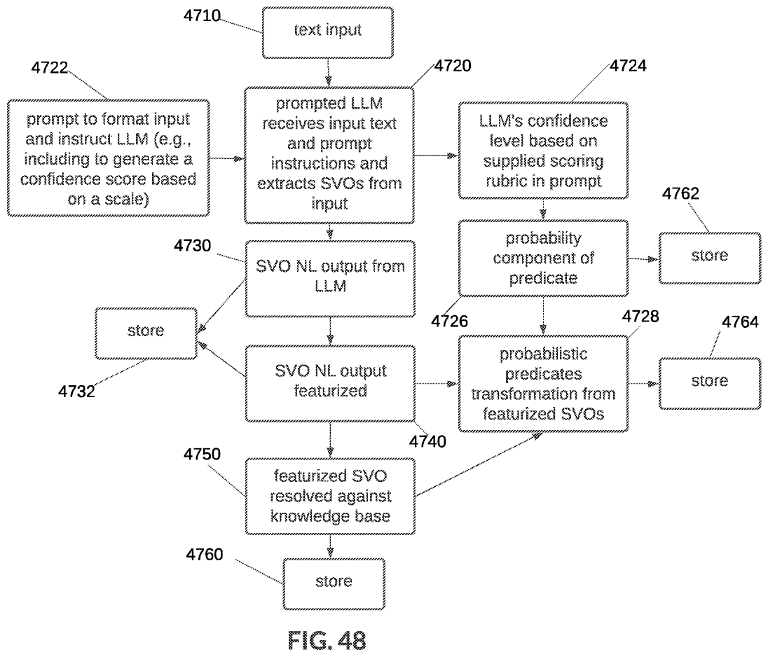

In the example embodiment, language data may be analyzed to determine likely connections between various semantic relationships (e.g., SVOs) and class hierarchy relationships, since the class hierarchy uses language to describe terms and definitions. For example, a Role may in the story-based ontology class hierarchy may refer to a set of skills associated with a set of deliverables, wherein deliverables are the product of an action, or task. Tasks in turn may require skills. These terms and the relationships between them may be described in natural language, and thus analyzed as sets of SVOs. By using a LLM to extract SVOs and story-based ontology information, albeit unstructured, these extracted outputs may be associated efficiently, and featurized, transformed into predicates, mapped to the knowledge base, knowledge graphs, etc. See FIG. 48 and description.

Note, not every model used by the example embodiment may take exactly the same input. In the example embodiment, multiple models may run simultaneously, some of which may require vectorized data first to do extractions while others may require simple data only (e.g., timestamps, device output data), which in turn may be converted into predicates later and without either vectorization or extraction. Additionally, predicates may be associated with SVOs and vice versa, as well as with story-based ontology information, which may be used by the system to represent the same data in different ways depending on a model's needs (e.g., NLP v attribute construction or optimization). The universal data types created by the example embodiment for use by its systems may create efficiencies for system operations and performance.

For example, let's say a person's facial expressions are being recorded during an interaction with the example embodiment. A facial recognition system trained to recognize (classify) faces may be used by the example embodiment to identify a person's face and return a person's ID. Further, the facial recognition system used by the example embodiment may be trained to classify and score facial expressions based on labeled expressions. To continue with the illustration, expressions similar to expressions used to train a classifier on happiness scale may return a score associated with the label, “sad,” along with a level of certainty using the loss function, say “0.7”. This classification occurs in a particular context that may be tagged by the example embodiment to the user, for example, at home after a day at the office. A schema for the example predicate, which may illustrate what kind of data may be stored (not its format), may be “User ID 0177: is sad, probability 0.7,” This schema also may be associated with metadata illustrated as a schema, for example [date from device],[universal coordinated time], [list of context masks from handling of input stream by example embodiment].

As to generating SVOs from input data, there are various methods. For example, text data may be parsed into a syntax tree, and everything except the S, V, O may be discarded. For video, SVOs may be determined by a series of methods. For example, an object detection model may be trained to detect similar clusters of actions that may characterize certain observed behaviors for which a label may be created (e.g., frowning, running, eating, etc.). Let's say, for purposes of illustration, the object “fish” is detected, “eating” as a series of actions is detected, and the face of a person is detected and matched to a User ID. Libraries of labels created during training to describe similar object or objects (e.g., “fish”, “person”, eating,”) as well as the person's name associated with the User ID, may be looked up by the example embodiment. As the next step in rendering an SVO form the detected objects, the example embodiment may resolve the labels against the knowledge base, to determine that Person [Charles] eats fish. (See SVO resolution).

Recall that input may be expressed as a predicate. And so, the SVO, “person eats fish,” in some instances may be associated with a predicate, “Charles is eating fish, 0.7,” if desired, using in part the loss function of the object detection model. Conversion from predicates to SVOs may be a straight-forward matter of discarding the probability constituent and converting the data type.

In the steps shown in of FIG. 47 input tensor(s) are provided to the system from processed text datastreams 4610; deep learning text extraction modeling takes place 4620; training 4622 may be applied to those models to improve their performance; output tensors are created 4630, including locations in the input tensor(s) referring to specific word vectors. From the output tensors, loss function scores are produced 4632 associated with output vectors (i.e., probability) and lookups of words by word vectors are performed, creating a mention 4640. Knowledge base resolution is performed 4650 and Subject-verb-object sets resolved and stored 4660. Output tensors and lookup functions provide input to the mention or SVO transformation functions from which predicate data structure with probability are generated 4642. These are output fulfill the probabilistic predicate and are stored 4644. Finally, conversions take place between resolved SVOs and predicates 4646.

FIG. 48 illustrates a flow for a LLM-prompted extraction of SVOs from inputs in accordance with various embodiments of the invention. In FIG. 48, text input 4710 and prompt information 4722 is received by a LLM 4720. The LLM is tasked with extracting SVOs from the text input 4730. As described in FIG. 24, a confidence score may be generated by the LLM 4724 if prompted to provide one. The natural language output of step 4730 may be a subject-verb-object set in natural language, which then may be stored and featurized 4740 and stored 4732. The featurized SVO may be resolved against the knowledge base 4750, just as a SVO extracted by a structured knowledge extractor may be (see FIG. 47). The resolved SVO may be transformed into a predicate 4728 which may have a computed probability 4726 based on the LLM's confidence level in its SVO extraction, if provided. In the example embodiment, various outputs are stored 4762, 4764, 4732, 4760 during processing for use by other programs or models that may require input data in certain formats (e.g., LLM may use unfeaturized text).

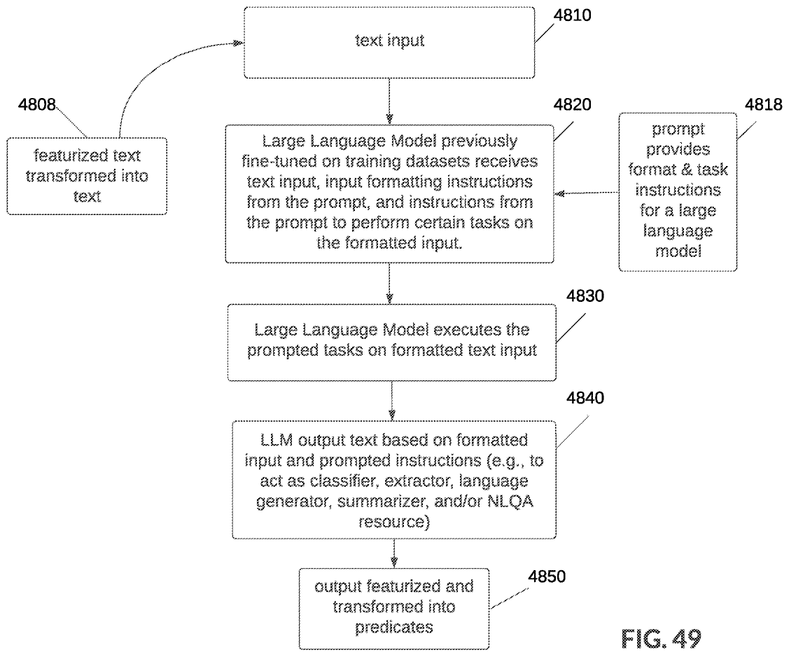

FIG. 49 illustrates a large language model input and output process in accordance with various embodiments of the invention.

As shown in FIG. 49, text input 4810 (unfeaturized natural language) may be received by a LLM based on a format that may be specified by a prompt 4818. As illustrated, the text input may be the output of a prior process in which featurized text is transformed into raw text, or natural language 4808. This would be necessary to accommodate the need of a LLM for natural language input. The LLM also may receive a prompt 4820 in natural language instructing the LLM to perform certain tasks on the formatted text input and to produce output also based on the instructions in a prompt. Prompts may be developed manually by editors or in a preferred embodiment automatically by a prompt generation model, which also may include editors. Further definition of this is included in connection with the discuss of FIG. 12.

In FIG. 49, the LLM is described as being fine-tuned, meaning that it may have learned from previous prompting, based on training data, to perform certain tasks associated with that training data. In the example embodiment, a LLM may be fine-tuned or not, depending on the function determined for the LLM. For example, if a LLM is to act as an extractor of story-based ontology information, it may be preferable to fine-tune (“train”) the LLM on annotated examples of a story-based ontology before asking the LLM to determine story-based ontology information from the text input.

After the LLM receives text input and the prompt, as shown in FIG. 49, the LLM then may perform its tasks 4830 on the formatted input and generates output in natural language, as instructed. The output, depending on the instruction and the fine-tuning of the LLM, if any, may be a classification, extraction, new language generation, summary, and/or Natural Language Question and Answering 4840. The output of the LLM, whether fine-tuned or not, may be transformed into various types of structured knowledge representations (e.g., probabilistic predicates) for use by probabilistic programming and/or by other models that require structured data 4850. Additionally, LLMs, conditioned by prompts, may output text components that may be constructed into a hypergraph, a datastructure that may be used in the example embodiment.

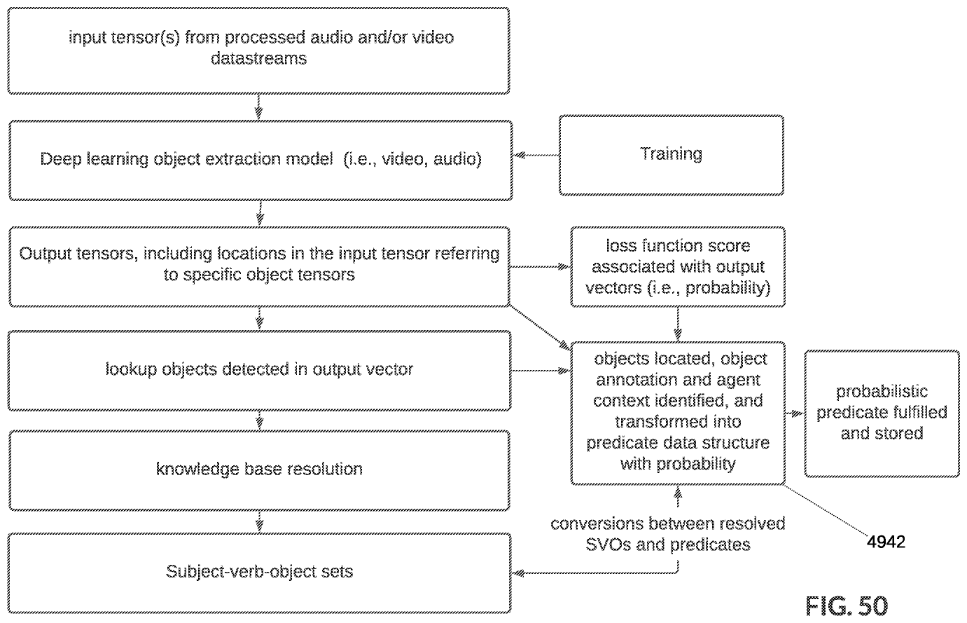

FIG. 50 illustrates insight extraction flow involving SVOs and predicates, particularly producing SVOs and predicates from deep learning object extraction models (e.g., video or audio). In the example embodiment, a deep learning model trained to identify certain objects, such as audio or images (e.g., video), may identify and extract the objects from featurized inputs, then lookup annotations for detected objects stored in a library of objects, which may then be used as the basis for SVOs and predicate transformation.

The process of FIG. 50 substantially follows that of FIG. 47 with step 4642 being modified to include the steps of object location, object annotation and agent context identification, and transformation into predicate data structure with probability.

FIG. 51 illustrates insight extraction flow scores from classifiers, particularly producing scores and predicates from deep learning classifier models (e.g., text, video, audio) in accordance with various embodiments of the invention. In the example embodiment, scores from classifiers trained on a reference data set may be rendered in real-time and associated with other extractions to create a body of relationships between scores and extractions, including story-based ontology information extractions, useful to models and programs, such as may be involved in attribute and goal construction.

The process disclosed in FIG. 51 includes the following steps: input tensor(s) processed from datastreams are provided to the system 5010; deep learning classifier model, which may be trained 5022 takes those inputs and output tensors of possible classes (e.g., Anxiety/No Anxiety) shows probability breakdown (i.e., score) for potential classes 5030; reflexive predicate transformations take place from output label and are stored 5040; property/attribute descriptions are generated (i.e., “anxiety high”) which may in turn accept input from threshold labels for score (e.g., “high”) 5052.

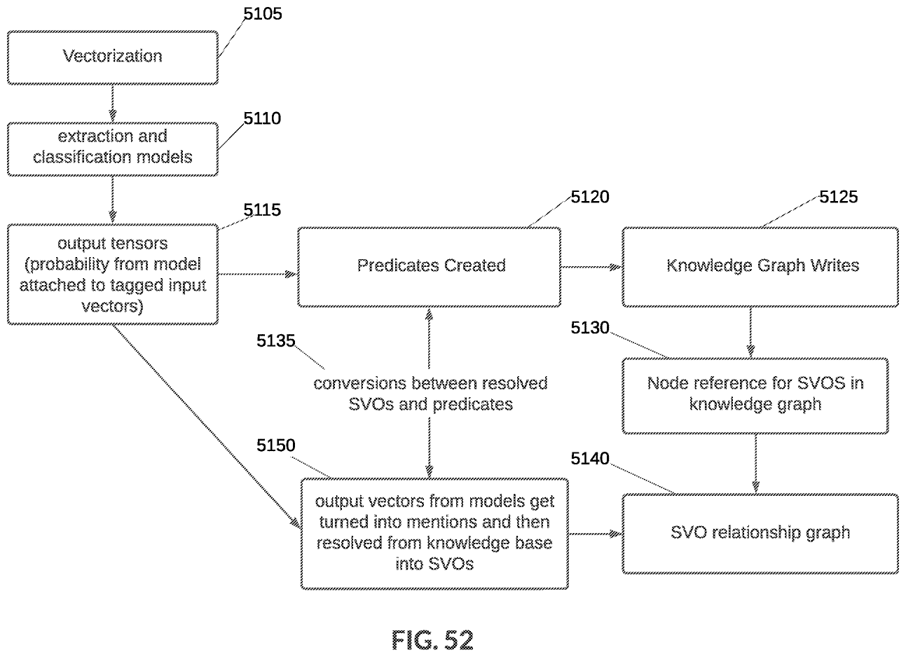

FIG. 52 illustrates insight extraction flow involving SVOs, predicates, graphs, and particularly converting data formatted by type into standardized data for use by system (e.g., predicates, SVOs, scores). The output of the insight extraction flow, as illustrated in FIG. 52, may be universal data types used by the example embodiment in its functions. In the example embodiment, all input data may be treated as context in the ‘story’ of a user. As such, for every piece of input data entering the system, irrespective of datastream, a predicate representation of that input may be generated. In addition, in the example embodiment, this predicate representation may be added to one or more inference graphs (e.g., via Problog) at multiple scopes (e.g., user cluster, use case clusters, etc.).

In FIG. 52, a Knowledge Graph write are also disclosed. A knowledge graph may be a set of nodes, which represent named entities, connected by a set of edges which define the relationships between those entities. Based on the output of extraction models, new entities and relationships may be inserted into the graph.

As is also shown in FIG. 52, predicates may be converted into SVOs and vice versa, and output vectors from models may be transformed into mentions and then resolved from knowledge base into SVOs in the example embodiment. Further, a knowledge graph may be generated by the example embodiment showing the relationships between various SVOs. Recall from FIG. 48 and description that SVOs may be extracted by LLMs and then featurized; so a knowledge graph may be generated from SVOs featurized after natural language extractions. Likewise, scores and confidence ratings in the LLM's scores that may be generated by LLMs as natural language classifications, as described in FIG. 24 and FIG. 35, may be featurized. From this featurization of the natural language scores and confidence, probabilistic predicates may be generated.

The process disclosed in FIG. 52 flows in the following manner and includes the following steps: vectorization of system input 5105; followed by extraction and classification models 5110 working on the output therefrom. From there predicates are created 5120 from which knowledge graph writes take place 5125. Node reference are generated for SVOS in the knowledge graph 5130 and provided to the SVO relationship graph 5140. In creating the output tensors (probability from model attached to tagged input vectors) 5115 the tensors are stepped at 5150 to generate output vectors from models which get turned into mentions and then resolved from knowledge base into SVOs 5150. These then are also provided to the SVO relationship graph 5140. During this process, conversions between resolved SVOs and predicates are constantly taking place 5135.

FIG. 53 is a flow diagram showing steps to determine reciprocity in accordance with various embodiments of the invention. In the example embodiment, reciprocity may refer to a measure of how similar inputs may be between different users, or between any two sets of inputs. Reciprocity may begin with processed datastreams, including vectorizations of inputs 5205. To determine the degree of similarity, the cosine distance between respective vector distances may be averaged 5250, and a reciprocity score calculated. Reciprocity may be used by the example embodiment in various ways to facilitate improved interactions between users. Reciprocity may be associated with user attributes, and be established as goals for users to reach during their interactions. For example, a professional (e.g., nurse speaking with a patient or an insurance representative speaking with a claimant) may receive a score for reciprocity during their conversation, which may be compared against a target score for reciprocity. In the example embodiment, a reciprocity score may be mapped to what is said and then analyzed, including for impact analysis. For example, the agent of a nurse receiving a low reciprocity score may generate a communications strategy use case to lift the tone of the nurse's response and for the nurse to confirm more of what the patient says in the course of responding to the patient. Reciprocity may be used in evaluations of professional performance and in conjunction with the example embodiment to facilitate ongoing professional training and performance evaluations.

As shown in FIG. 53, the process of computing reciprocity may begin with received communications inputs from two users 5205. In other example embodiments, two different communications inputs may be from the same user. In either case, those inputs may then be featurized. The featurization of communications inputs from users may include transformations of non-language data (e.g., images) of the users into featurized text. The input from each user may be tagged to each user 5210, 5230. In the example embodiment, a predicate head may be extracted from the featurized communications input (e.g., conversational data), and tagged to the appropriate user. A user's communications may be associated with said extracted predicates. Specifically, each user's communications may be identified with the constituent words and/or sounds and/or images and/or simple data in the user's communication 5215, 5235. The words and/or sounds and/or images and/or simple data associated with each user may be converted into semantically meaningful vectors, and mathematically averaged 5220/5225, 5240/5245. The other speaker's responsive communications likewise may be analyzed. In the example embodiment, to determine the degree of similarity between the two user's communications, the cosine distance between their respective vector averages may be computed 5250. The cosine distance may be converted into a reciprocity value 5255 and the distribution of scores across the whole conversation (transcript) may be tracked. This may permit a cut off value 5265 to be determined for high reciprocity (top quartile) and low reciprocity (bottom quartile). Such threshold values may be applied to label the reciprocity feature as high, medium, or low, for example. The reciprocity score may be added as a predicate 5260. In this way, classifier may be trained to recognize which language features 5270 may be associated with reciprocity and reciprocity values.

FIG. 54 shows a transformation matrix 5380 illustrating the numerous transformations of data between data and knowledge in its featurization and structure respectively. The arrows in FIG. 54 illustrate the six core transformations managed in the system. These transformations may be between: i) featurized data 5384 and unfeaturized data 5382, ii) featurized data 5384 and structured knowledge 5388, iii) featurized data 5384 and unstructured knowledge 5386, iv) unfeaturized data 5382 and unstructured knowledge 5386, v) unfeaturized data 5382 and structured knowledge 5388, and vi) structured knowledge 5388 and unstructured knowledge 5386.

The system may manage the data transformations shown in FIG. 54 in various manners. In a preferred embodiment, data transformations may be managed or orchestrated by a prompt generation system including downstream models and programs. This management system is referred to as a prompt generation system architecture and is further described with reference to FIG. 12.

The data transformations illustrated in FIG. 54 may facilitate efficient integrations of data based on specific data formats required by various models and programs within the system. The transformations into representations of structured knowledge may facilitate reasoning based on structured knowledge, such as a story-based ontology class hierarchy. As a practical example, such reasoning may advance a system user towards goals that are determined and based on analysis of the structured knowledge representations of the associated data.

In the example embodiment, universal representations of structured knowledge may include the story-based ontology class hierarchy, outputs of classifiers and extractors trained on the story-based ontology, probabilistic predicates based on rules of the story-based ontology, knowledge stores such as knowledge bases and knowledge graphs, which may be encoded with the story-based ontology, subject-verb-object (SVO) sets, which may be tagged to the story-based ontology, and data types structured based on the story-based ontology. In the example embodiment, which transformations to perform on what data may be determined by various factors, often involving analysis of how most efficiently to identify, quantify and resolve data dependencies related to class and attribute relationships and dependencies in the story-based ontology. For example, a LLM may be queried for information related to importance attributes (e.g., how important on a 10-scale is shopping to a diabetic) due to its extensive database of language data, but the raw text answer from the LLM may require featurization to represent that value as a probabilistic predicate for use in various probabilistic computations (e.g., while it may be important for a diabetic X to shop for himself to learn to choose the right foods, what if the diabetic x also has early stage dementia?), which LLMs may not perform, generally speaking.

FIG. 54 also illuminates some of the interdependencies of featurized/unfeaturized data and structured/unstructured data. It should be appreciated that in all of the data transformations described in connection with this system, some information may be lost. This is due to a number of reasons each uniquely associated with the specific transformation processes being used. One such data loss effect is due to dimensionality reduction. Due to these losses, it may be preferrable to store and tag all original source inputs. Then the system can have access to and operate on (e.g. featurize) stored and tagged original data. Via indexes to repositories, the system may also access the original data to facilitate certain transformations. Further access to both the featurized data and the original input, data may facilitate the measurement and evaluation of the losses incurred during data transformation. If the data losses are determined to be significant during transformations, other model may be given access to and use the original input data to achieve the desired end results with the desired accuracy.

Regarding model input requirements, it should be appreciated that some models may take hybrid inputs, i.e. based on original as well as featurized data. For example, natural language (NL) outputs of a LLM may be mapped, without first featurizing the NL output of a LLM, to a knowledge graph. LLM output, when featurized, may also be mapped to a knowledge graph. Thus, a knowledge graph may use inputs based on either featurized or unfeaturized data, or both, for various purposes, including for example to compare inputs from the same source.

In the example embodiment, the standardization of tensors and their use may facilitate integrations of various model outputs. For example, a large language model fine-tuned on an anxiety data set may generate richly contextualized text data from the same input that a deep learning classifier may simply score. Additionally, the text output of the large language model may be timestamped for synchronized association with a deep learning classifier output on the same input as a simple data tensor. By then tensorizing the text output, a single tensor representing both types of outputs may be analyzed and the performance of each compared.

Transformations between featurized and unfeaturized data. In the example embodiment, featurization of data may refer generally to breaking data down into features, which then may be used for further analysis. For example, natural language text may be featurized by breaking the natural language text into tokens, or words, and then associating these tokens with word embeddings, or word vectors. See FIG. 38 for methods of featurizing text and other types of data inputs. In the example embodiment, various deep learning models, such as certain deep learning classifiers and extractors that may produce tensors as output, may use featurized inputs to perform tasks. Meanwhile, LLMs fine-tuned to act as classifiers and/or extractors may use unfeaturized inputs. So transformations between featurized and unfeaturized data may be desirable when interoperability is important. As to transforming featurized data into non-featurized data, various methods may be used. See FIG. 46 for a method of transforming featurized text into natural language. Note the importance in FIG. 46 of the IDs for words or word vectors in reconstituting the natural language input from a text featurization. Various models in the example embodiment, such as LLMs, may generally take natural language inputs, whereas a knowledge graph may take inputs based on either featurized or unfeaturized inputs. Because knowledge graphs also may represent data as structured knowledge, a knowledge graph may provide a desirable degree of transitivity between models, and in addition be used to efficiently evaluate them.

Transformations between featurized data and structured knowledge. In the example embodiment, data represented as structured knowledge may refer to data that is organized into predetermined formats to facilitate comparisons and analysis of similarly formatted data to gain insights from the data. In the example embodiment, structured knowledge representations may include but may not be limited to: databases, knowledge bases, knowledge graphs, semantic networks, Bayesian networks, the story-based ontology class hierarchy, probabilistic predicates, subject-verb-object sets, health and other and assessment scores based on validated healthcare models (e.g., reference treatment data) and assessment instruments (e.g., reference speech data). In the example embodiment, featurized data may be transformed into structured knowledge by models and algorithms that use featurizations to generate representations of structured knowledge. For example, a classifier that is trained to analyze featurized voice data to determine if there is anxiety may output an anxiety score based on featurized input (See FIG. 30A), thus transforming audio frames into knowledge. In the example embodiment, certain types of structured knowledge, such as probabilistic predicates and knowledge graphs, are computable and may facilitate the use of other structured knowledge, such as health scores, within the probabilistic framework provided by the story-based ontology class hierarchy.

Transformations between featurized data and unstructured knowledge. In the example embodiment, unstructured knowledge may refer to data that is not specifically formatted for reasoning or analytical purposes. Examples of unstructured knowledge may include audio and video recordings, sensor data, natural language text, and so forth. In the example embodiment, featurized text may be turned into natural language text (See FIG. 46), which may be unfeaturized, unstructured knowledge. LLMs may take such unfeaturized unstructured knowledge as inputs. Meanwhile, unstructured knowledge such as a LLM output then may be featurized, and then further transformed into a structured knowledge representation, such as probabilistic predicates or nodes and edges in a knowledge graph.

Transformations between unfeaturized data and unstructured knowledge. In the example embodiment; unfeaturized data may be transformed into unstructured knowledge in various scenarios. For example, natural language input, which may be unfeaturized data to begin with, may be transformed into unstructured knowledge, such as audio. This type of transformation may involve, for example, text-to-speech transformations. Here, the data may be transformed from raw text data to raw audio data, and the resulting audio may be unstructured in the sense that it has sound waveforms rather than textual elements.

Transformations between unfeaturized data and structured knowledge. In the example embodiment, a LLM output may be transformed from raw text into nodes and edges in a knowledge graph, which is a structured representation of knowledge. Meanwhile, nodes in a graph may be transformed into raw text. In the example embodiment, there may be various scenarios involving transformations between unfeaturized data and structured knowledge. For example, text descriptions of objects may be parsed into fields in a data base, thus structuring the text descriptions as a representation as knowledge.

Transformations between unstructured knowledge and structured knowledge. In the example embodiment, a LLM output, which may be unstructured knowledge, may be transformed into nodes and edges in a knowledge graph, which is structured knowledge, as an example. In the example embodiment, mapping LLM outputs to knowledge graphs may be an efficient way to handle knowledge structuring based on the story-based ontology class hierarchy. In the example embodiment a LLM fine-tuned on a story-based ontology and a knowledge graph may be used together in various ways to create computable representations of inputs in terms of the story-based ontology. See FIG. 30E for a more detailed description.

Let's go further into an example, since mapping LLM outputs to knowledge graphs may be an efficient way to handle knowledge structuring, based on the story-based ontology class hierarchy in the example embodiment. In the example embodiment a LLM fine-tuned on a story-based ontology and a knowledge graph may be used together in various ways to create computable representations of inputs in terms of the story-based ontology. For example, a LLM may be prompted to output pairings of input text with extracted story-based ontology information related to the input text. (See FIG. 28 for a more detailed description of how this pairing may work). This input text and extracted story-based ontology information based on one or more prompts may be mapped to nodes (e.g., representing a story-based ontology class structure, see FIGS. 3, 4A and 4B) and edges (e.g., representing relationships between classes and between components of the story-based ontology class structure) in a knowledge graph. Meanwhile, the pairing from extractions of extracted story-based ontology information to input text may be used to establish the instance of the story-based ontology class structure as associated nodes. To now illustrate one way this may be executed, let's say the output of a LLM fine-tuned on a story-based ontology includes a caregiver role for a role class and a Charles identity for an Identity Class. In this scenario, an Identity node may have an edge to a name property attribute node which may have an edge to value node which may have an edge to a Charles node. Thus, Charles may be represented as an instance of the story-based ontology identity Class using a knowledge graph. Note how precisely this may follow the class structure described in FIGS. 3, 4A and 4B. In a similar manner, the caregiver role extraction may be represented in the knowledge graph by a Role Class node with an edge to a Caregiver Role node with an edge to a name property attribute node with an edge to a value node with an edge to a caregiver node. Note how closely this also may match FIGS. 4A and 4B descriptions. Meanwhile, the Charles node and the caregiver node may share an edge, since in the example embodiment, an Identity Class and a Role Class have a dependency (See FIG. 3). Thus, in this simple example, Charles as a caregiver may be represented as an instance of the story-based ontology identity Class using a knowledge graph, based on story-based ontology-based extractions from input. This also shows one way, in the example embodiment, structured knowledge may be represented in knowledge graphs. Representing structured knowledge in a knowledge graph may facilitate various computations and analytics, using graphical computing methods. Now to close the loop on how predicates may be generated from the knowledge graphs based on LLM outputs, the nodes and edges may be analyzed and associated with a unique identifier. The identifiers may be used to track and calculate the number and distribution of connections and other factors useful in determining the centrality of nodes, strength of a community (based on clustering) and so forth. These identifiers may facilitate feature engineering to output features, based on the knowledge graph structure, that then may be used to generate probabilistic predicates.

In the example embodiment, a story-based ontology class hierarchy may act as a computable, probabilistic framework for managing uncertainty based on an analysis of streaming inputs and class structures where each attribute of each class may have an uncertainty component. In the example embodiment, a probabilistic programming language (e.g., Problog) may be used to reason on the basis of uncertain information, using probabilistic predicate logic, in combination with a Bayesian network. This functional programming allows for the evaluation of a nested series of probabilistic predicates generated from featurized inputs, and the Bayesian network allows for efficiently evaluating prior and new data to arrive at more probable probabilities. In the example embodiment, probabilistic logic based on the story-based ontology class structure and hierarchy, may determine which actions may be likely to reduce uncertainty or to complete information to improve it, as may be required to resolve dependencies in the story-based ontology to properly instantiate instances with user data. In a preferred embodiment, actions based on probabilistic reasoning on inputs and various associated computations may be determined by functional programming, such as probabilistic programming. However, it is recognized that the performance of certain tasks, especially involving the outside world, may be better suited to object oriented programming. In the example embodiment, probabilistic programming and object oriented programming may work “hand in glove”, where probabilistic programming may determine the action through probabilistic reasoning and then delegate the action to object oriented programming to execute. To facilitate interoperability, both probabilistic programming and object oriented programming may be based on the same story-based ontology. Interoperability may improve the performance of the system and facilitate standards for evaluating not only input data but also the programming code. For example, in example embodiment, object oriented programming may be used to encapsulate dependencies in the story-based ontology through methods, where code may then may be evaluated by predicates also based on the story-based ontology. The hand in glove approach also may facilitate interoperability with the outside world. For example, an API with an electronic medical record system may be more likely to use object oriented programming than probabilistic programming. In the example embodiment, object oriented programming may perform tasks involving a series of actions related to the outside world (e.g., making a phone call, writing to an electronic medical record system, ordering a car service for a doctor's appointment, conducting a banking transaction, etc.). To facilitate the back and forth between programming languages, methods in the object oriented programming may “hook” into predicates, for example, related to actions (e.g., updating or retrieving a medical record) to then perform the determined actions (e.g., updating or retrieving a medical record). In the example embodiment, a translation layer, or transpiler, may be used, which may take the source code in one language and turn it into source code for another language. In the example embodiment, transpilers connecting the described object oriented programming and the described functional programming may facilitate the continuous, back and forth flow of data between the outside world and the probabilistic information used to reason about the outside world. The story objects that encode relationships may also be represented as part of a hypergraph. Hypergraphs, as a datastructure, may be optimized to facilitate a network of agents based on hypergraphs.

### Automated Assessment and Engagement Evaluation

This portion of the patent application relates to computer-implemented software systems, data processing, and machine learning systems according to example embodiments, and more specifically to an automated assessment system for evaluating the quality of interactions between people and scoring their respective health or wellness situations based on their conversations.

Fidelity monitoring is essential in behavioral research for providing researchers, caregivers and providers with an understanding whether an intervention is implemented as intended. However, fidelity monitoring relies on manual-coded rating systems that are labor intensive and expensive to implement, especially in non-clinical settings, such as the home. Fidelity monitoring is crucial to understanding the quality of care being received by millions of older adults in the home who are reliant on family caregivers and visiting providers for help performing basic activities of daily living. Therapeutic engagement is an important fidelity measure.

In the example embodiment, fidelity may be measured using recognized measures of therapeutic alliance in clinician-dementia caregiver interactions during the implementation of an evidence-based dementia care program (e.g., COPE, or Care of Older Persons in their Environment, a validated in-home care model). Such a system may provide feedback on therapeutic alliance to providers in real time to help scale evidence-based dementia programs with fidelity. The data set used to train and test a novel engagement classifier may be obtained from a clinical trial, which includes a series of recorded conversations with family caregivers of persons living with dementia and clinicians (occupational therapists or registered nurses) as they implemented a dementia caregiving plan, followed by assessments of therapeutic engagement using an assessment instrument called the Therapeutic engagement index. In the example embodiment, fidelity monitoring may be optimized by providing clinical feedback based on dyadic communication (e.g., between caregiver and OT, caregiver and cared for, etc). Additionally, interaction-based measures such as therapeutic engagement may have predictive value for treatment outcomes.

### Therapeutic Engagement Index (TEI) Automation.

In the example embodiment, the scoring rubric of a widely recognized manually completed assessment instrument for scoring a condition or user state may be used by an AI-based classifier to automatically score the same condition or user state. For example, a validated 24-item Therapeutic Engagement Index (TEI), used to assess therapeutic engagement, may involve 12 caregiver items and 12 matching provider items, with a scoring rubric for the items (e.g., a question and answer set with a predetermined value for each possible answer), which may be tabulated and assessed at the end of each treatment session. The scoring rubric of the TEI involves asking clinicians and dementia caregivers to rate verbal and nonverbal behaviors of the caregiver or clinician, respectively, using a Likert scale that reflects engagement. The same items and Likert scale may be used in the example embodiment for rating these same behaviors, as will be described.

In the example embodiment, in addition to health assessment instrument data, EMR, demographic and other participant data from a clinical trial may be used to train a therapeutic engagement classifier.

### TEI: Comparing Human and AI Generated TEI Scores.

Various steps may be carried out automatically by the inventive system using retrospective clinical trial datasets containing coached conversations and human scored TEI. These steps may include, but not limited to:
1. Compare scores from a manually completed Therapeutic Engagement Index (TEI) instrument chosen to measure fidelity with the TEI scores generated by AI ambiently listening to the audio recorded dyadic sessions.
2. Compare an expert human rater analysis of the interaction for each session for each respondent on a with the same tiering of values generated by AI ambiently listening to the audio recorded dyadic sessions.
3. Determine quality of AI results in 1) and 2) compared to human results (e.g., precision, recall, sensitivity, etc) based on assumption human scores are the “ground truth”, or standard for comparison.

To perform these three steps automatically, the clinical trial data may be prepared first before being uploaded into the system:

### TEI: Data Preparation.

1. The original audio recordings may be cleaned of personally identifiable information automatically, including through a deidentification algorithm
2. A data grid, or store, may be created listing the filename (for each of the audio files), the dyad ID, and a collection of metadata (the length of the recording, the number and role of speakers, demographic information for the interviewee, etc.). Each row of this grid also may contain the engagement survey item score and total engagement scores for each caregiver and occupational therapist (OT) or registered nurse (RN), plus the respective expert human-rater rating for each session.

### TEI: Automated Data Processing, AI Training and Output Pipeline.

Once the data is prepared and uploaded, the inventive system may generate individual engagement index scores for each answer for each caregiver, clinician, dyad and session; perform comparisons to the original study data results; and, render a statistical analysis (e.g., Cohen's Kappa) of the AI's performance—automatically.

As a first step in the automated process, the system may transcribe each of the provided audio recordings using a commercially available automatic speech recognition (ASR) service, and speaker diarization and deidentification algorithms. ASRs take voice data and turn it into words. Diarization refers to separating voices in a conversation and matching transcribed words to the right voice. This process may be used in the example embodiment to transform each audio file into a collection of timestamped words and sentences, each tagged with a speaker ID.

Next, the system may look up each of the twelve subscores for each speaker (caregiver and OT) in the assessment instrument (e.g., therapeutic engagement index), using the data grid. Each question contained in the index is answerable with a single integer (e.g., 0 (not at all/never), 1 (somewhat/occasionally), or 2 (very much/always)). For each question and each possible response, a single transcript may be chosen at random that had received that score from a human. The selected transcripts for each of the three possible responses illustrated above then may be tagged as examples of that score in the database of the example embodiment. In the example embodiment, clinical trial transcripts may be used in this manner as part of the training set leaving as a balance a test set of other clinical trial transcripts.

FIG. 55 provides a flow diagram showing the training of a ML-based agent network to predict assessments (e.g., health and/or engagement assessments) using transcripts in accordance with various embodiments of the present invention. First, at 5410, the clinical trial (CT) dataset is provided, including clinical conversations (recorded and featurized) and health assessments scores based on human subject answers temporally associated with the clinical conversations, plus EMR and other participant data. Then, at 5420, a data store is created for CT data, including actual CT participant assessment scores based on scoring rubric for participant's assessment instrument answers to instrument questions. Next, at 5430, the system looks up each possible score for each health assessment instrument answer and matches each looked up score to a collection of representative transcripts for people having that same score from a temporally completed health instrument. At 5440, training set of example transcripts corresponding to each possible score to each question on the assessment instrument is established. Then at 5450, training transcript examples are incorporated into agent hierarchical memory. Searchable memory is distilled into optimized prompt. The LLM is instructed by the prompt, output is generated (including information on weights), and adjustments are made in prompt based on weights, output and evaluation. At 5460, winning prompt is determined and the training complete.

Next, a machine-learning based agent network may orchestrate how a commercial large language model (LLM) would interact with the randomly selected transcripts to generate an assessment instrument score (e.g., TEI). In the example embodiment, ML-based agents may continuously learn and reason once trained using various training sources. An AI agent may be established for each of the subscores in an assessment instrument (e.g., TEI)—each agent having a customized system prompt containing the question corresponding to the sub-score, and also access to the database with the example transcripts in it. Each agent may be configured to use the relevant training set transcripts from the database as examples (e.g., a “few-shot learning” approach).

FIG. 56 is a flow diagram showing transformation of audio input to scoring outputs using a ML-based agent network, a LLM, and predicates. First, at 5510 is a live streaming or recorded audio file containing conversation with multiple speakers. Shown next, at 5520, the audio input is featurized, diarized and transcribed. At 5530, the transcript is deidentified as required (e.g., medical). 5520 output goes into ML-based agent network 5550. Within 5550, at 5553, a training transcript corresponding to each response in the assessment instrument is fetched. At 5552, a custom LLM prompt is imported for each question in the assessment instrument. A custom prompt containing training transcript for each possible response to that one question instructs the LLM how to perform the evaluation. Next, at 5554, formatted transcript is imported and operated on by LLM per prompt instructions. At 5556, there is a custom response parser for each question type in the assessment instrument. At 5558, responses are assembled into predicates. At 5559, which connects with 5558, there are specialized prompt nodes/subgraphs for each predicate type. Predicates are combined into final assessment score in inference layer 5540.

Example prompt to instruct a LLM how to evaluate, based on a original transcript, a TEI score for questions about the caregiver on the TEI engagement instrument:
You are a clinical research specialist tasked with reading the transcript of a conversation between a caregiver and an OT (Occupational Therapist) and answering questions about the transcript. The questions pertain to how engaged the caregiver is with the OT. Each question should be answered with a single integer response on a scale of 0-2:0 for “Not at all or never”, 1 for “Somewhat or occasionally”, and 2 for “Very much or always”. The first question is “Does the caregiver ask questions about caregiving difficulties?”.
Here is an example of a transcript that should receive a 0 (not at all or never):

```
      {{ transcript_example_0 }}
  Here is an example of a transcript that should receive a 1 (somewhat or
occasionally):
        {{ transcript_example_1 }}
    Here is an example of a transcript that should receive a 2 (very much or always):
        {{ transcript_example_2 }}
    Here is the transcript I want you to categorize for me:
    [[BEGIN NOVEL TRANSCRIPT]]
        {{ transcript_example_novel }}
    [[END NOVEL TRANSCRIPT]]
    As a reminder, the question is “Does the caregiver ask questions about caregiving
difficulties?”. Please respond with a single integer response on a scale of 0-2: 0 for “Not
at all or never”, 1 for “Somewhat or occasionally”, or 2 for “Very much or always”.
Thank you!
```

Finally, agent nodes may be configured to run simultaneously and send their results to a “director” node. The director node may combine the results together into a single score, using the instrument formula. In the case of TEI, this consists of summing the scores of the nine standard questions together with two minus the score of the three reverse-coded questions. In the example embodiment, an agent network may run on each of the sessions in the test set, keeping track of the final predicted scores (e.g., TEI) for each session.

FIG. 57 is a flow diagram in time from the start of a conversation to the end of a conversation from an annotated transcript generated from audio recording or live conversation and displayed in accordance with various embodiments of the present invention. In FIG. 57 a transcript 5610, beginning with Speaker A transcribed word, or line (semantic unit) and timestamp 5620 is shown. At 5622, corresponding assessment subscores are generated, tallied and displayed. Speaker B transcribed word, or line (semantic unit) with timestamp 5630 is shown. At 5632, corresponding assessment subscores are generated, tallied and displayed. Speaker A transcribed word, or line (semantic unit) with timestamp 5640. At 5642 corresponding assessment subscores are generated, tallied and displayed. Speaker B transcribed word, or line (semantic unit) with a timestamp 5650 is shown. At 5652, corresponding assessment subscores are generated, tallied and displayed.

FIG. 58 shows a total assessment score for each speaker based on completed conversation between speakers in accordance with various embodiments of the present invention. In particular and provided in this figure are a Speaker Score Summary 5710 for each speaker 5720 and 5730. The Speaker Score summary shows Speaker A 5720 has a total score for the conversation 5722, and Speaker B 5730 has a total score for the conversation 5732.

Next, these AI generated scores may be compared as described previously to the “ground truth,” meaning the actual scores tabulated from manually completed individual items by human respondents. This may be further evaluated by a team of expert human raters (as opposed to respondents) as a quality check on the respondent answers. This information may contained in the datagrid, or store.

Example software output explaining a TEI score and the LLM's rationale for generating it.

Below is a verbatim response from a LLM in the example embodiment. When asked to provide a score and a rationale for the score, based on the specific TEI question: “Does the caregiver ask questions about caregiving difficulties?” the System's generated response is:

The answer is 1 (Somewhat or occasionally).
While the caregiver primarily describes the difficulties she faces,
she occasionally asks questions seeking advice or clarification:

| Caregiver verbatim | Timestamp | How this relates to score |
|---|---|---|
| Will all sessions . . . ? | (142.16) | asking about the format of future sessions |
| You mean living or period? | (290.475) | seeking clarification about the question regarding |
| | | children |
| Helpful? What's the barrier? | (1611.495, | asking for advice on getting her husband to attend |
| | 1612.695) | the center more often. |
| Do I have to send extra | (3139.425) | seeking clarification on center procedures. |
| clothes? | | |
| What's a late drop off? | (1933.63) | asking for clarification about late drop-off options. |
| (1933.63) | | |

These instances suggest that the caregiver is engaged with the OT and seeking solutions, but doesn't explicitly frame her questions as seeking help with caregiving difficulties.

Example software output explaining a TEI score and the LLM's rationale for generating it.

In this example, predicate-based search may be used for all possible pairs and then each pair of transcripts is evaluated using this LLM prompt:

```
  You are a clinical research specialist tasked with reading the transcripts of two
consecutive conversations between a caregiver and an OT (Occupational Therapist). You
are looking for a scenario where the caregiver is given advice of some sort in the first
conversation, and then the second conversation contains evidence that the caregiver has
followed that advice in a way that has made a positive difference to their life. The
transcripts of the two conversations are pasted below:
  Transcript 1 (earlier):
  [[BEGIN TRANSCRIPT 1]]
      {{ transcript_example_earlier }}
  [[END TRANSCRIPT 1]]
  Transcript 2 (later):
  [[BEGIN TRANSCRIPT 2]]
    {{ transcript_example_later }}
  [[END TRANSCRIPT 2]]
  As a reminder, you are looking for a scenario where the caregiver is given advice of
some sort in the first conversation, and then the second conversation contains evidence that
the caregiver has followed that advice in a way that has made a positive difference to their
life. If you find such a scenario, then respond with the word “SUCCESS” and a description
of what you found. If you don't find such a scenario, then respond with the word
“FAILURE”.
```

Example software output regarding adherence from above prompting of a LLM.

In the first transcript, the OT, C., advises the caregiver to practice deep breathing exercises
as a stress management technique (around timestamps 509-532). In the second transcript,
the caregiver confirms that she has tried the deep breathing exercise at least once since the
previous conversation and found it somewhat helpful in reducing her stress (around
timestamps 780-886). This demonstrates that the caregiver has followed the OT's advice
and experienced a positive impact on her well-being.

### Additional AI System Uses.

The example embodiment may be used to determine/assess dementia caregiver depression and burden, determine based on caregiver burden and other caregiver scores the dementia patient (i.e., the cared for)'s healthcare utilization (911 calls, hospitalizations, etc), and identify “intervenable factors” during the conversations based on inferences using the predicted assessments and utilizations.

To meet these, the example embodiment may be described as a cloud-based deep learning audio and text classification system. This system may use a proprietary network of ML-based agents to orchestrate interactions between a commercial LLM, curated information in a data grid, and deidentified transcripts. The system's ML-based agents may learn and reason continuously once trained using various training sources.

Four steps may be followed: data preparation (data grid and transcripts), system training transcripts, system output generation (hold out set of transcripts), and output analysis.

### Data Preparation.

### Datagrid.

Update with consented, deidentified PHQ9 & Zarit's Caregiver Burden subset scores; add text from respective instrument items. Update with consented, deidentified EMR demographic, diagnosis, prescription, and utilization data for participants; add Activity of daily Living (ADL) information derived from LLM queries related to subset scores; perform regression analysis using PHQ9/Zarit's data, EMR data, and ADL information to establish strongest correlations to particular sessions, update grid with analysis results. Use fully populated grid from above steps.

### Transcripts.

Automatically transform each session audio file into a collection of deidentified timestamped words and sentences, each tagged with a speaker ID and session ID. Detail: Run supplied audio recordings, previously cleaned of personally identifiable information (PII), through a commercial ASR and a diarizer trained on older adult voices to improve speaker ID and voice matching. Use deidentifier as extra privacy safeguard. Store generated transcripts in secure database.

### Few-Shot Training.

Randomly choose a single transcript associated temporally with each possible subset score from the human-completed assessments, and store it as an example of that score. All transcripts identified this way go into the training set.

Identify a session with the strongest correlation to each utilization category as determined by the regression analysis (see data prep), and assign the corresponding session transcript this value. Training transcripts.

Determine inflection points in the human scoring and utilization analysis and identify sections of transcripts corresponding to these inflections, then labeling these transcripts for the respective inflections.

### Output Generation.

Once trained to predict outcomes based on the training transcripts (and data grid), the system's ML-based agents in the existing system may orchestrate interactions with the LLM and the hold out transcripts to generate inspectable outputs.

The ML-based agents may generate a situational context for identified inflection points using topic modeling, retrieval-augmented generation (RAG), and other techniques to evaluate and describe in natural language key determinants of the changes predictive of future outcomes.

### Analysis

The system's output may be compared to the actual manually rendered scores as well as relevant deidentified behavioral health available on the caregiver or patient from electronic medical records. The analysis may include statistical measures as well as natural language insights generated from agent queries of LLM rationales.

Meanwhile, results may be shared with a study and clinical team, including trained providers, for suggestions. For example, suggestions to change the trajectory at identified inflection points could be input into the existing system and used to simulate what impact the suggestions may have on predicted outcomes. This may yield a list of intervenable factors with impact predictions on trajectories.

### Automated Health Risk Monitoring and Mitigation System.

This portion of the patent application relates to computer-implemented software systems, data processing, and machine learning systems according to example embodiments, and more specifically to an automated assessment system for monitoring health, wellness and lifestyle changes from conversational and other data inputs correlating to higher risk of hospitalization or other urgent health resource utilizations.

### Predicting Healthcare Resource Utilization Based, in Part, on User Interactions

In an example embodiment, the inventive system may generate an alert, based on the interaction, to flag a likely future hospitalization, 911 call, emergency room visit, urgent care visit, or various other urgent health care encounters, for one or more users. In an example embodiment, the alert may involve a user not involved in the interaction. For example, signs of a health issue for a family caregiver detected by the inventive system during an interaction between a family caregiver and a nurse or other health care worker may correlate to the health of a loved one (e.g., a dementia patient), who may or may not be present during the illustrated interaction, but nonetheless who is in the caregiver's care.

In the example embodiment, a novel method may involve determining during a caregiver-involved interaction (e.g., a phone conversation or a text-chat), what part or parts of what interactions involving the caregiver indicate signs of a caregiver health issue (e.g., depression, anxiety) or situational matter (e.g., lack of health education, financial, or work related challenges affecting availability of caregiver when needed) that may correlate to the loved one's risk of hospitalization or other type of healthcare utilization. In the example embodiment, this risk to the cared-for, if determined to be above certain thresholds, may trigger an alert, among other actions, to appropriate users, in accordance with regulations, including to other systems (e.g., electronic medical record systems, emergency systems, community based support systems, etc., may be users of our system) to facilitate early interventions on behalf of the patient (cared-for) and other mitigating actions.

In the example embodiment, a signal detected from the caregiver's voice or text or other communication (e.g., images or combination of different types of data inputs) may be used to indicate a condition or situation that may pose or relate to some risk associated with the cared-for's health and wellness. For example, a family caregiver user with their own condition (e.g., depression or anxiety) and/or situation (e.g., caregiver burden, socio-economic challenges) may be predicted by our inventive system, based on what they say, to have difficulty in making decisions due to their own condition and/or situation. Some of these decisions that may be difficult for the caregiver to make or implement may be on behalf of the cared for and thus directly affect the cared for and their health outcomes. These may include matters inhibiting medication adherence, for example. Difficulty in making decisions (e.g., a potential sign of depression), may impede the caregiver's ability to properly administer medication needed by a loved one, a common caregiver activity.

In the example embodiment, an alert resulting from an assessment of a caregiver's condition (e.g., signs of depression) or situation (economic hardship), using various methods, may result in an alert that leads to treatment or services for the caregiver that helps the caregiver attack their own issues as part of the total approach to providing care effectively for the cared-for in the home. Returning to the example of a cared-for (e.g., dementia cared for) not taking their medications due to caregiver matters, the caregiver's condition and/or situation, when treated or addressed, may result in the caregiver being able to focus better on administering the medications. As a result, by caring for the caregiver, the risk to the cared-for of the cared-for not taking their own medication for the cared-for's own condition may be lowered.

As another example, a caregiver burden may be detected and an association made with, say, the caregiver's difficulty preparing meals for a cared-for that are appropriately nutritious, which could invite an escalation of professional care due to malnutrition. In this example, on the basis of the alert, a meal service may be engaged or updated to provide a reliable, nutritional solution based on the situational assessment made by a care team, using inputs from the inventive system.

In the example embodiment, the detected issue may or may not involve a situational issue that may be addressed through education (e.g., not knowing more about the right nutrition). In the example embodiment, an alert may involve a deficit in caregiver knowledge detected or predicted by the inventive system that could be remedied by a caregiver training or education event (e.g., an action that may also be linked to a billing code, if necessary), as a step to reduce a risk of malnutrition, for example.

In the example embodiment, various levels of care provided by the caregiver for the cared-for may be determined based in part on the type, scope and intensity of dependencies (e.g., related to activities of daily living) of the cared-for on the caregiver. In the example embodiment, dependencies related to activities of daily living may be determined using various methods. These may involve automated assessments based on one or more validated ADL assessment instruments (e.g., Katz Index of Independence in Activities of Daily Living, Lawton-Brody instrumental activities of daily living), which the system may perform automatically and, in many cases, ambiently (e.g., without directly questioning a user). This evidence gathering may also involve various sources (e.g., electronic medical records, sensors, etc), what is said or communicated during interactions with professionals, or data obtained regarding user actions (e.g., grocery purchases, body weight levels based on electronic scale data, etc) that may be integrated into the data schemas used by the example embodiment to determine the impact of prior recommendations and how they may have been communicated.

In the example embodiment, a health alert may be generated based on a live or recorded interaction between users in either clinical or non-clinical settings (e.g., home, work, etc).

Furthermore, in the example embodiment, the interactions between users may occur in any setting or between any settings—for example, a call between a nurse at a clinic and a family caregiver at home or a caregiver and an occupational therapist visiting the home. In the example embodiment, access to the system may be by phone, computer or by other means (e.g., other systems connected to the inventive system). In the example embodiment, a probability may be generated, based on the interaction between the family caregiver and the nurse or other healthcare worker being illustrated, that the loved one, or patient, in the care of the caregiver is at a higher risk of hospitalization, or another site of service more expensive than where services may currently be delivered (e.g., the home, outpatient, etc).

In an example embodiment, various methods may be used to correlate the health of the caregiver, the health of the cared and the respective trajectories of their health.

In the example embodiment, the alert may be generated based on various types of evidence gathered before and during the interaction and analyzed by the inventive system in real time to generate and/or update a model representative of each user that uses probability in its determinations of user likely health and wellness trajectories. In the example embodiment, the alert may be generated as the next action step.

In the example embodiment, an alert may include, or link to, various data associated with the risk that is determined by the inventive system and what actions may be necessary, by whom, and in what time frame to mitigate the identified risk. In the example embodiment, multiple alerts may be triggered and sent to multiple different users, as appropriate (e.g., based on permissions, skill/licensing levels, etc), based on the nature of the alert, and the intended prompted action, for the predicted risk.

In the example embodiment, an alert may link a family caregiver's health/wellness and/or situation/story to a risk of escalated health costs for the cared-for (patient). These costs may be predicted in the example embodiment using access to data from a variety of sources (e.g., electronic medical record and billing data). In the example embodiment, the cost associated with the predicted risk may be predicted and provided, as necessary, to facilitate not only timely but also cost-effective solutions. In the example embodiment, an alert to an insurance company may contain information relevant to the insurance company, while an alert to a provider may contain information relevant to the provider, wherein both alerts may be triggered at the same time and associated, based on evidence.

The information generated by the example embodiment may facilitate better management of available fixed monies for a patient's care. For example, an insurance company may wish to know how effectively its payments are being used to manage care and determine which outcomes appear to improve based on payment arrangements. Alerts may assist health care payers and providers with cost analysis and enable them to determine cost effective solutions together for better payer-provider collaboration. This may mean speedier authorizations of certain health care procedures or treatments (e.g., where pre-authorization may be required) that in turn may facilitate addressing an issue earlier.

As another example, in risk-based contracts, a fixed amount of money may be available to care for the patient (e.g., a dementia patient) by contract between an insurance company and a provider. Balances remaining after all necessary care-related costs may be accounted for and shared between payer and provider. Providers and payers in risk contracts have an incentive to manage care cost-effectively—and so each may benefit from learning as early as possible, through our inventive system, of risks that can change a patient's health trajectory for the worse. In the example embodiment, associations between risks and medically necessary interventions may be further associated with relevant billing or reimbursement codes, actual costs, and so forth to predict a fuller financial picture of the risk. In the example embodiment, a fuller financial risk picture may include, but may not be limited to: a comparison between health trajectories and cost trajectories based on whether there is an intervention or not, the type of intervention, the intervention cost, associated health outcomes, and the like.

In the example embodiment, the communication choice for the alert (text to a user, an electronic signal to another system, data for an electronic medical record system, a call to a doctor, etc) may be determined based on various factors (e.g., urgency, responsiveness patterns of users, skill of users involved, etc.) In the example embodiment, the risks identified may be associated with various medically necessary interventions.

In the example embodiment, early probabilities of a more expensive care clinical setting (e.g., hospital) may be used to flag appropriate parties.

Interactions through the inventive system or ambiently captured by it, with permission, may involve multiple parties. These interactions may include, but may not be limited to, interactions between family caregivers and their loved ones (e.g., a cared-for, where the cared-for user also may be “patient”), caregivers and health care workers, caregivers and community services support experts, and caregivers and their coworkers, if they are employed, for example. These interactions may involve the caregiver.

In the example embodiment, interactions between users may involve various types of input data and multiple different devices. For example, one user may text a receiving user and the user receiving the text may call the texting user, instead of responding to the texting user by text. In the example embodiment, multiparty and various modes of communicating, along with the respective types of data (e.g., text for texting, voice/speech for calls, etc). In the example embodiment, users may interact with each other through the inventive system. In another embodiment, user data may be ambiently obtained by the inventive system, or alternatively by another system, with appropriate permissions, and then processed by the inventive system as described. In the example system, other systems may become system users of the inventive system, and as users may interact with each other to determine, among other things, if an alert is to be triggered and dispatched and in what form and to whom. For example, a caregiver may receive a phone call, a provider may receive a text from an EMR system, and so on.

In the example embodiment, data from the interactions is received, linked to a source, timestamped, and subject to various transformations and analysis, and various actions, such as alerts, based on the analysis, may be executed.

### System Overview

As shown in FIG. 59, user inputs may be received and featurized by the inventive system, and, using a plurality of agents in a machine-learning based agentic network consisting of multiple agents, transform the featurized inputs into probabilistic predicates, which, when stored in a knowledge graph, may be operated on, using queries and probabilistic logic programming (e.g., Problog, Wolfram), among other things.

Queries may relate to various searches as well as complex computations and predictions, which may involve inference using information in the knowledge graph. For example, queries may be used, in combination with various AI computational tools, to generate answers to what is the health status of a given user, what is the health trajectory of a given user or multiple users, what alert, if any, based on what threshold, and what financial analysis, should be sent to what party, in what situation, etc.?

In the example embodiment, queries may be initiated by users related to data about them in the system, which in turn may be produced, using the system. For example, a user may wish to know more about the reasons for an alert, or a health score from an automated health assessment instrument. Additionally, the inventive system may query one or more users. For example, the system may need, from time to time, a user's answer to meet sufficiency requirements, such as may be the case with a missing predicate argument needed to complete a predicate set. So, the system may prompt a user, using natural language. The interactions between the users and the system may take place through various interfaces, and may involve only voice (i.e., audio data), or a combination of various types of data.

As further examples, in the example embodiment, a response to a query may include, but may not be limited to:

Returning a list of all subject-verb-object sets that match a given search query.

Formatting the above in an arbitrary format; e.g. as an annotated transcript, a structured data table, a JSON representation of all scores for a given transcript, etc.

Performing causal reasoning to answer queries about cause and effect, e.g. “What would happen if we do X?” or “Why did X happen?”

Performing probabilistic reasoning to answer questions about uncertainty, e.g. “What is the probability that X will happen?”

FIG. 59 is a flow diagram at 5810 showing an overview of processing an active interaction using an agentic network in accordance with various embodiments of the present invention. Agent 1 at 5814, agent 2 at 5816, and agent N at 5818 are respectively shown coupled to 5820. At 5812, featurized data from active interaction (e.g., live or recorded conversation) is shown coupled to 5820. At 5820, there is a dynamic agentic network using multiple prompts to extract features and determine predicates from active interaction (e.g., conversation). At 5830, predicates determined from agentic network populate probabilistic knowledge graph for inference. At 5840, knowledge graph query conducts inference on knowledge graph to generate outputs based on query. At 5850, output (e.g., an alert, a question to a person, etc.) is shown.

In the embodiment, with regard to FIG. 59, input data related to users may be received and featurized.

### Dynamic Machine Learning-Based Agent Network.

In the example embodiment, incoming “requests”, or inputs from any user via an interface, for example a web-based application running on a smart phone, may be received, featurized, and then routed to an agentic conversation manager.

Other examples of routing to an agentic conversation manager, in the example embodiment, may involve an ontology builder, an app using an external service (e.g., Twilio), or a native application, to name a few.

External, or exogenous sources, of input, such as from sensors, may be received as well by the inventive system, and processed into formats usable by the inventive system's agentive network and machine learning models.

In the example embodiment, an “agentic conversation manager,” within the agentic network, using featurized inputs, may compile a graph configuration of featurized inputs. The resulting agent graph (e.g., Langraph) may be operated on using various AI tools (e.g., predicate extraction tools), to create additional graphs (e.g., predicate graphs), used to quickly serve the computational needs, and other data needs, of the inventive system.

The agent may be used, in the example embodiment, to inform other graphs, for example a probabilistic knowledge graph, to respond to/evaluate user conversational input, based on user or system queries.

In the example embodiment, to further describe the use of the agent graph, the conversation manager may maintain a conversation history (e.g., via PostgreSQL database), and use a dynamically defined agent graph to respond to each user message. In the example embodiment, an agent graph may be configured with a separate API endpoint that allows clients (e.g., user interfaces) to add, remove, and/or modify agents and connections between them.

In the example embodiment, an agent graph may be configured to run chats with a user and to fill out a set of predicates that fit into an ontology.

### Predicate Extraction.

In the example embodiment, a predicate extraction tool may extract structured data from unstructured input (e.g., audio, text, images, video, sensor data). The extraction tool may be configured to handle a number of different data inputs (e.g. live calls, transcribed text, etc) to produce a set of outputs.

Each type of output may be associated with a particular agent graph, and the extractor will extract the appropriate structured data from the input based on the agent graph configuration. For example, one output predicate may related to a health assessment score, another may relate to a story object based on a story-based ontology. In the example embodiment, some input data types also may be associated with a specialized agent graph; for example, audio data may be used in conjunction with an audio-specific multi-modal LLM.

Additionally, in the example embodiment, each output data type's agent graph may include a specialized response parser agent responsible for converting a raw LLM response into an appropriate structured data type, and assign a confidence score to the extracted predicate.

In the example embodiment, after candidate predicates are extracted, they may be evaluated against the knowledge graph described in the next step. If there is no conflict with existing predicates in the knowledge graph, the predicate may be added to the knowledge graph with the same confidence score assigned during extraction. If there is a conflict (with confidence over a threshold), then the confidence score of the new predicate may be adjusted downward to account for the conflict.

### Knowledge Graph.

In the example embodiment, a probabilistic knowledge graph may be a graph-based representation of all predicates known to the system. This may include the predicates extracted at a global level from schema definitions, ontology definitions, etc. as well as those extracted at the user level from individual user interactions and other data sources (e.g. sensors, wearables, electronic health/medical record integrations, etc.).

In the example embodiment, predicates may be stored in a knowledge graph (e.g., Caley) using a backend (PostgreSQL), with each predicate represented as a triple (Subject-verb-object, SVO) with optional metadata fields to include a confidence score, a timestamp, and a source to indicate where the predicate was extracted from.

### Knowledge Graph Queries and Outputs.

In the example embodiment, a query service may be responsible for answering queries about the information in the knowledge graph, as described above.

In the example embodiment, simple queries may be supported with, for example, SPARQL queries and handled by a query engine (e.g., Cayley). More complex queries, requiring inference or natural language processing may be handled at, say, a Python layer after ingesting all relevant predicates into an instance managed by a probabilistic logic programming language (e.g., Problog).

In this case, the set of relevant predicates may be dynamically selected based on the query and the current state of the knowledge graph: all global predicates may always be included, and all user predicates that are referenced in the query may be dynamically added to the set of relevant predicates.

As an example of a complex query, let's say that a caregiver asks the inventive system to show the caregiver how the caregiver's health related to the health of their loved one (patient), over the same period, and to point out, using verbatims, what the inflections are.

In the example embodiment, various queries may be automated. For example, inputs may be monitored continuously or at various predetermined intervals to assess and modify baselines using automated health assessment instrument scores, automated evaluations of therapeutic engagement, and other automated measures, including biometrics, etc., that may be received from other systems. In the example embodiment, the integration of different types of data into a schema may facilitate the automation of alerts, as well as an explainable audit for them. In the example embodiment, an alert may be traced back to given transcripts, and certain inflections identified and explained by the inventive system, based on user input data.

FIG. 60 is a flow diagram showing an overview of a single agent 5910 in an agentic network in accordance with various embodiments of the present invention. At 5930, there is featurized data related to an interaction. At 5920, there are prompts. At 5940, there is a deep learning model pre-trained on vast amount of data (e.g., large language or multi-modal model). At 5950, there is an output parser. At 5960, there is the output predicate.

In the example embodiment, each agent may consist, as shown in FIG. 60, at least, of a prompt 5920 and a set of tools that the agent may instruct (e.g., predicate extractor), via the prompt, and may involve another data source, such as a pre-trained deep learning model trained on vast amounts of data (e.g., a large language model or a multi-modal model) 5940, in addition to the featurized input data 5930.

Additionally, in the example embodiment, edges may be configured to allow agents to send messages to one another. Each edge may be either a “default edge” which may always be used if no other edges are appropriate, or a “conditional edge” which may have triggers to be met before it will route a message to an agent.

### Role of Probabilistic Predicates.

In the example embodiment, probabilistic predicates may be used to model and update a user representation as a set of probabilities, based on reasoning on uncertain facts. In the example embodiment, probabilistic predicates may include predicate heads and arguments as well as a probability value. These probabilities may include the result of Bayesian and other statistical methods to make optimal sense of different data values.

In the example embodiment, probabilistic predicates may be informed, during their determination or extraction, by an ontology that uses probabilities in each class structure in a hierarchy of classes. For example, every class may have attributes that include value and uncertainty components, which the inventive system may use to predict and minimize uncertainties.

In the example embodiment, probabilistic predicates may assist in reducing uncertainty to represent a more likely current or future situation. For example, is a caregiver really “fine” when the caregiver says in a conversation the caregiver is fine? Or, is there evidence, to suggest otherwise, for example, a sign of depression based on an assessment score for health condition or state of mind that the inventive system may generate in real time during a conversation, and how likely is this sign, based on this real-time, temporally related evidence, to be true as well?

As another example, in the inventive system, let's say a cough may be detected by a tool and committed to evidence (e.g., a predicate). A frequency of coughs within a time range combined with other evidentiary signals like a weak/raspy voice, along with mentions of illness, may create a likelihood of the user having a cold. Now, to continue the example, additional data from say, an electronic medical record, or another source, may be used to determine, in real time, that the cough is more likely associated with a heart condition.

In the example embodiment, both sound and text to be expressed in terms of universal data types, including as predicates associated with a probability.

In the example embodiment, data representations of the user may include a current view or snapshot of a user, based on current and/or longitudinal data input, as well as on simulations of a user future state or situation, expressed as probabilistic predicates and/or as objects based on an ontology that uses probability.

In the example embodiment, simulations of various user states may be analyzed for predicted impact on user goals, and adjusted, based on what is learned during an analysis of the predicted impact on a user progression towards goals, to generate a next recommendation for the user.

In the example embodiment, user representations may include any number of data views, including past, current and predicted/projected views. These views may include relationship data, for example, details on interactions with others.

In the example embodiment, queries may be automated by the inventive system, as it seeks answers from knowledge graphs and other data sources sufficient to meet thresholds for appropriate predicate formation (e.g., large language models) and/or to satisfy instance requirements of an ontology.

### Receiving and Processing Data.

In the example embodiment, users may interact with each other though the inventive system (e.g., via a phone call or text exchange routed through the inventive system). In the example embodiment, interactions between users, through the system, may take place using any connected device. For example, an interaction may take place using a phone number that routes a call to the inventive system without downloads required, or through other techniques (e.g., a downloaded phone application). The exchange of information between parties on the call then may be received as data from the call service and processed as input data, tagged to the speakers, and deidentified.

In the example embodiment, an interaction between users may be synchronous or asynchronous, or a combination thereof. For example, a text initiated by a caregiver in the morning may be responded to with a text from the recipient, say a physical therapist, right away. In another scenario, the therapist may respond with a call in the afternoon. In another example, a party designated by the therapist in a permissioned circle of responders may respond with a text right away while the therapist in this example may respond later with a call or email.

In the example embodiment, certain interactions may take place between users exogenously, outside the invented system (i.e., where the interactions with each other take place outside our system), wherein the data captured by these exogenous devices may be received by the inventive system, based on the data delivery timetable related to the device. Receipt may be either synchronous or asynchronous. For example, the input data into the inventive system from these exogenous devices may be a recorded call, or a sensor data, or an electronic medical record entry, including notes from a patient session.

In the example embodiment, certain aspects of typical human interactions, such as human gestures, movements within and between locations, and the like, may be ambiently captured via sensors or cameras or other devices that may detect the movement of people and objects, and, in some cases, read heat signatures, and the like. Ambiently captured data, regardless of its source, may be received and processed by the inventive system.

An example of a device that may collect ambiently and/or through interactions using the inventive system (with or without an application) is a smart phone.

In the example embodiment, the raw received data may be virtually any type of data and any combination of different data types. This data may include text data, audio data, image data, sensor data, device measurements/readings, or a combination thereof.

### Featurization of Input Data.

In the example embodiment, the input data may be streaming or batched or episodic. Regardless of the frequency or data type, the incoming/received data may be tagged to source (e.g., speaker, user device, metadata such as log data,), identified as a type of data, and then featurized using a processing pipeline, or featurization system, appropriate for the corresponding type of input data.

In the example embodiment, data related to interactions involving a conversation may be featurized using different processing routines for extracting sound features and word features; the latter may involve an automatic speech recognition system or equivalent tool. In the example embodiment, a deep learning model pre-trained on vast amounts of speech and other audio data may be used to perform part or all of this processing. In the example embodiment, the output of the acoustic processing routine may include sound features (e.g., pitch, loudness, etc), and the output of the speech-to-text processing routine may include word features such as tokens, word vectors, and so forth sequenced to generate a transcript.

In the example embodiment, parts of speech, phonemes, and entities and ontology elements, such as a role class in a story-based ontology with a class hierarchy, may be recognized from speech, and the output of the speech processing annotated accordingly, for example.

All features processed from audio and text datastreams may be transformed into a single output tensor used by various machine learning models in the example embodiment.

In the example embodiment, audio frames, or segments of the raw audio, may be temporally associated with segments of the transcript, based on generated text-tokens from an ASR or equivalent tool (e.g., a deep learning model pre-trained on vast amounts of speech and other audio data) using time stamping and other techniques. This may facilitate, for example, the processing of the sounds of a “cough” and representing it accordingly in a transcript (e.g., (Chad coughs)).

In the example embodiment, input streams may be evaluated with tools that enable the system to detect the presence of certain utterances, phrases, phonemes, sounds or patterns that become system evidence used in the construction of probabilistic predicates.

### Training of Various Systems in the Example Embodiment

In the example embodiment, the featurization system may be trained on one or more clinical datasets (e.g., clinical trial studies involving conversations, biometrics, health assessment instrument scores, electronic medical records, sensor data, hospital and care visits and costs, etc., for the studied cohorts). In the example embodiment, this training dataset may be featurized during the training process. A holdout set of data not used in the training process may then be used to test the output of the featurization system for accuracy and various other performance measures.

In the example embodiment, extractors and classifiers may be trained on these same clinical datasets.

FIG. 61 shows at 6010 how an alert may be generated using an agentic network in accordance with various embodiments of the present invention. At 6020, data is received related to a caregiver interaction or set of caregiver interactions. At 6030, received data is featurized and output generated from the featurization (e.g., transcripts, annotations). At 6040, using predicates extracted from featurized output by an agentic network and stored in a knowledge graph, a health assessment instrument score and health trajectory for the caregiver are generated. At 6050, predicates extracted from an external data source related to resource utilizations (e.g., hospitalization and associated metrics, costs, etc.) of the caregiver's cared-for (patient) are retrieved from a knowledge graph. At 6060, using predicates related to both caregiver and cared for, a risk of patient hospitalization (or other escalated use of health care resources) based on said caregiver interaction(s) is determined above a threshold. At 6070, said risk is communicated (e.g., alert).

As shown in FIG. 61, in the example embodiment, an escalated use of health resources may be predicted for a loved one in a caregiver's care (e.g., a cared for, or patient), based on a caregiver interaction. One or more health assessment instruments and health assessment instrument scores may be used in the analysis. In this example use case, data from various sources, including a conversation, may be received and processed, as described above, by the inventive system.

In the example embodiment, one or more predicates related to a family caregiver may be extracted from featurized data based on a conversation, or other interaction.

In an example embodiment, a set of feature extractors may be used that include both agent-based text large language models (LLMs) structured data extractors, multimodal LLM audio feature extractors, and also traditional ML-based classifiers. Each agent may orchestrate a prompt, which may instruct a large language model what task to perform and how, tools for extracting predicates, and the active input data. The generated predicates are stored in a knowledge graph for fast and efficient retrieval.

In the example embodiment, as described above, predicates may be extracted from multimodal input data streams, which may include input data from external (exogenous) devices. These devices may stream audio, text and/or video live from the involved parties.

Auxiliary data sources such as Electronic Health Records (EHR), or electronic medical records (EMRs), may be a source of input data from which predicates may be extracted. Below are various examples of the types of data inputs, via EHR integrations, that may be made available to the inventive system:

Medications: prescribed antidepressants or sleep aids may indicate ongoing mental health issues.

Clinical Notes: Doctor's notes mentioning reported increased fatigue and loss of appetite, or other similar indicators of depression.

Diagnoses: A history of depression, anxiety, or other mental health conditions that a patient or caregiver have been diagnosed with

Medical Tests: Blood work indicating potential markers of depression

Appointment Frequency: frequent mental health-related visits may signal deteriorating mental health.

In the example embodiment, predicates extracted from such exogenous data sources may be added to a knowledge graph in the inventive system, as described above. The knowledge graph also may have predicates related to automated health assessment instrument scores for a patient or caregiver, say, determined from a conversation. The knowledge graph, containing predicates from multiple sources, including real-time input streams (e.g., audio/text) during an interaction, may form a more holistic picture of the patient's and caregiver's health.

Generating, based on predicates, using a knowledge graph of user predicates, the health trajectory of the family caregiver.

In the example embodiment, generating a health trajectory may involve querying the knowledge graph. In the example embodiment, a set of all predicates that could possibly be related to the family caregiver's health trajectory, as well as to selected other user trajectories to be analyzed, may be ingested into an inference engine (e.g., Problog or Mathematica). Logical queries may be used then to retrieve the set of predicates that could be true in the future, given the current state.

In the example embodiment, the predicates stored in a knowledge graph may be organized various ways, which may include by user and call/source. Further, an abstract knowledge graph relating entities in accordance with an ontology and its class hierarchy may be used to “constrain” and help manage the probabilistic logic between predicates. The totality of that context may then be used by the agent system (recency weighted) to provide the necessary context and allow it to make an informative determination.

Predicting, based on a family caregiver health trajectory, a risk of hospitalization, a 911 call, and/or another urgent health care encounter for the patient.

In the example embodiment, for a classification model, the input features may be the predicates from our knowledge graph, and the output classes may be the health outcomes. In the example embodiment, a classifier based on a validated health assessment instrument may be used. The classifier itself may be a simple linear regression model (for explainability) but the underlying features may be complex and driven by a deep learning model trained on vast amounts of data (e.g., a large language model or a multi-modal model that can process audio, images and other data, besides text).

In the example embodiment, the totality of the predicate stream associated with a user may be transformed into text and fed into a graph. In the example embodiment, structure of the graph and the prompt in the agentic network may both encode objects based on an ontology and examine the predicate stream through that lens to determine if a specific action should be taken. In the instance that the inventive system (e.g., via a chain of structured calls to a large language model) decides to trigger an alert, an alert tool may be invoked to trigger said alert, provide the parameters of the alert and dispatch it to the outgoing queue where it may be sent to a designated party.

### Communicating a Patient Risk.

In the example embodiment, there may be a tiered alerting structure where each risk has a configured severity score and inferred probability score (e.g. 95% probability of an imminent 911 call would be 10/10 severity, 9.5/10 probability), and different tiers have different responses. High probability high severity events could go straight to the care team as a phone call, medium events could go out as text messages, and low events could just go to email or the web dashboard.

Once an alert has been triggered by the agent system, it may be popped off the outgoing mailbox queue for that user's agent instance and sent to the inbox of the designated receiver of such alerts, a provider or caregiver or a patient, for example.

The above described system is not limited to health risk monitoring, and can be used in other applications, for example coaching.

Some portions of this description describe the embodiments of the invention in terms of algorithms. These operations, while described functionally, computationally, or logically, are understood to be implemented by computer programs or equivalent electrical circuits, micro-code, or the like. The described operations may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to herein may include a single processor or may be implemented with architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially available operating systems and other known applications for purposes such as database management. These devices can also include other electronic devices, such as dummy terminals, virtual terminals, thin-clients, and other devices capable of communicating via a network.

Embodiments can utilize at least one network that would be familiar to those skilled in the art for supporting communications using any of a variety of commercially available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, or any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python, or TCL, as well as combinations thereof. The server(s) may also include database servers, including without limitation those commercially available from Oracle®, Microsoft®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element, or keypad) and at least one output device (e.g., a display screen, a display device, printer, or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed, and/or removable storage devices as well as storage media for temporarily and/or more permanently containing, storing, transmitting, and retrieving computer-readable information. The system and various devices also can include a number of software applications, modules, services, or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets, APIs, scripts, and the like), or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments and that many modifications and variations are possible.

The foregoing description of the embodiments of the invention has been presented for the purpose of illustration; it is not intended to be exhaustive or to limit the invention to the precise forms disclosed. The description and drawings are, accordingly, to be regarded in an illustrative rather than a restrictive sense. The language used in the specification has been principally selected for readability and instructional purposes. It is therefore intended that the scope of the invention be limited not by this detailed description and drawings, but rather by any claims that issue based on this application. It will, however, be evident that various modifications and changes may be made thereunto without departing from the broader spirit and scope of the invention as set forth in the claims.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

Although various embodiments, which incorporate the teachings of the present invention have been shown and described in detail herein, those skilled in the art can readily devise many other varied embodiments that still incorporate these teachings.

What is claimed is:

1. A computer-implemented method, comprising:
evaluating, through a large language model (LLM), streaming input data corresponding to a live conversation among a set of users to generate a first set of scores associated with a first set of communications exchanged during the live conversation, wherein the first set of communications is evaluated according to a scoring rubric associated with an assessment instrument, and wherein the first set of scores is generated according to different assessment criteria associated with the assessment instrument and a first set of confidence values associated with the first set of scores;
generating, based on the first set of scores and the first set of confidence values generated by the LLM, a first total assessment score for the live conversation and a first total confidence value for the first total assessment score;
providing, during the live conversation, the first set of scores and the first total assessment score, wherein the first set of scores and the first total assessment score are provided as a result of the first set of confidence values and the first total confidence value satisfying a sufficiency threshold;
obtaining, during the live conversation and in real-time, a second set of communications exchanged among the set of users, wherein the second set of communications is exchanged among the set of users after the first set of communications;
evaluating, through the LLM, the first set of communications and the second set of communications to generate a second set of scores associated with the first set of communications and the second set of communications, wherein the second set of scores is generated according to the different assessment criteria and a second set of confidence values associated with the second set of scores; and
generating, based on the second set of scores and the second set of confidence values, a new total assessment score for the live conversation and a new total confidence value for the new total assessment score.

2. The computer-implemented method of claim 1, wherein the assessment instrument is selected from the group consisting of a therapeutic engagement index (TEI) assessment, a general anxiety disorder 7-item assessment (GAD-7), a personal health questionnaire 9-item assessment (PHQ-9), a quality of life assessment (QoL), and a caregiver burden assessment.

3. The computer-implemented method of claim 1, wherein the streaming input data includes real-time audio containing the first set of communications exchanged during the live conversation.

4. The computer-implemented method of claim 1, wherein evaluating the streaming input data through the LLM further comprises:
instantiating a prompt according to a role, wherein the prompt causes the LLM to assume the role for processing the streaming input data and generating outputs corresponding to the first set of scores and the first set of confidence values.

5. The computer-implemented method of claim 1, wherein the LLM performs a simulation of the assessment instrument in real-time according to the streaming input data and without interacting with any of the set of users to generate the first set of scores and the first set of confidence values.

6. The computer-implemented method of claim 1, wherein evaluating the streaming input data through the LLM further comprises:
transforming a prompt into a story-based ontology instance associated with a story-based ontology, wherein the prompt instructs the LLM to process the streaming input data according to the story-based ontology instance to generate outputs corresponding to the first set of scores and the first set of confidence values.

7. The computer-implemented method of claim 1, wherein the streaming input data is segmented into a set of data slices corresponding to the first set of communications, and wherein the LLM generates the first set of scores and the first set of confidence values for each data slice of the set of data slices.

8. The computer-implemented method of claim 1, further comprising:
obtaining, based on new streaming input data associated with the live conversation, feedback corresponding to at least one of the first total assessment score or a subset of the first set of scores; and
re-training the LLM using labeled training data comprising the feedback, the first total assessment score, and the first set of scores.

9. The computer-implemented method of claim 1, wherein the set of users includes at least one automated intelligent agent.

10. A system, comprising:
one or more processors; and
memory storing thereon instructions that, as a result of being executed by the one or more processors, cause the system to:
evaluate, through a large language model (LLM), streaming input data corresponding to a live conversation among a set of users to generate a first set of scores associated with a first set of communications exchanged during the live conversation, wherein the first set of communications is evaluated according to a scoring rubric associated with an assessment instrument, and wherein the first set of scores is generated according to different assessment criteria associated with the assessment instrument and a first set of confidence values associated with the first set of scores;
generate, based on the first set of scores and the first set of confidence values generated by the LLM, a first total assessment score for the live conversation and a first total confidence value for the first total assessment score;
provide, during the live conversation, the first set of scores and the first total assessment score, wherein the first set of scores and the first total assessment score are provided as a result of the first set of confidence values and the first total confidence value satisfying a sufficiency threshold;
obtain, during the live conversation and in real-time, a second set of communications exchanged among the set of users, wherein the second set of communications is exchanged among the set of users after the first set of communications;
evaluate, through the LLM, the first set of communications and the second set of communications to generate a second set of scores associated with the first set of communications and the second set of communications, wherein the second set of scores is generated according to the different assessment criteria and a second set of confidence values associated with the second set of scores; and
generate, based on the second set of scores and the second set of confidence values, a new total assessment score for the live conversation and a new total confidence value for the new total assessment score.

11. The system of claim 10, wherein the assessment instrument is selected from the group consisting of a therapeutic engagement index (TEI) assessment, a general anxiety disorder 7-item assessment (GAD-7), a personal health questionnaire 9-item assessment (PHQ-9), a quality of life assessment (QoL), and a caregiver burden assessment.

12. The system of claim 10, wherein the streaming input data includes real-time audio containing the first set of communications exchanged during the live conversation.

13. The system of claim 10, wherein the instructions that cause the system to evaluate the streaming input data through the LLM further cause the system to:
instantiate a prompt according to a role, wherein the prompt causes the LLM to assume the role for processing the streaming input data and generating outputs corresponding to the first set of scores and the first set of confidence values.

14. The system of claim 10, wherein the LLM performs a simulation of the assessment instrument in real-time according to the streaming input data and without interacting with any of the set of users to generate the first set of scores and the first set of confidence values.

15. The system of claim 10, wherein the instructions that cause the system to evaluate the streaming input data through the LLM further cause the system to:
transform a prompt into a story-based ontology instance associated with a story-based ontology, wherein the prompt instructs the LLM to process the streaming input data according to the story-based ontology instance to generate outputs corresponding to the first set of scores and the first set of confidence values.

16. The system of claim 10, wherein the streaming input data is segmented into a set of data slices corresponding to the first set of communications, and wherein the LLM generates the first set of scores and the first set of confidence values for each data slice of the set of data slices.

17. The system of claim 10, wherein the instructions further cause the system to:
obtain, based on new streaming input data associated with the live conversation, feedback corresponding to at least one of the first total assessment score or a subset of the first set of scores; and
re-train the LLM using labeled training data comprising the feedback, the first total assessment score, and the first set of scores.

18. The system of claim 10, wherein the set of users includes at least one automated intelligent agent.

19. A non-transitory computer-readable storage medium storing thereon executable instructions that, as a result of being executed by one or more processors of a computer system, cause the computer system to:
evaluate, through a large language model (LLM), streaming input data corresponding to a live conversation among a set of users to generate a first set of scores associated with a first set of communications exchanged during the live conversation, wherein the first set of communications is evaluated according to a scoring rubric associated with an assessment instrument, and wherein the first set of scores is generated according to different assessment criteria associated with the assessment instrument and a first set of confidence values associated with the first set of scores;
generate, based on the first set of scores and the first set of confidence values generated by the LLM, a first total assessment score for the live conversation and a first total confidence value for the first total assessment score;
provide, during the live conversation, the first set of scores and the first total assessment score, wherein the first set of scores and the first total assessment score are provided as a result of the first set of confidence values and the first total confidence value satisfying a sufficiency threshold;
obtain, during the live conversation and in real-time, a second set of communications exchanged among the set of users, wherein the second set of communications is exchanged among the set of users after the first set of communications;
evaluate, through the LLM, the first set of communications and the second set of communications to generate a second set of scores associated with the first set of communications and the second set of communications, wherein the second set of scores is generated according to the different assessment criteria and a second set of confidence values associated with the second set of scores; and
generate, based on the second set of scores and the second set of confidence values, a new total assessment score for the live conversation and a new total confidence value for the new total assessment score.

20. The non-transitory computer-readable storage medium of claim 19, wherein the assessment instrument is selected from the group consisting of a therapeutic engagement index (TEI) assessment, a general anxiety disorder 7-item assessment (GAD-7), a personal health questionnaire 9-item assessment (PHQ-9), a quality of life assessment (QoL), and a caregiver burden assessment.

21. The non-transitory computer-readable storage medium of claim 19, wherein the streaming input data includes real-time audio containing the first set of communications exchanged during the live conversation.

22. The non-transitory computer-readable storage medium of claim 19, wherein the executable instructions that cause the computer system to evaluate the streaming input data through the LLM further cause the computer system to:
instantiate a prompt according to a role, wherein the prompt causes the LLM to assume the role for processing the streaming input data and generating outputs corresponding to the first set of scores and the first set of confidence values.

23. The non-transitory computer-readable storage medium of claim 19, wherein the LLM performs a simulation of the assessment instrument in real-time according to the streaming input data and without interacting with any of the set of users to generate the first set of scores and the first set of confidence values.

24. The non-transitory computer-readable storage medium of claim 19, wherein the executable instructions that cause the computer system to evaluate the streaming input data through the LLM further cause the computer system to:
transform a prompt into a story-based ontology instance associated with a story-based ontology, wherein the prompt instructs the LLM to process the streaming input data according to the story-based ontology instance to generate outputs corresponding to the first set of scores and the first set of confidence values.

25. The non-transitory computer-readable storage medium of claim 19, wherein the streaming input data is segmented into a set of data slices corresponding to the first set of communications, and wherein the LLM generates the first set of scores and the first set of confidence values for each data slice of the set of data slices.

26. The non-transitory computer-readable storage medium of claim 19, wherein the executable instructions further cause the computer system to:
obtain, based on new streaming input data associated with the live conversation, feedback corresponding to at least one of the first total assessment score or a subset of the first set of scores; and
re-train the LLM using labeled training data comprising the feedback, the first total assessment score, and the first set of scores.

27. The non-transitory computer-readable storage medium of claim 19, wherein the set of users includes at least one automated intelligent agent.
